(19) United States
(12) Patent Application Publication
(10) Pub. No.: US 2006/0110135 A1
(43) Pub. Date: May 25, 2006

(54) Information storage medium, information playback method, and information playback apparatus

(76) Inventors: Shunichi Kawabata, Ome-shi (JP); Takero Kobayashi, Akishima-shi (JP); Yasufumi Tsumagari, Yokohama-shi (JP); Hideki Mimura, Yokohama-shi (JP); Yasuhiro Ishibashi, Ome-shi (JP); Kazuhiko Taira, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/282,828

(22) Filed: Nov. 21, 2005

(30) Foreign Application Priority Data
Nov. 22, 2004 (JP) 2004-338077

(51) Int. Cl. H04N 7/52

(52) U.S. Cl. 386/95; 386/125; 386/126

(57) ABSTRACT

A data area of an information storage medium according to an embodiment of the invention has a video data recording area including an area for recording expanded video objects in addition to a management area, and an advanced content recording area including information different from the recording content of this area. The advanced content recording area has a playback sequence information recording area that stores playback sequence information which can arbitrarily define a playback sequence upon playing back a video picture of the expanded video objects using a markup language.

### CROSS-REFERENCE TO RELATED APPLICATIONS

This application is based upon and claims the benefit of priority from prior Japanese Patent Application No. 2004-338077, filed Nov. 22, 2004, the entire contents of which are incorporated herein by reference.

### BACKGROUND OF THE INVENTION

1. Field of the Invention

The invention relates to an information storage medium such as an optical disc or the like, a method of playing back this information storage medium, and an information playback apparatus for playing back this information storage medium.

2. Description of the Related Art

In recent years, DVD-Video discs having high image quality and advanced functions, and video players that play back such discs have prevailed, and the range of choice for peripheral devices and the like used to play back such multi-channel audio has broadened. An environment in which users can personally implement a home theater and allows users to freely enjoy movies, animations, and the like with high image quality and high sound quality at home has become available. As described in Jpn. Pat. Appln. KOKAI Publication No. 10-50036 (p. 18 to 20, FIGS. 50 to 57), a playback apparatus which can superimpose various menus by changing, e.g., text colors for playback video pictures from a disc has been proposed.

However, in recent years, along with the improvement of image compression techniques, a demand has arisen for realization of higher image quality from both users and content providers. In addition to realization of higher image quality, the content providers require an environment that can provide more attractive content to users by upgrading and expanding the content (e.g., more colorful menus, improvement of interactiveness, and the like) in content such as menu screens, bonus video pictures, and the like as well as a title itself. Furthermore, some users require to freely enjoy content by playing back still picture data sensed by the user, subtitle text data acquired via Internet connection, and the like by freely designating their playback positions, playback regions, or playback times.

As described above, an environment that can provide more attractive content to users by upgrading and expanding the content (e.g., more colorful menus, improvement of interactiveness, and the like) in content such as menu screens, bonus video pictures, and the like in addition to realization of higher image quality of a title itself is required.

On the other hand, in order to produce content with more colorful menus and high interactiveness, a technique different from conventional content production is required. Hence, much time must be spent to master such a technique. For this reason, a content providing environment that allows the conventional production technique and can realize high image quality of a title itself (although functions are a little more than the conventional technique) is required at the same time.

In a conventional DVD-Video disc (ROM disc), a video object to be played back (to be referred to as a VOB or EVOB) and/or its playback order is determined on the basis of program chain (PGC) information which is set, determined in advance, and recorded on a disc by content producers. However, a video object to be played back and its playback order are determined in advance upon its production and cannot be changed after the disc is produced. That is, when the above video object to be played back and its playback order are to be changed, the content producers need to make new management information of the DVD-Video disc and record a changed PGC on a new disc, and users need to buy the DVD-Video disc with the changed PGC recorded thereon.

### BRIEF SUMMARY OF THE INVENTION

An embodiment of the invention can provide an environment, with respect to content recorded on a read-only information storage medium such as a DVD-video disc, to implement video objects to be played back by a method different from an existing playback sequence and control of its playback order.

An information storage medium (1) according to an embodiment of the invention may have a data area (12) storing a video data recording area (20) that includes a management area (30) which records management information and an object area (40, 50) which records objects to be managed by this management information, and an advanced content recording area (21) which includes information (21A to 21E) different from recording content (30 to 50) of the video data recording area (20), and a file information area (11) that stores file information corresponding to recording content of the data area (12). In the information storage medium, the object area (40, 50) is configured to store expanded video objects (objects in an HDVTS; to be abbreviated as EVOBS or VOBS hereinafter as needed) which undergo playback management using a logical unit called a program chain, and advanced objects (objects in an AHDVTS) recorded independently of the expanded video objects.

The advanced objects may be configured to store playback sequence information (playback control information implemented using a markup language or the like) that describes the playback order of the expanded video objects, playback control information that gives the playback conditions (playback timings, picture output positions, display sizes, and the like) of the other advanced objects, and the like.

Note that the playback conditions (or playback control information/playback sequence information) can be described by providers and the like of content recorded on the information storage medium using a predetermined language (markup language or the like). Also, the provider supplies the markup language that gives playback conditions to a playback apparatus using a network (Internet or the like) and can update management information which is recorded on the information storage medium and is uniquely determined so far.

By practicing the invention, it is possible to provide an information storage medium and its playback apparatus/method, which can implement colorful expressions and can form attractive content.

### BRIEF DESCRIPTION OF THE SEVERAL VIEWS OF THE DRAWING

FIG. 1 shows an example of the data structure of recording information on disc-shaped information storage medium (optical disc, etc.) 1 according to an embodiment of the present invention;

FIG. 2 is a view for explaining an example of a file system used to manage content recorded on the disc-shaped information storage medium according to the embodiment of the present invention;

FIG. 3 shows an example of the data structure of HD video manager information (HDVMGI) recorded on an HD video manager (HDVMG) recording area;

FIG. 4 shows an example of the data structure of an HD video manager information management table (HDVMGI_MAT) included in the HD video manager information (HDVMGI) and the recording content of category information (HDVMG_CAT) stored in this management table;

FIG. 5 shows an example of the data structure of a title search pointer table (TT_SRPT) recorded in the HD video manager information (HDVMGI);

FIG. 6 shows an example of the data structure of an HD video manager menu PGCI unit table (HDVMGM_PGCI_UT) recorded in the HD video manager information (HDVMGI);

FIG. 7 shows an example of the data structure of each HD video manager menu language unit (HDVMGM_LU#n);

FIG. 8 shows an example of the recording content of an HDVMGM_PGC category (HDVMGM_PGC_CAT);

FIG. 9 shows an example of the data structure of a parental management information table (PTL_MAIT) recorded in the HD video manager information (HDVMGI);

FIG. 10 shows an example of the data structure of each parental management information (PTL_MAI#n);

FIG. 11 shows an example of the data structure of an HD video title set attribute information table (HDVTS_ATRT) recorded in the HD video manager information (HDVMGI);

FIG. 12 shows an example of the data structure of a text data manager (TXTDT_MG) recorded in the HD video manager information (HDVMGI);

FIG. 13 shows an example of the data structure of each text data language unit (TXTDT_LU#n);

FIG. 14 shows an example of the data structure of text data (TXTDT);

FIG. 15 shows an example of the data structure of an HD video manager menu cell address table (HDMVGM_C_ADT) recorded in the HD video manager information (HDVMGI);

FIG. 16 shows an example of the data structure of an HD video manager menu video object unit address map (HDVMGM_VOBU_ADMAP) recorded in the HD video manager information (HDVMGI);

FIG. 17 shows an example of the data structure of an HD menu audio object set information table (HDMENU_AOBSIT) recorded in the HD video manager information (HDVMGI);

FIG. 18 shows an example of the data structure of a menu video object area (HDVMGM_VOBS) recorded in the HD video manager (HDVMG) area;

FIG. 19 shows an example of the data structure of a menu audio object area (HDMENU_AOBS) recorded in the HD video manager (HDVMG) area;

FIG. 20 shows an example of the data structure of HD video title set information (HDVTSI) recorded on each HD video title set (HDVTS#n) recording area;

FIG. 21 shows an example of the data structure of an HD video title set information management table (HDVTSI_MAT) recorded in the HD video title set information (HDVTSI);

FIG. 22 shows an example of the data structure of an HD video title set part-of-title search pointer table (HDVTS_PTT_SRPT) recorded in the HD video title set information (HDVTSI);

FIG. 23 shows an example of the data structure of an HD video title set program chain information table (HDVTS_PGCIT) recorded in the HD video title set information (HDVTSI);

FIG. 24 shows an example of the recording content of an HDVTS_PGC category (HDVTS_PGC_CAT);

FIG. 25 shows an example of the data structure of an HD video title set menu PGCI unit table (HDVTSM_PGCI_UT) recorded in the HD video title set information (HDVTSI);

FIG. 26 shows an example of the data structure of each HD video title set menu language unit (HDVTSM_LU#n);

FIG. 27 shows an example of the recording content of an HDVTSM_PGC category (HDVTSM_PGC_CAT);

FIG. 28 shows an example of the data structure of an HD video title set time map table (HDVTS_TMAPT) recorded in the HD video title set information (HDVTSI);

FIG. 29 shows an example of the data structure of an HD video title set menu cell address table (HDVTSM_C_ADT) recorded in HD video title set information (HDVTSI);

FIG. 30 shows an example of the data structure of an HD video title set menu video object unit address map (HDVTSM_VOBU_ADMAP) recorded in HD video title set information (HDVTSI);

FIG. 31 shows an example of the data structure of an HD video title set cell address table (HDVTS_C_ADT) recorded in HD video title set information (HDVTSI);

FIG. 32 shows an example of the data structure of an HD video title set video object unit address map (HDVTS_VOBU_ADMAP) recorded in HD video title set information (HDVTSI);

FIG. 33 shows an example of the data structure of program chain general information (PGC_GI) included in program chain information (PGCI: e.g., corresponding to one of HDVTS_PGCI in FIG. 23), and the recording content of a PGC graphics unit stream control table (PGC_GUST_CTLT) and resume/audio object category (RSM&AOB_CAT) stored in this PGCI;

FIG. 34 shows an example of the data structure of a program chain command table (PGC_CMDT) included in the program chain information (PGCI);

FIG. 35 shows an example of the content of program chain command table information (PGC_CMDTI) and each resume command (RSM_CMD) included in the program chain command table (PGC_CMDT);

FIG. 36 shows an example of the data structure of a program chain program map (PGC_PGMAP) and that of a cell position information table (C_POSIT) included in the program chain information (PGCI);

FIG. 37 shows an example of the data structure of a cell playback information table (C_PBIT) included in the program chain information (PGCI);

FIG. 38 is a block diagram showing an example of the internal structure of a playback apparatus for the disc-shaped information storage medium (optical disc, etc.) according to the embodiment of the present invention;

FIG. 39 is a block diagram for explaining an example of the arrangement of each decoder in the apparatus shown in FIG. 38;

FIG. 40 is a view for explaining the concept of imaginary video access unit IVAU;

FIG. 41 is a view for explaining a practical example of system parameters used in the embodiment of the present invention;

FIG. 42 shows an example of a list of commands used in the embodiment of the present invention;

FIG. 43 shows practical examples in respective fields of the commands used in the embodiment of the present invention;

FIG. 44 shows an example of allocation of graphics units GU in video objects;

FIG. 45 shows an example of the data structure in each graphics unit;

FIG. 46 shows an example of header information content and general information content in each graphics unit;

FIG. 47 is a view for explaining image examples of mask data and graphics data in each graphics unit;

FIG. 48 is a view showing an example of video composition including mask patterns;

FIG. 49 is a view for explaining an example of button position information in graphics unit GU;

FIG. 50 is a view for explaining an example of the recording content of an advanced content recording area of the information content recorded on disc-shaped information storage medium (optical disc, etc.) 1 according to another embodiment of the present invention;

FIG. 51 is a view for explaining an example of the recording content of an advanced HD video title set (AHDVTS) recording area of the information content recorded on disc-shaped information storage medium (optical disc, etc.) 1 according to still another embodiment of the present invention;

FIG. 52 shows an example of the data structure of advanced HD video title set information (AHDVTSI) recorded on the advanced HD video title set recording area;

FIG. 53 shows an example of the data structure of an advanced HD video title set information management table (AHDVTSI_MAT) recorded in the advanced HD video title set information (AHDVTSI), and the recording content of category information (AHDVTS_CAT) stored in this management table;

FIG. 54 shows an example of the data structure of an advanced HD video title set part-of-title search pointer table (AHDVTS_PTT_SRPT) recorded in the advanced HD video title set information (AHDVTSI);

FIG. 55 shows an example of the data structure of an advanced HD video title set program chain information table (AHDVTS_PGCIT) recorded in the advanced HD video title set information (AHDVTSI);

FIG. 56 shows an example of the data structure of program chain general information (PGC_GI) included in program chain information (PGCI: e.g., corresponding to AHDVTS_PGCI in FIG. 55);

FIG. 57 shows an example of the data structure of an advanced HD video title set cell address table (AHDVTS_C_ADT) recorded in the advanced HD video title set information (AHDVTSI);

FIG. 58 shows an example of the data structure of a time map information table (TMAPIT) recorded in the advanced HD video title set information (AHDVTSI);

FIG. 59 shows an example of the data structure of each time map information (TMAPI) included in the time map information table (TMAPIT), and the recording content of time map generation information (TMAP_GI) stored in this time map information;

FIG. 60 shows an example of the data structure of a time entry table (TM_ENT) included in the time map information (TMAPI) and the recording content of the number of time entries (TM_EN_Ns) and a time entry (TM_EN) stored in this time entry table;

FIG. 61 shows an example of the recording content of a video object unit entry (VOBU_ENT), those of an interleaved unit address entry (ILVU_ADR_ENT), and those of an entry video object number (ENT_VOBN), which are included in the time map information (TMAPI);

FIG. 62 is a flowchart for explaining an example of the playback sequence of an advanced VTS (AHDVTS in FIGS. 51, 74, 79, and the like) according to the content of information (application type) included in the management information (e.g., AHDVTS_CAT in FIG. 53);

FIG. 63 is a view for explaining the configuration of a navigation pack (NV_PCK) allocated at the head of each data unit (EVOBU) used in an expanded video object (a video object in an HDVTS) according to the embodiment of the present invention;

FIG. 64 shows an example of the data structure of playback control information (PCI) in the navigation pack (NV_PCK) used in the expanded video object;

FIG. 65 shows an example of the data structure of data search information (DSI) in the navigation pack (NV_PCK) used in the expanded video object;

FIG. 66 is a view for explaining an example of the configuration of an advanced VTS (AHDVTS);

FIG. 67 is a view for explaining elements which form a time map according to the embodiment of the present invention;

FIG. 68 is a view for explaining practical elements which form the time map;

FIG. 69 shows an example of a case wherein a plurality of objects (e.g., VOB#2 and VOB#3) are to be played back using ILVU data of an interleaved block;

FIG. 70 is a view for explaining a time map of an ILVU interval in the example of FIG. 69;

FIG. 71 is a view for explaining a time map in the interleaved block;

FIG. 72 is a block diagram showing an example of the internal structure of a playback apparatus according to still another embodiment of the present invention;

FIG. 73 is a view for explaining a part (HDVMG_CAT) of the recording content of an HD video manager (HDVMG) recording area of the information content recorded on disc-shaped information storage medium (content type 1 disc) 1 according to still another embodiment of the present invention;

FIG. 74 is a view for explaining the data structure (AHDVMGI is allocated in the HDVMG unlike in the example of FIG. 1) of an HD video manager (HDVMG) recording area of the information content recorded on disc-shaped information storage medium (content type 2 disc example 1) 1 according to still another embodiment of the present invention;

FIG. 75 shows an example of the data structure of advanced HD video manager information (AHDVMGI) recorded on the HD video manager (HDVMG) shown in FIG. 74;

FIG. 76 shows an example of the data structure of an advanced HD video manager information management table (AHDVMGI_MAT) included in the advanced HD video manager information (AHDVMGI), and the recording content of category information (HDVMG_CAT) stored in this management table;

FIG. 77 shows an example of the data structure of an advanced title search pointer table (ADTT_SRPT) included in the advanced HD video manager information (AHDVMGI);

FIG. 78 is a view for explaining a playback model (example 1) of a disc that records an advanced VTS (AHDVTS);

FIG. 79 is a view for explaining the data structure of video data recording area 20 and advanced content recording area 21 of the information content recorded on disc-shaped information storage medium (content type 2 disc example 2) 1 according to still another embodiment of the present invention;

FIG. 80 shows an example of the data structure of advanced HD video manager information (AHDVMGI) that can be recorded in an HD video manager (HDVMG) shown in FIG. 79;

FIG. 81 shows an example of the data structure of an advanced HD video manager information management table (AHDVMGI_MAT) included in the advanced video manager information (AHDVMGI) in FIG. 80, and the recording content (the content different from FIG. 76) of category information (HDVMG_CAT) stored in this management table;

FIG. 82 shows an example of the data structure (the content different from FIG. 77) of an advanced title search pointer table (ADTT_SRPT) included in the advanced video manager information (AHDVMGI) in FIG. 80;

FIG. 83 is a view for explaining the relationship between the advanced VTS playback state and standard VTS playback state;

FIG. 84 is a view for explaining a playback control module shift command on the DVD-Video playback engine side;

FIG. 85 is a flowchart for explaining a switching algorithm of a user command process;

FIG. 86 is a view for explaining a domain transition model in a content type 2 disc (FIG. 79, etc.) which records the advanced VTS and standard VTS together;

FIG. 87 is a view for explaining a playback model (example 2) that records the advanced VTS (AHDVTS) and standard VTS (HDVTS) together;

FIG. 88 is a view for explaining a unique reference model of objects in a disc that records the advanced VTS (AHDVTS) and standard VTS (HDVTS) together;

FIG. 89 is a view for explaining a shared reference model of objects in a disc that records the advanced VTS (AHDVTS) and standard VTS (HDVTS) together;

FIG. 90 is a view for explaining a practical example of loading information included in advanced content;

FIG. 91 is a block diagram for explaining the arrangement of a buffer manager in an interactive engine of the apparatus shown in FIG. 72;

FIG. 92 is a flowchart for explaining an example of the apparatus operation when the interactive engine of the apparatus shown in FIG. 72 is activated;

FIG. 93 is a view for explaining an example of the configuration of an advanced VTS having multiple PGCs;

FIG. 94 is a view for explaining an example of the configuration of an advanced VTS having one PGC;

FIG. 95 is a view for explaining a description example (an example using the chapter/PTT numbers) of a playback sequence in a playback sequence information file (e.g., file PBSEQ001.XML in FIG. 2);

FIG. 96 is a view for explaining another description example (an example using the cell numbers) of a playback sequence in a playback sequence information file (a PBSEQ001.XML file or the like);

FIG. 97 is a view for explaining still another description example (an example using the PGC number and chapter/PTT numbers) of a playback sequence in a playback sequence information file (file PBSEQ001.XML or the like);

FIG. 98 is a view for explaining yet another description example (an example using the PGC number and cell numbers) of a playback sequence in a playback sequence information file (file PBSEQ001.XML or the like);

FIG. 99 is a flowchart for explaining an example of the processing for initializing the playback sequence of an advanced VTS by a DVD playback engine using a playback sequence information file (e.g., file PBSEQ001.XML in FIG. 2) (so as to initialize to use a playback sequence based on the description of the playback sequence information file in place of that based on existing PGC information);

FIG. 100 is a block diagram for explaining an example of the internal structure of a playback apparatus according to still another embodiment of the present invention;

FIG. 101 is a view showing another example of the data structure of an advanced HD video title set program chain information table (AHDVTS_PGCIT) recorded in advanced HD video title set information (AHDVTSI);

FIG. 102 is a view showing an example of the plane configuration upon super in posing output frames of respective modules in a video mixer shown in FIG. 100;

FIG. 103 is a view for explaining an example of time map information (TMAPI) including no time entry in a case wherein one TMAPI is stored in one TMAP file;

FIG. 104 is a view for explaining an example of time map information (TMAPI) including no time entry in a case wherein one or more pieces (in this example, two pieces) of TMAPI are stored in one TMAP file;

FIG. 105 is a view for explaining the configuration of time map information for EVOBs which are allocated in an interleaved block and form angles;

FIG. 106 is a view showing an example of the data structure of a time map information table (TMAPIT) including no time entry;

FIG. 107 is a view showing an example of the data structure of time map information (TMAPI) including no time entry;

FIG. 108 is a view showing an example of the data structure of control packs (standard GCI_PCK and advanced GCI_PCK) including general control information (GCI);

FIG. 109 is a view showing an example of the data structure of general control information (GCI);

FIG. 110 is a view for explaining another example of the data structure of advanced HD video title set information (advanced VTSI) recorded in the advanced HD video title set recording area;

FIG. 111 is a view showing an example of the data structure of an advanced HD video title set attribute information table (AHDVTS_ATRIT) stored in the advanced VTSI in FIG. 110; and

FIG. 112 is a view showing an example of the data structure of an advanced HD video title set EVOB information table (AHDVTS_EVOBIT) stored in the advanced VTSI in FIG. 110.

### DETAILED DESCRIPTION OF THE INVENTION

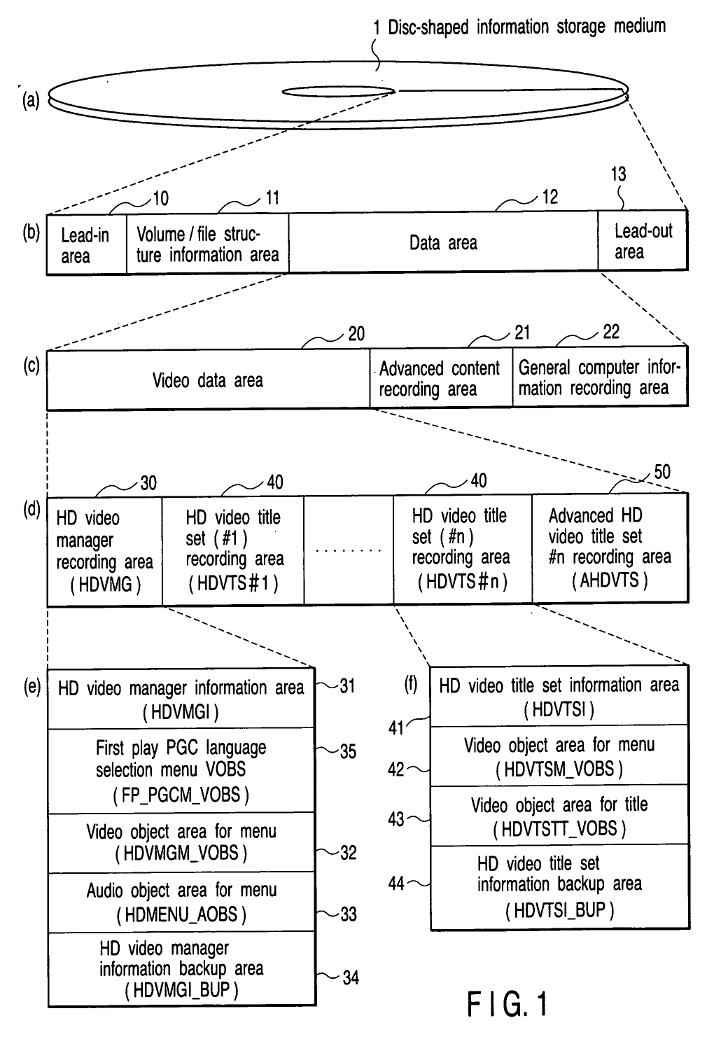

An information storage medium, information playback method, and information playback apparatus according to an embodiment of the present invention will be described hereinafter with reference to the accompanying drawings. FIG. 1 is a view for explaining the information content recorded on a disc-shaped information storage medium according to the embodiment of the present invention. Information storage medium 1 shown in FIG. 1(a) can be configured by a high-density optical disk (a high-density or high-definition digital versatile disc: HD_DVD for short) which uses, e.g., a red laser of a wavelength of 650 nm or a blue laser of a wavelength of 405 nm (or less).

Information storage medium 1 includes lead-in area 10, data area 12, and lead-out area 13 from the inner periphery side, as shown in FIG. 1(b). This information storage medium 1 adopts the ISO 9660 and UDF bridge structures as a file system, and has ISO 9660 and UDF volume/file structure information area 11 on the lead-in side of data area 12.

Data area 12 allows mixed allocations of video data recording area 20 used to record DVD-Video content (also called standard content or SD content), another video data recording area (advanced content recording area used to record advanced content) 21, and general computer information recording area 22, as shown in FIG. 1(c).

Video data recording area 20 includes HD video manager (High Definition-compatible Video Manager [HDVMG]) recording area 30 that records management information associated with the entire HD_DVD-Video content recorded in video data recording area 20, HD video title set (High Definition-compatible Video Title Set [HDVTS], also called standard VTS) recording area 40 which are arranged for respective titles, and record management information and video information (video objects) for respective titles together, and advanced HD video title set (advanced VTS) recording area [AHDVTS] 50, as shown in FIG. 1(d).

HD video manager (HDVMG) recording area 30 includes HD video manager information (High Definition-compatible Video Manager Information [HDVMGI]) area 31 that indicates management information associated with overall video data recording area 20, HD video manager information backup (HDVMGI_BUP) area 34 that records the same information as in HD video manager information area 31 as its backup, and menu video object (HDVMGM_VOBS) area 32 that records a top menu screen indicating whole video data recording area 20, as shown in FIG. 1(e).

In the embodiment of the present invention, HD video manager recording area 30 newly includes menu audio object (HDMENU_AOBS) area 33 that records audio information to be output in parallel upon menu display. An area of first play PGC language select menu VOBS (FP_PGCM_VOBS) 35 which is executed upon first access immediately after disc (information storage medium) 1 is loaded into a disc drive is configured to record a screen that can set a menu description language code and the like.

One HD video title set (HDVTS) recording area 40 that records management information and video information (video objects) together for each title includes HD video title set information (HDVTSI) area 41 which records management information for all content in HD video title set recording area 40, HD video title set information backup (HDVTSI_BUP) area 44 which records the same information as in HD video title set information area 41 as its backup data, menu video object (HDVTSM_VOBS) area 42 which records information of menu screens for each video title set, and title video object (HDVTSTT_VOBS) area 43 which records video object data (title video information) in this video title set.

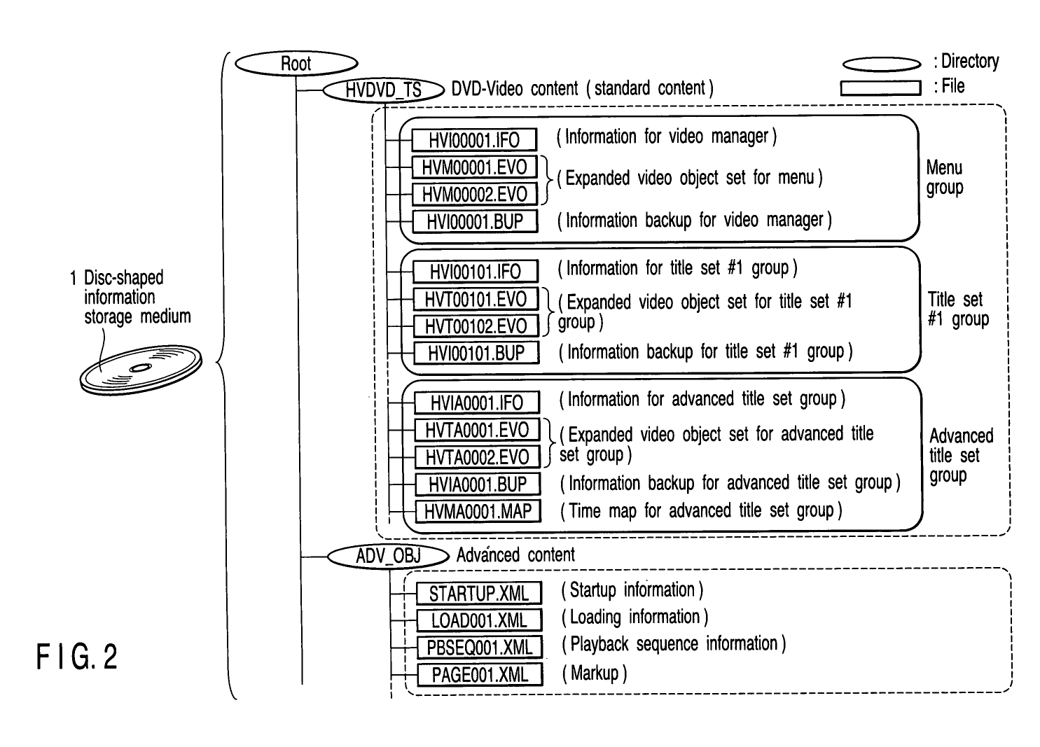

FIG. 2 is a view for explaining an example of a file system which manages content recorded on the disc-shaped information storage medium according to the embodiment of the present invention. The areas (30, 40) shown in FIG. 1 form independent files in the file system having the ISO 9660 and UDF bridge structures. Conventional (standard SD) DVD-Video content are allocated together under a directory named “VIDEO_TS”. On the other hand, files according to the embodiment of the present invention have a configuration in which an HVDVD_TS directory for storing information files that handle High-Definition video data, and an ADV_OBJ directory for storing information files that handle advanced object data are allocated under a Root directory, as shown in, e.g., FIG. 2.

The HVDVD_TS directory broadly includes a group of files which belong to a menu group used for a menu, and groups of files which belong to title set groups used for titles. As the group of files that belong to the menu group, an information file (HVI00001.IFO) for a video manager having information used to manage the entire disk, its backup file (HVI00001.BUP), and playback data files (HVM00001.EVO to HVM00003.EVO) of expanded video object sets for a menu used as background frames of a menu are stored.

As the group of files that belong to a title set #n group (e.g., title set #1 group), an information file (HVIxxx01.IFO: xxx=001 to 999) for a video title set having information used to manage title set #n, its backup file (HVIxxx01.BUP: xxx=001 to 999), playback data files (HVTxxxyy.EVO: xxx=001 to 999, yy=01 to 99) of expanded video object sets for title set #n used as a title are stored.

Furthermore, as the group of files that belong to an advanced title set group, an information file (HVIA0001.IFO) for a video title set having information used to manage an advanced title set, its backup file (HVIA0001.BUP), playback data files (HVTAxxyy.EVO: xx=01 to 99, yy=01 to 99) of video object sets for advanced title sets used as titles, time map information files (HVMAxxxx.MAP: xxxx=0001 to 9999) for advanced title sets, their backup files (HVMAxxxx.BUP: xxxx=0001 to 9999, not shown), and the like are stored.

The ADV_OBJ directory stores a startup information file (STARTUP.XML), loading information file (LOAD001.XML), playback sequence information file (PBSEQ001.XML), markup language file (PAGE001.XML), moving picture data, animation data, still picture data file, audio data file, font data file, and the like. Note that the content of the startup information file include startup information of data such as moving picture data, animation data, still picture data, audio data, font data, a markup language used to control playback of these data, and the like. The loading information file records loading information (that can be described using a markup language/script language/stylesheet, and the like), which describes information associated with files to be loaded onto a buffer in a playback apparatus, and the like.

The playback sequence information file (PBSEQ001.XML) records playback sequence information (that can be also described using a markup language or the like), which defines a section to be played back of the playback data files of expansion video object sets for advanced title sets in the advanced title set group, and the like.

Note that the markup language is a language that describes text attributes along commands which are defined in advance, and can give the font type, size, color, and the like to a character string as attributes. In other words, the markup language is a description language which describes structures (headings, hyperlinks, and the like) and modification information (character size, the state of composition, and the like) of sentences in these sentences by partially bounding special character strings called tags.

Since a document written using the markup language becomes a text file, the user can normally read it using a text editor, and can edit that file, of course. As typical markup languages, Standard Generalized Markup Language (SGML), Hypertext Markup Language (HTML) evolved from SGML, TeX, and the like are known.

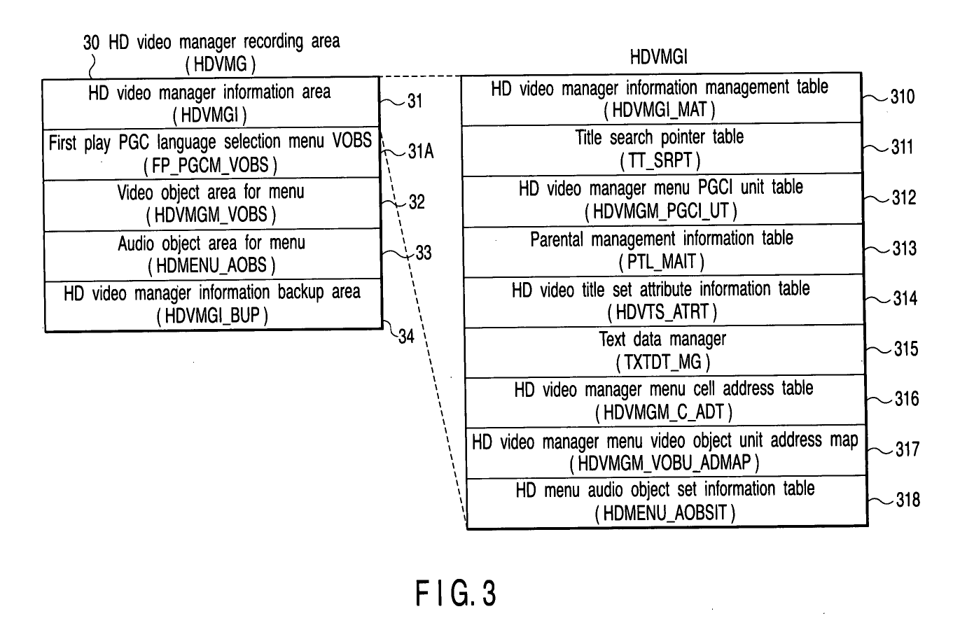

FIG. 3 shows an example of the detailed data structure in HD video manager information (HDVMGI) area 31 shown in FIG. 1(e). At the head of this area 31, HD video manager information management table (HDVMGI_MAT) 310, which records management information common to the entire HD_DVD-Video content recorded in video data recording area 20 together, is allocated. After this table, title search pointer table (TT_SRPT) 311 that records information helpful to search (to detect the start positions of) titles present in the HD_DVD-Video content, HD video manager menu program chain information unit table (HDVMGM_PGCI_UT) 312 that records management information of a menu screen, which is separately allocated for each menu description language code used to display a menu, parental management information table (PTL_MAIT) 313 that records information for managing pictures fit or unfit for children to see as parental information, HD video title set attribute information table (HDVTS_ATRT) 314 that records attributes of title sets together, text data manager (TXTDT_MG) 315 that records text information to be displayed for the user together, HD video manager menu cell address table (HDVMGM_C_ADT) 316 that records information helpful to search for the start address of a cell that forms the menu screen, HD video manager menu video object unit address map (HDVMGM_VOBU_ADMAP) 317 that records address information of VOBU which indicates a minimum unit of video objects that form the menu screen, and HD menu audio object set information table (HDMENU_AOBSIT) 318 are stored in turn. HD menu audio object set information table (HDMENU_AOBSIT) 318 in HD video manager information (HDVMGI) area 31 records management data for objects in menu audio object (HDMENU_AOBS) area 33.

Note that the data structure from HD video manager information management table (HDVMGI_MAT) 310 to HD video manager menu video object unit address map (HDVMGM_VOBU_ADMAP) 317 matches that of the conventional DVD-Video management information.

In the embodiment of the present invention, the field of HD menu audio object set information table (HDMENU_AOBSIT) 318 to be newly added is separately allocated after those which match the conventional DVD-Video management information. With this allocation, a description of a conventional control program using the conventional DVD-Video management information can be utilized upon practicing the present invention (the description of the control program using management information with the same data structure as in the conventional DVD-Video can be commonly used in the prior art and the present invention). In this manner, generation of a control program for an information playback apparatus according to the embodiment of the present invention can be simplified.

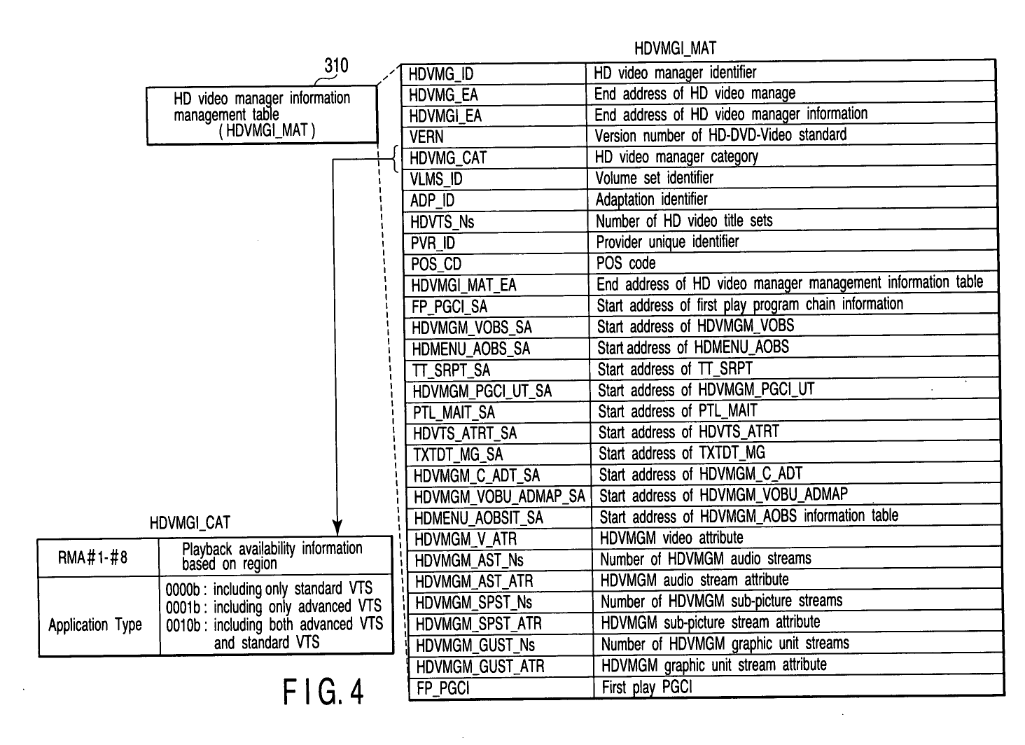

FIG. 4 shows an example of the detailed data structure in HD video manager information management table (HDVMGI_MAT) 310 in FIG. 3. In this management table 310, information of first play PGCI (FP_PGCI) that records language select menu management information for the user, the start address information (HDMENU_AOBS_SA) of an HDMENU_AOBS, the start address information (HDMENU_AOBSIT_SA) of an HDVMGM_AOBS information table, information of the number (HDVMGM_GUST_Ns) of HDVMGM graphics unit streams, HDVMGM graphics unit stream attribute information (HDVMGM_GUST_ATR), and the like are allocated.

In addition, HD video manager information management table (HDVMGI_MAT) 310 records various kinds of information: an HD video manager identifier (HDVMG_ID), the end address (HDVMG_EA) of the HD video manager, the end address (HDVMGI_EA) of the HD video manager information, the version number (VERN) of the HD_DVD-Video standard, an HD video manager category (HDVMG_CAT), a volume set identifier (VLMS_ID), an adaptation identifier (ADP_ID), the number (HDVTS_Ns) of HD video title sets, a provider unique identifier (PVR_ID), a POS code (POS_CD), the end address (HDVMGI_MAT_EA) of the HD video manager information management table, the start address (FP_PGCI_SA) of first play program chain information, the start address (HDVMGM_VOBS_SA) of an HDVMGM_VOBS, the start address (TT_SRPT_SA) of the TT_SRPT, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C_ADT_SA) of the HDVMGM_C_ADT, the start address (HDVMGM_VOBU_ADMAP_SA) of the HDVMGM_VOBU_ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, and an HDVMGM sub-picture stream attribute (HDVMGM_SPST_ATR).

In FIG. 4, the HD video manager category (HDVMG_CAT) includes RMA#1, RMA#2, RMA#3, RMA#4, RMA#5, RMA#6, RMA#7, and RMA#8 which are determined by dividing the world countries into predetermined regions, and indicate playback availability information in respective regions, and application type indicating the VMG category. Note that application type assumes the following values:

$$\begin{matrix}Application type = 000 b \text{:} including only standard VTS \\ = 0001 b \text{:} including only advanced VTS \\ = 0010 b \text{:} including both advanced VTS\end{matrix}$$

and standard VTS That is, when application type is “0000b”, it indicates that this information storage medium is the one (content type 1 disc) including only standard VTS; when application type is “0001b”, it indicates that this information storage medium is the one (content type 2 disc) including only advanced VTS; and when application type is “0010b”, it indicates that this information storage medium is the one (content type 2 disc) including both standard VTS and advanced VTS (to be described in detail later).

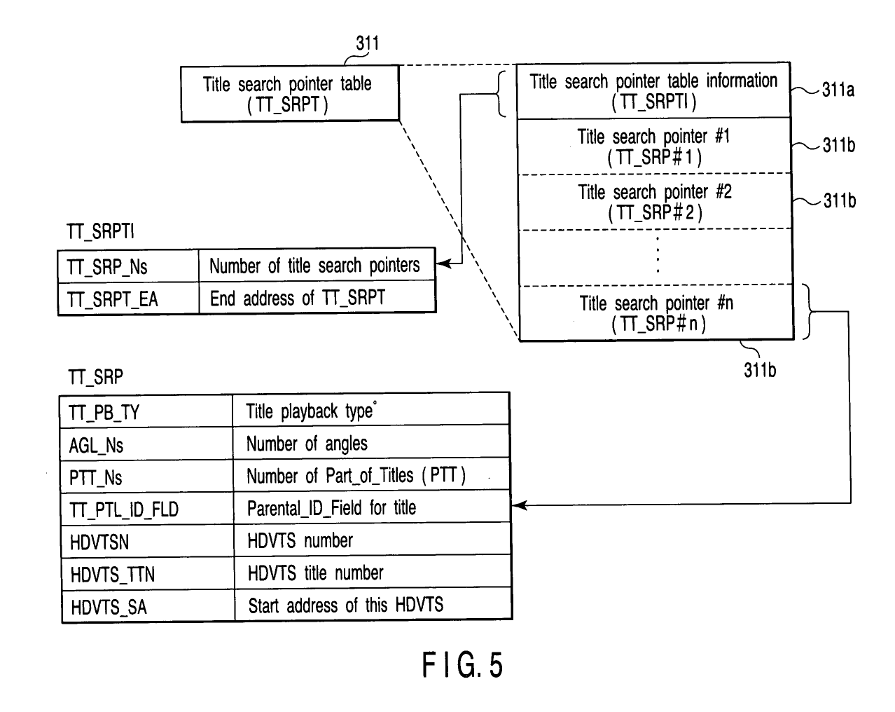

FIG. 5 shows an example of the internal structure of title search pointer table (TT_SRPT) 311 shown in FIG. 3. Title search pointer table (TT_SRPT) 311 includes title search pointer table information (TT_SRPTI) 311a, and title search pointer (TT_SRP) information 311b. One or a plurality of pieces of title search pointer (TT_SRP) information 311b in title search pointer table (TT_SRPT) 311 can be set in correspondence with the number of titles included in the HD_DVD-Video content. Title search pointer table information (TT_SRPTI) 311a records common management information of title search pointer table (TT_SRPT) 311: the number (TT_SRP_Ns) information of title search pointers included in title search pointer table (TT_SRPT) 311, and the end address (TT_SRPT_EA) information of title search pointer table (TT_SRPT) 311 in a file (HD_VMG00.HDI in FIG. 2) of the HD video manager information (HDVMGI) area.

One title search pointer (TT_SRP) information 311b records various kinds of information associated with a title pointed by this search pointer: a title playback type (TT_PB_TY), the number (AGL_Ns) of angles, the number (PTT_Ns) of Part_of_Titles (PTT), title Parental_ID_Field (TT_PTL_ID_FLD) information, an HDVTS number (HDVTSN), an HDVTS title number (HDVTS_TTN), and the start address (HDVTS_SA) of this HDVTS.

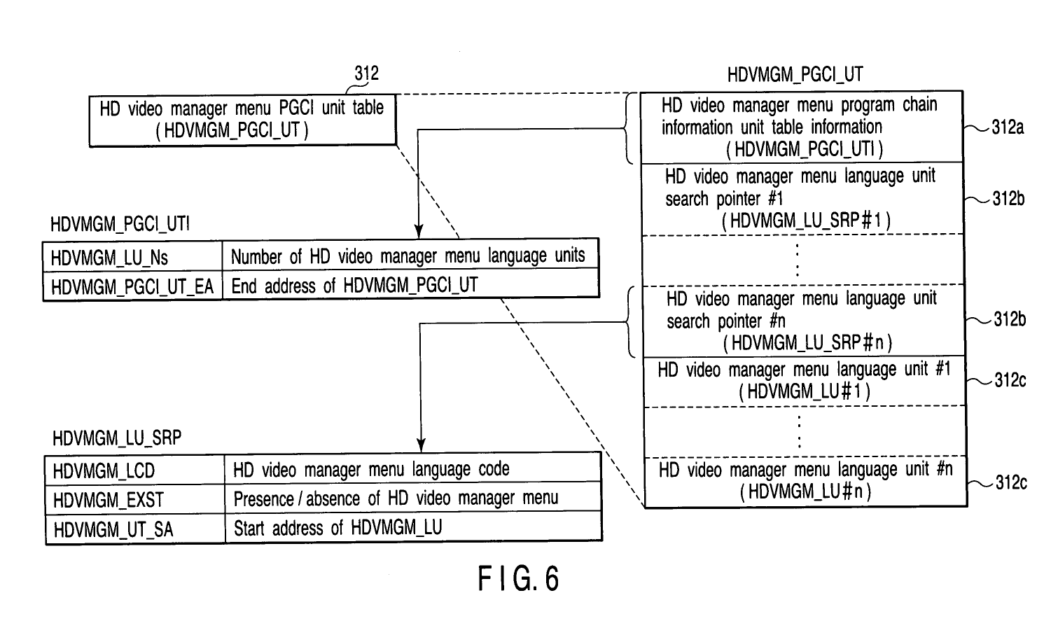

FIG. 6 shows an example of the internal structure of HD video manager menu PGCI unit table (HDVMGM_PGCI_UT) 312 shown in FIG. 3. HD video manager menu PGCI unit table (HDVMGM_PGCI_UT) 312 records HD video manager menu program chain information unit table information (HDVMGM_PGCI_UTI) 312a that records common management information in HD video manager menu PGCI unit table (HDVMGM_PGCI_UT) 312, HD video manager menu language units (HDVMGM_LU) 312c which are arranged for menu description language codes used to display a menu, and record management information associated with menu information, and the like. Table 312 has information of HD video manager menu language units (HDVMGM_LU) 312c as many as the number of menu description language codes supported by the HD_DVD-Video content. HD video manager menu PGCI unit table (HDVMGM_PGCI_UT) 312 has information of HD video manager menu language unit search pointers (HDVMGM_LU_SRP) 312b, which have the start address information of respective HD video manager menu language units (HDVMGM_LU) 312c, as many as the number of HD video manager menu language units (HDVMGM_LU) 312c, so as to facilitate access to HD video manager menu language units (HDVMGM_LU) 312c for respective menu description language codes.

HD video manager menu PGCI unit table information (HDVMGM_PGCI_UTI) 312a has information of the number (HDVMGM_LU_Ns) of HD video manager menu language units, and the end address (HDVMGM_PGCI_UT_EA) of this HD video manager menu PGCI unit table (HDVMGM_PGCI_UT) 312 in a file (HD_VMG00.HDI in FIG. 2) of the HD video manager information (HDVMGI) area.

Each HD video manager menu language unit search pointer (HDVMGM_LU_SRP) information 312b has not only differential address information (HDVMGM_UT_SA) from the start position of HD video manager menu PGCI unit table (HDVMGM_PGCI_UT) 312 in the file (HD_VMG00.HDI in FIG. 2) of the HD video manager information (HDVMGI) area to the head position of corresponding HD video manager menu language unit (HDVMGM_LU) 312c, but also information of an HD video manager menu language code (HDVMGM_LCD) indicating the menu description language code of corresponding HD video manager menu language unit (HDVMGM_LU) 312c, and information of the presence/absence (HDVMGM_EXST) of an HD video manager menu indicating if corresponding HD video manager menu language unit (HDVMGM_LU) 312c has a menu screen to be displayed for the user as a video object (VOB or EVOB).

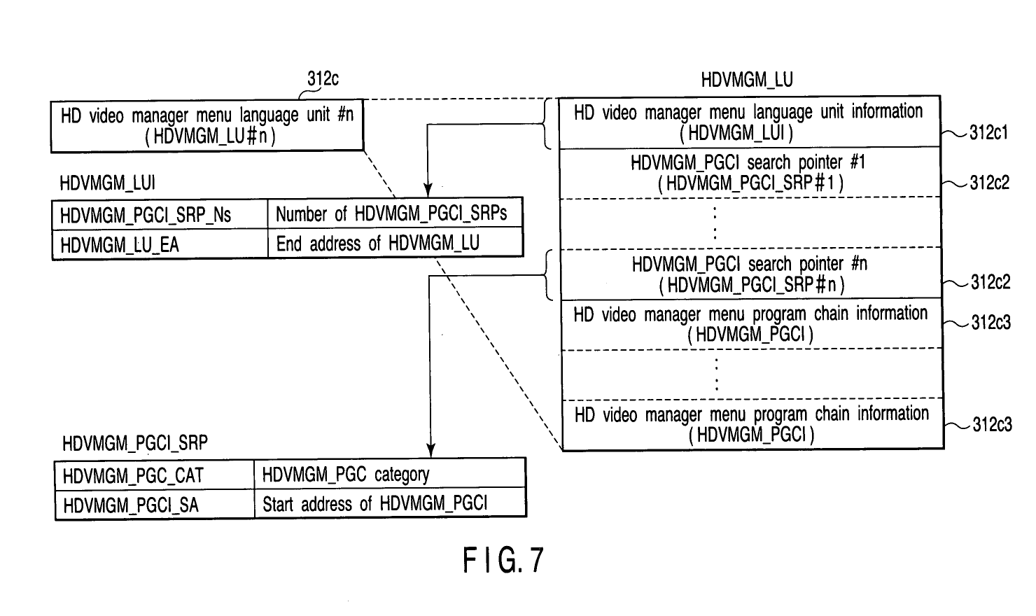

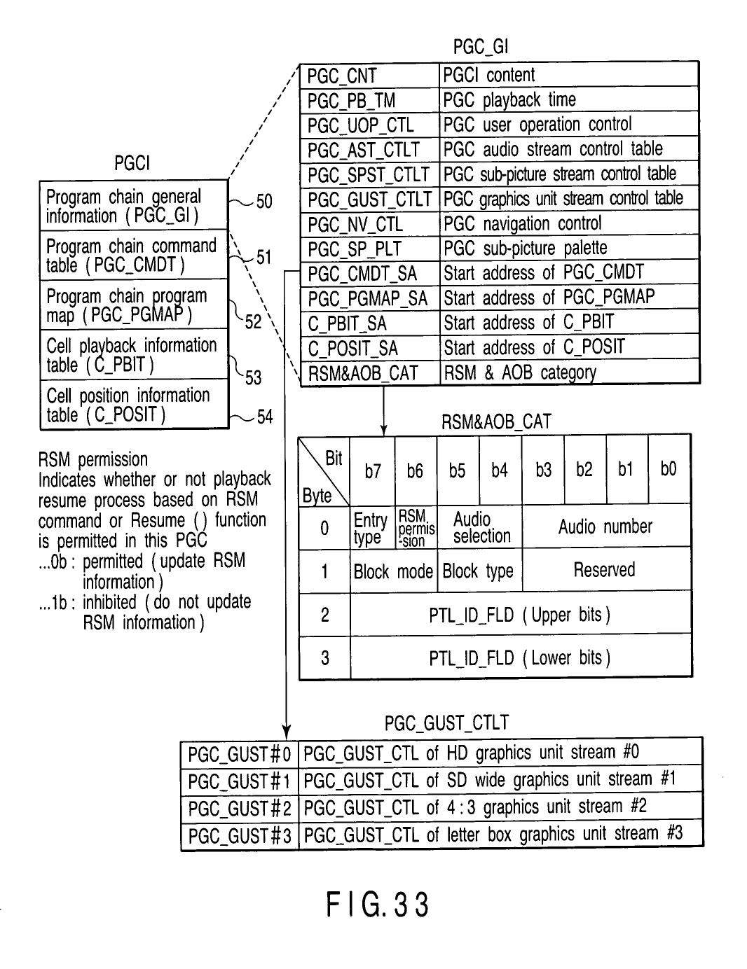

FIG. 7 shows an example of the detailed data structure in HD video manager menu language unit #n (HDVMGM_LU#n) 312c (FIG. 6) recorded in HD video manager menu PGCI unit table (HDVMGM_PGCI_UT) 312 shown in FIG. 3. HD video manager menu language unit (HDVMGM_LU) 312c has the following pieces of information: HD video manager menu language unit information (HDVMGM_LUI) 312c1 that records common management information associated with a menu in HD video manager menu language unit (HDVMGM_LU) 312c, HD video manager menu program chain information (HDVMGM_PGCI) 312c3 having a structure shown in FIG. 33, and information 312c2 of HDVMGM_PGCI search pointers (HDVMGM_PGCI_SRP#1 to HDVMGM_PGCI_SRP#n) each indicating a differential address from the head position of HD video manager menu language unit (HDVMGM_LU) 312c to that of each HD video manager menu program chain information (HDVMGM_PGCI) 312c3 in the file (HD_VMG00.HDI in FIG. 2) of the HD video manager information (HDVMGI) area.

HD video manager menu language unit information (HDVMGM_LUI) 312c1 allocated in the first field (group) in HD video manager menu language unit #n (HDVMGM_LU#n) 312c has information associated with the number (HDVMGM_PCGI_SRP_Ns) of HDVMGM_PGCI_SRP data, and the end address (HDVMGM_LU_EA) information of the HDVMGM_LU. Each information 312c of HDVMGM_PGCI search pointers (HDVMGM_PGCI_SRP#1 to HDVMGM_PGCI_SRP#n) has start address (HDVMGM_PGCI_SA) information of the HDVMGM_PGCI and HDVMGM_PGC category (HDVMGM_PGC_CAT) information.

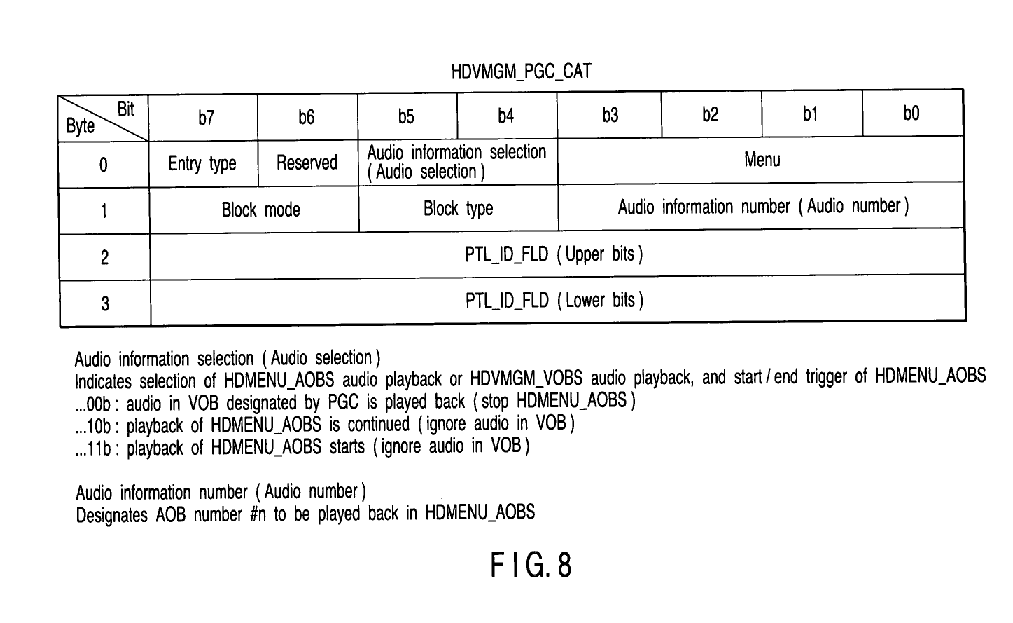

FIG. 8 shows an example of the recording content of the HDVMGM_PGC category (HDVMGM_PGC_CAT) shown in FIG. 7. HDVMGM_PGC category information (HDVMGM_PGC_CAT) in HDVMGM_PGCI search pointer #n (HDVMGM_PGCI_SRP#n) 312c2 records selection information of audio information which is to be simultaneously played back upon displaying an HD content menu in the embodiment of the present invention on the screen, and an audio information selection flag (audio selection information) indicating start/end trigger information of audio information playback. As audio data which is to be simultaneously played back upon displaying the HD content menu in the embodiment of the present invention on the screen, the following audio data can be selected:

<1> audio data (distributed and recorded in audio packs; not shown) recorded in menu video object area (HDVMGM_VOBS) 32 shown in FIG. 1(e), or

<2> audio data which exist in menu audio object area (HDMENU_AOBS) 33 shown in FIG. 1(e) as one or more menu AOB data (HDMENU_AOB) arranged in turn, as shown in FIG. 19.

When the audio information selection flag (Audio Selection information)=“00b” is selected, audio data <1> are played back, and audio playback is interrupted upon switching menus. When the audio information selection flag (audio selection information)=“10b” or “11b” is selected, audio data <2> of menu AOB (HDMENU_AOB) in menu audio object area (HDMENU_AOBS) 33 are played back. Upon playing back audio data <2>, if the audio information selection flag designates “11b”, the audio data begin to be played back from the beginning every time the menu screen is changed; if it designates “10b”, playback of the audio data continues irrespective of switching of menu screens.

In the embodiment of the present invention, menu audio object area (HDMENU_AOBS) 33 can store a plurality of types of menu AOB (HDMENU_AOB) data, as shown in FIG. 19. An audio selection number (audio number information) shown in FIG. 8 can be used as selection information of menu AOB (HDMENU_AOB) to be simultaneously played back upon displaying the menu display PGC of interest. This audio information number can be used to “select which menu AOB from the top” of those which are allocated as menu AOB selection candidates, as shown in FIG. 19.

In addition, the HDVMGM_PGC category (HDVMGM_PGC_CAT) information in FIG. 8 can record entry type information used to check if a PGC of interest is an entry PGC, menu ID information indicating a menu identification (e.g., a title menu or the like), block mode information, block type information, PTL_ID_FLD information, and the like.

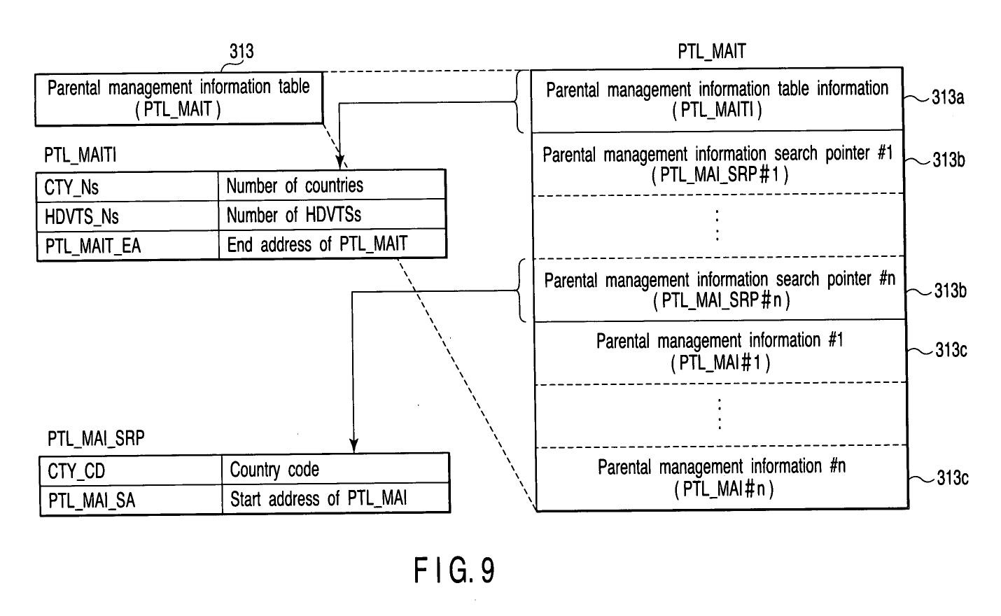

FIG. 9 shows an example of the data structure in parental management information table (PTL_MAIT) 313 shown in FIG. 3. As shown in, e.g., FIG. 9, parental management information table 313 includes parental management information table information (PTL_MAITI) 313a, one or more parental management information search pointers (PTL_MAI_SRP#1 to PTL_MAI_SRP#n) 313b, and a plurality of pieces of parental management information (PTL_MAI#1 to PTL_MAI#n) 313c as many as the number of search pointers. Note that parental management information table information (PTL_MAITI) 313a records information such as the number (CTY_Ns) of countries, the number (HDVTS_Ns) of HDVTS data, the end address (PTL_MAIT_EA) of the PTL_MAIT, and the like. Each parental management information search pointer (PTL_MAI_SRP) 313b records information such as a country code (CTY_CD), the start address (PTL_MAI_SA) of the PTL_MAI, and the like.

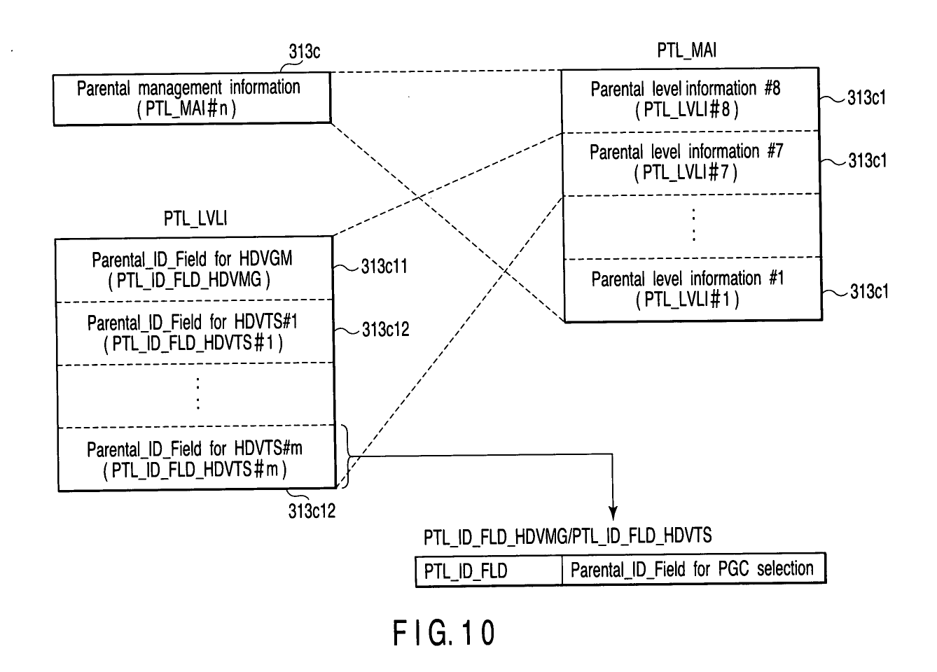

FIG. 10 shows an example of the data structure in parental management information (PTL_MAI) 313c shown in FIG. 9. This parental management information (PTL_MAI) 313c has one or more pieces of parental level information (PTL_LVLI) 313c1. Each parental level information (PTL_LVLI) 313c1 includes information of parental ID field (PTL_ID_FLD_HDVMG) 313c11 for HDVMG, and parental ID field (PTL_ID_FLD_HDVTS) 313c12 for HDVTS. Information of each parental ID field (PTL_ID_FLD_HDVTS) 313c12 for HDVTS can store parental ID field (PTL_ID_FLD) for PGC selection.

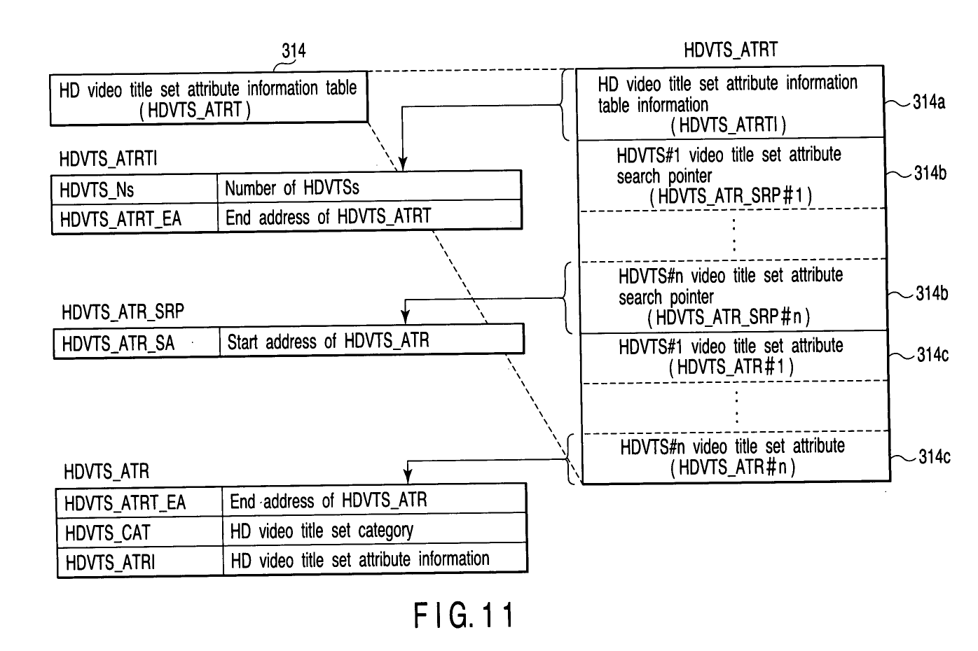

FIG. 11 shows an example of the data structure of HD video title set attribute information table (HDVTS_ATRT) 314 shown in FIG. 3. As shown in FIG. 11, this HD video title set attribute information table 314 includes: HD video title set attribute table information (HDVTS_ATRTI) 314a having information of the number (HDVTS_Ns) of HDVTS data and the end address (HDVTS_ATRT_EA) of the HDVTS_ATRT; HDVTS video title set attribute search pointers (HDVTS_ATR_SRP) 314b each of which records information of the start address (HDVTS_ATR_SA) of the HDVTS_ATR; and HDVTS video title set attributes (HDVTS_ATR) 314c each having information of the end address (HDVTS_ATRT_EA) of the HDVTS_ATR, HD video title set category (HDVTS_CAT), and HD video title set attribute information (HDVTS_ATRI).

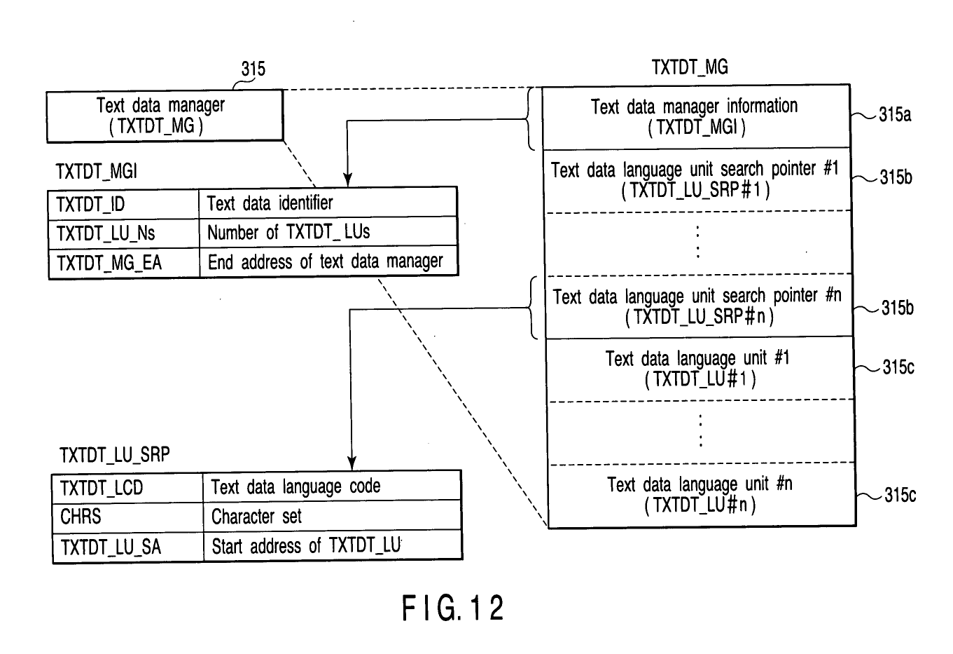

FIG. 12 shows an example of the data structure of text data manager (TXTDT_MG) 315 shown in FIG. 3. As shown in FIG. 12, this text data manager 315 includes text data manager information (TXTDT_MGI) 315a having information of a text data identifier (TXTDT_ID), the number (TXTDT_LU_Ns) of TXTDT_LU data, and the end address (TXTDT_MG_EA) of the text data manager; text data language unit search pointers (TXTDT_LU_SRP) 315b each of which records various kinds of information including a text data language code (TXTDT_LCD), a character set (CHRS), and the start address (TXTDT_LU_SA) of the TXTDT_LU; and text data language units (TXTDT_LU) 315c.

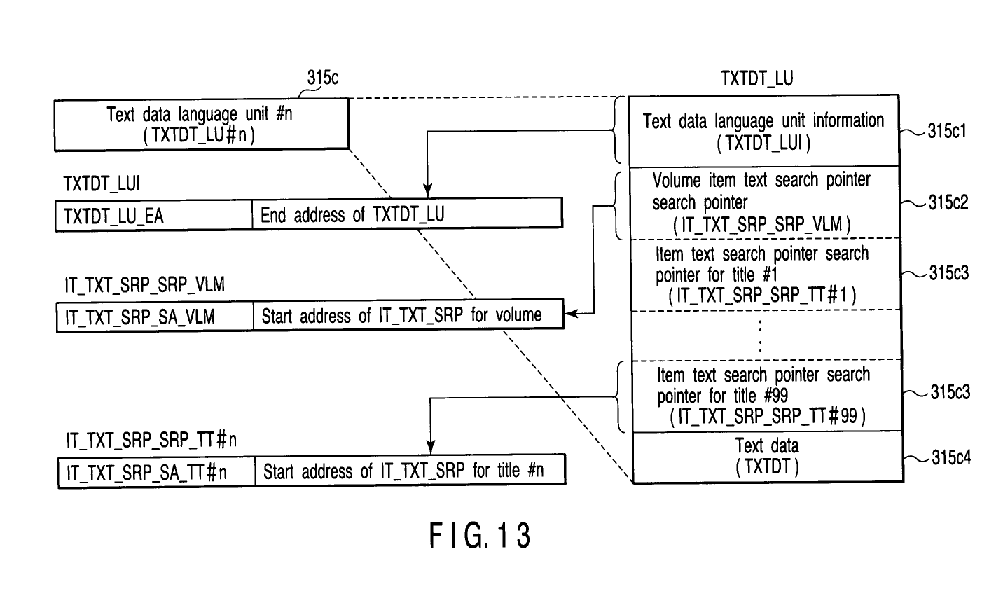

FIG. 13 shows an example of the internal data structure of text data language unit (TXTDT_LU) 315c. As shown in FIG. 13, this text data language unit 315c includes various kinds of information: text data language unit information (TXTDT_LUI) 315c1 that records the end address (TXTDT—LU—EA) information of the TXTDT_LU; item text search pointer search pointer (IT_TXT_SRP_SRP_VLM) 315c2 for volume that records the start address (IT_TXT_SRP_SA_VLM) information of the IT_TXT_SRP for volume; item text search pointer search pointers (IT_TXT_SRP_SRP_TT) 315c3 for volume each of which holds the start address (IT_TXT_SRP_SA_TT) information of the IT_TXT_SRP for title; and text data (TXTDT) 315c4.

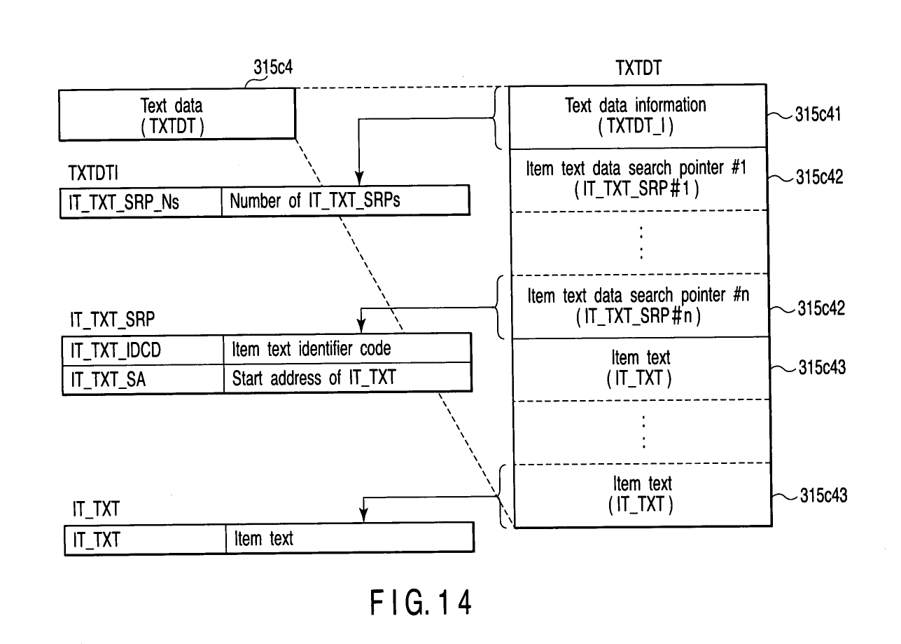

FIG. 14 shows an example of the internal data structure of text data (TXTDT) 315c4. As shown in FIG. 14, this text data 315c4 records various kinds of information: text data information (TXTDTI) 315c41 having information of the number (IT_TXT_SRP_Ns) of IT_TXT_SRP data; item text search pointers (IT_TXT_SRP) 315c42 each of which records an item text identifier code (IT_TXT_IDCD) and the start address (IT_TXT_SA) information of the IT_TXT; and item text (IT_TXT) data 315c43.

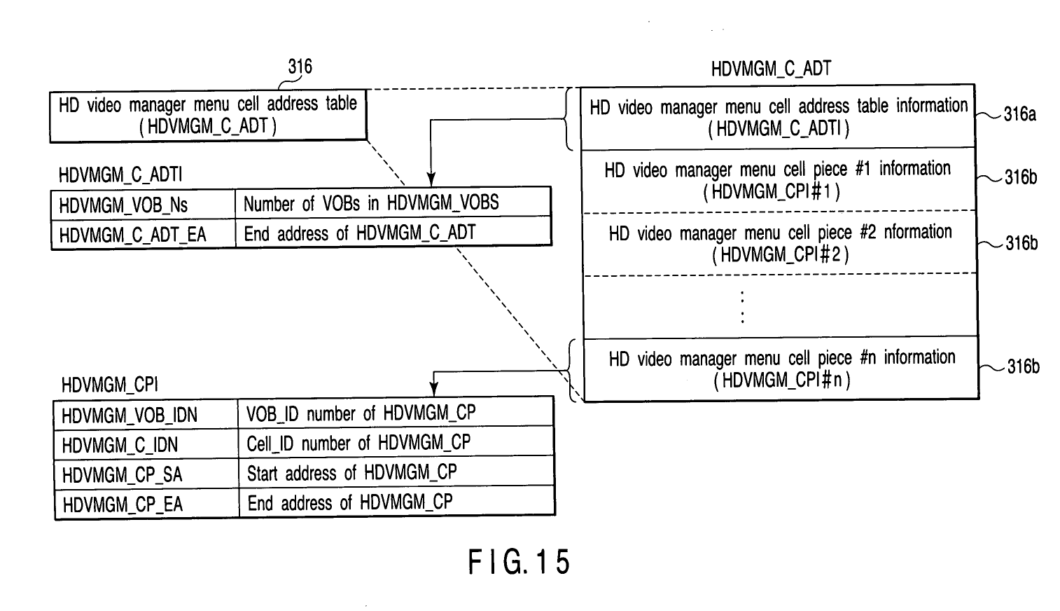

FIG. 15 shows an example of the data structure of HD video manager menu cell address table (HDVMGM_C_ADT) 316 shown in FIG. 3. As shown in FIG. 15, this HD video manager menu cell address table 316 records various kinds of information: HD video manager menu cell address table information (HDVMGM_C_ADTI) 316a having information of the number (HDVMGM_VOB_Ns) of VOB data in HDVMGM_VOBS and the end address (HDVMGM_C_ADT_EA) of the HDVMGM_C_ADT; and a plurality of pieces of HD video manager menu cell piece information (HDVMGM_CPI) 316b each of which records information of a VOB_ID number (HDVMGM_VOB_IDN) of an HDVMGM_CP, a Cell_ID number (HDVMGM_C_IDN) of the HDVMGM_CP, the start address (HDVMGM_CP_SA) of the HDVMGM_CP, and the end address (HDVMGM_CP_EA) of the HDVMGM_CP (“CP” of HDVMGM_CP indicates a cell piece).

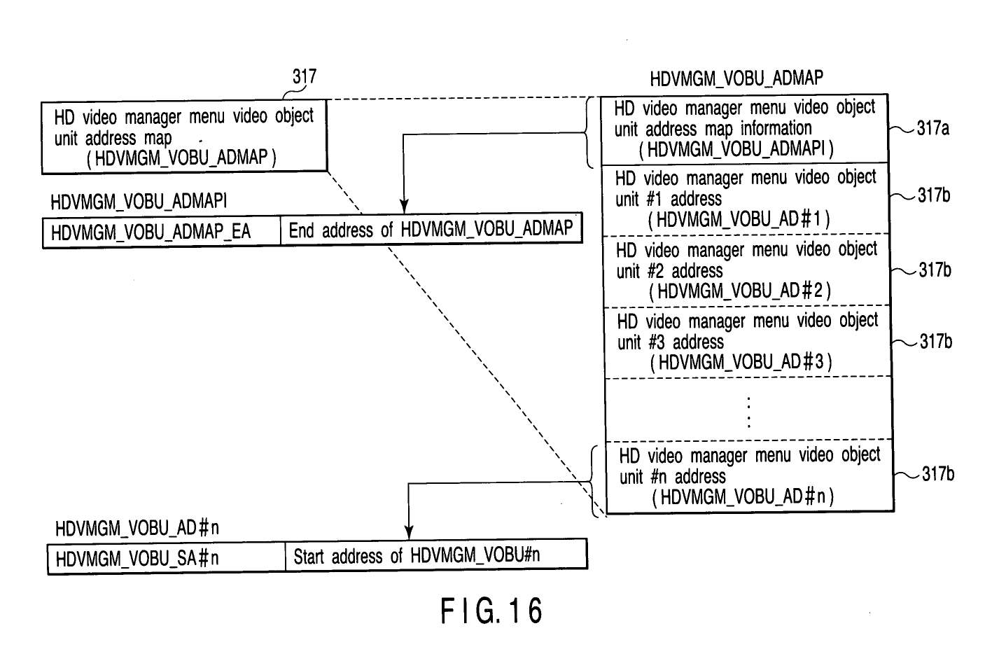

FIG. 16 shows an example of the data structure of HD video manager menu video object unit address map (HDVMGM_VOBU_ADMAP) 317 shown in FIG. 3. As shown in FIG. 16, this HD video manager menu video object unit address map 317 records various kinds of information: HD video manager menu video object unit address map information (HDVMGM_VOBU_ADMAPI) 317a having information of the end address (HDVMGM_VOBU ADMAP EA) of the HDVMGM_VOBU_ADMAP; and start addresses (HDVMGM_VOBU_AD#1 to HDVMGM VOBU AD#n) 317b of HDVMGM_VOBU data.

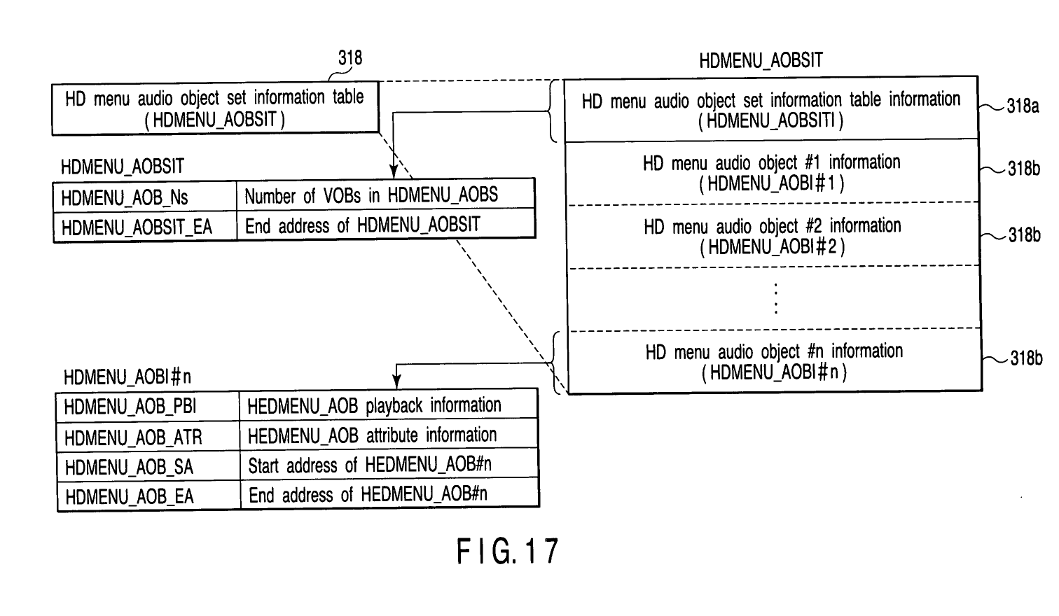

FIG. 17 shows the management information content for menu audio object (HDMENU_AOB) itself, and shows an example of the internal data structure of HD menu audio object set information table (HDMENU_AOBSIT) 318 shown in FIG. 3 stored in HD video manager information (HDVMGI) area 31 shown in FIG. 1(e). As shown in FIG. 17, HD menu audio object set information table information (HDMENU_AOBSITI) 318a allocated at the first field of HD menu audio object set information table 318 stores HDMENU_AOB_Ns as information of the number of AOB data in HDMENU_AOBS, and the end address information (HDMENU_AOBSIT_EA) of the HDMENU_AOBSIT. In the embodiment of the present invention, a plurality of types of menu audio objects (audio data) can be recorded in information storage medium 1.

In HD menu audio object set information table 318 shown in FIG. 17, one or more pieces of HD menu audio object information (HDMENU_AOBI) 318b are allocated after HD menu audio object set information table information 318a. Each HD menu audio object information (HDMENU_AOBI) 318b indicates management information for each individual menu audio object (audio data), and includes playback information (HDMENU_AOB_PBI) of HDMENU_AOB, attribute information (HDMENU_AOB_ATR) of HDMENU_AOB, the start address information (HDMENU_AOB_SA) of HDMENU_AOB#n (HDMENU_AOB of interest), and the end address information (HDMENU_AOB_EA) of HDMENU AOB#n (HDMENU_AOB of interest).

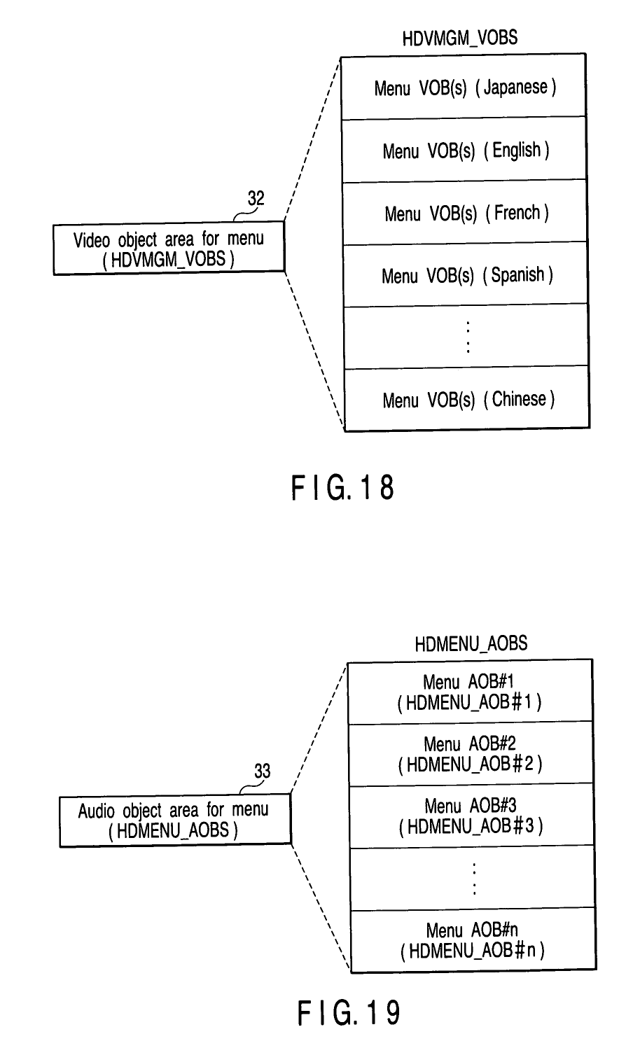

FIG. 18 shows an example of the data structure of menu video object area (HDVMGM_VOBS) 32 shown in FIG. 1(e), which is stored together in, e.g., file HD_VMG01.HDV (file HD VMG01.HDV can be stored as a file in the menu group in FIG. 2; not shown). As shown in FIG. 18, menu screens (video objects) which record an identical menu screen using different menu description language codes are allocated in juxtaposition with this menu video object area 32. In this way, a plurality of menu screens of a plurality of languages are prepared, and a menu screen can be displayed by arbitrarily selecting one of a plurality of them. For example, when only one Japanese menu VOB is selected, a Japanese menu can be displayed; when only one English menu VOB is selected, an English menu can be displayed. Alternatively, when the display screen is configured to display multi-windows, and the Japanese menu VOB and English menu VOB are selected, the Japanese and English menus can be displayed on the multi-windows.

FIG. 19 shows an example of the data structure of menu audio object area (HDMENU_AOBS) 33 recorded in the HD video manager (HDVMG) recording area. In the embodiment of the present invention, a plurality of types of menu audio objects (audio data) can be recorded in information storage medium 1. Each menu audio object (AOB) is recorded at a location in menu audio object area (HDMENU_AOBS) 33 in HD video manager recording area (HDVMG) 30, as shown in, e.g., FIG. 1. This menu audio object area (HDMENU_AOBS) 33 forms one file with, e.g., file name HD_MENU0.HDA (file HD_MENU0.HAD can be a file in the menu group in FIG. 2; not shown). Respective menu audio objects (AOB) are allocated and recorded in turn in menu audio object area (HDMENU_AOBS) 33 that forms one file with file name HD_MENU0.HAD, as shown in FIG. 19.

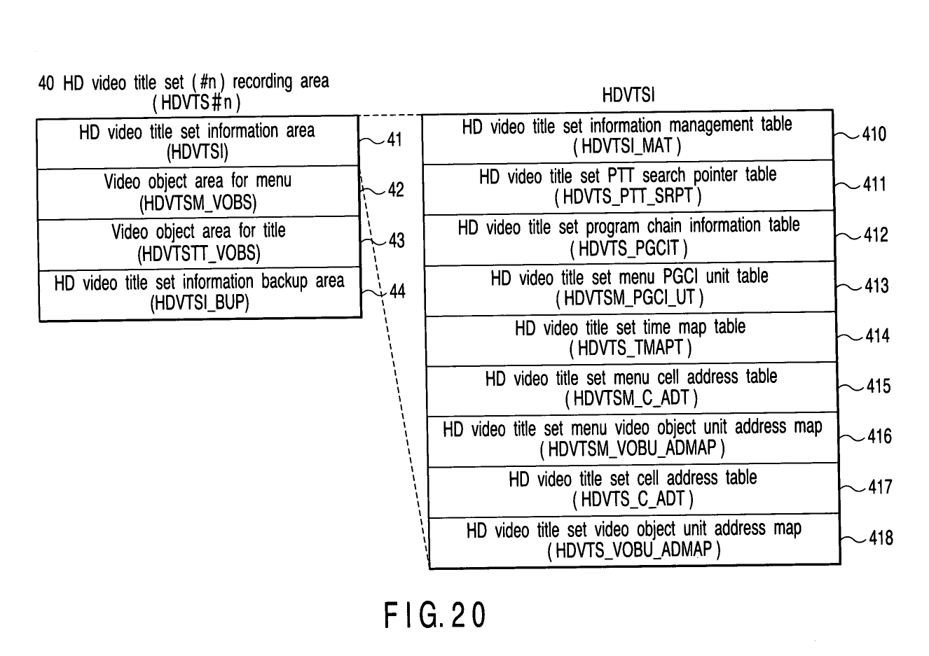

FIG. 20 shows an example of the data structure of HD video title set information (HDVTSI) 41 recorded in each HD video title set (HDVTS#n) recording area. This HD video title set information 41 is recorded together in file HVI00101.IFO and/or HVIA0001.IFO shown in, e.g., FIG. 2 (or independent file VTS00100.IFO in the DVD-Video content; not shown). As shown in FIG. 20, the interior of HD video title set information (HDVTSI) 41 shown in FIG. 1(f) is divided into respective fields (management information groups): HD video title set information management table (HDVTSI_MAT) 410, HD video title set PTT search pointer table (HDVTS_PTT_SRPT) 411, HD video title set program chain information table (HDVTS_PGCIT) 412, HD video title set menu PGCI unit able (HDVTSM_PGCI_UT) 413, HD video title set time map table (HDVTS_TMAPT) 414, HD video title set menu cell address table (HDVTSM C ADT) 415, HD video title set menu video object unit address map (HDVTSM_VOBU_ADMAP) 416, HD video title set cell address table (HDVTS_C_ADT) 417, and HD video title set video object unit address map (HDVTS_VOBU_ADMAP) 418.

HD video title set information management table (HDVTSI_MAT) 410 records management information common to the corresponding video title set. Since this common management information (HDVTSI_MAT) is allocated in the first field (management information group) in HD video title set information (HDVTSI) area 41, the common management information in the video title set can be immediately loaded (before the beginning of object playback). Hence, the playback control process of the information playback apparatus can be simplified, and the control processing time can be shortened.

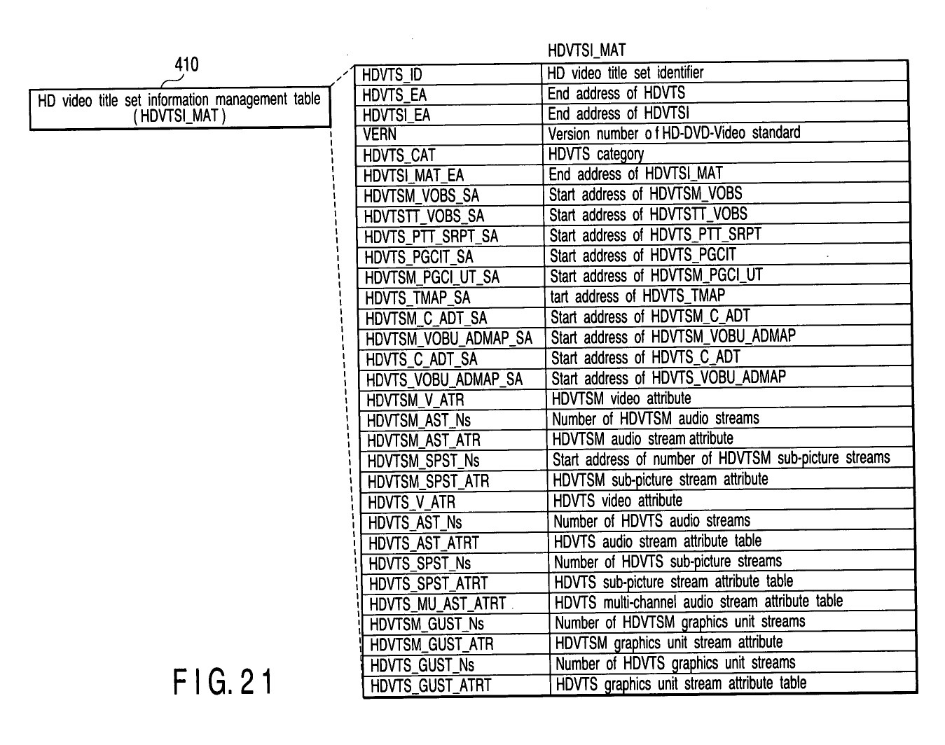

FIG. 21 shows an example of the data structure of the HD video title set information management table (HDVTSI_MAT) recorded in the HD video title set information (HDVTSI). Management information associated with graphics units included in the HDVTS (Video Title Set according to the embodiment of the present invention) is recorded in HD video title set information management table (HDVTSI_MAT) 410 (see FIG. 20), which is allocated in the first field (group) in HD video title set information (HDVTSI) area 41 shown in FIG. 1(f). Detailed-management information content are as shown in FIG. 21. That is, information of the number of graphics unit streams and attribute information are separately recorded for a menu screen and title (display picture) in the HDVTS as information of the number (HDVTSM_GUST_Ns) of HDVTSM graphics unit streams, HDVTSM graphics unit stream attribute information (HDVTSM_GUST_ATR), information of the number (HDVTS_GUST_Ns) of HDVTS graphics unit streams, and HDVTS graphics unit stream attribute table information (HDVTS_GUST_ATRT).

Also, as shown in FIG. 21, HD video title set information management table (HDVTSI_MAT) 410 records various kinds of information: an HD video title set identifier (HDVTS_ID), the end address (HDVTS_EA) of the HDVTS, the end address (HDVTSI_EA) of the HDVTSI, the version number (VERN) of the HD_DVD-Video standard, an HDVTS category (HDVTS_CAT), the end address (HDVTSI_MAT_EA) of the HDVTSI_MAT, the start address (HDVTSM_VOBS_SA) of the HDVTSM_VOBS, the start address (HDVTSTT_VOBS_SA) of the HDVTSTT_VOBS, the start address (HDVTS_PTT_SRPT_SA) of the HDVTS_PTT_SRPT, the start address (HDVTS_PGCIT_SA) of the HDVTS_PGCIT, the start address (HDVTSM_PGCI_UT_SA) of the HDVTSM_PGCI_UT, the start address (HDVTS_TMAP_SA) of the HDVTS_TMAP, the start address (HDVTSM_C_ADT_SA) of the HDVTSM_C_ADT, the start address (HDVTSM_VOBU_ADMAP_SA) of the HDVTSM_VOBU_ADMAP, the start address (HDVTS_C_ADT_SA) of the HDVTS_C_ADT, the start address (HDVTS_VOBU_ADMAP_SA) of the HDVTS_VOBU ADMAP, an HDVTSM video attribute (HDVTSM_V_ATR), the number (HDVTSM_AST_Ns) of HDVTSM audio streams, an HDVTSM audio stream attribute (HDVTSM_AST_ATR), the start address (HDVTSM_SPST_Ns) of the number of HDVTSM sub-picture streams, an HDVTSM sub-picture stream attribute (HDVTSM_SPST_ATR), an HDVTS video attribute (HDVTS_V_ATR), the number (HDVTS_AST_Ns) of HDVTS audio streams, an HDVTS audio stream attribute table (HDVTS_AST_ATRT), the number (HDVTS_SPST_Ns) of HDVTS sub-picture streams, an HDVTS sub-picture stream attribute table (HDVTS_SPST_ATRT), and an HDVTS multi-channel audio stream attribute table (HDVTS_MU_AST_ATRT).

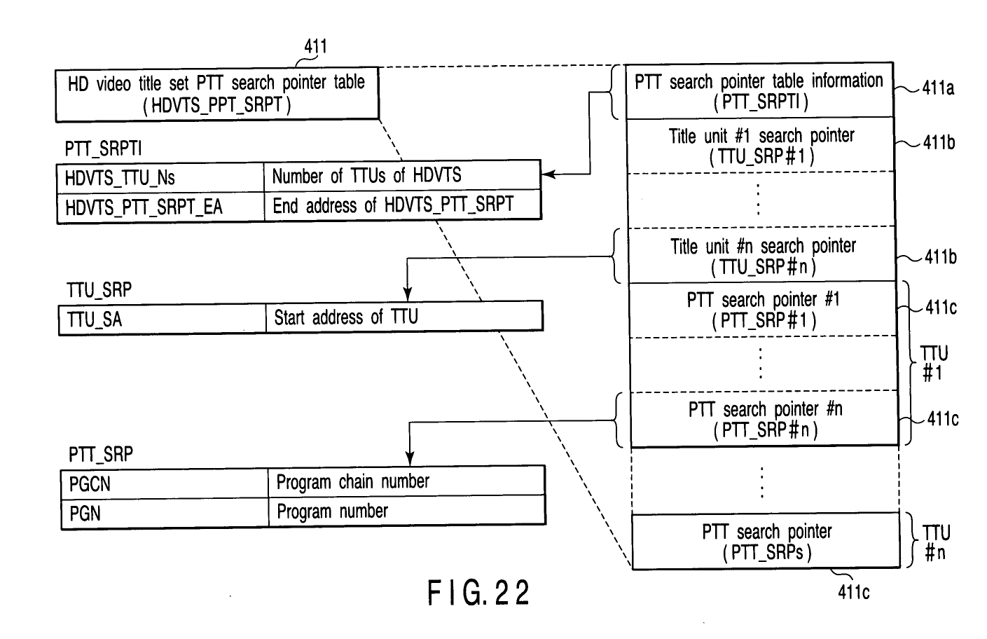

FIG. 22 shows an example of the data structure in HD video title set PTT search pointer table (HDVTS_PTT_SRPT) 411 shown in FIG. 19. This HD video title set PTT search pointer table 411 includes various kinds of information: PTT search pointer table information (PTT_SRPTI) 411a having information of the number (HDVTS_TTU_Ns) of HDVTS TTU data and the end address (HDVTS_PTT_SRPT_EA) of the HDVTS_PTT_SRPT; title unit search pointers (TTU_SRP) 411b each of which records information of the start address (TTU_SA) of the TTU; and PTT search pointers (PTT_SRP) 411c having information of a program chain number (PGCN) and program number (PGN).

<Allocation of Information that Manages Resume Information>

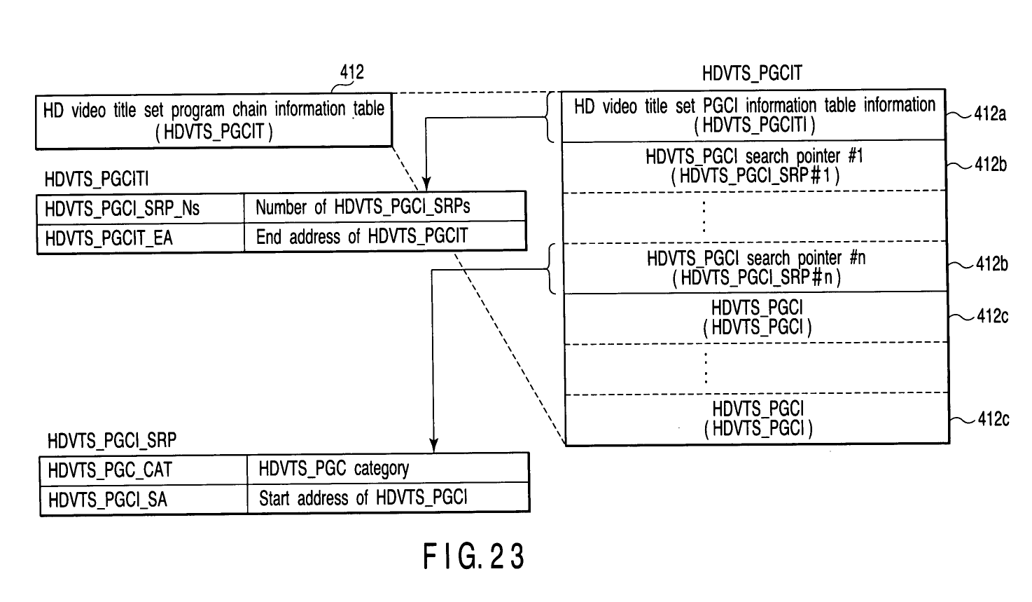

FIG. 23 shows an example of the data structure of HD video title set program chain information table (HDVTS_PGCIT) recorded in the HD video title set information (HDVTSI). In the embodiment of the present invention, as shown in FIG. 23, an HDVTS_PGC category in HDVTS_PGCI search pointer 412b stores an update permission flag of resume information (RSM permission flag). Information of HDVTS_PGCI search pointer 412b is allocated in HD video title set program chain information table (HDVTS_PGCIT) 412 (FIG. 20) stored in HD video title set information (HDVTSI) area 41 shown in FIG. 1(f). In addition, as shown in FIG. 23, HD video title set program chain information table (HDVTS_PGCIT) 412 also records information of HD video title set PGCI information table (HDVTS_PGCITI) 412a including information of the number (HDVTS_PGCI_SRP_Ns) of HDVTS_PGCI_SRP data and the end address (HDVTS_PGCIT_EA) of the HDVTS_PGCIT. Also, HDVTS_PGCI search pointer (HDVTS_PGCI_SRP) 412b records information of the start address (HDVTS_PGCI_SA) of the HDVTS_PGCI together with the aforementioned HDVTS_PGC category (HDVTS_PGC_CAT).

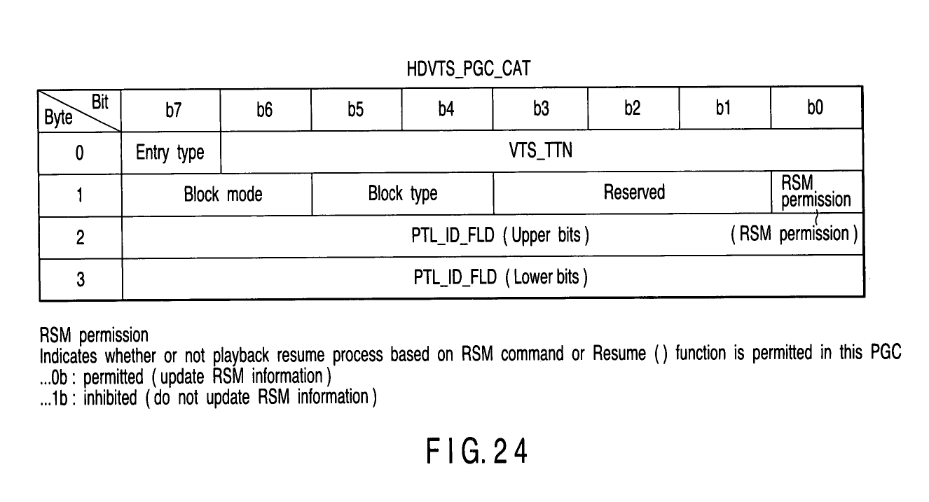

FIG. 24 shows an example of the recording content of the HDVTS_PGC category (HDVTS_PGC_CAT). The update permission flag of resume information (RSM permission Flag) shown in FIG. 24 designates whether or not the content of resume information are to be updated after playback of the HDVTS_PGC of interest starts (whether or not resume information is updated as needed in correspondence with the playback state of the PGC of interest). That is, the following process is made in correspondence with the flag:

When RSM permission flag=“0b”, resume information is updated, or

when RSM permission flag=“1b”, resume information is not updated, and playback resume information is held in the HDVTS_PGC (program chain in the video title set according to the embodiment of the present invention) played back previously.

In addition, the HDVTS_PGC category (HDVTS_PGC_CAT) can record entry type information used to check if a PGC of interest is an entry PGC, title number information in a VTS (video title set) indicated by the corresponding PGC, block mode information, block type information, PTL_ID_FLD information, and the like.

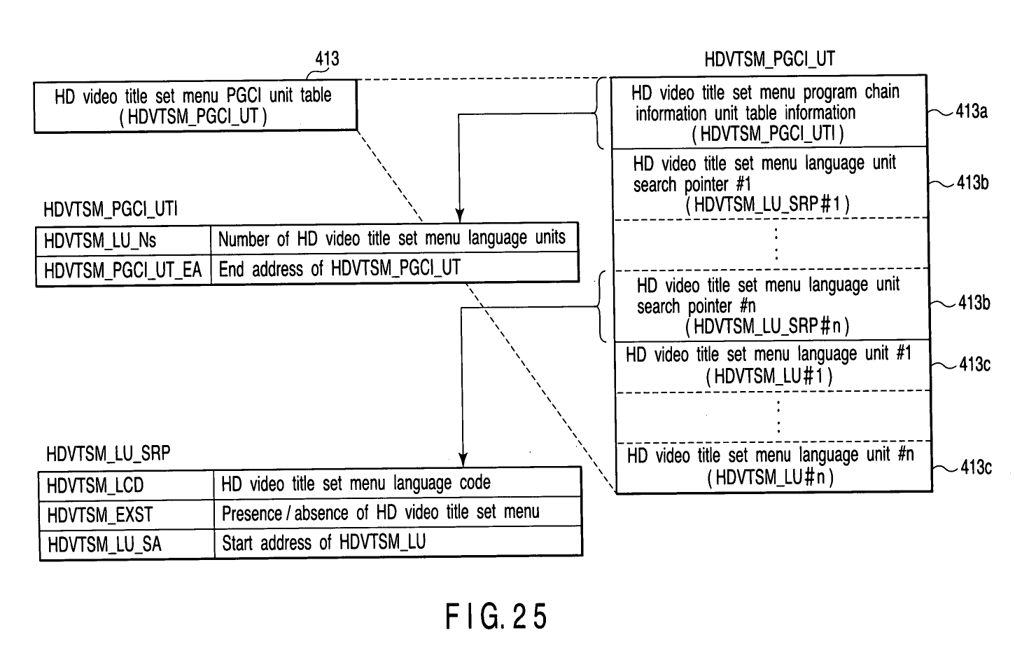

FIG. 25 shows an example of the data structure in HD video title set menu PGCI unit table (HDVTSM_PGCI_UT) 413 shown in FIG. 20. This HD video title set menu PGCI unit table 413 includes various kinds of information: HD video title set menu program chain information unit table information (HDVTSM_PGCI_UTI) 413a having information of the number (HDVTSM_LU_Ns) of HD video title set menu language units and the end address (HDVTSM_PGCI_UT_EA) of the HDVTSM_PGCI_UT; HD video title set menu language unit search pointers (HDVTSM_LU_SRP) 413b each of which records information of an HD video title set menu language code (HDVTSM_LCD), the presence/absence (HDVTSM_EXST) of a HD video title set menu, and the start address (HDVTSM_LU_SA) of the HDVTSM_LU; and HD video title set menu language units (HDVTSM_LU) 413c.

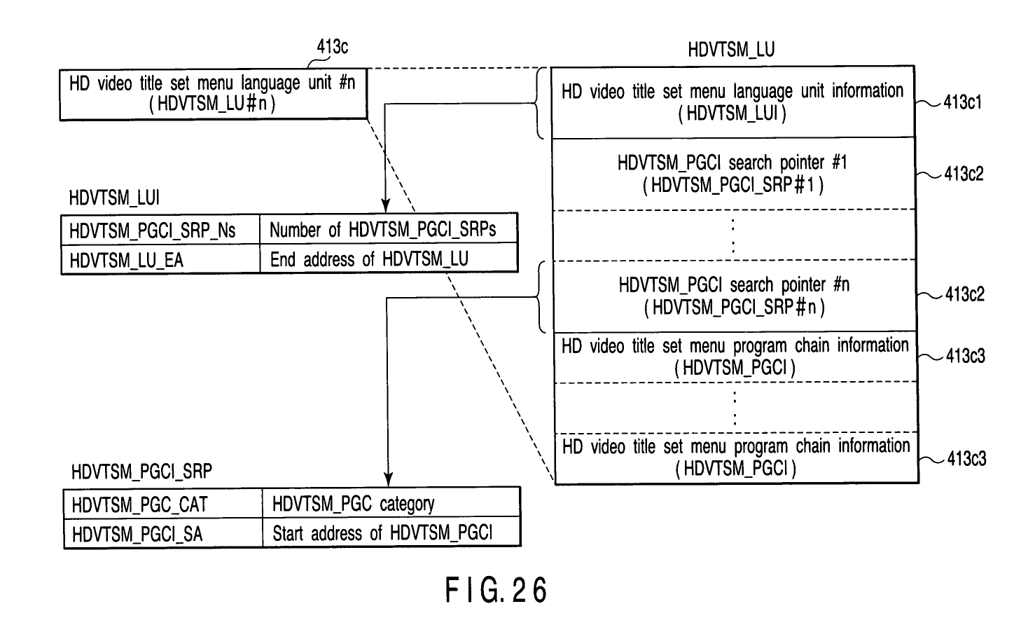

FIG. 26 shows an example of the data structure in HD video title set menu language unit (HDVTSM_LU) 413c. As shown in FIG. 26, this HD video title set menu language unit 413c includes: HD video title set menu language unit information (HDVTSM_LUI) 413c1 having information of the number (HDVTSM_PGCI_SRP_Ns) of HDVTSM_PGCI_SRP data and the end address (HDVTSM_LU_EA) of the HDVTSM_LU; a plurality of pieces of HD video title set menu program chain information (HDVTSM_PGCI) 413c3 having the same data structure as in FIG. 33; and HDVTSM_PGCI search pointers (HDVTSM_PGCI_SRP) 413c2 each of which records information of the HDVTSM_PGC category (HDVTSM_PGC_CAT) and the start address (HDVTSM_PGCI_SA) of the HDVTSM_PGCI.

As the setting location of information that refers to (designates) the menu AOB (HDMENU_AOB), in the embodiment of the present invention, as for a menu for each HDVTS, that information is allocated in the HDVTSM_PGC category information (HDVTSM_PGC_CAT) in HDVTSM_PGCI search pointer #n (HDVTSM_PGCI_SRP#n) 413c2, as shown in FIG. 26.

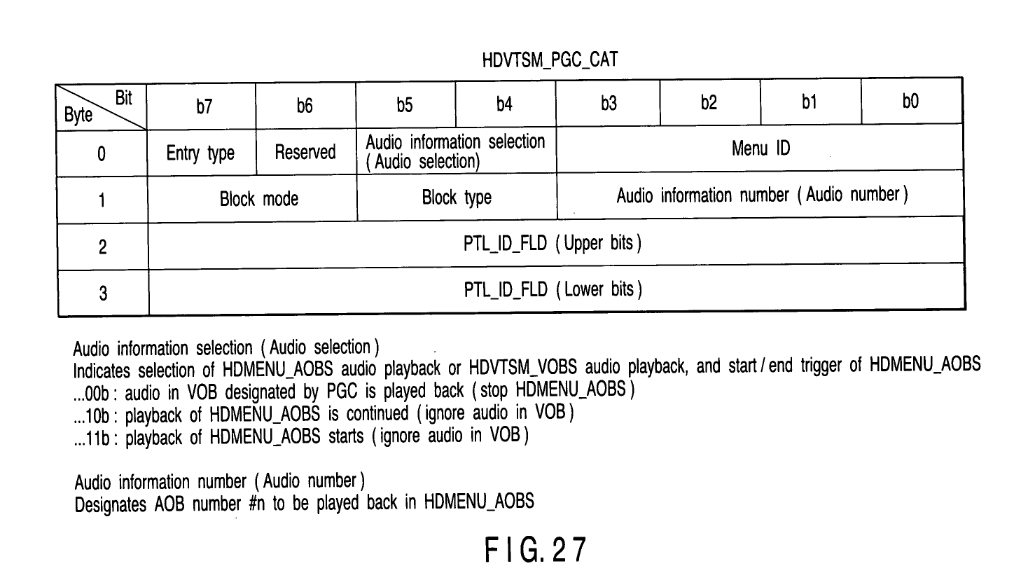

FIG. 27 shows an example of the recording content of the HDVTSM_PGC category (HDVTSM_PGC_CAT). AOB Number information in the HDVTSM_PGC category information (HDVTSM_PGC_CAT) shown in FIG. 27 means AOB number information (AOB Number) which designates AOB number #n (indicating which AOB of menu AOB (HDMENU_AOB) data which are arranged, as shown in FIG. 19 corresponds to) to be played back in HDMENU_AOBU. Also, audio selection information means selection information of audio information which is to be simultaneously played back upon displaying an HD content menu in the embodiment of the present invention on the screen, and an audio information selection flag (audio selection information) indicating start/end trigger information of audio information playback.

When the audio information selection flag (Audio Selection information)=“00b” is selected, audio data recorded in respective menu video objects are played back, and audio playback is interrupted upon switching menus. When the audio information selection flag (Audio Selection information)=“10b” or “11b” is selected, audio data of menu AOB (HDMENU_AOB) data stored in menu audio object area (HDMENU_AOBS) 33 are played back. Upon playing back the menu audio data (AOB), if the audio information selection flag=“11b” is designated, the audio data begin to be played back from the beginning every time the menu screen is changed; if “10b” is designated, playback of the audio data continues irrespective of switching of menu screens. In the embodiment of the present invention, menu audio object area (HDMENU_AOBS) 33 can store a plurality of types of menu AOB (HDMENU_AOB) data, as shown in FIG. 19.

Audio number information shown in FIG. 27 indicates selection information of menu AOB (HDMENU_AOB) data to be simultaneously played back upon displaying the menu display PGC of interest. This Audio Number information as the selection information of menu AOB data is used to “select which menu AOB from the top” of those which are allocated in FIG. 19 using number information. Also, the HDVTSM_PGC category (HDVTSM_PGC_CAT) records entry type information used to check if a PGC of interest is an entry PGC, menu ID information indicating a menu identification (e.g., a title menu or the like), block mode information, block type information, PTL_ID_FLD information, and the like.

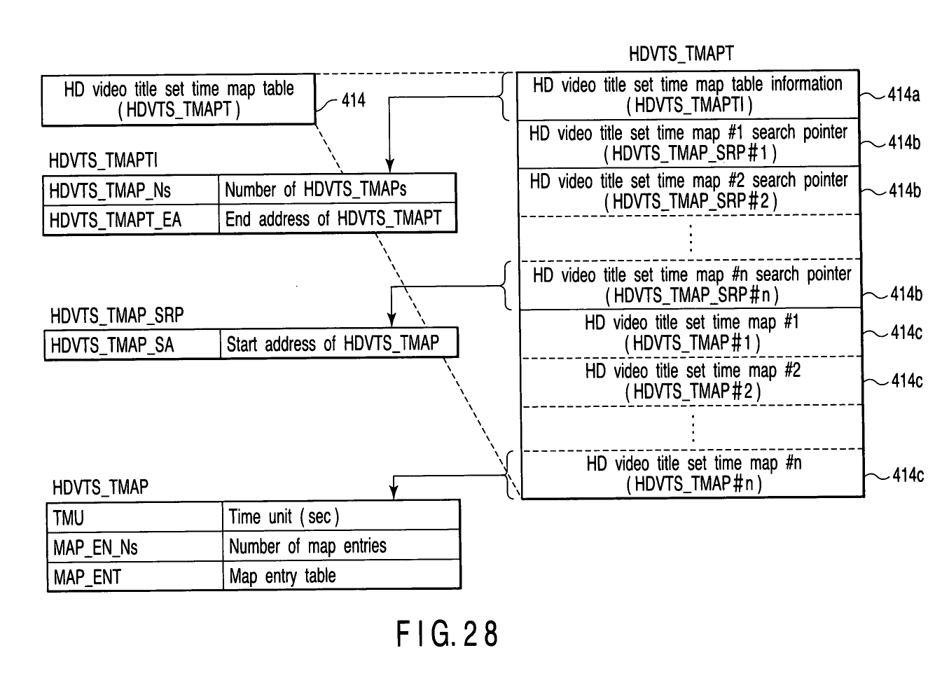

FIG. 28 shows an example of the data structure in HD video title set time map table (HDVTS_TMAPT) 414 shown in FIG. 20. This HD video title set time map table 414 includes various kinds of information: HD video title set time map table information (HDVTS_TMAPTI) 414a that describes information of the number (HDVTS_TMAP_Ns) of HDVTS_TMAP data and the end address (HDVTS_TMAPT_EA) of the HDVTS_TMAPT; HD video title set time map search pointer (HDVTS_TMAP_SRP) 414b having information of the start address (HDVTS_TMAP_SA) of the HDVTS_TMAP; and HD video title set time maps (HDVTS_TMAP) 414c each of which records information of the length (TMU) of a time unit (sec) as a reference in a map entry, the number (MAP_EN_Ns) of map entries, and a map entry table (MAP_ENT).

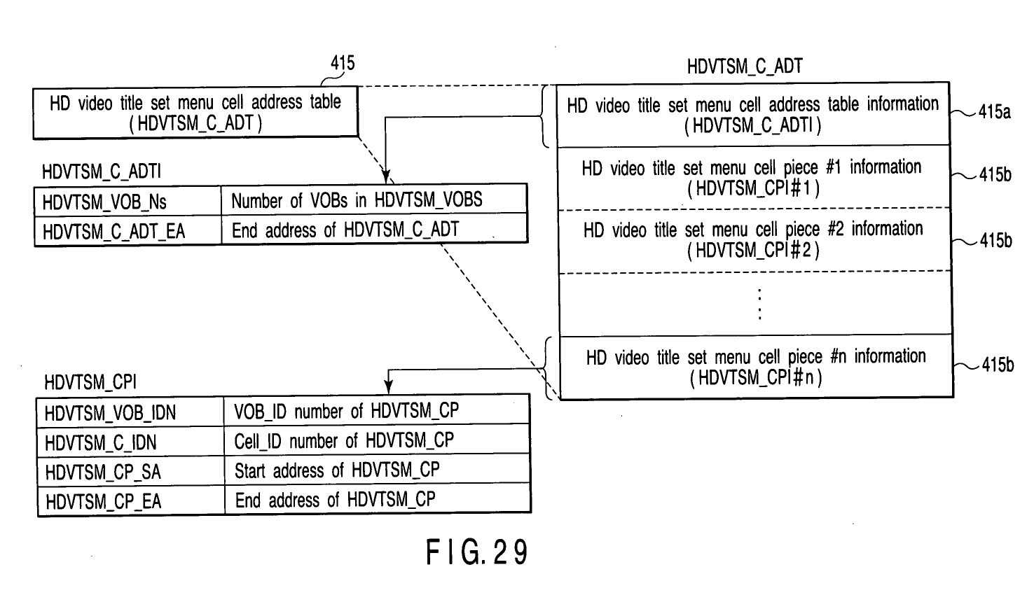

FIG. 29 shows an example of the data structure in HD video title set menu cell address table (HDVTSM_C_ADT) 415 shown in FIG. 20. As shown in FIG. 29, this HD video title set menu cell address table 415 includes various kinds of information: HD video title set menu cell address table information (HDVTSM_C ADTI) 415a having information of the number (HDVTSM_VOB_Ns) of VOB data in an HDVTM_VOBS and the end address (HDVTSM_C_ADT_EA) of the HDVTSM_C_ADT; and a plurality of pieces of HD video title set menu cell piece information (HDVTSM_CPI) 415b each of which records information of a VOB_ID number (HDVTSM_VOB_IDN) of an HDVTSM_CP, a Cell_ID number (HDVTSM_C_IDN) of the HDVTSM_CP, the start address (HDVTSM_CP_SA) of the HDVTSM_CP, and the end address (HDVTSM_CP_EA) of the HDVTSM_CP.

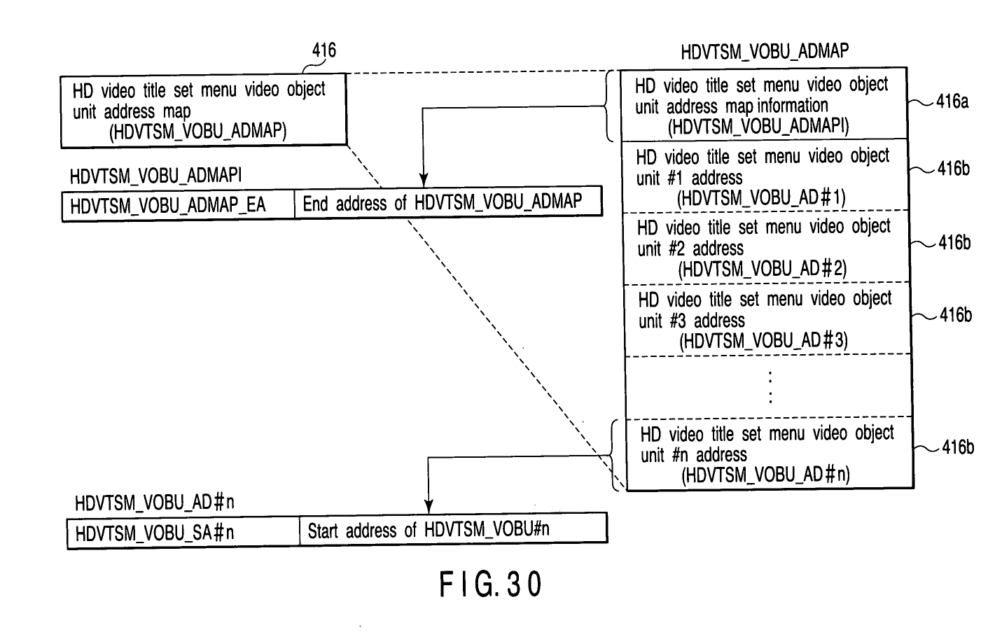

FIG. 30 shows an example of the data structure of HD video title set menu video object unit address map (HDVTSM_VOBU_ADMAP) 416 shown in FIG. 20. As shown in FIG. 30, this HD video title set menu video object unit address map 416 includes: HD video title set menu video object unit address map information (HDVTSM_VOBU_ADMAPI) 416a that describes the information of the end address (HDVTSM_VOBU_ADMAP_EA) of the HDVTSM_VOBU_ADMAP, and information of HD video title set menu video object unit addresses (HDVTSM_VOBU_AD) 416b each having information of the start address (HDVTSM_VOBU_SA) of an HDVTSM_VOBU.

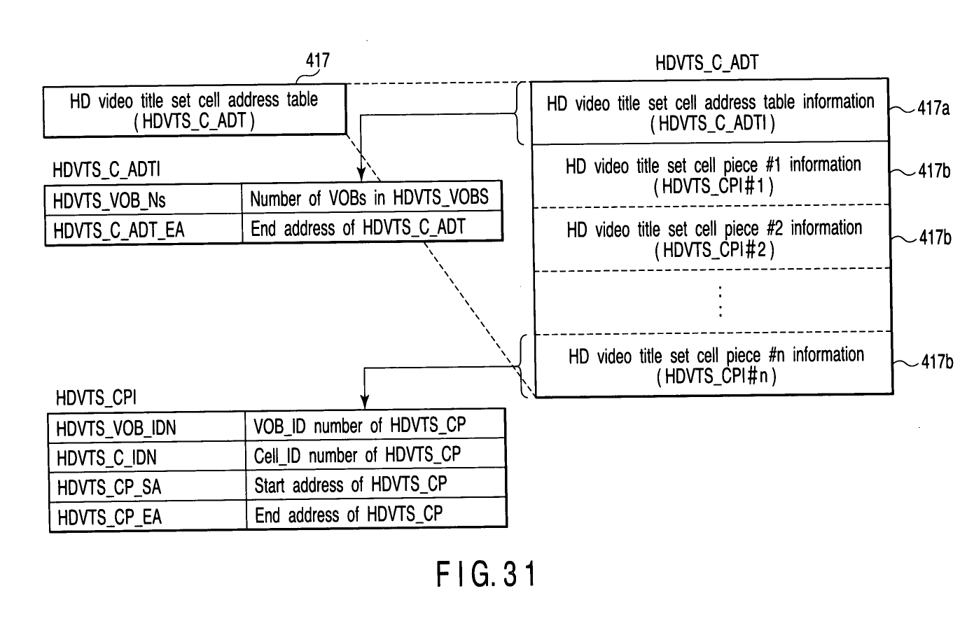

FIG. 31 shows an example of the data structure in HD video title set cell address table (HDVTS_C_ADT) 417 shown in FIG. 20. As shown in FIG. 31, this HD video title set cell address table 417 includes various kinds of information: HD video title set cell address table information (HDVTS_C_ADTI) 417a having the information of the number (HDVTS_VOB_Ns) of VOB data in an HDVTS_VOBS and the end address (HDVTS_C_ADT_EA) of the HDVTS_C_ADT; and a plurality of pieces of HD video title set cell piece information (HDVTS_CPI) 417b each including a VOB_ID number (HDVTS_VOB_IDN) of an HDVTS_CP, a Cell_ID number (HDVTS_C_IDN) of the HDVTS_CP, the start address (HDVTS_CP_SA) of the HDVTS_CP, and the end address (HDVTS_CP_EA) of the HDVTS_CP.

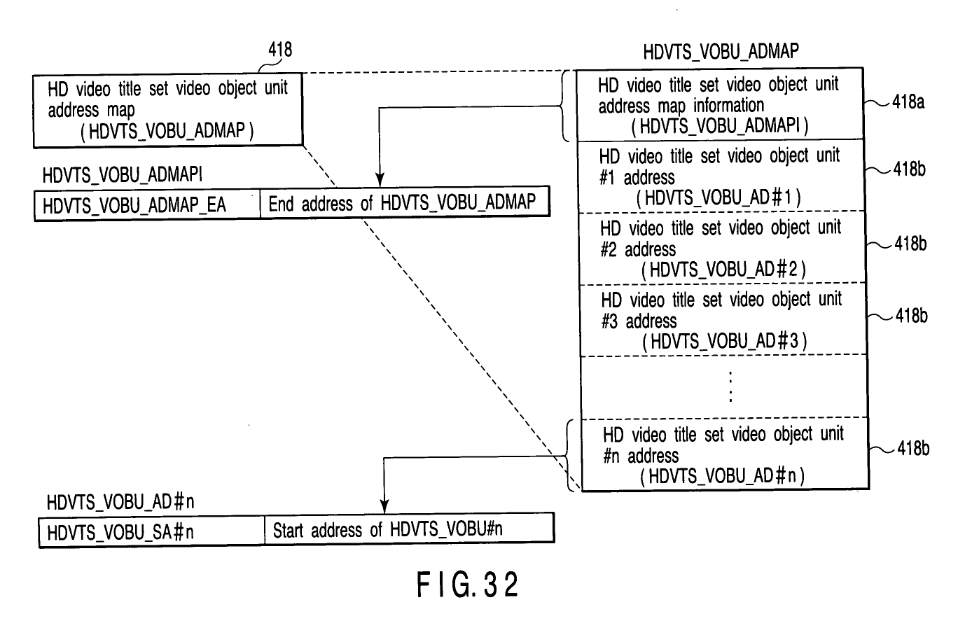

FIG. 32 shows an example of the data structure in HD video title set video object unit address map (HDVTS_VOBU_ADMAP) 418 shown in FIG. 20. As shown in FIG. 32, this HD video title set video object unit address map 418 includes various kinds of information: HD video title set video object unit address map information (HDVTS_VOBU_ADMAPI) 418a having information of the end address (HDVTS_VOBU_ADMAP_EA) of the HDVTS_VOBU_ADMAP; and HD video title set video object unit addresses (HDVTS_VOBU_AD) 418b each of which records information of the start address (HDVTS_VOBU_SA) of each HDVTS_VOBU.

FIG. 33 shows an example of the data structure of program chain general information (PGC_GI) included in program chain information (PGCI: corresponding to one of HDVTS_PGCI in, e.g., FIG. 23), and the recording content of a PGC graphics unit stream control table (PGC_GUST_CTLT) and resume/audio category (RSM&AOB_CAT) stored in this PGCI.

The information of the update permission flag of resume information (RSM permission flag) and audio information selection flag (audio selection information)/audio information number (audio number information) as some of characteristic features according to the embodiment of the present invention are stored in PGCI search pointer information in the existing example (see FIGS. 26, 27, etc.). However, the present invention is not limited to this. For example, the PGCI itself can store the update permission flag information of resume information and audio information selection flag/audio information number. This example is FIG. 33. The PGCI information shown in FIG. 33 corresponds to:

a] HD video manager menu program chain information (HDVMGM_PGCI) 312c3 which is shown in FIG. 7 in association with each HD video manager menu language unit (HDVMGM_LU) 312c in FIG. 6 stored in HD video manager menu PGCI unit table (HDVMGM_PGCI_UT) 312 (FIG. 3) in HD video manager information (HDVMGI) area 31 in FIG. 1(e);

b] HD video title set menu program chain information (HDVTSM_PGCI) 413c3 shown in FIG. 26 which is allocated in each HD video title set menu language unit (HDVTSM_LU) 413c in FIG. 25 in HD video title set menu PGCI unit table (HDVTSM_PGCI_UT) 413 in FIG. 20 that shows the data structure in HD video title set information (HDVTSI) area 41 in FIG. 1(f); and

c] HDVTS_PGCI 412c (FIG. 23) in HD video title set program chain information table (HDVTS_PGCIT) 412 in FIG. 20 that shows the data structure in HD video title set information (HDVTSI) area 41 in FIG. 1(f) (the PGCI information shown in FIG. 33 can be allocated in one of the above three locations (a) to (c)).

As shown in FIG. 33, the program chain information (PGCI) includes five fields (five management information groups), i.e., program chain general information (PGC_GI) 50, program chain command table (PGC_CMDT) 51, program chain program map (PGC_PGMAP) 52, cell playback information table (C_PBIT) 53, and cell position information table (C_POSIT) 54.

As shown in FIG. 33, RSM & AOB category information (RSM&AOB_CAT) is recorded at the end of program chain general information (PGC_GI) 50 allocated in the first field (management information group) in the PGCI. The RSM & AOB category information (RSM&AOB_CAT) stores the update permission flag of resume information (RSM permission information), audio information selection flag (audio selection information) and audio information number (audio number information). This RSM permission information have the same meaning as the content described using FIG. 24. Also, the content of the audio information selection flag or audio information number match those described using FIG. 8 or 27. Furthermore, the RSM & AOB category information (RSM&AOB_CAT) records entry type information used to check if a PGC of interest is an entry PGC, block mode information, block type information, and PTL_ID_FLD information.

Information in the PGC graphics unit stream control table (PGC_GUST_CTLT) that records control information associated with graphics unit streams allocated in the PGC is independently recorded in each of a PGC_GUST_CTL (PGC_GUST#0) field of HD graphics unit stream #0, a PGC_GUST_CTL (PGC_GUST#1) field of SD wide graphics unit stream #1, a PGC_GUST_CTL (PGC_GUST#2) field of 4:3 (SD) graphics unit stream #2, and a PGC_GUST_CTL (PGC_GUST#3) field of letterbox (SD) graphics unit stream #3 as independent fields in correspondence with four different types of pictures (an HD picture at 16:0, SD picture at 16:9, SD picture at 4:3, and SD picture at letterbox), as shown in FIG. 33.

In addition to the aforementioned information, program chain general information (PGC_GI) 50 records various kinds of information including PGC content (PGC_CNT), a PGC playback time (PGC_PB_TM), PGC user operation control (PGC_UOP_CTL), a PGC audio stream control table (PGC_AST_CTLT), a PGC sub-picture stream control table (PGC_SPST_CTLT), PGC navigation control (PGC_NV_CTL), a PGC sub-picture palette (PGC_SP_PLT), the start address (PGC_CMDT_SA) of the PGC_CMDT, the start address (PGC_PGMAP_SA) of the PGC_PGMAP, the start address (C_PBIT_SA) of the C_PBIT, and the start address (C_POSIT_SA) of the C_POSIT.

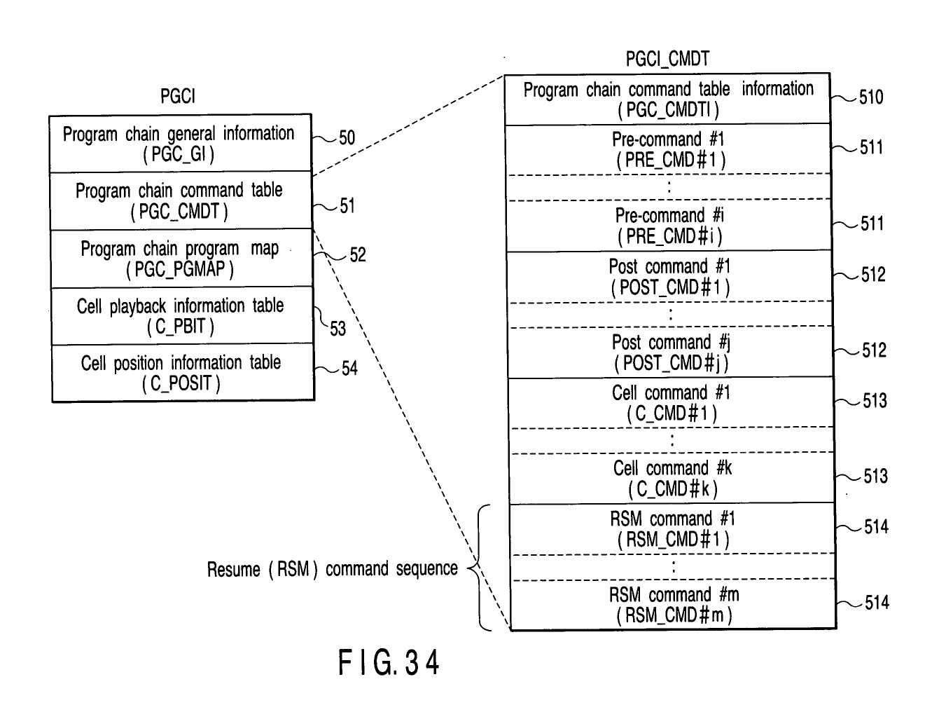

FIG. 34 shows an example of the program chain command table (PGC_CMDT) included in the program chain information (PGCI). As shown in FIG. 34, a plurality of pieces of command information to be applied to each PGC are allocated together on program chain command table (PGC_CMDT) 51. The allocation of this PGCI information can be one of the three locations (a) to (c), as described using FIG. 33. A resume (RSM) command sequence (or resume sequence) is recorded in program chain command table (PGC_CMDT) 51, as shown in FIG. 34. The information content of the resume sequence (resume command sequence) in the embodiment of the present invention is described in a format in which RSM commands (RSM_CMD) 514 are allocated in juxtaposition with the field of command table 51. One RSM command (RSM_CMD) 514 described in one column in FIG. 34 means one command that can be designated in the HD_DVD-Video content in the present invention, and RSM commands (RSM_CMD) 514 allocated in the resume (RSM) command sequence field are successively (sequentially) executed in turn from the top.

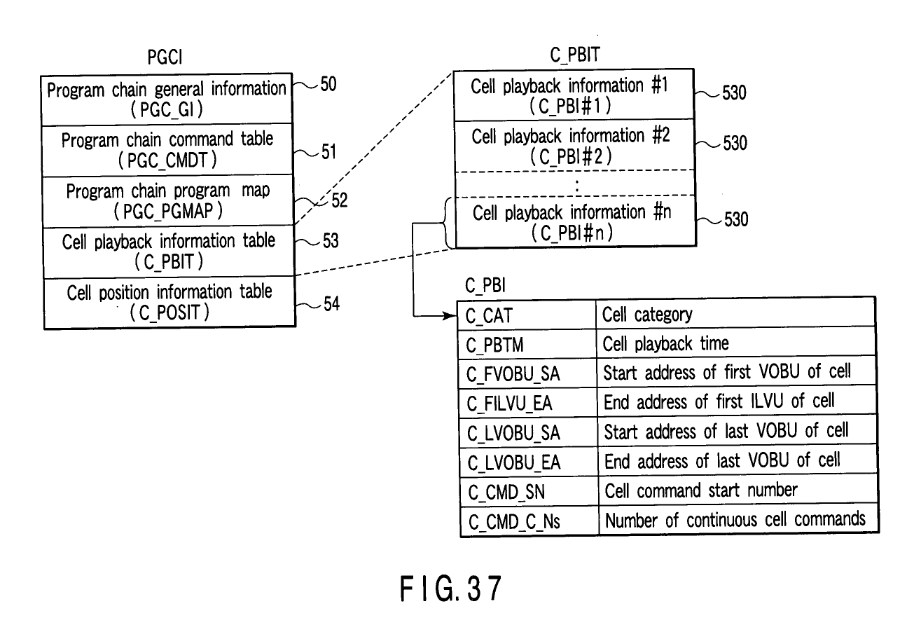

In the embodiment of the present invention, a sequence of cell commands (C_CMD) 513 in FIG. 34 also means a sequential command sequence. That is, command processes are sequentially executed in turn from the top in accordance with the arrangement order of cell commands (C_CMD) 513 shown in FIG. 34. As will be additionally described with reference to FIG. 37, a structure that can designate some of cell command processing sequences for each cell (the first cell command number at which the sequential process of cell command is to start, and the execution range of the sequential process of cell commands for each cell) in a series of cell command processing sequences designated from cell command #1 (C_CMD#1) to cell command #k (C_CMD#k) is adopted.

Referring to FIG. 34, RSM command (RSM_CMD) 514 indicates a part of a command sequence which is executed “immediately before playback from the middle of a PGC” whose playback was interrupted previously after the control returns from, e.g., a menu screen to the PGC of interest. On the other hand, pre-command (PRE_CMD) 511 means a command executed “immediately before the PGC of interest is to be played back from the beginning”. Also, a command to be executed after playback of the PGC of interest is post command (POST_CMD) 512. The number of pre-commands (PRE_CMD) 511, that of post commands (POST_CMD) 512, that of cell commands (C_CMD) 513, and that of RSM commands (RSM_CMD) 514 that can be allocated in one program chain command table (PGC_CMDT) 51 in FIG. 34 can be freely set (any of the numbers of commands to be described may be “0”). In the embodiment of the present invention, the upper limit of a total value obtained by adding the number of pre-commands (PRE_CMD) 511, that of post commands (POST_CMD) 512, that of cell commands (C_CMD) 513, and that of RSM commands (RSM_CMD) 514 that can be allocated in one program chain command table (PGC_CMDT) 51 is specified to be 1023. Therefore, when all of the number of pre-commands (PRE_CMD) 511, that of post commands (POST_CMD) 512, and that of RSM commands (RSM_CMD) 514 are “0”, a maximum of 1023 cell commands (C_CMD) 513 can be set.

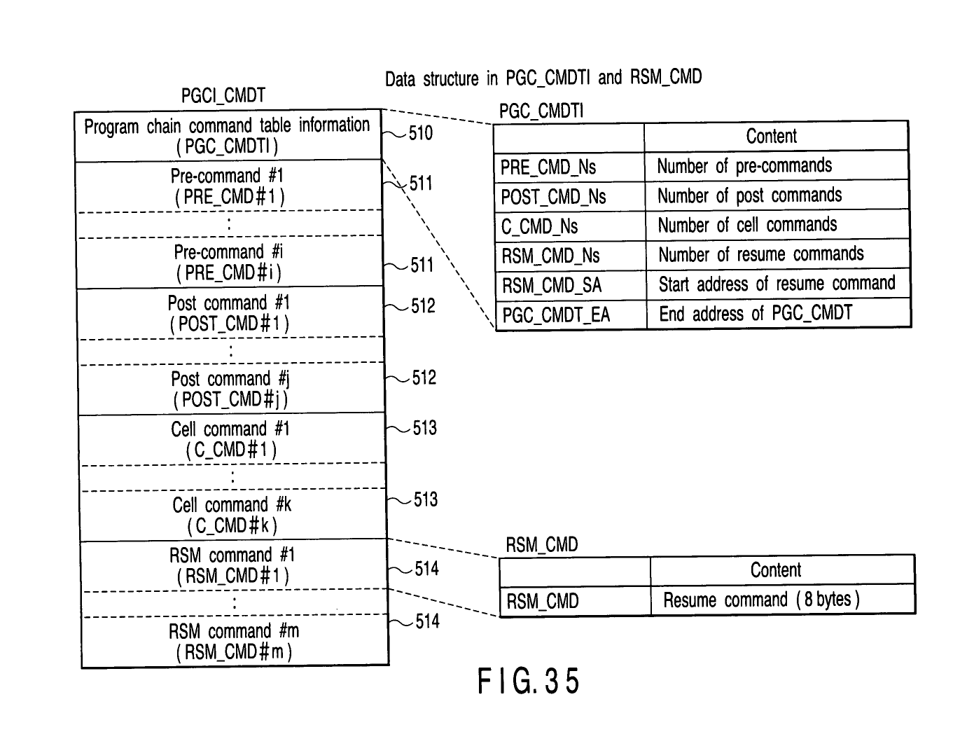

FIG. 35 shows an example of the content of program chain command table information (PGC_CMDTI) and those of each resume command (RSM_CMD) included in the program chain command table (PGC_CMDT). As shown in FIG. 35, program chain command table information (PGC_CMDTI) 510 records PRE_CMD_Ns as information indicating the number of pre-commands (PRE_CMD) 511, POST_CMD_Ns as information indicating the number of post commands (POST_CMD) 512, C_CMD_Ns as information indicating the number of cell commands (C_CMD) 513, and RSM_CMD_Ns as information indicating the number of RSM commands (RSM_CMD) 514, which can be allocated in one program chain command table (PGC_CMDT) 51.

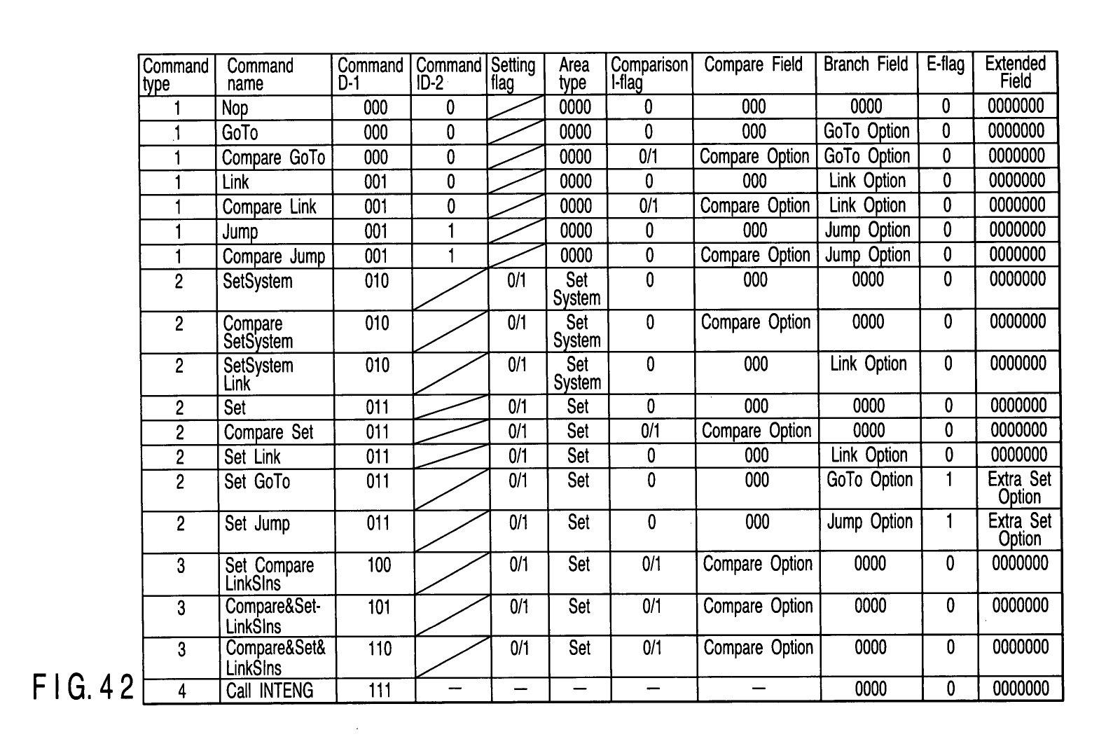

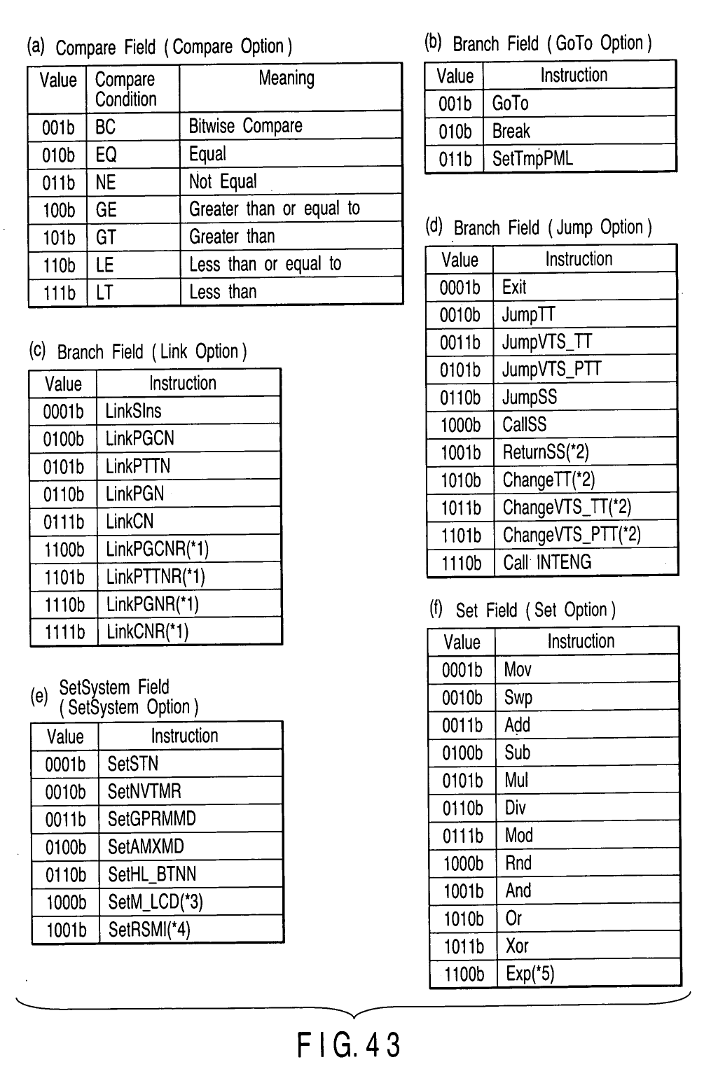

A detailed data structure in RSM command (RSM_CMD) 514 recorded in program chain command table (PGC_CMDT) 51 will be described below. The detailed data structure in RSM command (RSM_CMD) 514 will be described in this paragraph, but the data structures in pre-command (PRE_CMD) 511, post command (POST_CMD) 512, and cell command (C_CMD) 513 are the same as the detailed data structure in RSM command (RSM_CMD) 514. In the detailed data structure in RSM command (RSM_CMD) 514, an “8-byte” field is merely assigned to each command, as shown in FIG. 35. In this “8-byte” field, any of command content that will be additionally explained with reference to FIG. 43 are selected and recorded. This command stores “command ID-1” data shown in FIG. 42 in its MSB to the third bit in 8 bytes. The data content of the following bits are different depending on the value of “command type” shown in FIG. 42, but they commonly have information of “comparison I-flag”, “compare field”, and the like shown in FIG. 42 independently of the command type.

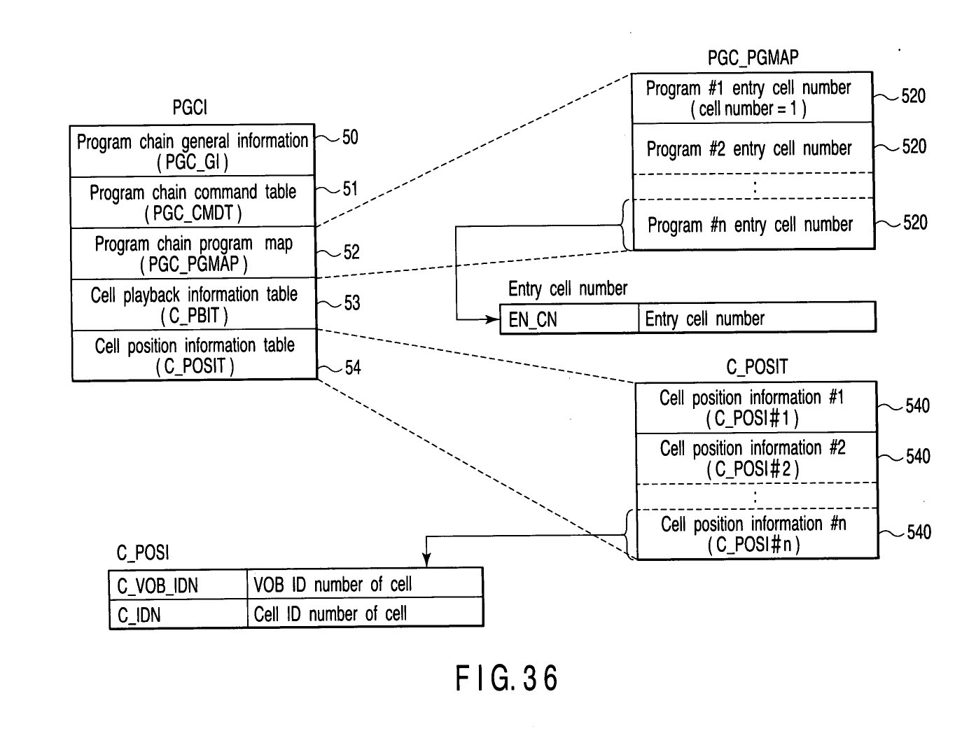

FIG. 36 shows an example of the data structures in program chain program map (PGC_PGMAP) 52 and cell position information table (C_POSIT) 54 allocated in the program chain information (PGCI). In program chain program map (PGC_PGMAP) 52, a plurality of pieces of program entry cell number 520 information that record entry cell numbers (EN_CN) indicating the cell numbers corresponding to entries are allocated in correspondence with the number of entries. Cell position information table (C_POSIT) 54 has a structure in which a plurality of pieces of cell position information (C_POSI) 540 each including a pair of a cell VOB_ID number (C_VOB_IDN) and cell ID number (C_IDN) are allocated in turn.

In the description of FIG. 34, the structure that can designate some of cell command processing sequences for each cell (the first cell command number at which the sequential process of cell command is to start, and the execution range of the sequential process of cell commands for each cell) in a series of cell command processing sequences designated from cell command #1 (C_CMD#1) to cell command #k (C_CMD#k) is adopted. FIG. 37 shows execution range information of the sequential process of cell commands which can be set for each cell. As has been explained in FIG. 33, the PGCI information can be allocated at the three locations (a) to (c). Management information associated with individual cells that form a PGC is recorded in cell playback information (C_PBI) 530 in cell playback information table (C_PBIT) 53 in the PGCI as the management information of the PGC of interest, as shown in FIG. 37.

Information associated with the first cell command number, at which the sequential process of cell command is to start, designated for each cell in a series of cell command processing sequences designated from cell command #1 (C_CMD#1) to cell command #k (C_CMD#k) is recorded in cell command start number information (C_CMD_SN) in cell playback information (C_PBI) 530, as shown in FIG. 37. At the same time, cell command continuous number information (C_CMD_C_Ns) indicating the number of commands, the command processes of which are to be continuously executed as well as cell command (C_CMD) 513 designated by the cell command start number information (C_CMD_SN) is recorded in cell playback information (C_PBI) 530. Based on these two pieces of information, the execution range of the sequential process of cell command to be executed by the cell of interest is designated. In the embodiment of the present invention, after completion of playback of the cell of interest, a command sequence of the range designated by the cell command start number information (C_CMD_SN) and cell command continuous number information (C_CMD_C_Ns) in FIG. 37 can be executed.

FIG. 37 shows an example of the data structure of the cell playback information table (C_PBIT) included in the program chain information (PGCI). Referring to FIG. 37, cell playback information (C_PBI) can store the following information: a cell category (C_CAT) indicating if a cell of interest corresponds to the start or last cell of an interleaved block when the cell of interest forms an interleaved block corresponding to multi-angle playback, a part of a general continuous block, or a part of an interleaved block corresponding to multi-angle playback; a cell playback time (C_PBTM) indicating a playback time required to play back the entire cell of interest; the start address position information (C_FVOBU_SA) of the first VOBU of the cell; the end address position information (C_FILVU_EA) of the first ILVU of the cell; the start address position information (C LVOBU_SA) of the last VOBU of the cell; the end address position information (C_LVOBU_EA) of the last VOBU of the cell, and the like.

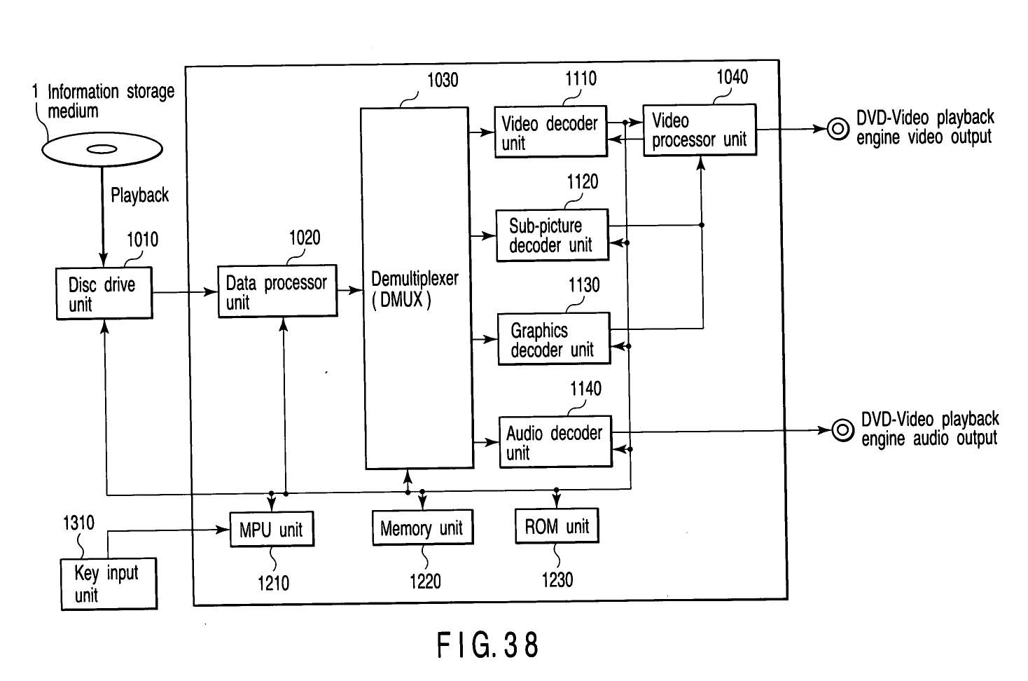

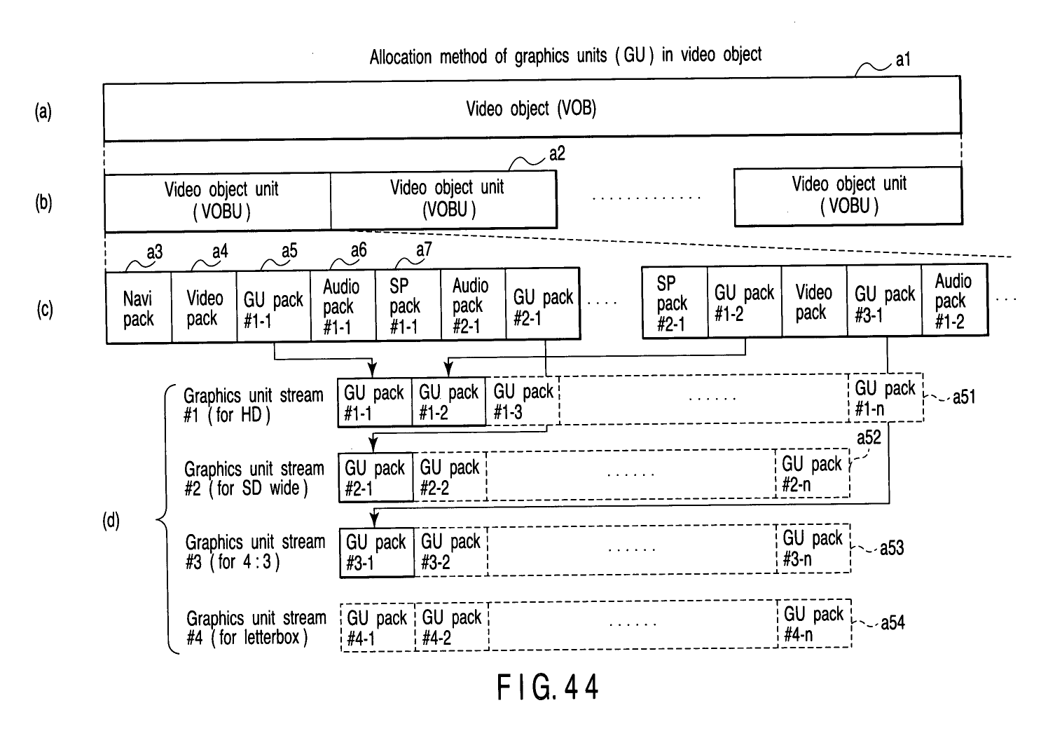

FIG. 38 is a block diagram for explaining an example of the internal structure of a playback apparatus of the disc-shaped information storage medium (optical disc, etc.) according to the embodiment of the present invention. Referring to FIG. 38, information storage medium 1 records HD_DVD-Video content according to the embodiment of the present invention. Disc drive unit 1010 plays back the HD_DVD-Video content from this information storage medium 1, and transfers them to data processor unit 1020. A Video Object (VOB) as picture data in the HD_DVD-Video content includes a group of Video Object Unit (VOBU) data as a basic unit shown in FIG. 44(c), and navi pack a3 is allocated at the head in each VOBU. Video data, audio data, and sub-picture data are respectively distributed and allocated in video packs a4, audio packs a6, and sub-picture (SP) packs a7, thus forming a multiplexed structure.

The embodiment of the present invention newly have graphics unit data, which is distributed and recorded in graphics unit (GU) packs a5. Demultiplexer 1030 in FIG. 38 demultiplexes a VOB formed by multiplexing these kinds of data into packets. Demultiplexer 1030 transfers video data recorded in video packs a4 to video decoder unit 1110, sub-picture data recorded in sub-picture packs a7 to sub-picture decoder unit 1120, graphics data recorded in graphics unit packs a5 to graphics decoder unit 1130, and audio data recorded in audio packs a6 to audio decoder unit 1140. Respective kinds of incoming data are decoded by decoder units 1110 to 1140, and are combined as needed in video processor unit 1040. Then, the combined data is converted into an analog signal via digital-to-analog converters 1320 and 1330, and the analog signal is output. MPU unit 1210 systematically manages a series of these processes, and temporarily stores data, which is required to be temporarily saved during processing, in memory unit 1220. ROM unit 1230 records processing programs to be processed by MPU unit 1210 and permanent data set in advance. In FIG. 38, information which is input from the user to the information playback apparatus is input via key inputs at key input unit 1310. However, the present invention is not limited to this, and key input unit 1310 may comprise a general remote controller.

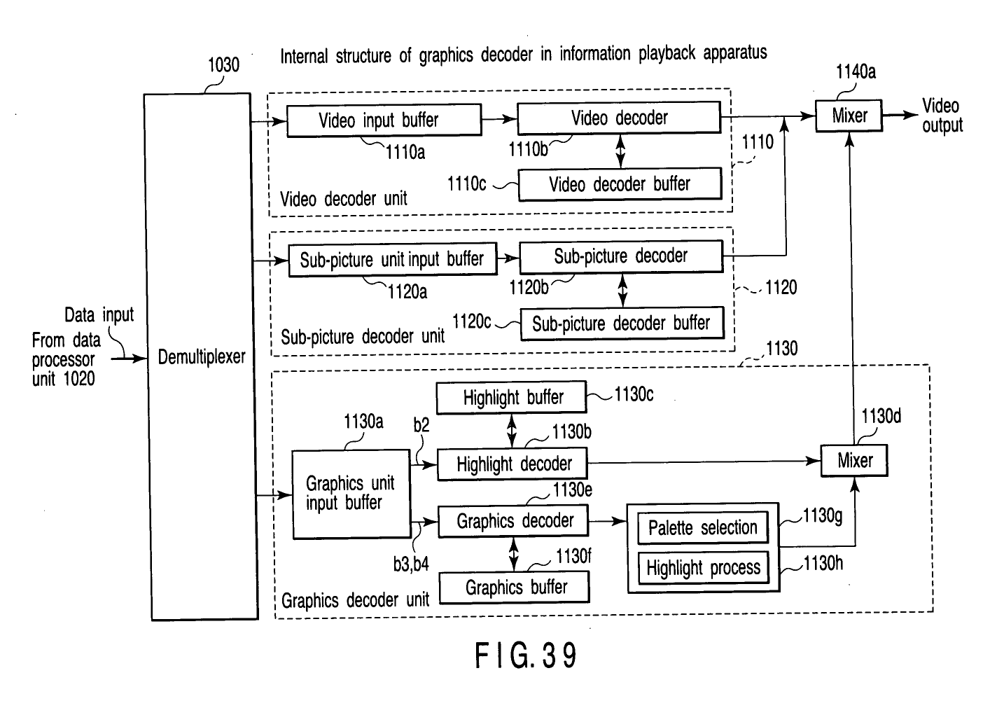

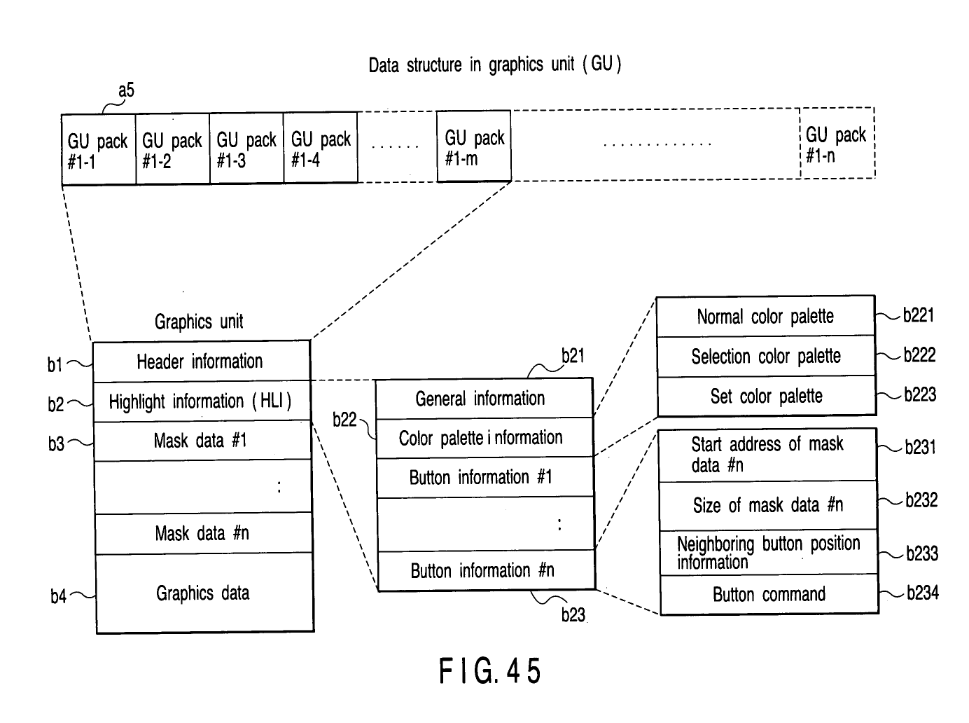

FIG. 39 is a block diagram for explaining the internal structure of graphics decoder unit 1130 shown in FIG. 38 in detail. Graphics unit data demultiplexed and extracted by demultiplexer 1030 is temporarily saved in graphics unit input buffer 1130a. The graphics unit data includes highlight information and graphics data and/or mask data, as will be described later with reference to FIG. 45. This highlight information is transferred to highlight decoder 1130b, and is decoded. The graphics data and mask data are decoded to 256-color screen information in graphics decoder 1130e.

Furthermore, after selection of color palettes and a highlight process (e.g., a process for changing a part of graphics data to be highlighted to a striking color) are applied to the decoded graphics data and/or mask data as needed, the graphics data and/or mask data are/is mixed with the decoded highlight data (e.g., picture data which has emphasized frame pixels at positions to be highlighted, and transparent pixels at other positions) by mixer 1130d, and the decoded graphics data and/or mask data modified by the highlight data as needed are/is sent to mixer 1140a. This mixer 1140a mixes the decoded graphics data and/or mask data with video data from video decoder unit 1110 and sub-picture data from sub-picture decoder unit 1120, thus forming a video output. Note that mixer 1140a in FIG. 39 is included in video processor unit 1040 in FIG. 38.

In the arrangement shown in FIG. 39, the decoded output of highlight decoder 1130b may control palette selector 1130g and/or highlight processor 1130h, so that the highlight modification may be directly applied to the decoded output of graphics decoder 1130e (in this case, mixer 1130d can be omitted).

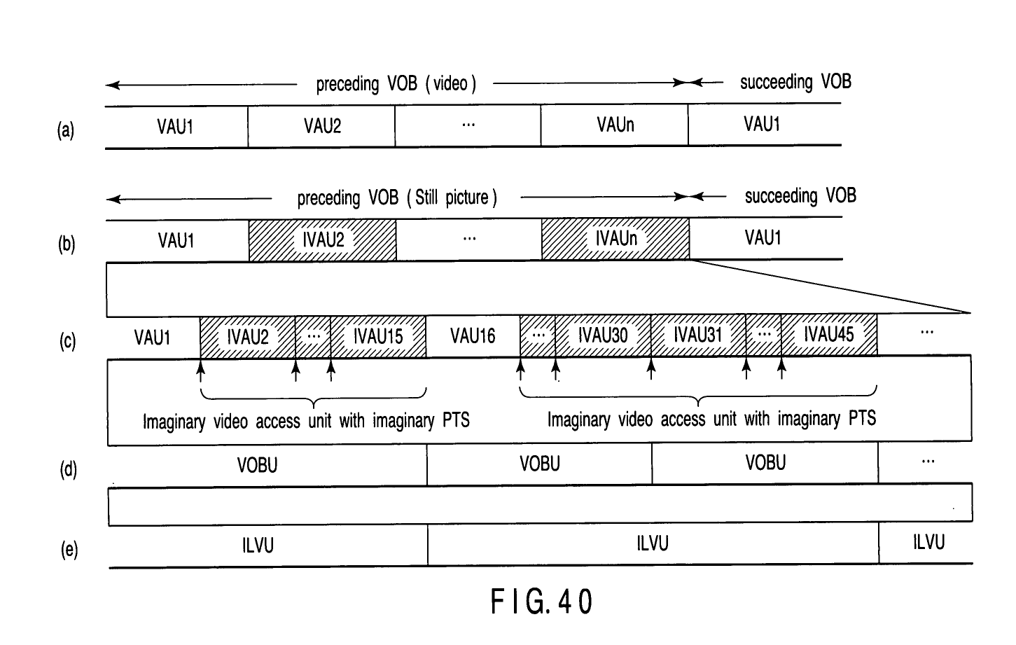

FIG. 40 is a view for explaining the concept of imaginary video access unit (IVAU). An IVAU according to the embodiment of the present invention will be described below using FIG. 40. Each VOB of a movie in the conventional SD DVD-Video content is divided into Video Access Unit (VAU) data, as shown in FIG. 40(a). By matching the boundary position of neighboring VOB data with that of neighboring VAU data, seamless playback between different VOB data can be attained.

In the HD_DVD-Video according to the embodiment of the present invention, as shown in FIG. 40(b), “imaginary access units” IVAU2 to IVAUn (imaginary video access units 2 to n) are set in a period between VAU1 which includes I-picture that records a still picture, and VAU1 including I-picture that records a next still picture to be displayed. This is a characteristic feature of this invention. As the setting method of access units, an interval between (VAU1 including) I-picture from which a still picture starts and (VAU1 including) the next I-picture is imaginarily finely time-divided for respective periods of access units using as a unit the video frame time or a time in an integer multiple of the video frame. A Decoding Time Stamp (DTS) indicating the input timing of a still picture to the decoder, and a Presentation Time Stamp (PTS) indicating the display timing of a still picture are set in advance for each still picture. Since one video frame period is determined in National Television System Committee (NTSC) and Phase Alternation by Line (PAL), the timing of a boundary position of the “imaginary access units” is calculated, and the calculated timing is set as an imaginary PTS, as shown in FIG. 40(c). Then, it can be (imaginarily) considered as if a still picture is repetitively played back and displayed for respective virtual access units.

In the embodiment of the present invention, as shown in FIG. 40(d), one VOBU is formed of an integer number of “virtual access units”. As a result, in the embodiment of the present invention, a VOBU display time of each still picture becomes an integer multiple of a video frame. In FIG. 40(c), a VAU (Video Access Unit) includes one I-picture indicating a still picture, but an IVAU does not include any I-picture. Hence, no video data is included in the IVAU. That is, each of a VOBU formed by VAU1 to IVAU15 and that formed by VAU16 to IVAU30 includes only one I-picture. By contrast, a VOBU formed by IVAU30 to IVAU45 does not include any video data (I-picture).

Note that the embodiment of the present invention allows to define a VOBU having no video data. Also, the embodiment of the present invention inhibits one VOBU from having a plurality of I-picture data, and limits (constrains) so that one VOBU has one or less (including zero) I-picture. As can be seen from comparison of the positions in (c) and (d) of FIG. 40, one VOBU adopts a structure in which a VAU is (imaginarily) allocated ahead of an IVAU. As shown in FIG. 40(e), the first VOBU in an Interleaved Unit (ILVU) always has video data (I-picture that records a still picture)

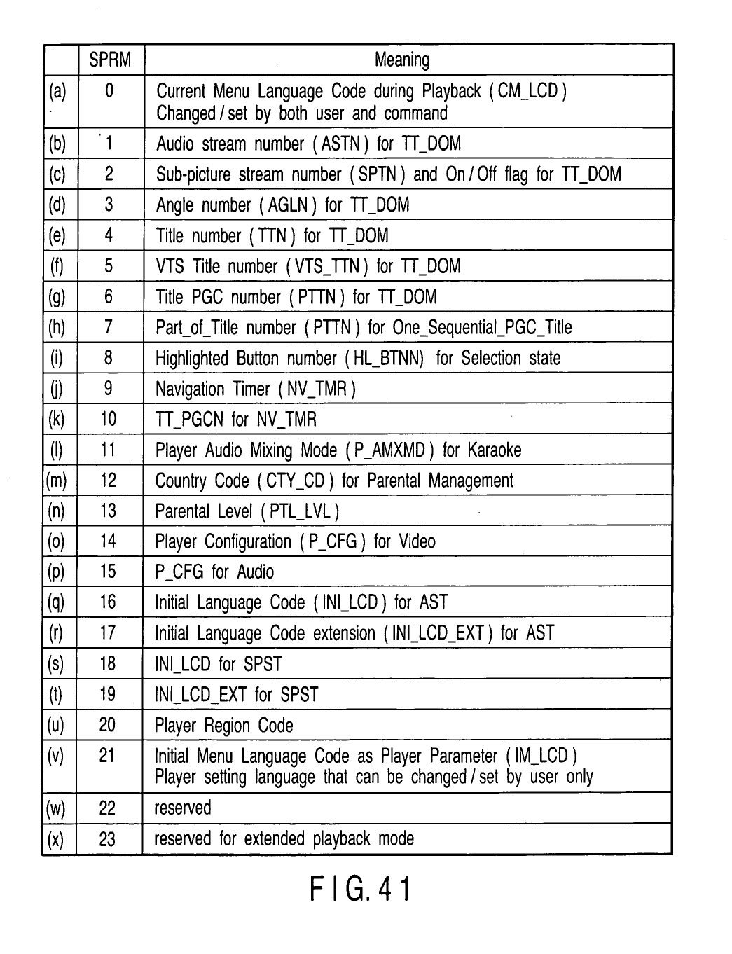

FIG. 41 is a view for explaining a practical example of system parameters used in the embodiment of the present invention. In the system block diagram in the information playback apparatus shown in FIG. 38, memory unit 1220 is assigned fields for storing system parameters “0” to “23” shown in FIG. 41. Current menu language code information during playback (a language code that can be changed/set by the user and/or a command) is recorded in “SPRM0”, and initial menu language code information (a setting language code of the playback apparatus which can be changed/set by only the user) is recorded in “SPRM21”. Other kinds of information to be stored in other system parameters are: audio stream number (ASTN) for TT_DOM in SPRM(1); sub-picture stream number (SPSTN) and on/off flag for TT_DOM in SPRM(2); angle number (AGLN) for TT_DOM in SPRM(3); title number (TTN) for TT_DOM in SPRM(4); VTS title number (VTS_TTN) for TT_DOM in SPRM(5); title PGC number (TT_PGCN) for TT_DOM in SPRM(6); Part_of_Title number (PTTN) for One_Sequential_PGC_Title in SPRM(7); Highlighted Button number (HL_BTNN) for Selection state in SPRM(8); Navigation Timer (NV_TMR) in SPRM(9); TT_PGCN for NV_TMR in SPRM(10); Player Audio Mixing Mode (P_AMXMD) for Karaoke in SPRM(11); Country (or Region) Code (CTY_CD) for Parental Management in SPRM(12); Parental Level (PTL_LVL) in SPRM(13); Player Configuration (P_CFG) for Video in SPRM(14); P_CFG for Audio in SPRM(15); Initial Language Code (INI_LCD) for AST in SPRM(16); Initial Language Code extension (INI_LCD_EXT) for AST in SPRM(17); INI_LCD for SPST in SPRM(18); INI_LCD_EXT for SPST in SPRM(19); and Player Region Code in SPRM(20).

FIG. 42 shows an example of a list of commands used in the embodiment of the present invention. Commands with command ID-1=“000” to “110” are the same as those used in the conventional DVD-Video, but a command “Call INTENG” with command ID-1=“111” is the one which is newly introduced in the embodiment of the present invention and uses an interactive engine.

FIG. 43 shows an example of a command list used in the HD_DVD-Video content in the embodiment of the present invention. “Compare Field” shown in FIG. 43(a) is used to compare a value in a navigation parameter with a specific value specified by an operand of a command. If this comparison result is true, a subsequent instruction is executed; if it is false, a subsequent instruction is skipped. This instruction is used in combination with other instruction groups. In FIG. 43(a), EQ means Equal; NE, Not Equal; GE, Greater than or equal to; GT, Greater than; LE, Less than or equal to; LT, Less than; and BC, Bitwise Compare.

“Go To Option” in “Branch Field” shown in FIG. 43(b) is used to change the execution order of navigation commands in a pre-command area or post command area, or a resume command area or cell command area. In FIG. 43(b), GoTo means transition to another navigation command, and Break means the end of execution of a navigation command in the pre-command area or post command area, or the resume command area or cell command area. Also, SetTmpPML means confirmation of a temporal change in parental level, a change in parental level, and transition to a specific navigation command if possible.

“Link Option” in “Branch Field” shown in FIG. 43(c) is used to start playback specified in one domain. In FIG. 43(c), LinkPGCN means the start of playback of a PGC of interest by directly designating a program chain number (PGCN). LinkPTTN means the start of playback of a PTT of interest (or a chapter of interest) by directly designating a part_of_title number (PTTN). LinkPGN means the start of playback of a PG of interest by directly designating a program number (PGN). LinkCN means the start of playback of a cell of interest by directly designating a cell number (CN).

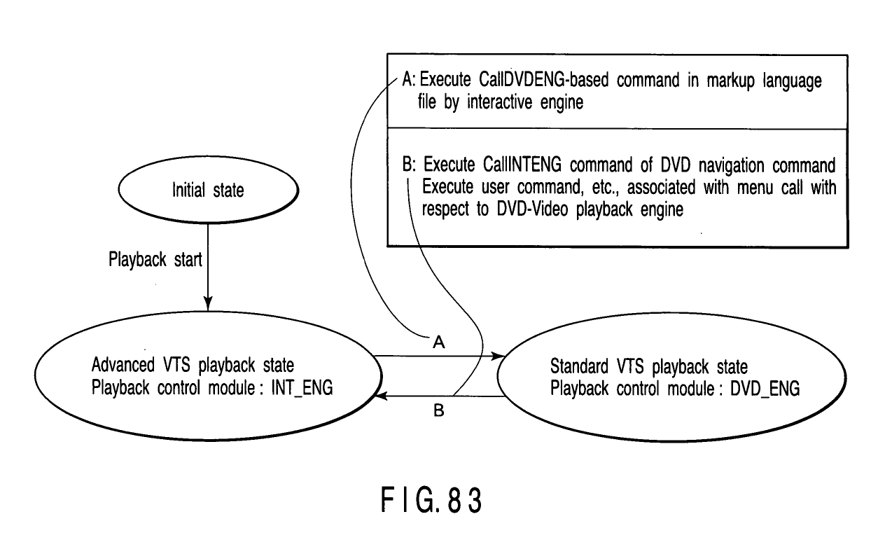

“Jump Option” in “Branch Field” shown in FIG. 43(d) is used to start specific playback after space movement. In FIG. 43(d), Exit means the end of playback. JumpTT means title playback start (when title number TTN is used). JumpVTS_TT means title playback start in a single VTS. CallSS means PGC playback start in a system space that stores resume information. JumpSS means playback start of a part_of_title included in a specific title in a single VTS. CallINTENG represents transfer of the control from a DVD-Video playback engine to an interactive engine (details are shown in FIG. 83).

“SetSystem Field” shown in FIG. 43(e) is used to set a system parameter value, and a mode and value of a general parameter. In FIG. 43(e), SetSTN means setting of a stream number (parameters to be set are SPRM(1), SPRM(2), and SPRM(3)). SetNVTMR means condition setting of the navigation timer (parameters to be set are SPRM(9) and SPRM(10)). SetHL_BTNN means setting of the highlighted button number for a selection state (a parameter to be set is SPRM(8)). SetAMXMD means setting of an audio mixing mode of the playback apparatus for Karaoke (a parameter to be set is SPRM(11)). SetGPRMMD means setting of modes and values of general parameters (parameters to be set are GPRM(0) and GPRM(15)). SetM_LCD means setting of a menu description language code (a parameter to be set is SPRM(0)). SetRSMI means updating of resume information (parameters to be set are a CN, NV_PCK address, PGC control state, VTSN (Video Title Set Number), SPRM(4), SPRM(5), SPRM(6), SPRM(7), and SPRM(8)).

“Set Field” shown in FIG. 43(f) is used to execute a calculation on the basis of a specific value specified by an operand and a general parameter. The calculation includes the following two types:

1) Arithmetic operation

2) Bitwise operation

The calculation result is re-stored as a general parameter. In FIG. 43(f), Exp means an exponential calculation; Div, division; and Add, addition.

FIG. 44 shows the allocation of graphics units GU in a video object. The HD_DVD-Video content used in the embodiment of the present invention comply with the multiplexing rule of the MPEG system layer. That is, graphics unit data is segmented into every 2048-byte packs, and these packs are separately allocated. Upon playback, graphics unit (GU) packs which are distributed and allocated in information storage medium 1 are collected to re-form a single graphics unit stream, as shown in (c) and (d) of FIG. 44. Graphics units can support graphics data corresponding to an HD picture at 16:9, SD picture at 16:9, SD picture at 4:3, and SD picture at letter box, and independent streams are formed in correspondence with the four types of pictures (HD picture at 16:9, SD picture at 16:9, SD picture at 4:3, and SD picture at letter box), as shown in FIG. 44(d).

FIG. 45 shows an example of the data structure in a graphics unit. As shown in FIG. 45, the data structure in the graphics unit includes header information b1, highlight information b2, mask data b3, and graphics data b4. Highlight information b2 includes general information b21, color palette information b22, and button information b23.

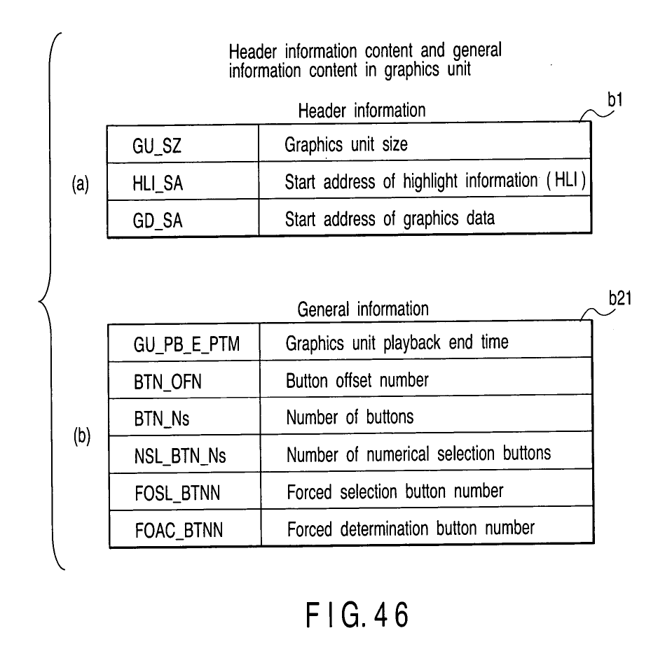

FIG. 46 shows an example of the header information content and general information content in the graphics unit. As shown in FIG. 46, the content of the header information include graphics unit size (GU_SZ) information, the start address (HLI_SA) information of the highlight information, and the start address (GD_SA) information of the graphics data. Of these content, the graphics unit size (GU_SZ) information indicates the overall size of the graphics unit shown at the lower left position in FIG. 45. The start address (HLI_SA) information of the highlight information means an address to the start position of highlight information b2 with reference to the head position (that of header information b1) of the graphics unit shown at the lower left position in FIG. 45. Also, the start address (GD_SA) information of the graphics data means an address to the head position of graphics data b4 with reference to the head position (that of header information b1) of the graphics unit shown at the lower left position in FIG. 45.

Referring to FIG. 45, general information b21 in highlight information b2 has graphics unit playback end time (GU_PB_E_PTM) information, button offset number (BTN_OFN) information, information of the number (BTN_Ns) of buttons, information of the number (NSL_BTN_Ns) of numeral selection buttons, forced selection button number (FOSL_BTNN) information, forced determination button number (FOAC_BTNN) information, and the like. The graphics unit area is distributed and allocated as graphics unit (GU) packs, as described above using FIG. 44. This graphics unit pack (strictly speaking, a packet header in a graphics unit packet included in that pack) records in advance PTS (Presentation Time Stamp) information at which playback of the graphics unit starts. Using this PTS information and the graphics unit playback end time (GU_PB_E_PTM) information, a graphics unit display time and effective time that allows execution (of a command) (both the start/end times completely match) are set. Since the start/end time information uses a PTS/PTM, the time range can be set with a very high precision.

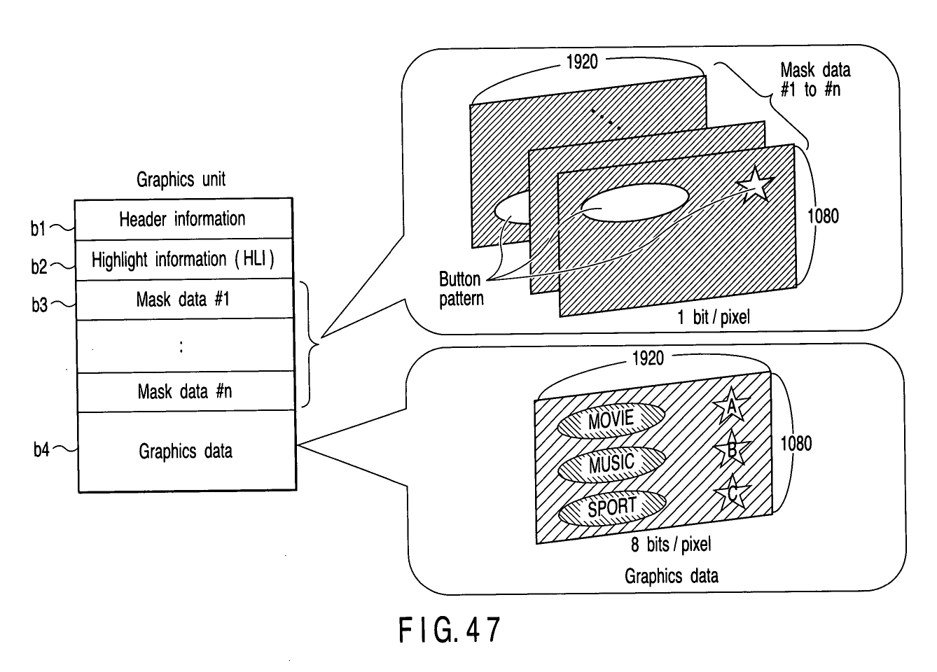

FIG. 47 is a view for explaining an image example of mask data and graphics data in the graphics unit. As the graphics data, as shown in FIG. 47, picture information (bitmap data or compressed data of that bitmap) for one screen which allows 256-color expression by assigning 8 bits per pixel is recorded. The mask data indicates a position range on the screen where the user can designate command execution, and sets only a screen region by assigning 1 bit per pixel. Since the mask data designates a region in the bitmap format using pixels, not only a plurality of regions located at positions separate from each other can be simultaneously set by masking, but also an arbitrary shaped region can be finely set as a masking screen region using pixels, as shown in FIG. 47. This is also a characteristic feature of this embodiment. A plurality of mask data can be set, and a plurality of menu choices to the user can be supplied (FIG. 47 exemplifies three user's choices).

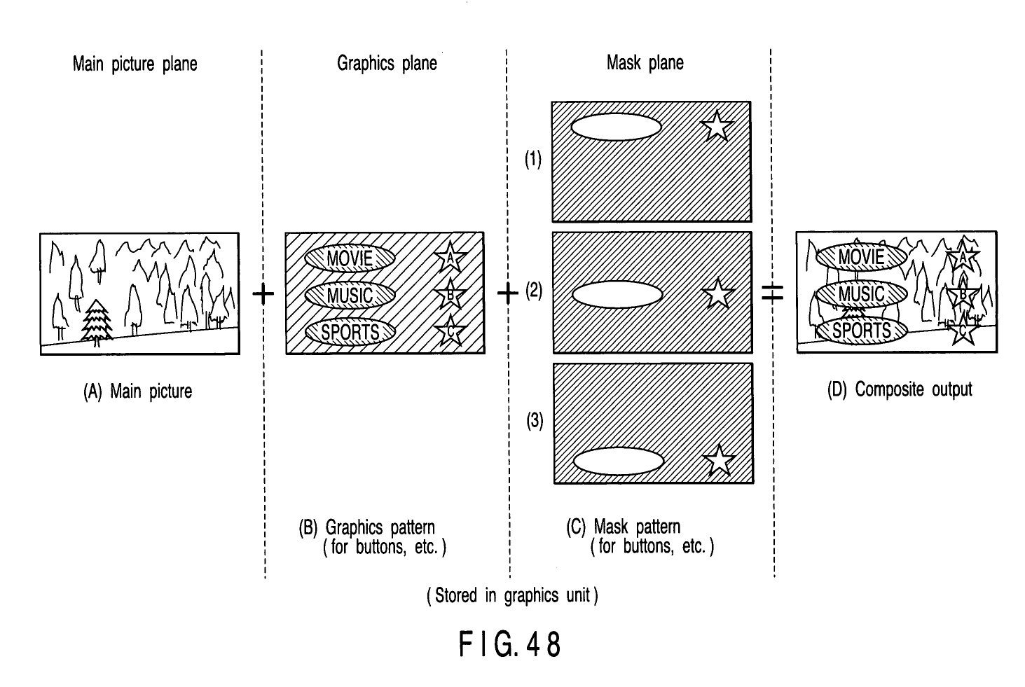

FIG. 48 shows an example of video composition including mask patterns. A screen to be presented to the user can be generated by compositing main picture (A) recorded in video packs a4 in FIG. 44(c), graphics pattern (B) recorded as the graphics data, and mask data (c) that can set a plurality of patterns, as shown in FIG. 48.

In the embodiment of the present invention, as shown in FIG. 45, the number n of mask data in a single graphics unit matches the number n of pieces of button information recorded in the highlight information, and each mask data #n and button information #n have one-to-one correspondence. That is, in m that satisfies 1≦m≦n, the m-th mask data from the top corresponds to the m-th button information from the top. For example, when the user highlights (designates) a region designated by the m-th mask data on the screen by operating a cursor key or the like on a remote controller (not shown), button command b234 recorded in m-th button information b23 is executed in response to that action. In this manner, each button information #n links with each individual mask data #n. In order to further facilitate access control to mask data, button information #n records start address (address from the head position of the header information to the n-th mask data start position in the lower left view of FIG. 45) information b231 and data size information b232 of corresponding mask data #n. In addition, button information b23 records neighboring button position information b233.

The data structure in color palette information b22 in highlight information b2 in FIG. 45 will be described below. Normal color palette b221 stores color information of buttons when the menu screen is presented to the user first (before user selection). When the user selects (designates) a specific button, the display color of that button changes on the screen. Selection color palette b222 records the changed display color of the button. Furthermore, when that button is set, and button command b234 corresponding to the button is about to be executed, the display color of the button can be set to be changed to a color indicating “set”. Set color palette b223 has the set display color of the button.

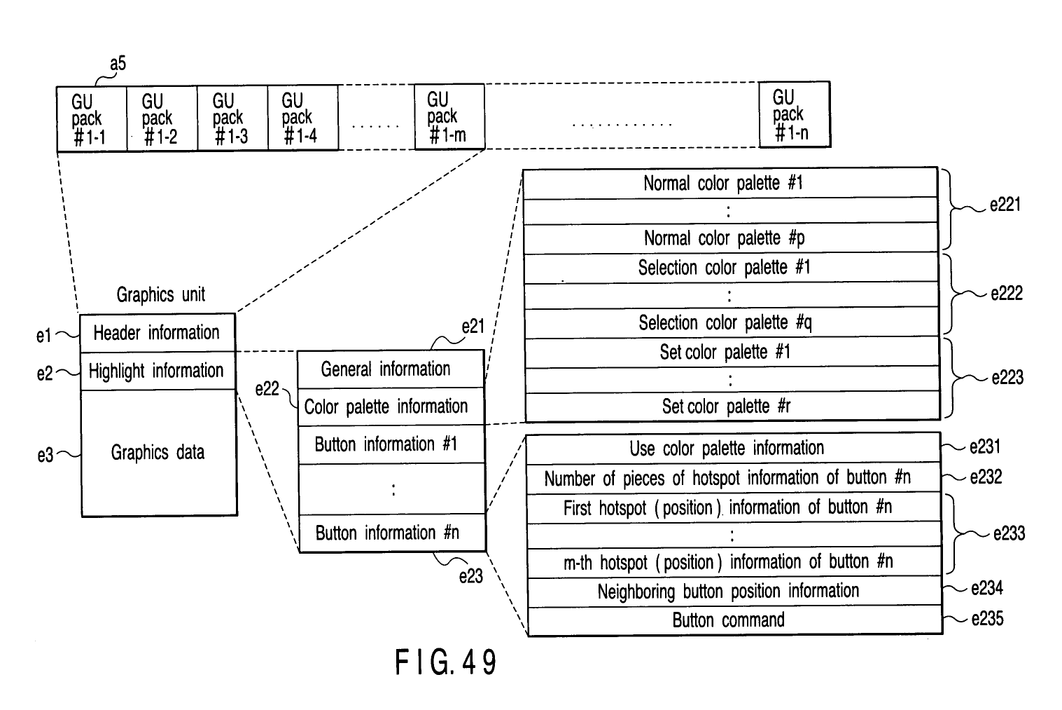

FIG. 49 shows another embodiment associated with the data structure of the graphics unit. The embodiment of FIG. 49 is characterized in that hot spot information is used in place of mask data. In correspondence with this feature, in the example of FIG. 49, a plurality of normal color palettes e221, selection color palettes e222, and set color palettes e223 can be set. As the region designation method of each button information e23 on the screen, a region on the screen can be designated by hot spot position information e233 in place of mask data. Furthermore, in the example of FIG. 49, a plurality of pieces of hot spot position information e233 can be set for one button information e23, so that a plurality of regions which are separate from each other on the screen can correspond to one button information e23.

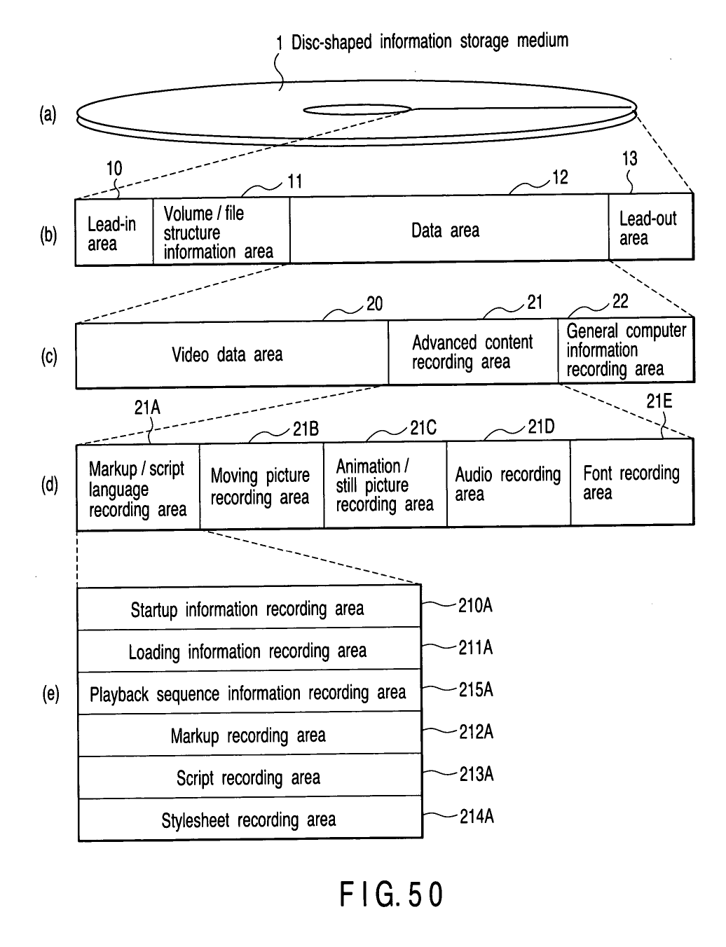

FIG. 50 is a view for explaining an example of the recording content of an advanced content recording area of the information content recorded on disc-shaped information storage medium (optical disc, etc.) 1 according to another embodiment of the present invention. As shown in FIG. 50(d), advanced content recording area 21 in FIG. 50(c) is configured to include moving picture recording area 21B for recording moving picture data, animation/still picture recording area 21C for recording animation data and still picture data, audio recording area 21D for recording audio data, font recording area 21E for recording font data, and markup/script language recording area 21A for recording information for controlling playback of these data (such information is described using a markup language/script language/StyleSheet, and the like) (the area 21A is the head of the recording order of these areas as shown in FIG. 50).

The information for controlling playback (recording content in area 21A) describes a playback method (display method, playback sequence, playback switching sequence, selection of objects to be played back, etc.) of advanced content (including audio, still picture, font/text, moving picture, animation, and the like) and/or DVD-Video content using a markup language, script language, and StyleSheet. For example, markup languages such as HTML (Hyper Text markup Language)/XHTML (extensible Hyper Text markup Language), SMIL (Synchronized Multimedia Integration Language), and the like, script languages such as an ECMA (European Computer Manufacturers Association) script, Javascript (Java is the registered trade name), and the like, StyleSheets such as CSS (Cascading Style Sheet), and the like, and so forth, may be used in combination.

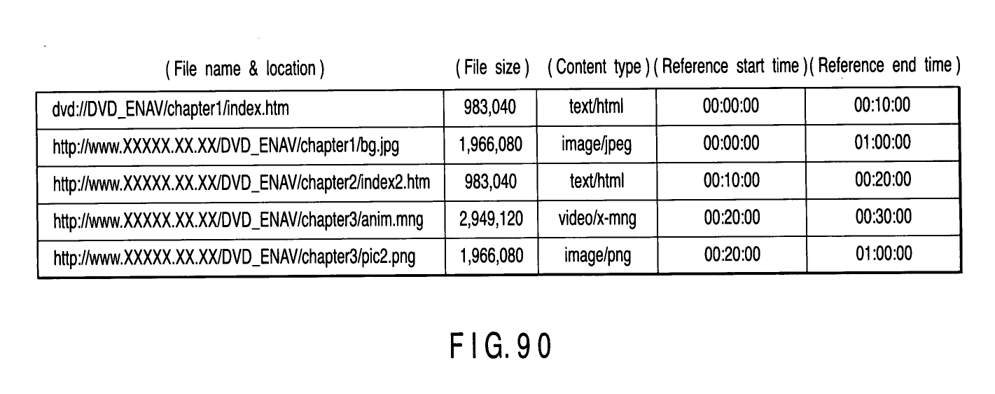

markup/script language recording area 21A includes startup recording area 210A for recording startup information, loading information recording area 211A for recording information of files to be loaded onto a buffer in a playback apparatus (see FIG. 90), playback sequence information recording area 215A for defining the playback order of video pictures for playing back the HD_DVD video pictures stored in the expansion video object sets of the advanced title sets using a markup language or script language, markup language recording area 212A for recording the aforementioned markup languages, script recording area 213A for recording the aforementioned script languages, and StyleSheet recording area 214A for recording the aforementioned StyleSheets.

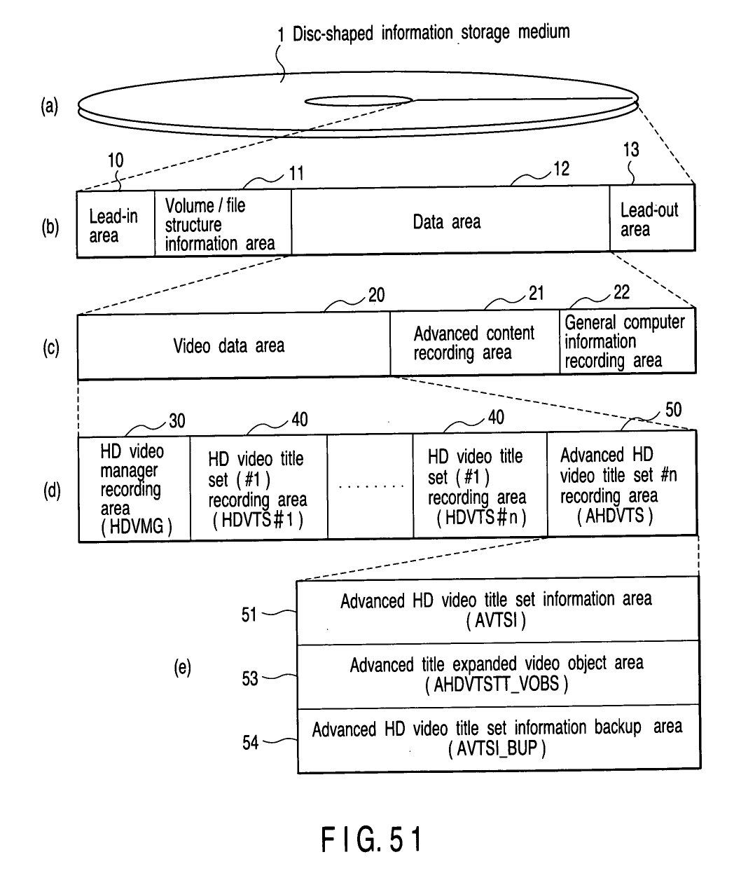

FIG. 51 is a view for explaining an example of the recording content of an advanced HD video title set recording area of the information content recorded on disc-shaped information storage medium (optical disc, etc.) 1 according to still another embodiment of the present invention. An advanced HD video title set (AHDVTS: advanced VTS) shown in FIG. 51(d) is a video object which is specialized to be referred to from a markup language as one of the aforementioned advanced content.

As shown in FIG. 51(e), advanced HD video title set (AHDVTS) recording area 50 includes advanced HD video title set information (AHDVTSI) area 51 that records management information for all the content in advanced HD video title set recording area 50, advanced HD video title set information backup area (AHDVTSI_BUP) 54 that records the same information as in HD video title set information area 51 as backup data, and advanced title video object area (AHDVTSTT_VOBS) 53 that records video object (title picture information) data in an advanced HD video title set.

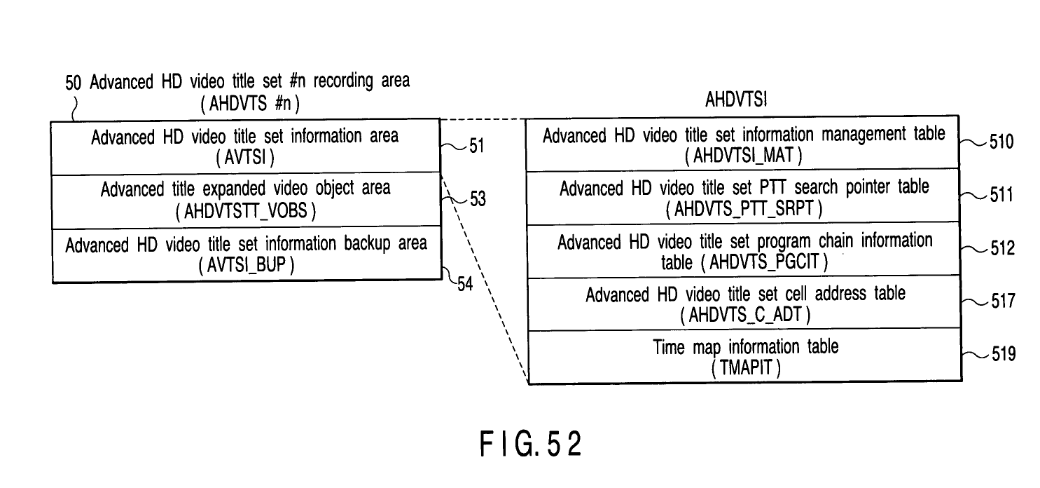

FIG. 52 shows an example of the data structure of advanced HD video title set information recorded in the advanced HD video title set recording area. This information is recorded together in file HVIA0001.IFO (or VTSA0100.IFO; not shown), and advanced HD video title set information (AHDVTSI) area 51 shown in FIG. 51(e) is divided into respective fields (management information groups): advanced HD video title set information management table (AHDVTSI_MAT) 510, advanced HD video title set PTT search pointer table (AHDVTS_PTT_SRPT) 511, advanced HD video title set program chain information table (AHDVTS_PGCIT) 512, advanced HD video title set cell address table (AHDVTS_C_ADT) 517, and time map information table (TMAPIT) 519, as shown in FIG. 52.

Note that time map information table (TMAPIT) 519 is one field of advanced HD video title set information (AHDVTSI) area 51, but it can be recorded in the same file (HVIA0001.IFO in FIG. 2) as advanced HD video title set information area 51 or in a file (e.g., HVM00000.MAP) independent from advanced HD video title set information area 51.

Advanced HD video title set information management table (AHDVTSI_MAT) 510 records management information common to the corresponding video title set. Since this common management information is allocated in the first field (management information group) in advanced HD video title set information (AHDVTSI) area 51, the common management information in the video title set can be immediately loaded. Hence, the playback control process of the information playback apparatus can be simplified, and the control processing time can be shortened.

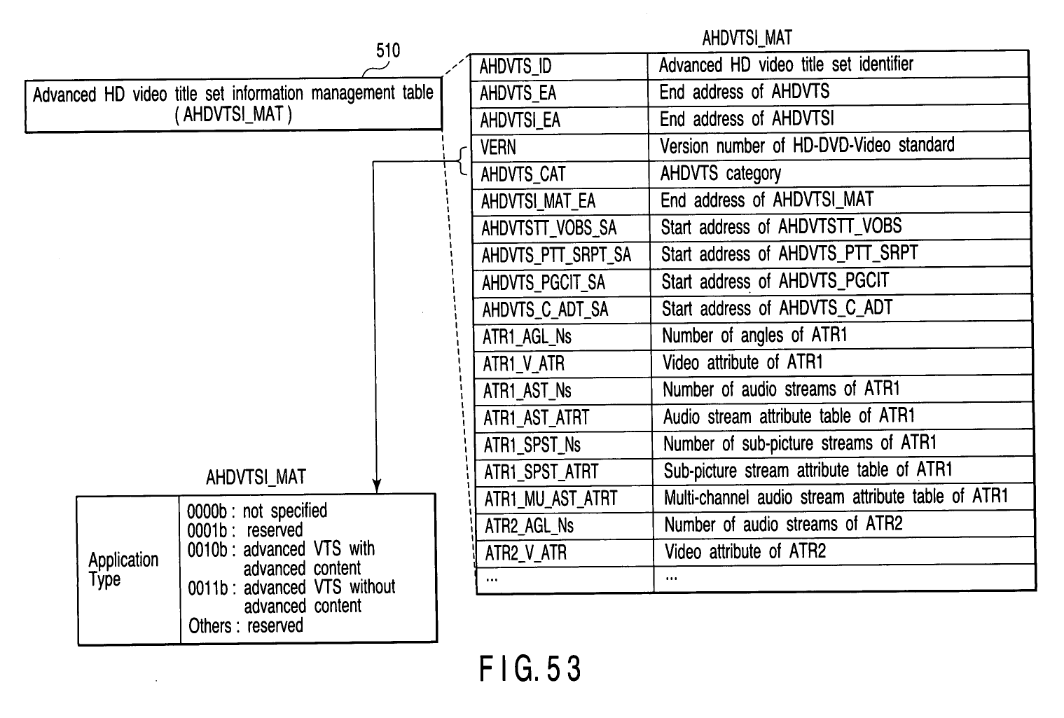

FIG. 53 shows an example of the data structure of the advanced HD video title set information management table (AHDVTSI_MAT) recorded in the advanced HD video title set information (AHDVTSI), and the recording content of category information (AHDVTS_CAT) stored in this management table. Advanced HD video title set information management table (AHDVTSI_MAT) 510 can store the following information as the common management information in the video title set. That is, as shown in FIG. 53, the advanced HD video title set information management table can store various kinds of information: an advanced HD video title set identifier (AHDVTS_ID), the end address (AHDVTS_EA) of the advanced HDVTS, the end address (AHDVTSI_EA) of the advanced HDVTSI, the version number (VERN) of the HD_DVD-Video standard, an AHDVTS category (AHDVTS_CAT), the end address (AHDVTSI_MAT_EA) of the AHDVTSI_MAT, the start address (AHDVTSTT_VOBS_SA) of the AHDVTSTT_VOBS, the start address (AHDVTS_PTT_SRPT_SA) of the AHDVTS_PTT_SRPT, the start address (AHDVTS_PGCIT_SA) of the AHDVTS_PGCIT, the start address (AHDVTS_C_ADT_SA) of the AHDVTS_C_ADT, the number (ATR1_AGL_Ns) of angles of a video object having attribute information 1 (ATR1), a video attribute (ATR1_V_ATR) of the video object having attribute information 1 (ATR1), the number (ATR1_AST_Ns) of audio streams of the video object having attribute information 1 (ATR1), an audio stream attribute table (ATR1_AST_ATRT) of the video object having attribute information 1 (ATR1), the number (ATR1_SPST_Ns) of sub-picture streams of the video object having attribute information 1 (ATR1), a sub-picture stream attribute table (ATR1_SPST_ATRT) of the video object having attribute information 1 (ATR1), a multi-channel audio stream attribute table (ATR1_MU_AST_ATRT) of the video object having attribute information 1 (ATR1), and the like (attribute information 2 and attribute information 3 follow).

Of the information that can be stored in the management table (AHDVTSI_MAT) in FIG. 53, the start address (HDVTSM_VOBS_SA) of an HDVTSM_VOBS included in a standard VTS need not exist since the advanced VTS does not include any HDVTSM_VOBS (or may be used as a reserved area). The start address (HDVTSM_PGCI_UT_SA) of the HDVTSM_PGCI_UT included in the standard VTS need not exist since the advanced VTS does not include any HDVTSM_VOBS (or may be used as a reserved area). The start address (HDVTSM_C_ADT_SA) of the HDVTSM_C_ADT included in the standard VTS need not exist since the advanced VTS does not include any HDVTSM (or may be used as a reserved area). The start address (HDVTSM_VOBU_ADMAP_SA) of the HDVTSM_VOBU_ADMAP included in the standard VTS need not exist since the advanced VTS does not include any HDVTSM (or may be used as a reserved area). Furthermore, the start address (HDVTS_VOBU_ADMAP_SA) of the HDVTS_VOBU_ADMAP included in the standard VTS need not exist since the advanced VTS includes the substitute time map information table (or may be used as a reserved area).

Note that the information (AHDVTS_CAT) indicating categories of the advanced VTS stored in advanced HD video title set information management table (AHDVTSI_MAT) 510 in FIG. 53 is defined as follows:

AHDVTS_CAT=0001b: no AHDVTS category is specified

AHDVTS_CAT=0001b: reserved

AHDVTS CAT=0010b: advanced VTS with advanced content

AHDVTS_CAT=001b: advanced VTS without advanced content

AHDVTS_CAT=other: reserved

The “advanced VTS with advanced content” whose category is indicated by “AHDVTS_CAT=0010b” basically represents an advanced VTS which is configured with the markup language. That is, in this category, the content producer assumes an “advanced VTS controlled by the markup language”, and playback is permitted only according to the control of the markup language but playback of the advanced VTS alone is not permitted. For example, when the content producer describes a markup language that permits playback of an advanced VTS in a given period only under a specific condition, if playback of the advanced VTS alone is permitted, this period can be undesirably played back under a condition other than the specific condition. Such playback is inhibited for the advanced VTS of the category “AHDVTS_CAT=0010b”.

The “advanced VTS without advanced content” whose category is indicated by “AHDVTS_CAT=0011b” basically represents an advanced VTS that allows playback of the advanced VTS alone without any markup language. This assumes an advanced VTS which maintains playback compatibility between other recording standards (to be referred to as a VR standard) such as DVD-VR/HDDVD-VR and the playback dedicated standard (to be referred to as a video standard) in the embodiment of the present invention. The video and VR standards have different standard content due to their different use applications (the video standard places an emphasis on interactiveness, and the VR standard places an emphasis on edit functions). By commonizing a structurally simplified advanced VTS between the two standards, playback compatibility can be assured between the two standards having different purposes. For example, an information storage medium recorded in an advanced VTS mode in a recorder according to the VR standard can be played back by all playback apparatuses that can play back the video standard.

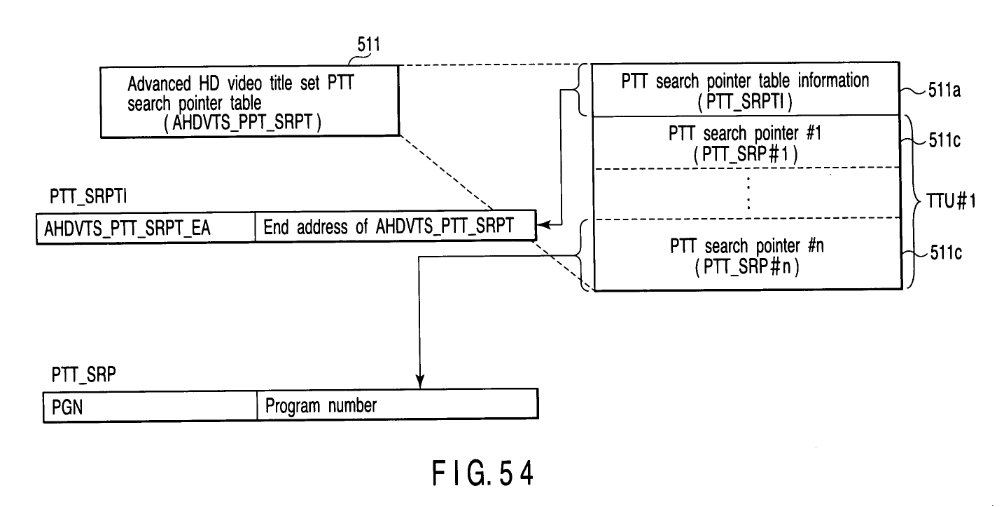

FIG. 54 shows an example of the data structure of advanced HD video title set PTT search pointer table (AHDVTS_PTT_SRPT) 511 shown in FIG. 52. Advanced HD video title set PTT search pointer table (AHDVTS_PTT_SRPT) 511 includes various kinds of information: PTT search pointer table information (PTT_SRPTI) 511a having information of the end address (AHDVTS_PTT_SRPT_EA) of the AHDVTS_PTT_SRPT; and PTT search pointers (PTT_SRP) 511c having information of a program number (PGN).

Note that HDVTS_TTU_Ns indicating the number of TTU data of an HDVTS which is included in the standard VTS need not exist since the number of TTU data in the advanced VTS is fixed, i.e., 1 (or if it exists, a fixed value is recorded). The advanced VTS can be configured to include only one title (TT). In this case, “title unit search pointers (TTU_SRP) 411b each of which records information of the start address (TTU_SA) of a TTU (see FIG. 22)” need not exist since there is only one TTU (or if it exists, a fixed value is recorded).

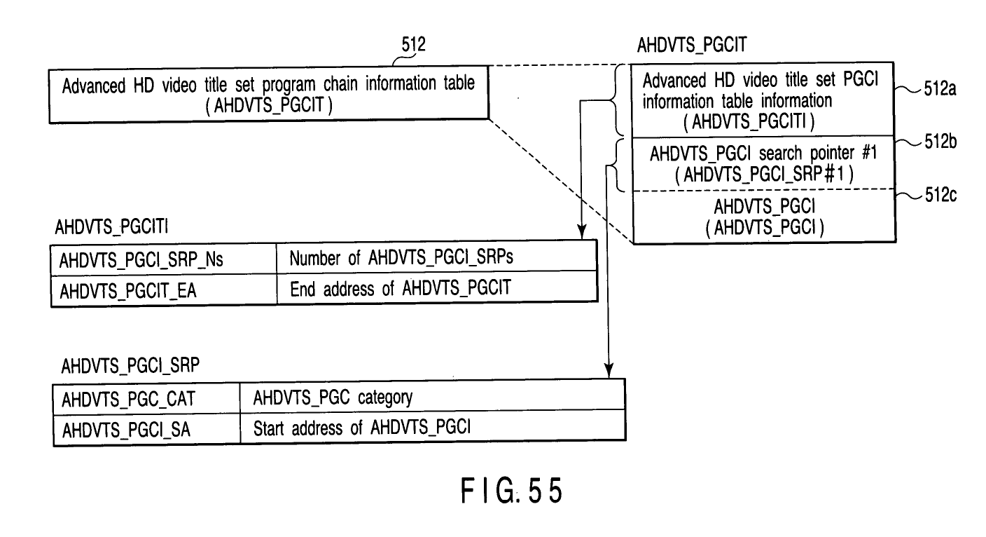

FIG. 55 shows an example of the data structure of advanced HD video title set program chain information table (AHDVTS_PGCIT) recorded in the advanced HD video title set information (AHDVTSI). As shown in FIG. 55, advanced HD video title set program chain information table (AHDVTS_PGCIT) 512 also records information of advanced HD video title set PGCI information table (AHDVTS_PGCITI) 512a including information of the number (AHDVTS_PGCI_SRP_Ns) of AHDVTS_PGCI_SRP data and the end address (AHDVTS_PGCIT_EA) of the AHDVTS_PGCIT. Also, AHDVTS_PGCI search pointer (AHDVTS_PGCI_SRP) 512b records information of the start address (AHDVTS_PGCI_SA) of the AHDVTS_PGCI together with the aforementioned AHDVTS_PGC category (AHDVTS_PGC_CAT).

Note that a plurality of PGCs can be prepared in the advanced VTS, but there is no function to control the connection relationship upon playback using navigation commands. For this reason, basically, there is only one PGC and one sequential playback of the advanced VTS is managed. In this case, the value of AHDVTS_PGCI_SRP_Ns is fixed, i.e., 1, and one each of search pointer (AHDVTS_PGCI_SRP) 512b and PGC information (AHDVTS_PGCI) 512c are present.

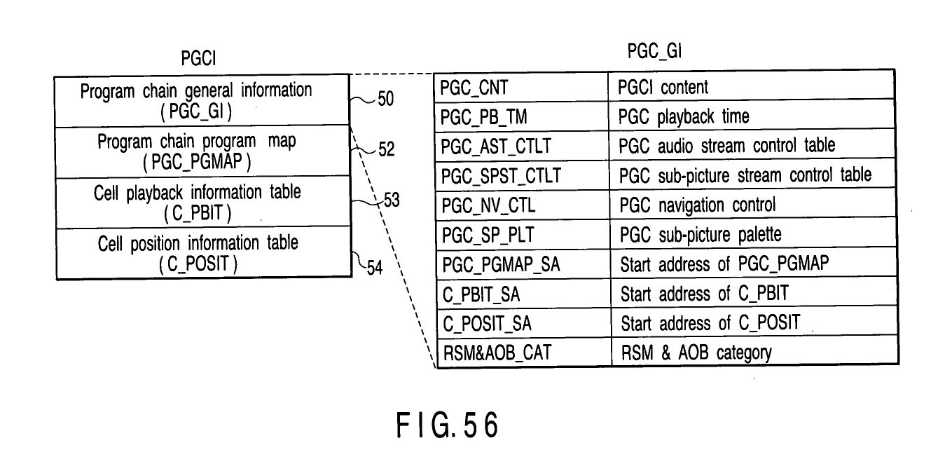

FIG. 56 shows an example of the data structure of program chain general information (PGC_GI) included in program chain information (corresponding to AHDVTS_PGCI in, e.g., FIG. 55). As shown in FIG. 56, the program chain information (PGCI) recorded in PGC information (AHDVTS_PGCI) 512c includes four fields (four management information groups), i.e., program chain general information (PGC_GI) 50, program chain program map (PGC_PGMAP) 52, cell playback information table (C_PBIT) 53, and cell position information table (C_POSIT) 54. Note that program chain command table (PGC_CMDT) 51 included in the PGCI of the standard VTS (FIG. 34) need not exist in the advanced VTS (or may be used as a reserved area).

As shown in FIG. 56, program chain general information (PGC_GI) 50 records various kinds of information including PGC content (PGC_CNT), a PGC playback time (PGC_PB_TM), a PGC audio stream control table (PGC_AST_CTLT), a PGC sub-picture stream control table (PGC_SPST_CTLT), PGC navigation control (PGC_NV_CTL), a PGC sub-picture palette (PGC_SP_PLT), the start address (PGC_PGMAP_SA) of the PGC_PGMAP, the start address (C_PBIT_SA) of the C_PBIT, and the start address (C_POSIT_SA) of the C_POSIT.

Note that the PGC user operation control (PGC_UOP_CTL) included in the standard VTS does not exist since the user operation control in the advanced VTS is made based on the markup language (or if it exists, PGC_UOP_CTL records a fixed value “00 . . . 00b”. Also, the PGC graphics unit stream control table (PGC_GUST_CTLT) included in the standard VTS does not exist since no graphics unit is used in the advanced VTS (or may be used as a reserved area). The start address (PGC_CMDT_SA) of the PGC_CMDT included in the standard VTS does not exist since no command table (PGC_CMDT) exists in the advanced VTS (or used as a reserved area).

Note that the example of the PGC_GI shown in FIG. 56 exemplifies RSM&AOB_CAT at its end. However, RSM&AOB category information (RSM&AOB_CAT) included in the standard VTS, i.e., RSM permission information, Audio selection information, and Audio Number information need not exist since the RSM information is controlled by the markup language and no Audio information is available in the advanced VTS (or may be used as a reserved area).

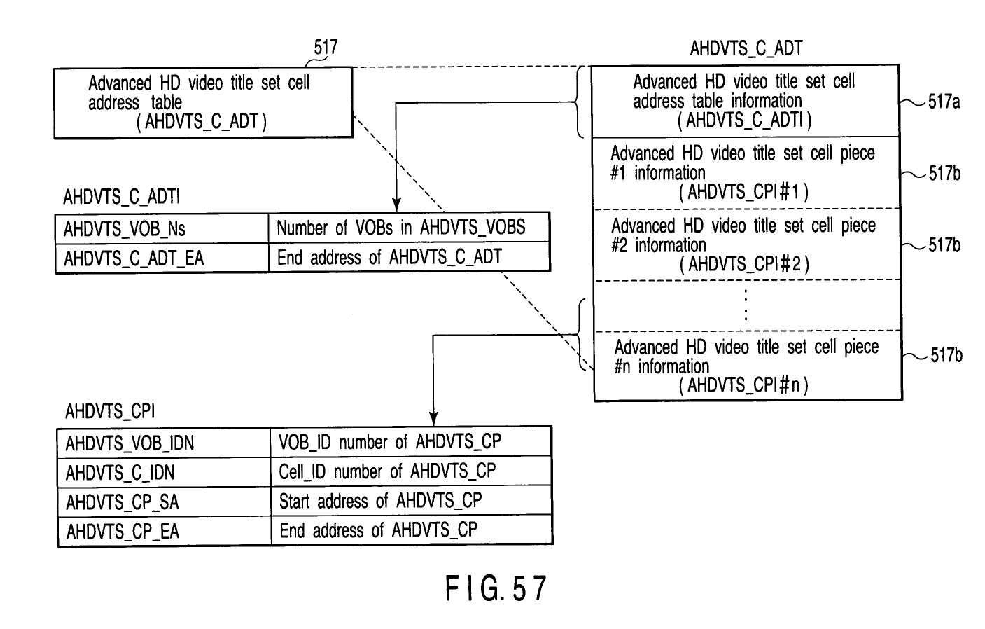

FIG. 57 shows an example of the data structure in advanced HD video title set cell address table (AHDVTS_C_ADT) 517 shown in FIG. 52. Advanced HD video title set cell address table (AHDVTS_C_ADT) 517 includes various kinds of information: advanced HD video title set cell address table information (AHDVTS_C_ADTI) 517a having the number (AHDVTS_VOB_Ns) of VOB data in an AHDVTS_VOBS and the end address (AHDVTS_C_ADT_EA) of the AHDVTS_C_ADT; and a plurality of pieces of advanced HD video title set cell piece information (AHDVTS_CPI) 517b each including a VOB_ID number (AHDVTS_VOB_IDN) of an AHDVTS_CP, a Cell_ID number (AHDVTS_C_IDN) of the AHDVTS_CP, the start address (AHDVTS_CP_SA) of the AHDVTS_CP, and the end address (AHDVTS_CP_EA) of the AHDVTS_CP.

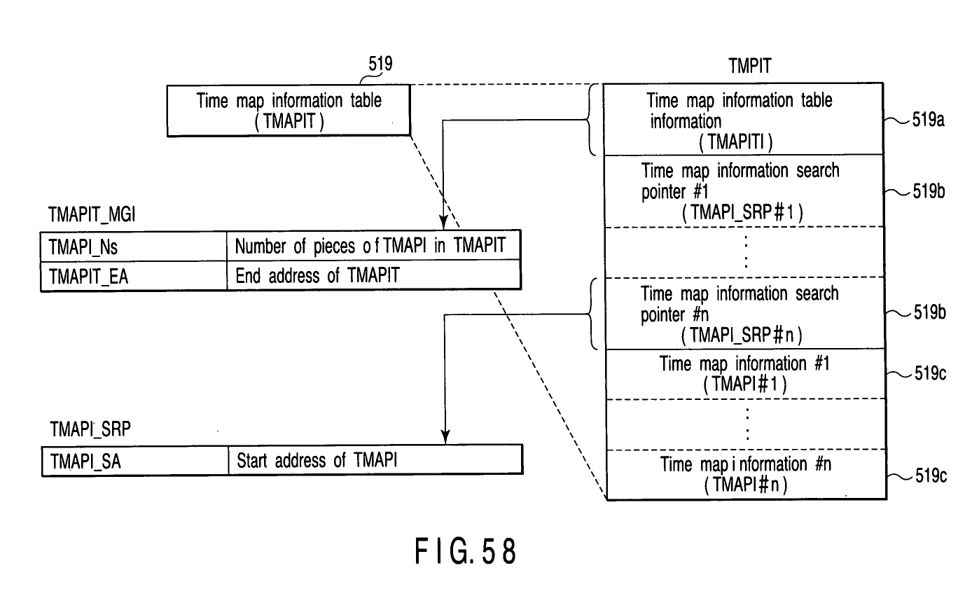

FIG. 58 shows an example of the data structure in time map information table (TMAPIT.) 519 shown in FIG. 52. Time map information table (TMAPIT) 519 includes time map information table information (TMAPITI) 519a, time map information search pointers (TMAPI_SRP) 519b, and a plurality of pieces of time information (TMAPI) 519c. Time map information table information (TMAPITI) 519a includes the number of pieces of time map information (TMAPI) 519c included in this time map information table (TMAPIT) 519, and the end address information of this time map information table (TMAPIT) 519. Time map information search pointers (TMAPI_SRP) 519b exist as many as the number of pieces of time map information (TMAPI) 519c, and each pointer records the start address where corresponding time map information (TMAPI) 519c is recorded.

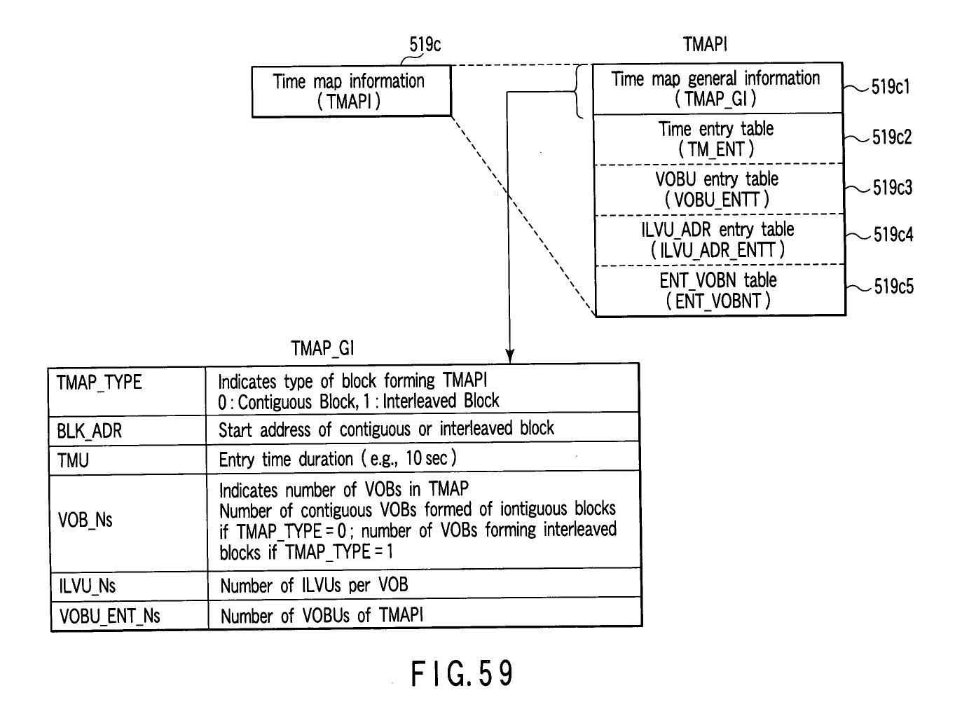

FIG. 59 shows an example of the data structure of time map information (TMAPI) 519c shown in FIG. 58. Time map information (TMAPI) 519c includes time map general information (TMAP_GI) 519c1, time entry table (TM_ENT) 519c2, VOBU entry table (VOBU_ENTT) 519c3, ILVU_ADR entry table (ILVU_ADR_ENTT) 519c4, and ENT_VOBN table (ENT_VOBNT) 519c5.

Time map general information (TMAP_GI) 519c1 includes TMAP_TYPE indicating the type of blocks which form this time map information (TMAPI) 519c, BLK_ADR indicating the start address of a contiguous or interleaved block, TMU indicating the time duration of a time entry, VOB_Ns indicating the number of VOB data to be referred to by this time map information (TMAPI) 519c, ILVU_Ns indicating the number of ILVU data per VOB to be referred to by this time map information (TMAPI) 519c, and VOBU_ENT_Ns indicating the number of all VOBU data to be referred to by this time map information (TMAPI) 519c.

In the TMAP_GI in FIG. 59, when blocks that form time map information TMAPI include a contiguous block, “0b” is recorded in TMAP_TYPE; when blocks that forms time map information TMAPI include an interleaved block, “1b” is recorded in TMAP_TYPE. The time duration of the time entry is constant in the time map information, and can be set to be a value, e.g., TMU=10 sec.

Furthermore, VOB_Ns indicating the number of VOB data to be referred to by the TMAPI indicates the number of VOB data formed by contiguous blocks when blocks that form the TMAPI are contiguous blocks (i.e., TMAP_TYPE=0b). On the other hand, VOB_Ns indicating the number of VOB data to be referred to by the TMAPI indicates the number of VOB data that form interleaved blocks when blocks that form the TMAPI are interleaved blocks (i.e., TMAP_TYPE=1b).

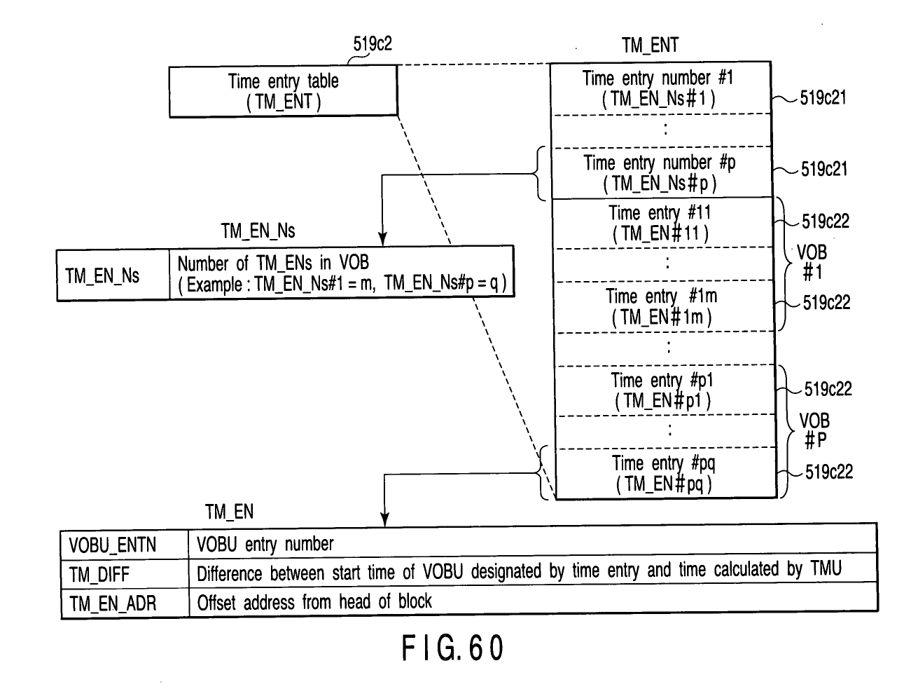

FIG. 60 shows an example of the data structure of time entry table (TM_ENT) 519c2 shown in FIG. 59. Time entry table (TM_ENT) 519c2 includes one or more time entry numbers (TM_EM_Ns) 519c21, and one or more time entries (TM_EN) 519c22. Note that the time entries are allocated for each VOB. More specifically, in the example of FIG. 60, the time entries are allocated in ascending order of VOB#p like time entry (TM_EN) 519c22 group of VOB#1, time entry (TM_EN) 519c22 group of VOB#2, . . . , time entry (TM_EN) 519c22 group of VOB#p.

Each time entry number (TM_EM_Ns) 519c21 records TM_EN_Ns indicating the number of time entries (TM_EN) 519c22. Each time entry 519c22 includes VOBU_ENTN indicating the number of VOBU entry (VOBU_ENT) 519c31 designated by the time entry, TM_DIFF indicating the time difference between the time of the time entry calculated based on TMU and the start time of the VOBU designated by the time entry, and TM_EN_ADR indicating an offset address of a Block (a VOB period with valid TMAPI) from the head position.

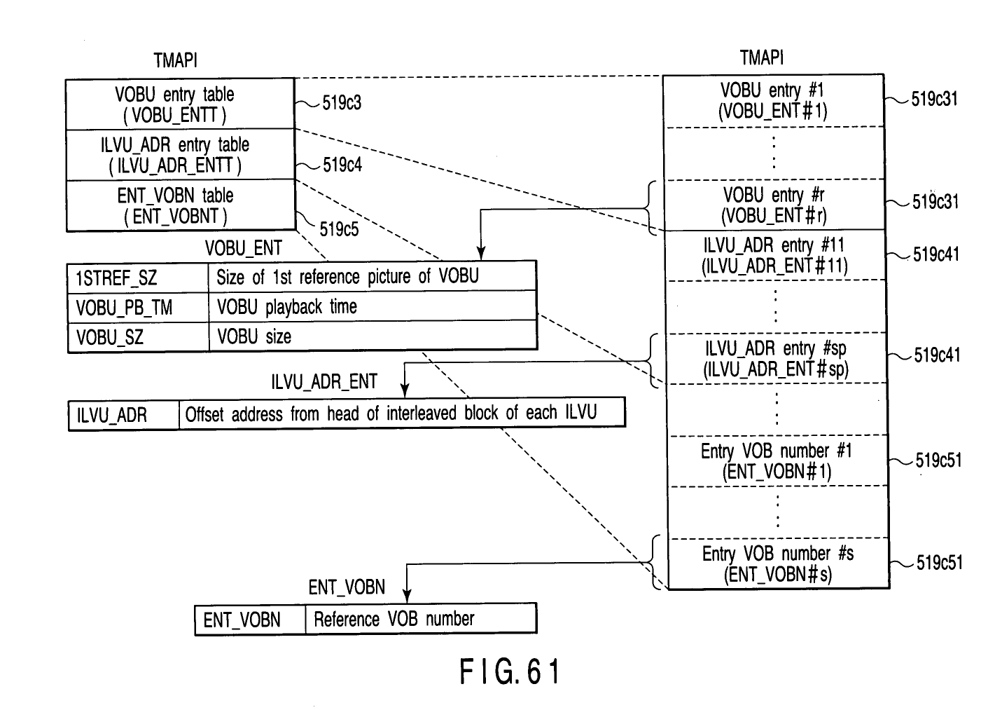

FIG. 61 shows an example of the data structures of VOBU entry table (VOBU_ENTT) 519c3, ILVU_ADR entry table (ILVU_ADR_ENTT) 519c4, and ENT_VOBN table (ENT_VOBNT) 519c5 shown in FIG. 59. As shown in FIG. 61, VOBU entry table (VOBU_ENTT) 519c3 includes VOBU entries (VOBU_ENT) 519c31. Each VOBU entry (VOBU_ENT) 519c31 includes 1STREF_SZ indicating the size (which can be indicated by the number of packs) of 1st Reference Picture data (i.e., first I-picture or equivalent data) included in a VOBU, VOBU_PB_TM indicating the VOBU playback time, and VOBU_SZ indicating the size (which can be indicated by the number of packs) of the VOBU.

ILVU_ADR entry table (ILVU_ADR_ENTT) 519c4 includes ILVU_ADR entries (ILVU_ADR_ENT) 519c41. Each ILVU_ADR entry (ILVU_ADR_ENT) 519c41 includes ILVU_ADR indicating an offset address from the head of an Interleaved block for each ILVU address.

ENT_VOBN table (ENT_VOBNT) 519c5 which indicates a list of VOB data that refer to time map information (TMAPI) 519c includes entry VOB numbers (ENT_VOBN) 519c51. Each entry VOB number (ENT_VOBN) 519c51 includes ENT_VOBN indicating a VOB number to be referred to. Note that ENT_VOBN is described in the order of VOB data that refer to time map information (TMAPI) 519c, and correspondence between the time map and VOB is indicated using the VOB number.

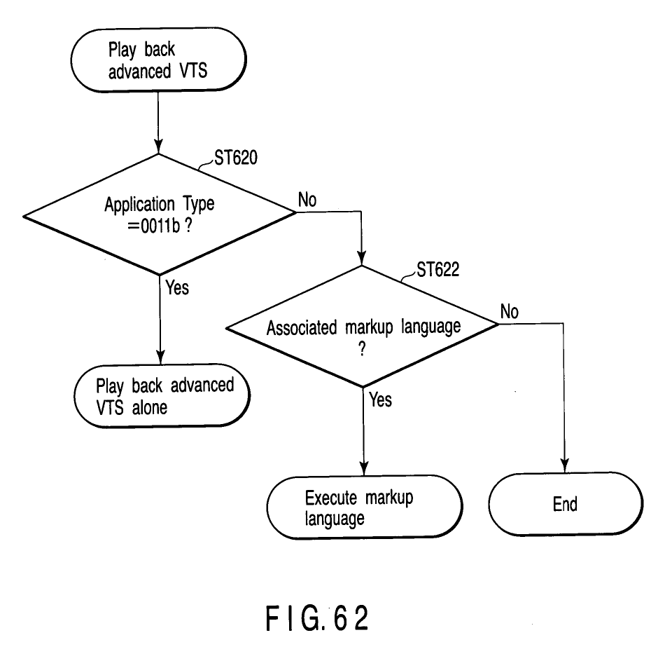

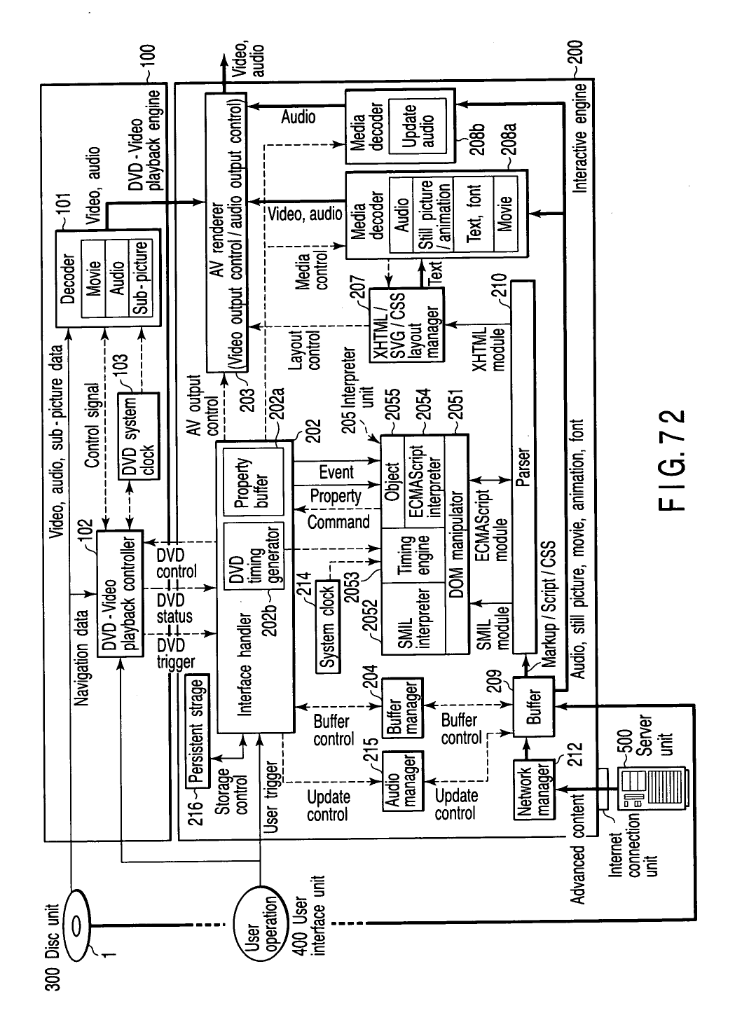

FIG. 62 is a flowchart for explaining an example of the playback sequence of an advanced VTS (AHDVTS in FIGS. 51, 74, 79, and the like) according to the content of information (Application Type) included in management information (e.g., AHDVTS_CAT in FIG. 53). When playback of an advanced VTS is designated, the playback apparatus (FIG. 72, etc.) checks the value of AHDVTS_CAT stored in AHDVTSI_MAT 510. If AHDVTS_CAT=0011b (YES in step ST620), since this advanced VTS to be played back is a video object without any advanced content, i.e., playback is controlled based on only data in advanced HD video title set recording area 50 (AHDVTS) in place of the markup/script language, playback can be done based on data of this AHDVTS (a sole playback process of the advanced VTS).

If the value of AHDVTS_CAT is other than “0011b” (e.g., “0010b”) (NO in step ST620), since this advanced VTS is a video object with advanced content, playback must be done on the basis of the markup/script language required to control this video object. If not, playback of this video object becomes different from that the content producer intended. Hence, the playback apparatus (FIG. 72, etc.) searches for a markup/script language file associated with this video object. If such file is found (YES in step ST622), the video object is played back on the basis of the description of the markup/script language of that file (an execution process of the markup/script language). If no markup/script language file associated with the video object is found (NO in step ST622), since data required to control playback are not sufficiently prepared, the process ends without playback.

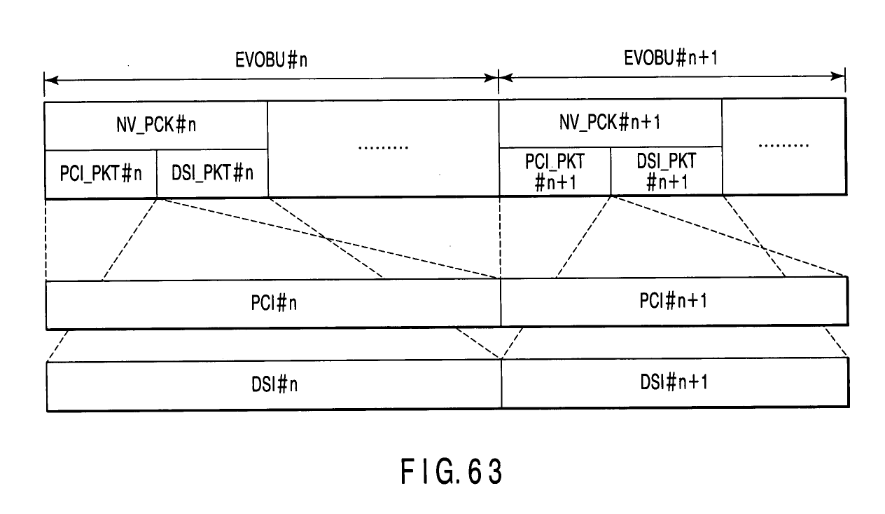

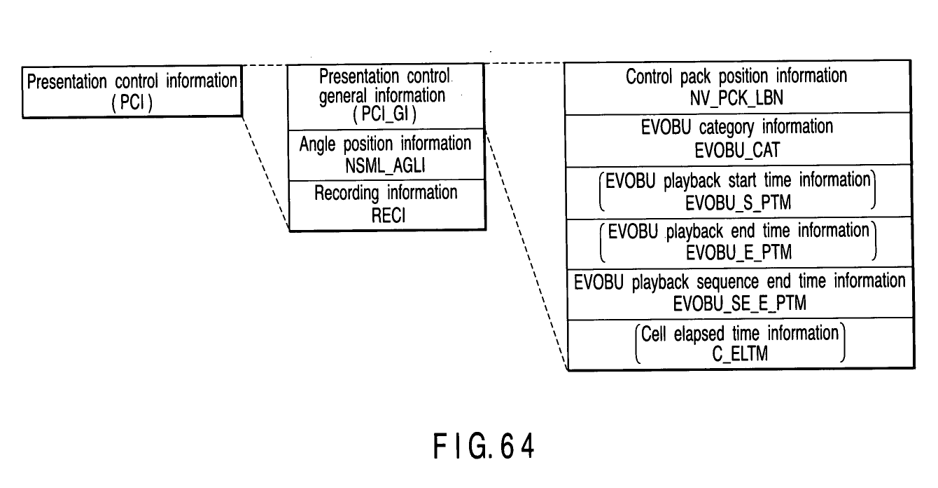

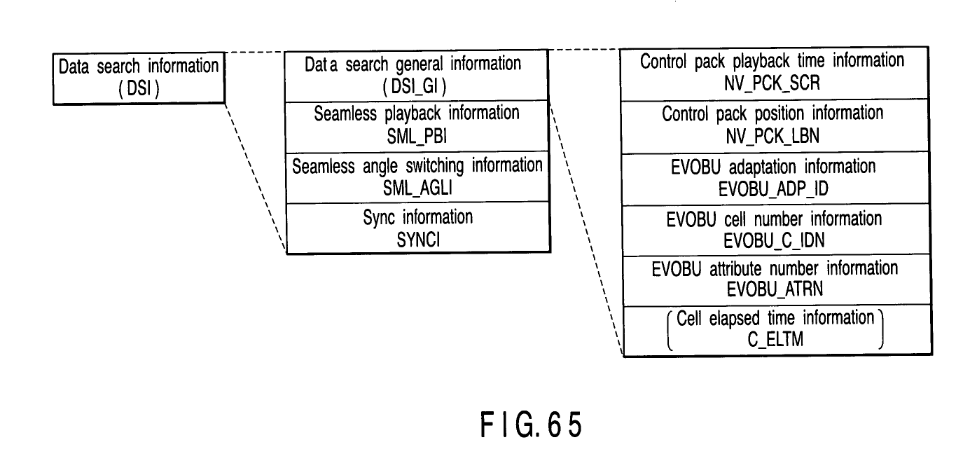

FIG. 63 shows the configuration of a navigation pack (NV_PCK) allocated at the head of each EVOBU in an enhanced video object (EVOB) which is to be referred to by an advanced VTS according to the embodiment of the present invention. The navigation pack includes a presentation information packet (PCI_PKT) and data search information packet (DSI_PKT), and respective packets store information shown in FIGS. 64 and 65.

FIG. 64 shows an example of the content of the presentation control information (PCI) as playback control information. The presentation control information includes playback control general information (PCI_GI), non-seamless angle position information (NSML_AGLI) which includes the start position information of each angle and does not require any seamless playback upon angle switching, and recording information (RECI). Note that the recording information (RECI) can record specific codes such as a country code, copyright holder code, recording date, recording number, and the like in association with the content of recorded video, audio, and sub-picture data.

The playback control general information (PCI_GI) includes control pack position information (NV_PCK_LBN) indicated by a logical block number (LBN) from the head of a VOBS, EVOBU category information (EVOBU_CAT) including analog copy control information, information (EVOBU_S_PTM) indicating the playback start time and information (EVOBU_E_PTM) indicating the playback end time of an EVOBU, EVOBU playback sequence end time information (EVOBU_SE_E_PTM) indicating information of the playback end time when video playback ends in response to a sequence end code in the EVOBU, and cell elapsed time information (C_ELTM) indicating an elapsed time in a cell of the EVOBU.

Note that “EVOBU playback start time information (EVOBU_S_PTM)”, “EVOBU playback end time information (EVOBU_E_PTM)”, and “cell elapsed time information (C_ELTM)” in parentheses in the playback control general information (PCI_GI) are option information, and can be omitted depending on embodiments.

FIG. 65 shows the content of the data search information (DSI) as data search information. The data search information includes data search general information (DSI_GI), seamless playback information (SML_PBI) as information required to make seamless playback without interrupting interleaved units (ILVU) which are interleaved, seamless angle position information (SML_AGLI) that describes a jump address of an interleaved unit of each angle as information required to switch angles without interrupting playback, and sync information (SYNCI) indicating position information of audio and sub-picture packs to be played back synchronously with video data.

The data search general information (DSI_GI) includes control pack playback time information (NV_PCK_SCR) indicated by system clock reference (SCR)-based time information, control pack position information (NV_PCK_LBN) indicated by a logical block number (LBN) from the head of a VOBS, EVOBU adaptation information (EVOBU_ADP_ID) as information indicating if a disc to which the standard is applied is a read-only disc (DVD-ROM) or a writable disc (DVD-R or the like), EVOBU_EVOB number information (EVOBU_EVOB_IDN: not shown) indicating an ID number of an EVOB that includes the DSI of interest, EVOBU cell number information (EVOBU_C_IDN) indicating an ID number of a cell that includes the DSI of interest, EVOBU attribute number information (EVOBU_ATRN) indicating the number of attribute information of an EVOB to which the EVOBU of interest belongs, and cell elapsed time information (C_ELTM) indicating an elapsed time in a cell of the EVOBU.

Note that “cell elapsed time information (C_ELTM)” in parentheses in the data search general information (DSI_GI) is option information, and can be omitted depending on embodiments.

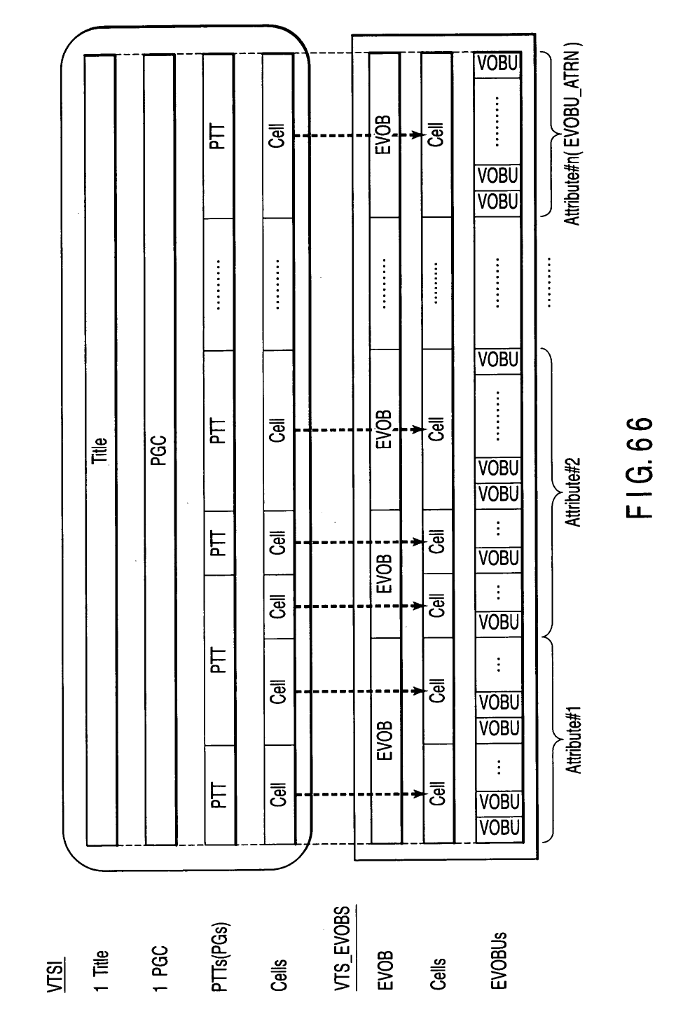

FIG. 66 is a view for explaining an example of the configuration of an advanced VTS (AHDVTS). Since the advanced VTS is basically controlled by a markup language, it requires a simple structure that allows easy control by the markup language. FIG. 66 shows an example of such structure. The advanced VTS includes only one VTS. This VTS includes only one Title. This Title includes only one PGC, which includes one or more PTT data and one or more Cells. Video object VTS_EVOBS is referred to by Cells in one-to-one correspondence.

Note that no navigation commands that can be recorded in VTSI and NV_PCK are available in the advanced VTS. The content production process which is complicated due to coexistence of control based on the markup language and that based on navigation commands in the advanced VTS, and the load on the manufacture of the playback apparatus can be avoided.

Furthermore, the standard VTS accesses a video object using VOBU search information included in NV_PCK. The advanced VTS does not use any VOBU search information in NV_PCK (which need not exist), and newly adds time map information. Upon accessing a video object in accordance with an instruction of the markup language, precise access can be done from an arbitrary location using the time map information.

Note that an attribute number “#n” which identifies an attribute (Attribute #n) assigned to a plurality of EVOBU data corresponding to each EVOB in FIG. 66 can be designated by the EVOBU attribute number information (EVOBU_ATRN) shown in FIG. 65.

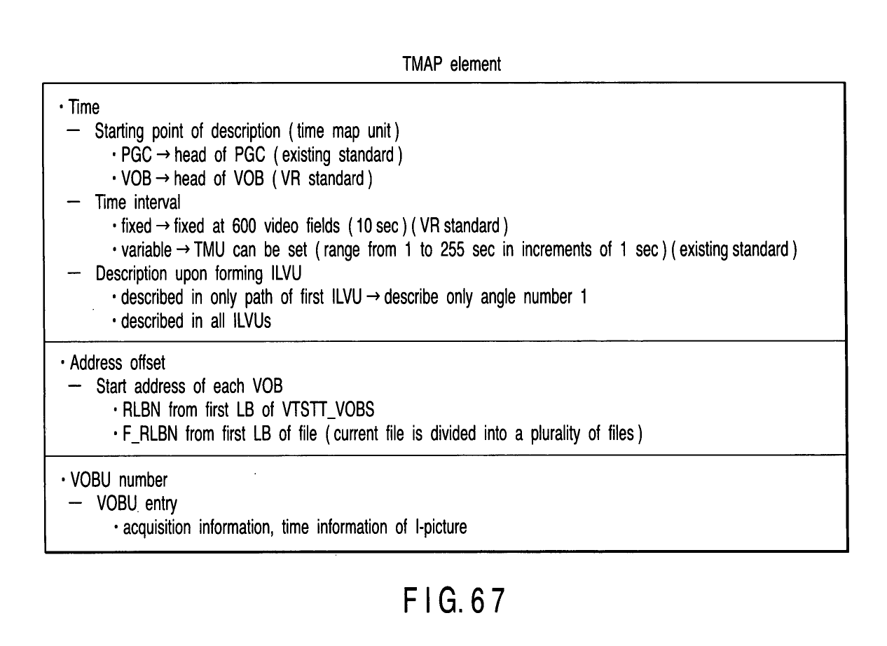

FIG. 67 shows time map elements according to the embodiment of the present invention. That is, as a time element of a time map, a starting point of a description (time map unit) is available. The head of a PGC can be defined as a starting point for the PGC, and the head of a VOB can be defined as a starting point for the VOB. A time map time interval may be fixed to 600 video fields (corresponding to 10 sec) in NTSC, or the time map time interval can be set in the time unit (e.g., the range of 1 to 255 sec in increments of 1 sec). Furthermore, upon forming ILVU data, a time map may be described in only the path of the first ILVU (e.g., only the path of angle number 1 in a multi-angle block) or time maps may be described in all ILVU data.

As for an offset address of a time map, the start address of each VOB can be described. More specifically, the offset address can be described using a relative logical block number from the first logical block of a VTSTT_VOBS, or the offset address can be described using a relative logical block number from the first logical block number of the file of interest (In this case, the file at the current timing may be divided into a plurality of files as needed according to the set time maps). Furthermore, a VOBU number quoted by a time map can be associated with a VOBU entry, which can be used as acquisition information of corresponding I-picture data and/or time information of this I-picture data.

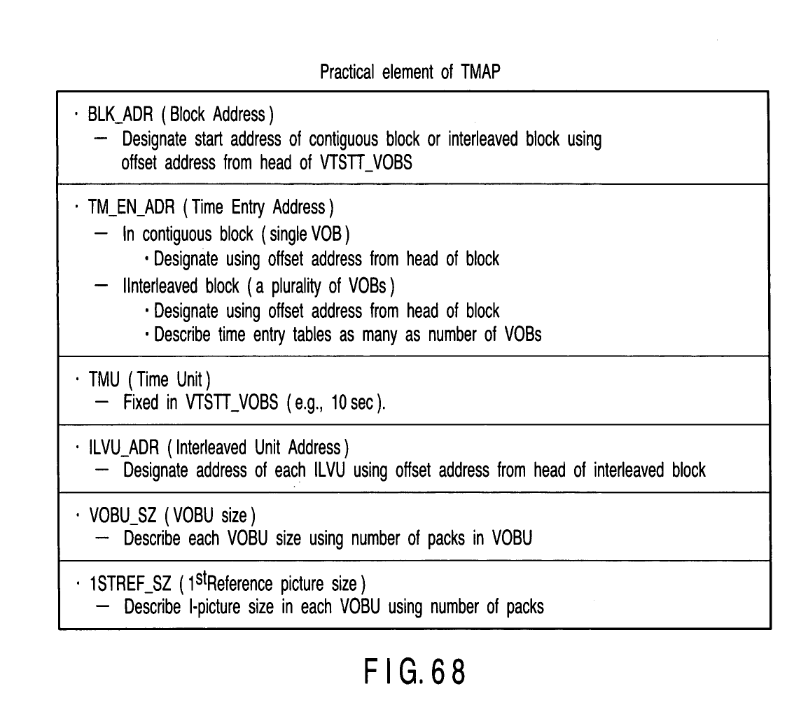

FIG. 68 shows an example of practical elements of the time map according to the embodiment of the present invention. A block address (BLK_ADR) designates the start address of a contiguous or interleaved block using an offset address from the head of a VTSTT_VOBS. A time entry address (TM_EN_ADR) of a contiguous block (single VOB) can be designated using an offset address from the head of a block. Also, a time entry address of an interleaved block (a plurality of VOB data) can be designated using an offset address from the head of a block (by the same method as in a single VOB) or time entry tables can be described as many as the number of VOB data. A time unit (TMU) is fixed to a constant value (e.g., 10 sec) in a single VTSTT_VOBS.

An interleaved unit address (ILVU_ADR) can designate the address of each ILVU using an offset address from the head of an Interleaved block. Furthermore, a VOBU size (VOBU_SZ) can describe the size of each VOBU using the number of packs in that VOBU. A first reference picture size (1STREF_SZ) can describe the size of I-picture data of each VOBU using the number of packs.

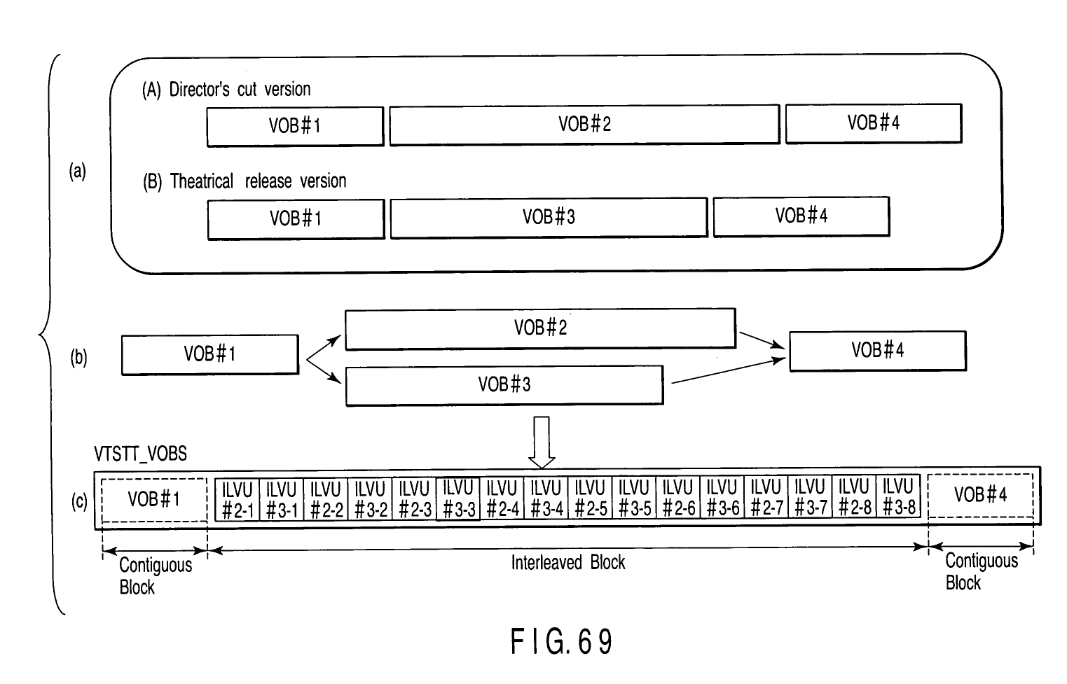

FIG. 69 shows a case having different playback paths so as to explain the time map according to the embodiment of the present invention. As shown in FIG. 69, disc 1 records two different playback paths (A) and (B). (A) is, for example, the director's cut version of a movie, and (B) is, for example, the theatrical release version. In this example, (A) and (B) include the same introductory chapter (VOB#1) and ending chapter (VOB#4), but have different main chapters (VOB#2 or VOB#3). At this time, in order to improve the recording efficiency on the disc in practice, the introductory chapter (VOB#1) and ending chapter (VOB#4) are used as a common playback path, and objects (VOB#2 and VOB#3) of different playback paths are independently recorded. However, if these objects are recorded intact, one of (A) and (B) cannot be read out in time upon playback depending on the manner of recording, thus interrupting its playback. In order to solve this problem, as shown in the lowermost column in FIG. 69, respective VOB data (VOB#2 and VOB#3) are broken up into smaller units, and these units are recorded alternately (i.e., so-called interleaved recording), thus implementing seamless playback. A unit of this interleaved recording is an interleaved unit (ILVU).

Note that an interval in which playback data of VOB#1 or VOB#4 are contiguously allocated is defined as a contiguous block, and an interval in which playback data of VOB#2 and VOB#3 are alternately allocated is defined as an interleaved block.

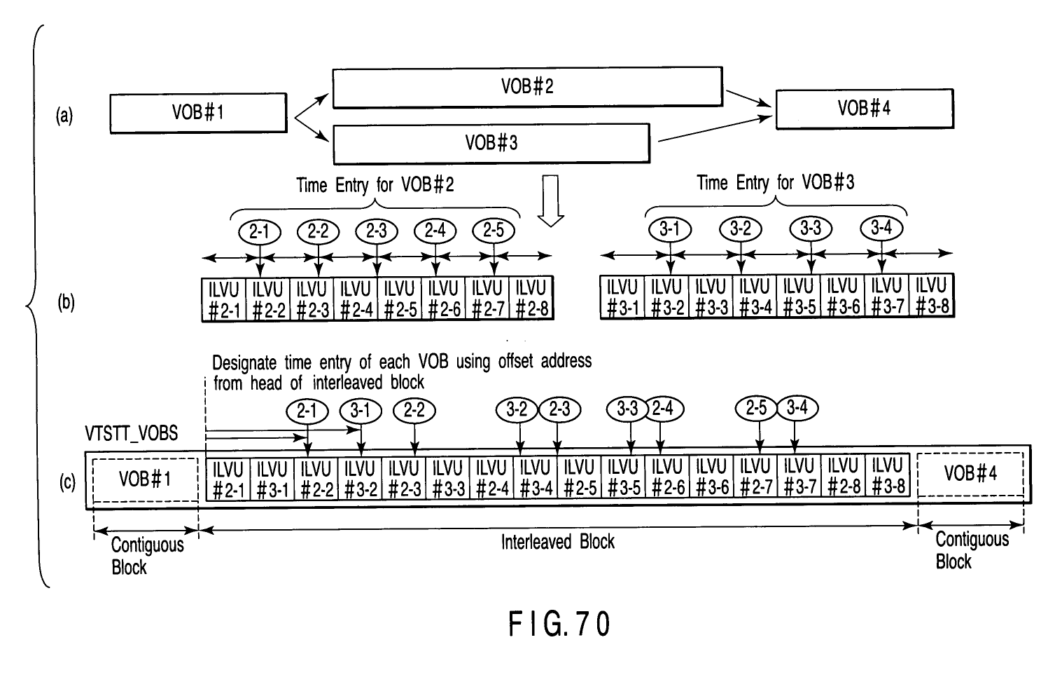

FIG. 70 is a view for explaining the time map of the ILVU interval. In order to form the time map of the interleaved-recorded ILVU interval (the interval of VOB#2 and VOB#3 in FIG. 70(a)) described using FIG. 69, time entries (2-1, 2-2, . . . of VOB#2, and 3-1, 3-2, . . . of VOB#3) are assigned to VOB#2 and VOB#3 as playback paths at predetermined time intervals (e.g., 10-sec time intervals) (FIG. 70(b)), and hold designated addresses. After interleaved allocation, the addresses of the respective time entries are re-designated as offset addresses from the head of the interleaved block (FIG. 70(c)).

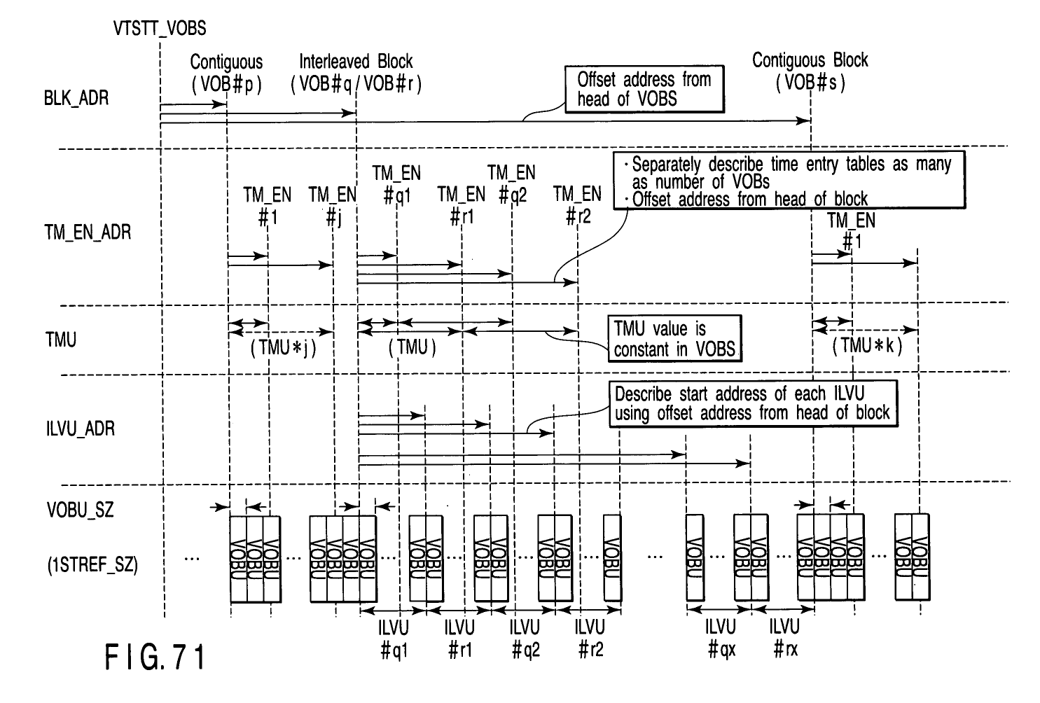

FIG. 71 shows an example that generalizes the time map including the interleaved block interval that has been explained using FIG. 70. As shown in FIG. 71, a VTSTT_VOBS of a playback object includes a contiguous block of VOB#p, an interleaved block formed by VOB#q and VOB#r, and a contiguous block of VOB#s (in the example of FIGS. 70 to 72, VOB#p=VOB#1, VOB#q=VOB#2, VOB#r=VOB#3, and VOB#s=VOB#4).

This time map is configured for each block. For this purpose, the start addresses of respective blocks are designated as offset addresses (BLK_ADR) from the head of the VTSTT_VOBS. With this configuration, a time map of each block describes position information to have the head of that block as a starting point, and information that forms the time map is completed in the block.

The address of each time entry (TM_EN#) designated by a predetermined time interval (TMU) (e.g., 10 sec) is indicated by an offset address (TM_EN_ADR) from the head of each block, and is stored as a time entry table (not shown). At this time, if the block of interest is an interleaved block, time entries (TM_EN#q1, TM_EN#q2, . . . , and TM_EN#r1, TM_EN#r2, . . . in this case) as many as the number of VOB data that form the block are separately stored in respective time entry tables (not shown).

When the block that forms the time map is an interleaved block, the start addresses (ILVU_ADR) of interleaved units alternately allocated in the interleaved block are designated by offset addresses from the head of the block. With this information, the start position of each ILVU can be easily detected, and ILVU data to be contiguously played back can be seamlessly switched and played back (each ILVU size (ILVU_SZ) can be described in, e.g., TMAP_GI in FIG. 59 (not shown)).

As information of a VOBU that stores actual playback information, each time map includes the number of all VOBU data (VOBU_Ns; not shown) stored in each block, the size (VOBU_SZ) and playback time (VOBU_PB_TM; not shown) of each VOBU, the end address information (1STREF_SZ) of first reference picture (first I-picture) data, and the like. With this information, target data is accessed. The time map may have the end address information (2NDREF_SZ, 3RDREF_SZ; neither are shown) of each of second reference picture (I- or P-picture other than the first reference picture) data and third reference picture (I- or P-picture other than the first and second reference pictures) data in addition to the first reference picture.

FIG. 72 is a block diagram for explaining an example of the internal structure of a playback apparatus (advanced VTS compatible DVD-Video player) according to another embodiment of the present invention. This DVD-Video player plays back and processes the recording content from information storage medium 1 shown in FIGS. 1, 50, 51, 73, 74, 79, and the like, and downloads and processes advanced content from a communication line (e.g., the Internet or the like).

The DVD-Video player shown in FIG. 72 comprises DVD-Video playback engine (DVD_ENG) 100, interactive engine (INT_ENG) 200, disc unit (disc drive) 300, user interface unit 400, and the like. DVD-Video playback engine 100 plays back and processes an MPEG2 program stream (DVD-Video content) recorded on information storage medium 1. Interactive engine (INT_ENG) 200 plays back and processes advanced content. Disc unit 300 reads out the DVD-Video content and/or advanced content recorded on information storage medium 1. User interface unit 400 supplies an input by the user of the player (user operation) to the DVD-Video player as a user trigger.

Basically, when a standard VTS is to be played back (standard VTS playback state), the user input is supplied to the DVD-Video playback engine; when an advanced VTS is to be played back (advanced VTS playback state), the user input is supplied to the interactive engine. Even when the advanced VTS is to be played back, a predetermined user input can be directly supplied to the DVD-Video playback engine.

Interactive engine (INT_ENG) 200 comprises an Internet connection unit. This Internet connection unit serves as communication means that connects server unit 500 or the like via a communication line (Internet or the like). Furthermore, interactive engine (INT_ENG) 200 is configured to include buffer unit 209, parser 210, XHTML/SVG/CSS layout manager 207, ECMAscript interpreter/DOM manipulator/SMIL interpreter/timing engine/object (interpreter unit) 205, interface handler 202, media decoders 208a/208b, AV renderer 203, buffer manager 204, audio manager 215, network manager 212, system block 214, persistent storage 216, and the like.

In the block arrangement of FIG. 72, DVD-Video playback controller 102, DVD-Video decoder 101, DVD system block 103, interface handler 202, parser 210, interpreter unit 205, XHTML/SVG/CSS layout manager 207, AV renderer 203, media decoders 208a/208b, buffer manager 204, audio manager 215, network manager 212, system clock 214, and the like can be implemented by a microcomputer (and/or hardware logic) which serves as the functions of respective blocks by an installed program (firmware; not shown). A work area used upon executing this firmware can be assured using a semiconductor memory (and a hard disc as needed; not shown) in the block arrangement.

DVD-Video playback engine (DVD_ENG) 100 is a device for playing back DVD-Video content recorded on information storage medium 1 shown in FIG. 1 and the like, and is configured to include DVD-Video decoder 101 for decoding the DVD-Video content loaded from disc unit 300, DVD-Video playback controller 102 for making playback control of the DVD-Video content, DVD system clock 103 for determining the decode and output timings in the DVD-Video decoder, and the like.

DVD-Video decoder 101 has a function of decoding main picture data, audio data, and sub-picture data read out from information storage medium 1 shown in FIG. 1 and the like, and outputting the decoded video data (obtained by mixing the main picture data and sub-picture data, etc.) and audio data. That is, the player shown in FIG. 72 can play back video data, audio data, and the like with the MPEG2 program stream structure in the same manner as a normal DVD-Video player.

In addition, DVD-Video playback controller 102 can control playback of the DVD-Video content in accordance with a “DVD control signal” output from interactive engine (INT_ENG) 200. More specifically, when a given event (e.g., menu call or title jump) has occurred in DVD-Video playback engine 100 upon DVD-Video playback, DVD-Video playback controller 102 can output a “DVD trigger” signal indicating the playback condition of the DVD-Video content to interactive engine (INT_ENG) 200. In this case (simultaneously with output of the DVD trigger signal or at an appropriate timing before and after the output), DVD-Video playback controller 102 can output a “DVD status” signal indicating property information (e.g., an audio language, sub-picture subtitle language, playback operation, playback position, various kinds of time information, disc content, and the like set in the player) of the DVD-Video player to interactive engine (INT_ENG) 200.

Interface handler 202 receives a “user trigger” corresponding to a user operation (menu call, title jump, play start, play stop, play pause, or the like) from user interface unit 400. Interface handler 202 transmits the received user trigger to interpreter unit 205 as a corresponding “event”. For example, the markup language describes the following instructions for this “event”.

1→issue a “command” corresponding to a user operation. That is, the same command as the user operation is transmitted to the DVD-Video layback engine as a DVD control signal.

2→issue a “command” different from a user operation. That is, the user action is substituted by another operation in accordance with an instruction of the markup language.

3→ignore user trigger. That is, a user event is inhibited since, for example, the user may designate a DVD-Video playback process which is not designed by the content provider.

Note that the content of the user trigger signal transmitted to interface handler 202 may be transmitted to AV renderer 203 as an “AV output control” signal. As a result, for example, when the user has changed the content or window size or has shifted its display position using a cursor key of a remote controller (not shown), a user trigger signal based on this operation is output to AV renderer 203 as a corresponding AV output control signal. In addition, when a user trigger signal which indicates switching between a video/audio output from DVD-Video playback engine 100 and that from interactive engine 200 is sent to AV renderer 203, the video/audio output can be switched in response to the user operation.

Interface handler 202 exchanges a “DVD status” signal, “DVD trigger” signal, and/or “DVD control” signal with DVD-Video playback controller 102, or exchanges a “user trigger” signal with user interface unit 400. Furthermore, interface handler 202 exchanges “event”, “property”, “command”, and “control” signals with interpreter unit 205.

That is, interface handler 202 can do the following.

1. Interface handler 202 transmits a “DVD trigger” signal which indicates the operation of DVD-Video playback engine 100 from DVD-Video playback engine 100, or a “user trigger” which indicates the user operation from user interface unit 400 to interpreter unit 205 as an “event”.

2. Interface handler 202 transmits a “DVD status” signal which indicates the playback status of DVD-Video playback engine 100 from DVD-Video playback engine 100 to interpreter unit 205 as a “property”. At this time, DVD status information is saved in property buffer 202a of interface handler 202 as needed.

3. Interface handler 202 outputs a “DVD control” signal to control playback of DVD-Video playback engine 100 to DVD-Video playback engine 100, an “AV output control” signal to switch video and audio data to AV renderer 203, a “buffer control” signal to load/erase the content of buffer 209 to buffer manager 204, an “update control” signal to download update audio data to audio manager 215, and a “media control” signal to instruct decoding of various media to media decoders 208a/208b, in accordance with the content of a “command” signal from Interpreter unit 205.

4. Interface handler 202 measures information of DVD system clock 103 in DVD-Video playback engine 100 using its DVD timing generator 202b, and transmits the measurement result to media decoders 208a/208b as a “DVD timing” signal. That is, media decoders 208a/208b can decode various media in synchronism with system clock 103 of DVD-Video playback engine 100.

As described above, interface handler 202 has a function of parsing and interpreting advanced content, and then exchanging control signals and the like between DVD-Video playback engine 100 and interactive engine 200.

Interface handler 202 is configured to exchange a first signal and also a second signal on the basis of the content which are parsed by parser 210 and are interpreted by interpreter unit 205, or a user trigger from an input device (e.g., a remote controller; not shown). In other words, interface handler 202 controls the output states of video and audio signals by AV renderer 203 on the basis of at least one of the first signal exchanged with DVD-Video playback controller 102, and the second signal exchanged with interpreter unit 205.

Note that the first signal pertains to the playback status of information storage medium 1, and corresponds to the “DVD control” signal, “DVD trigger” signal, “DVD status” signal, and the like. The second signal pertains to the content of the advanced content, and corresponds to the “event” signal, “command” signal, “property” signal, “control” signal, and the like.

Interface handler 202 is configured to execute processes corresponding to user triggers in accordance with the markup language. AV renderer 203 is configured to mix video/audio data generated by media decoders 208a/208b with that played back by DVD-Video playback engine 100 on the basis of the execution results of the processes corresponding to user triggers, and to output mixed data. Alternatively, AV renderer 203 is configured to select one of video/audio data generated by media decoders 208a/208b and that played back by DVD-Video playback engine 100 on the basis of the execution result of the “command” in interface handler 202, and to output the selected video/audio data.

Generally speaking, parser 210 parses the markup language indicating playback control information, which is included in advanced content acquired from information storage medium 1 or advanced content downloaded from the Internet or the like. The markup language is configured by a combination of markup languages such as HTML/XHTML, SMIL, and the like, script languages such as ECMAscript, Javascript, and the like, and stylesheets such as CSS and the like, as described above. Parser 210 has a function of transmitting an ECMAscript module to an ECMAscript interpreter, a SMIL module to a SMIL interpreter of interpreter unit 205, and an XHTML module to XHTML/SVG/CSS layout manager 207 in accordance with the parsing result.

The ECMAscript interpreter interprets the aforementioned ECMAscript module and follows its instructions. That is, the ECMAscript interpreter has a function of issuing a “command” signal used to control respective functions in interactive engine 200 to interface handler 202 in correspondence with an “event” signal sent from interface handler 202 or a “property” signal read from property buffer 202a of interface handler 202. At this time, the ECMAscript interpreter issues a “command” signal to DVD-Video playback engine 100 or a “media control” signal to media decoders 208a/208b at the timings designated by the markup language in accordance with the time measured by system clock 214. In this manner, the control operation of DVD-Video playback engine 100 and various media control operations (decode control of audio, still picture/animation, text/font, and movies, etc.) can be achieved.

The SMIL timing engine interprets the aforementioned SMIL module and follows its instructions. That is, the SMIL timing engine has a function of issuing a “control” signal to interface handler 202 or media decoders 208a/208b in correspondence with an “event” signal sent from interface handler 202 or a “property” signal read from property buffer 202a of interface handler 202 in accordance with system clock 214. With this function, control of the DVD-Video playback engine 100 and decoding of various media (audio, still picture/animation, text/font, movie) can be achieved at desired timings. That is, the SMIL timing engine can operate based on system clock 214 in accordance with the description of the markup language, or can operate on the basis of DVD system clock 103 from DVD timing generator 202b.

XHTML/SVG/CSS layout manager 207 interprets the aforementioned XHTML module and follows its instructions. That is, XHTML/SVG/CSS layout manager 207 outputs a “layout control” signal to AV renderer 203. The “layout control” signal includes information associated with the size and position of a video screen to be output (this information often includes information associated with a display time such as display start, end, or continuation), and information associated with the level of audio data to be output (this information often includes information associated with an output time such as output start, end, or continuation). Also, text information to be displayed, which is included in the XHTML module, is sent to media decoders 208a/208b, and is decoded and displayed using desired font data.

Practical methods of parsing and interpreting markup and script languages can adopt the same methods as parsing/interpretation in state-of-the-art techniques such as HTML/XHTML, SMIL, and the like or ECMAscript, Javascript, and the like (the hardware used is the microcomputer that has been mentioned at the beginning of the description of FIG. 72). Note that commands and variables described in scripts are different since objects to be controlled are different. The markup language used upon practicing the present invention uses unique commands and variables associated with playback of the DVD-Video content and/or advanced content. For example, a command that switches the playback content of the DVD-Video content or advanced content in response to a given event is unique to the markup or script language used in the embodiment of the present invention.

As another example of commands and variables unique to the markup or script language, those which are used to change the video size from DVD-Video playback engine 100 and/or interactive engine 200 and to change the layout of that video data are available. A change in video size is designated using a size change command and a variable that designates the size after change. A change in video layout is designated by a display position change command and a variable that designates the coordinate position or the like after change. When objects to be displayed overlap on the screen, variables that designate z-ordering and transparency upon overlaying are added.

As still another example of commands and variables unique to the markup or script language, those which are used to change the audio level from DVD-Video playback engine 100 and/or interactive engine 200 or to select an audio language to be used are available. A change in audio level is designated by an audio level change command and a variable that designates an audio level after change. An audio language to be used is selected by an audio language change command and a variable that designates the type of language after change. As yet another example, those which are used to control user triggers from user interface unit 400 are available.

On the basis of the commands/variables of the markup and script languages, as exemplified above, a “layout control” signal is sent from XHTML/SVG/CSS layout manager 207 (some functions are often implemented by the SMIL timing engine 206) to AV renderer 203. The “layout control” signal controls the layout on the screen, size, output timing, and output time of video data to be displayed on, e.g., an external monitor device or the like (not shown), and/or the tone/loudness, output timing, and output time of audio data to be played back from an external loudspeaker (not shown).

Media decoders 208a/208b decode data of the advanced content such as audio data, still picture (including a background picture)/animation, text/font data, movie data, and the like included in the advanced content. That is, each of media decoders 208a/208b includes an audio decoder, still picture/animation decoder, text/font decoder, and movie decoder in correspondence with objects to be decoded. For example, audio data in the advanced content, which is encoded by, e.g., MPEG, AC-3@, or DTS is decoded by the audio decoder and is converted into non-compressed audio data. Still picture data or background picture data, which is encoded by JPEG, GIF, or PNG, is decoded by the still picture decoder, and is converted into non-compressed picture data. Likewise, movie or animation data, which is encoded by MPEG2, MPEG4, Macromedia Flash, or Scalable Vector Graphics (SVG), is decoded by the movie or animation decoder, and is converted into non-compressed movie/animation data. Text data included in the advanced content is decoded by the text/font decoder using font data (e.g., OpenType format) included in the advanced content, and is converted into text picture data which can be superimposed on a movie or still picture. Video/audio data, which includes these decoded audio data, picture data, animation/movie data, and text picture data as needed, is sent from media decoders 208a/208b to AV renderer 203. This advanced content is decoded in accordance with an instruction of a “media control” signal from interface handler 202 and in synchronism with a “DVD timing” signal from interface handler 202 and a “timing” signal from system clock 214.

AV renderer 203 has a function of controlling a video/audio output. More specifically, AV renderer 203 controls, e.g., the video display position and size (often including the display timing and display time together), and the audio level (often including the output timing and output time together) in accordance with the “layout control” signal output from XHTML/SVG/CSS layout manager 207. Also, AV renderer 203 executes pixel conversion of video data in accordance with the type of designated monitor and/or the type of video data to be displayed. The video/audio outputs to be controlled are those from DVD-Video playback engine 100 and media decoders 208a/208b. Furthermore, AV renderer 203 has a function of controlling mixing and switching of the DVD-Video content and advanced content in accordance with an “AV output control” signal output from interface handler 202.

Note that interactive engine 200 in the DVD-Video player in FIG. 72 comprises an interface for sending the markup language in the advanced content read from information storage medium 1 to parser 210 via buffer unit 209, and an interface for sending data (audio data, still picture/animation data, text/font data, movie data, and the like) in the read advanced content to media decoders 208a/208b via buffer unit 209. These interfaces form an interface (first interface) independent from the Internet connection unit in FIG. 72.

Also, the DVD-Video player in FIG. 72 comprises an interface for receiving advanced content from a communication line such as the Internet or the like, and sending the markup language in the received advanced content to parser 210 via buffer unit 209, and an interface for sending data (audio data, still picture/animation data, text/font data, movie data, and the like) in the received advanced content to media decoders 208a/208b via buffer unit 209. These interfaces form the Internet connection unit (second interface) shown in FIG. 72.

Buffer unit 209 includes a buffer that stores the advanced content downloaded from server unit 500, and also stores the advanced content read from information storage medium 1 via disc unit 300. Buffer unit 209 reads the advanced content stored in server unit 500, and downloads them via the Internet connection unit under the control of buffer manager 204 based on the markup language/script language.

Also, buffer unit 209 loads the advanced content recorded on information storage medium 1 under the control of buffer manager 204 based on the markup language/script language. At this time, if disc unit 300 is a device that can access the disc at high speed, disc unit 300 can read out the advanced content from information storage medium 1 while playing back the DVD-Video content, i.e., reading out DVD-Video data from information storage medium 1.

If disc unit 300 is not a device that can make high-speed access, or if the playback operation of the DVD-Video content is to be perfectly guaranteed, playback of the DVD-Video content must not be interrupted. In such case, the advanced content is read out from information storage medium 1 and are stored in the buffer in advance prior to the beginning of playback. In this way, since the advanced content is read out from the buffer simultaneously when the DVD-Video content are read out from information storage medium 1, the load on disc unit 300 can be reduced. Hence, the DVD-Video content and advanced content can be simultaneously played back without interrupting playback of the DVD-Video content.

In this manner, since the advanced content downloaded from server unit 500 is stored in buffer unit 209 in the same manner as those recorded on information storage medium 1, the DVD-Video content and advanced content can be simultaneously read out and played back.

Buffer unit 209 has a limited storage capacity. That is, the data size of the advanced content that can be stored in buffer unit 209 is limited. For this reason, it is possible to erase the advanced content with low necessity and to save those with high necessity under the control of buffer manager 204 (buffer control). Buffer unit 209 can automatically execute such save and erase control.

Furthermore, buffer unit 209 has a function (preload end trigger, load end trigger) of loading content requested by buffer manager 204 from disc unit 300 or server unit 500 into buffer unit 209, and informing buffer manager 204 that the advanced content designated by buffer manager 204 have been loaded into the buffer.

Buffer manager 204 can send the following instructions as “buffer control” to buffer unit 209 in accordance with an instruction of the markup language (even during playback of DVD video content).

→load all or part of a specific file from a server;

→load all or part of a specific file from a disc; and

→erase all or part of a specific file from a buffer.

Furthermore, buffer manager 204 instructs buffer unit 209 to load the advanced content in accordance with loading information, which is described in the markup language (or in a file designated by the markup language). Buffer manager 204 has a function (buffer control) of requesting to inform that specific advanced content described in loading information have been loaded into buffer unit 209.

Upon completion of loading of the specific advanced content into buffer unit 209, buffer unit 209 informs buffer manager 204 of it, and the buffer manager informs interface handler 202 of it (preload end trigger, load end trigger).

Audio manager 215 has a function of issuing an instruction for loading update audio data (audio commentary data) from information storage medium 1 in disc unit 300 or server unit 500 into buffer unit 209 in accordance with an instruction of the markup language (update control).

Network manager 212 controls the operation of the Internet connection unit. That is, network manager 212 switches connection/disconnection of the Internet connection unit when the markup language designates connection or disconnection to or from the network as a “command”. Also, network manager 212 has a function of checking the connection state to the network, and allows the markup language to download the advanced content in accordance with the connection state to the network.

Persistent storage 216 is an area for recording information (information set by the user and the like) associated with information storage medium 1, and comprises a nonvolatile storage medium such as a hard disc, flash memory, or the like. That is, even after the power supply of the DVD player is turned off, this information is held.

As information associated with the information storage medium to be played back, information such as the playback position of the DVD-Video content or advanced content, user information required in user authentication implemented by the advanced content, a game score of a game implemented by the advanced content, and the like are recorded in accordance with an instruction of the markup language (storage control). As a result, when the information storage medium is played back next time, playback can be continued from the previous position. When the advanced content downloaded from the server into the buffer are recorded in this persistent storage 216 upon playing back the information storage medium, the information storage medium can be played back without connecting the network from the next time.

The building components of Interactive engine 200 in FIG. 72 can also be summarized as follows. That is, interactive engine 200 comprises:

Parser 210

Parser 210 parses the content of the markup language.

Interpreter Unit 205, XHTML/SVG/CSS Layout Manager 207

Interpreter unit 205 which comprises the ECMAscript interpreter, SMIL timing engine, and the like, and XHTML/SVG/CSS layout manager 207 respectively interpret the parsed modules.

Interface Handler 202

Interface handler 202 handles control signals from interpreter unit 205, and those from DVD-Video playback controller 102.

Media Decoders 208a/208b

Media decoders 208a/208b generate video/audio data corresponding to audio data, still picture data, text/font data, movie data, and the like included in the advanced content in synchronism with system clock 103 of DVD playback engine 100 or system clock 214 of Interactive engine 200.

AV Renderer 203

AV renderer 203 outputs data obtained by mixing video/audio data generated by media decoders 208a/208b to that played back by DVD-Video playback engine 100 on the basis of the execution result of the “command” in interface handler 202. Or AV renderer 203 selectively outputs one of video/audio data generated by media decoders 208a/208b and that played back by DVD-Video playback engine 100 on the basis of the execution result of the “command” in interface handler 202.

Buffer Unit 209

Buffer unit 209 temporarily stores the advanced content acquired from disc unit 300 or from server unit 500 via the Internet connection unit.

Buffer Manager 204

Buffer manager 204 loads or erases advanced content data to or from buffer unit 209 in accordance with an instruction from interface handler 202 (an instruction of the markup language), or the description of loading information (FIG. 90).

Network Manager

The network manager controls connection or disconnection to or from the network and checks the connection state in accordance with an instruction of the markup language.

Persistent Storage 216

The persistent storage holds information associated with the information storage medium such as the playback position of the content, user information, and the like, and also the advanced content downloaded from server unit 500.

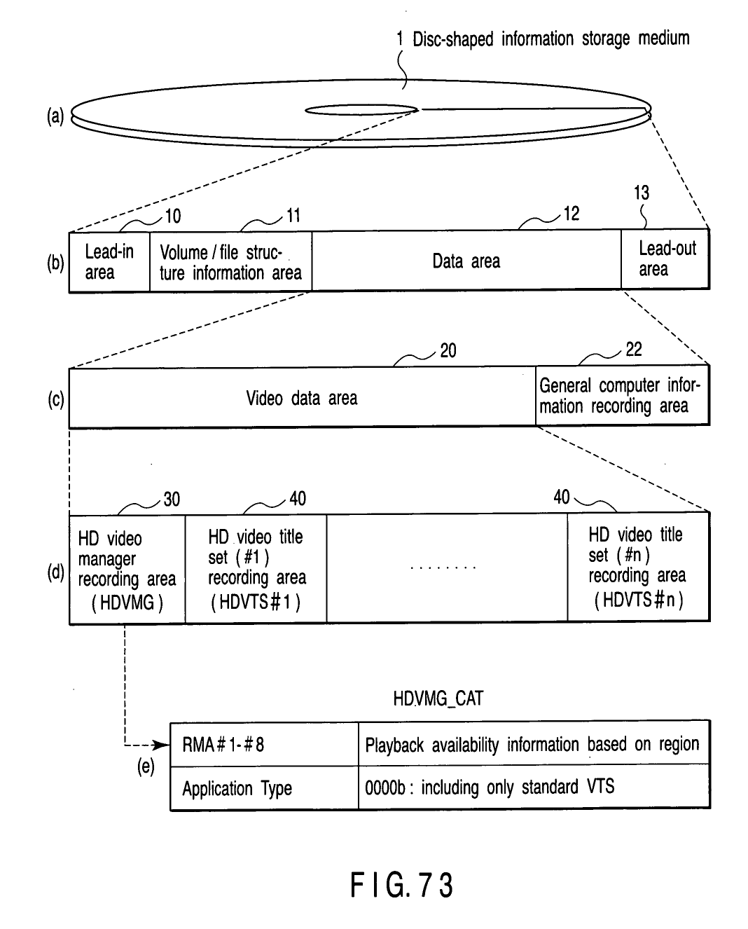

FIG. 73 shows an example of an information storage medium that records only content (standard content) which can be produced by the conventional production technique and aim at achieving high image quality of a title itself. Note that this information storage medium is called a “content type 1 disc”. The content type 1 disc includes HD video manager recording area 30 (at this time, Application Type in HDVMG_CAT in area 30 records “0000b” indicating that information storage medium 1 includes only standard VTS data), and one or more HD video title set recording areas 40, which are recorded in video data recording area 20. In addition, this information storage medium includes neither advanced HD video title set recording area 50 recorded in video data recording area 20 nor the advanced content recorded in advanced content recording area 21.

Upon playing back this information storage medium 1, FP_PGCI recorded in HD video manager information management table 310 is referred to, and playback starts in accordance with the description of the FP_PGCI. This procedure is the same as that of the conventional DVD-Video.

Also, upon playing back this information storage medium 1, in FIG. 72 that shows an example of the arrangement of the DVD player, data supplied from information storage medium 1 is processed by only DVD-Video playback engine 100, but does not undergo any processing in interactive engine 200. That is, video/audio data processed by DVD-Video playback engine 100 is output while passing through AV renderer 203.

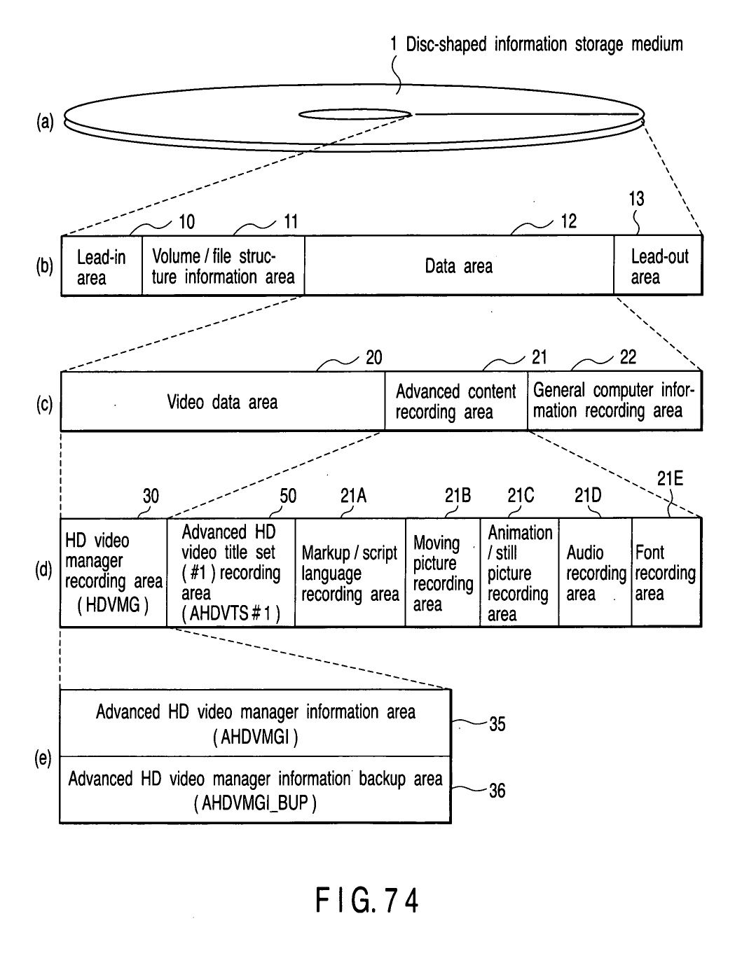

FIG. 74 shows an example of an information storage medium that records only content (advanced content) which aim at providing colorful menus, improving interactiveness, and so forth even in content of menu screens, bonus video pictures, and the like in addition to realization of high image quality of a title itself. Note that this information storage medium is called a “content type 2 disc (including only advanced VTS data)”. The content type 2 disc (including only advanced VTS data) includes one HD video manager recording area 30 and one advanced HD video title set recording area 50 recorded in video data recording area 20, and advanced content recorded in advanced content recording area 21. In addition, this information storage medium does not include any HD video title set recording area 40 recorded in video data recording area 20.

Note that since the advanced VTS does not require any menu objects, HD video manager recording area 30 of the content type 2 disc includes advanced HD video manager information recording area (AHDVMGI) 35 and advanced HD video manager information backup area (AHDVMGI_BUP) 36. At this time, Application Type in HDVMG_CAT in area 30 records “0001b” indicating that information storage medium 11 includes only advanced VTS data.

Upon playing back information storage medium 1 of this “content type 2 disc”, startup information (STARTUP.XML) recorded in the markup/script language recording area is referred to, and a “markup language file serving as a start point” described in this information is executed, thus starting playback.

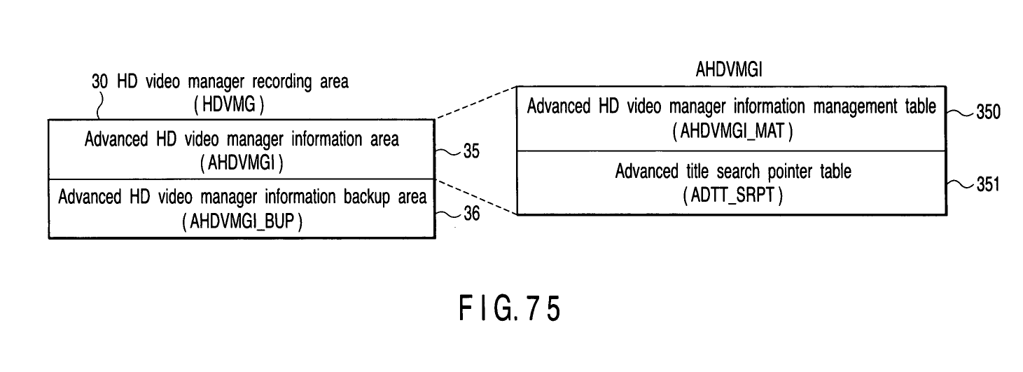

FIG. 75 shows an example of the detailed data structure in advanced HD video manager information (AHDVMGI) area 35 in information storage medium 1 in FIG. 74. Advanced HD video manager information (AHDVMGI) area 35 stores advanced HD video manager information management table (AHDVMGI_MAT) information 350 which records management information common to the entire HD_DVD-Video content recorded in video recording area 20 together, and advanced title search pointer table (ADTT_SRPT) information 351 that records information helpful to search (to detect the start positions of) titles present in the HD_DVD-Video content.

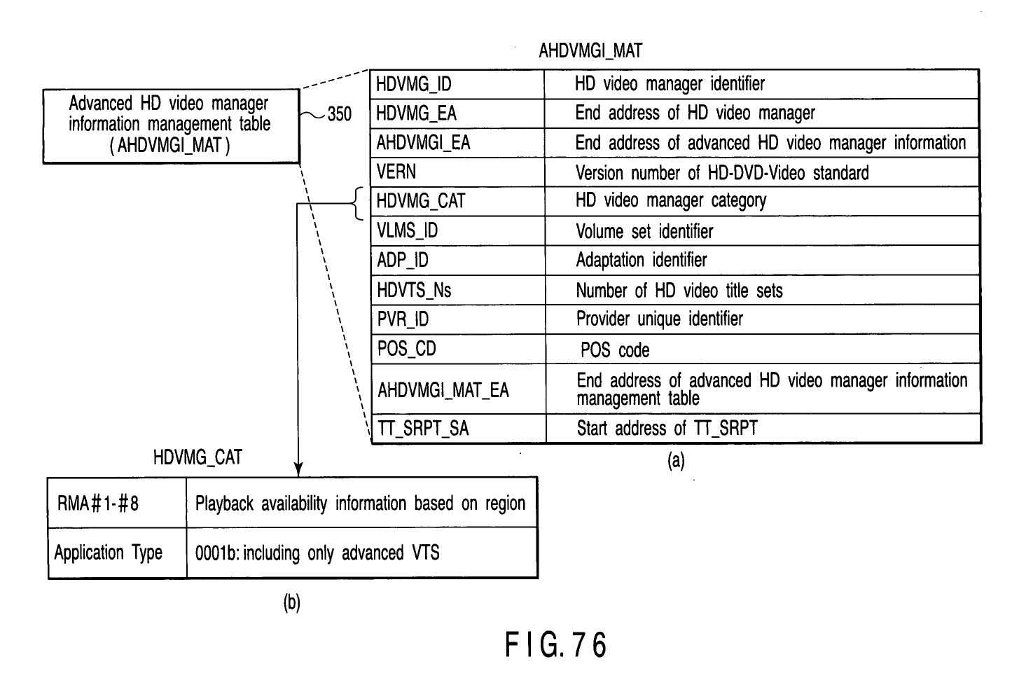

FIG. 76 shows an example of the detailed data structure in advanced HD video manager information management table (AHDVMGI_MAT) 350 in FIG. 75. Advanced HD video manager information management table (AHDVMGI_MAT) 350 records various kinds of information including an HD video manager identifier (HDVMG_ID), the end address (HDVMG_EA) of the HD video manager, the end address (HDVMGI_EA) of the HD video manager information, the version number (VERN) of the HD_DVD-Video standard, an HD video manager category (HDVMG_CAT) (in this information storage medium, Application Type in the HDVMG_CAT records “0001b”), a volume set identifier (VLMS_ID), an adaptation identifier (ADP_ID), the number (HDVTS_Ns) of HD video title sets (which records “0” since this information storage medium stores no standard VTS), a provider unique identifier (PVR_ID), a POS code (POS_CD), the end address (AHDVMGI_MAT_EA) of the advanced HD video manager information management table, and the start address (TT_SPRT_SA) of the TT_SPRT.

Note that this information storage medium does not store the start address (FP_PGCI_SA) of first play program chain information, the start address (HDVMGM_VOBS_SA) of an HDVMGM_VOBS, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C_ADT_SA) of the HDVMGM_C_ADT, the start address (HDVMGM_VOBU_ADMAP_SA) of the HDVMGM_VOBU_ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, an HDVMGM sub-picture stream attribute (HDVMGM_SPST_ATR), first play PGCI (FP_PGCI) that records management information for language selection menus, the start address information (HDMENU_AOBS_SA) of an HDMENU_AOBS, the start address information (HDMENU_AOBSIT_SA) of the HDVMGM_AOBS information table, and information of the number (HDVMGM_GUST_Ns) of HDVMGM graphics unit streams, which are stored in the content type 1 disc (or these areas are used as reserved areas).

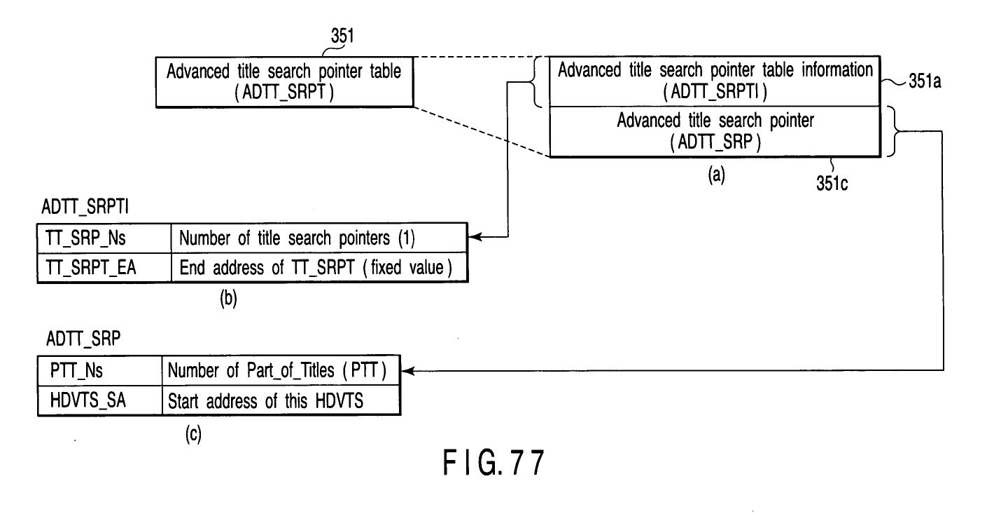

FIG. 77 shows an example of the internal structure of advanced title search pointer table (ADTT_SRPT) 351 shown in FIG. 75. Advanced title search pointer table (ADTT_SRPT) 351 includes advanced title search pointer table information (ADTT_SRPTI) 351a and advanced title search pointer table (ADTT_SRP) information 351c. Only one piece of advanced title search pointer table (ADTT_SRP) information 351c in advanced title search pointer table (ADTT_SRPT) 351 is present in an information storage medium including an advanced VTS but it does not exist in another information storage media.

Advanced title search pointer table information (ADTT_SRPTI) 351a records common management information of advanced title search pointer table (ADTT_SRPT) 351, and records information of the number (ADTT_SRP_Ns) of title search pointers included in advanced title search pointer table (ADTT_SRPT) 351 (“1” is recorded since there is only one advanced VTS in this information storage medium), and the end address (ADTT_SRPT_EA) information of this advanced title search pointer table (ADTT_SRPT) 351 (a fixed value is recorded since there is only one advanced VTS in this information storage medium) in a file of the advanced HD video manager information (AHDVMGI) area.

One advanced title search pointer (ADTT_SRP) information 351c records various kinds of information including the number (PTT_Ns) of Part_of_Titles (PTT), and the start address (HDVTS_SA) of the HDVTS of interest, in association with a title indicated by this search pointer. (This medium does not include a title playback type (TT_PB_TY), the number (AGL_Ns) of angles, title Parental_ID_Field (TT_PTL_ID_FLD) information, an HDVTS number (HDVTSN), and an HDVTS title number (HDVTS_TTN), which are stored in the content type 1 disc, or these areas are used as reserved areas.)

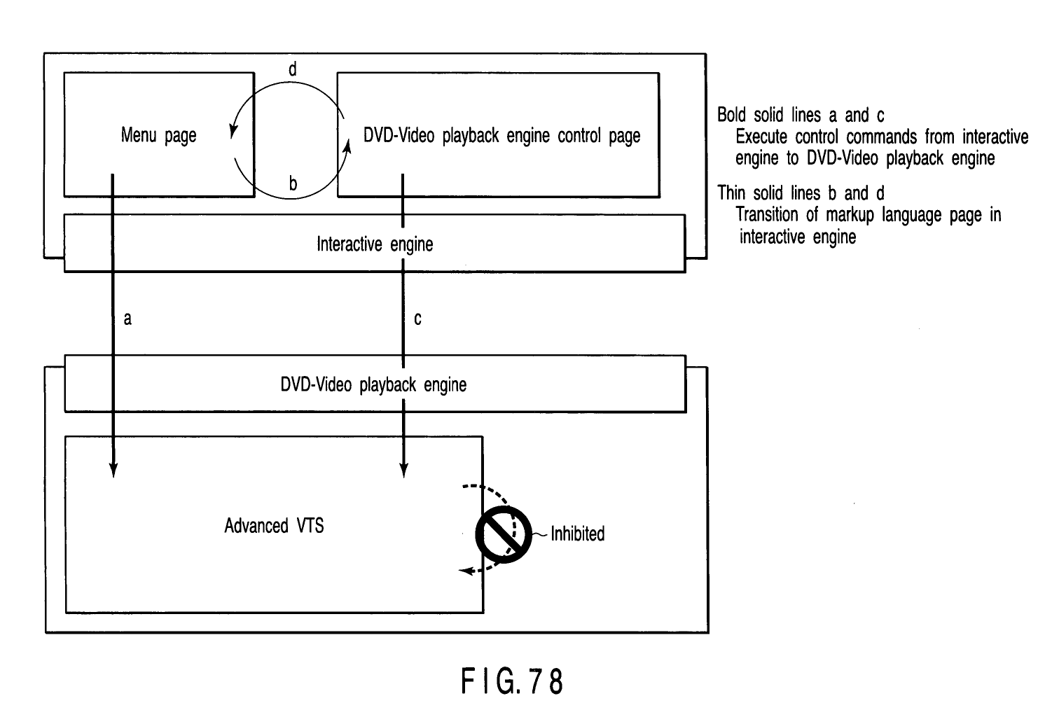

FIG. 78 is a view for explaining a playback model (example 1) of a disc that records an advanced VTS (AHDVTS). A playback example of typical content type 2 disc (including only an advanced VTS) will be described below using FIG. 78.

When playback of the content type 2 disc (including only an advanced VTS) starts, interactive engine (INT_ENG) 200 parses a menu page XML file which is stored in the advanced content recording area used to playback a menu screen described in the markup/script language.

For example, when a menu screen which prompts the user to execute a button selection process while repetitively playing back an impressive scene in movie video picture data is to be formed, the menu page XML file describes a control process for controlling DVD-Video playback engine (DVD_ENG) 100 to repetitively play back video data of the advanced VTS using the markup/script language. Interactive engine (INT_ENG) 200 issues a playback command (arrow a) to DVD-Video playback engine (DVD_ENG) 100 in accordance with the description.

At the same time, the page menu XML file stores a description for forming a menu screen using button images stored in the animation/still picture recording area and font data stored in the font recording area in advanced content recording area 21. Interactive engine (INT_ENG) 200 controls AV renderer 203 to mix the output that forms the screen according to these descriptions, and the video output of the advanced VTS by aforementioned DVD-Video playback engine (DVD_ENG) 100, thus implementing playback of the menu screen.

Next, the user selects a button used to execute playback of a video title itself of menu select buttons laid out on the screen using a remote controller or the like. The menu page XML file describes a script process associated with the selected button, and a jump event to a DVD playback engine control page is generated (arrow b).

The DVD playback engine control page describes a control process for playing back the starting part of the video title itself using the markup/script language. Interactive engine (INT_ENG) 200 issues a playback command to DVD-Video playback engine (DVD_ENG) 100 in accordance with the description (arrow c). The DVD playback engine control page also stores descriptions used to form a menu screen that can be displayed during playback of the video title itself (e.g., a menu is formed using a screen smaller than the video title itself, and is superimposed on the video title itself by seeing through the menu screen) and to superimpose a subtitle, using button images stored in the animation/still picture recording area and font data stored in the font recording area in the advanced content recording area 21. Interactive engine (INT_ENG) 200 controls AV renderer 203 to mix the output that forms the screen and the video output of the advanced VTS by aforementioned DVD-Video playback engine (DVD_ENG) 100 in accordance with these descriptions, thus implementing playback of the menu screen and subtitle.

Upon completion of playback of the video title itself, interactive engine (INT_ENG) 200 controls the XML file to be processed to jump to the menu page XML file so as to play back the menu screen again in accordance with the description in the DVD-Video playback engine control page XML file (arrow d). Note that a broken arrow marked with a circle with an oblique line in FIG. 78 indicates that a jump event based on a navigation command in the advanced VTS is inhibited.

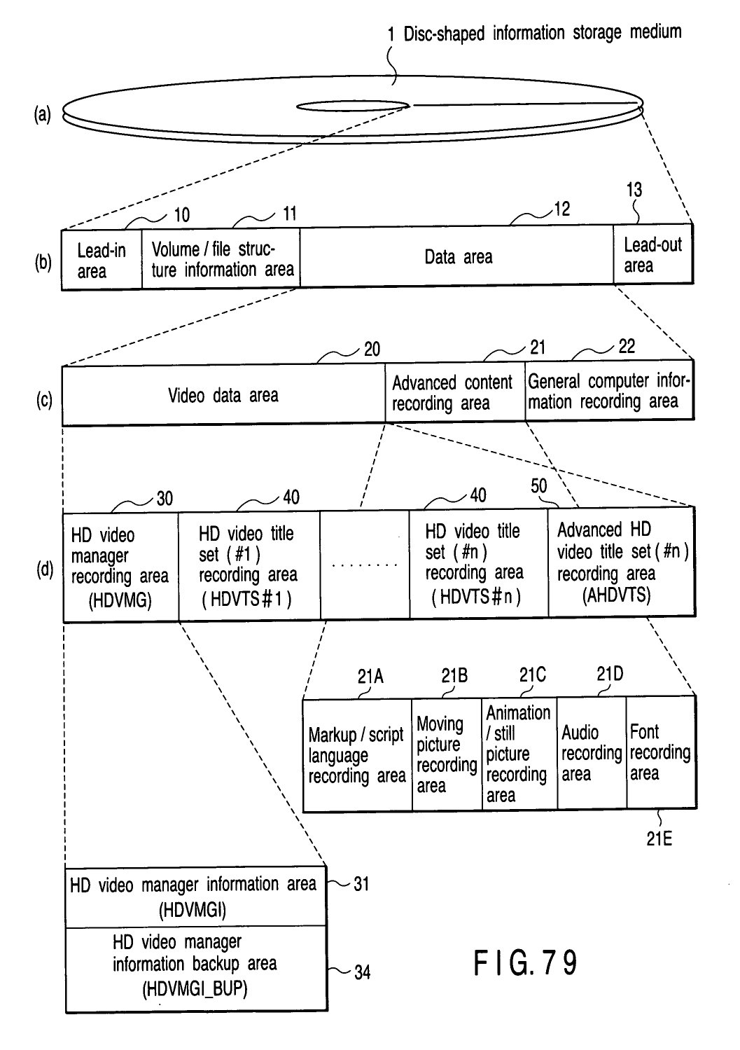

FIG. 79 shows an example of an information storage medium which records both content (standard content) which can be produced by the conventional production technique and aim at realizing high image quality of a title itself, and content (advanced content) which aim at providing colorful menus, improving interactiveness, and so forth even in content of menu screens, bonus video pictures, and the like in addition to realization of high image quality of the title itself. Note that this information storage medium is called a “content type 2 disc (including both advanced and standard VTS data)”.

The content type 2 disc including both advanced and standard VTS data includes one HD video manager recording area 30, one or more HD video title set recording areas 40, and one advanced HD video title set recording area 50, which are recorded in video data recording area 20, and advanced content (21A to 21E) recorded in advanced content recording area 21. Since the disc including the advanced VTS does not require any menu objects, this HD video manager recording area 30 includes advanced HD video manager information recording area (AHDVMGI) 35 and advanced HD video manager information backup area (AHDVMGI_BUP) 36. At this time, Application Type in the HDVMG_CAT in area 30 records “0010b” indicating that information storage medium 1 includes both standard and advanced VTS data.

Upon playing back this information storage medium (content type 2 disc) 1, startup information (STARTUP.XML) recorded in the markup/script language recording area is referred to, and a “markup language file serving as a start point” described in this information is executed, thus starting playback.

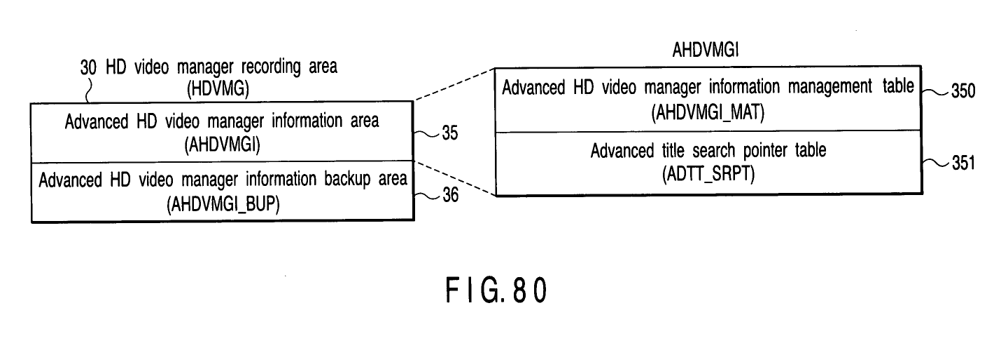

FIG. 80 shows an example of the detailed data structure in advanced HD video manager information (AHDVMGI) area 35 in the information storage medium in FIG. 79. Advanced HD video manager information (AHDVMGI) area 35 stores advanced HD video manager information management table (AHDVMGI_MAT) information 350 which records management information common to the entire HD_DVD-Video content recorded in video data recording area 20 together, and advanced title search pointer table (ADTT_SRPT) information 351 that records information helpful to search (to detect the start positions of) titles present in the HD_DVD-Video content.

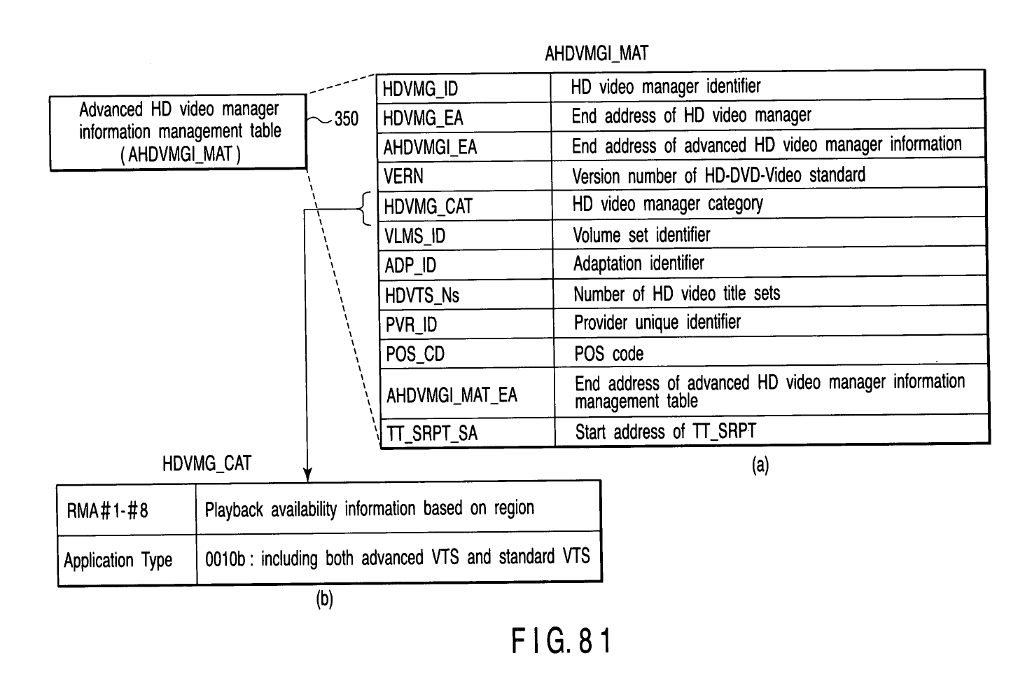

FIG. 81 shows an example of the detailed data structure in advanced HD video manager information management table (AHDVMGI_MAT) 350 in FIG. 80. Advanced HD video manager information management table (AHDVMGI_MAT) 350 records various kinds of information including an HD video manager identifier (HDVMG_ID), the end address (HDVMG_EA) of the HD video manager, the end address (AHDVMGI_EA) of the advanced HD video manager information, the version number (VERN) of the HD_DVD-Video standard, an HD video manager category (HDVMG_CAT: in this information storage medium, Application Type in the HDVMG_CAT records “0010b”), a volume set identifier (VLMS_ID), an adaptation identifier (ADP_ID), the number (HDVTS_Ns) of HD video title sets, a provider unique identifier (PVR_ID), a POS code (POS_CD), the end address (AHDVMGI_MAT_EA) of the advanced HD video manager information management table, and the start address (TT_SPRT_SA) of the TT_SPRT.

Note that this information storage medium (content type 2 disc) does not store the start address (FP_PGCI_SA) of first play program chain information, the start address (HDVMGM_VOBS_SA) of an HDVMGM_VOBS, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C_ADT_SA) of the HDVMGM_C_ADT, the start address (HDVMGM_VOBU_ADMAP_SA) of the HDVMGM_VOBU_ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, an HDVMGM sub-picture stream attribute (HDVMGM_SPST_ATR), first play PGCI (FP_PGCI) that records management information for language selection menus, the start address information (HDMENU_AOBS_SA) of an HDMENU_AOBS, the start address information (HDMENU_AOBSIT_SA) of the HDVMGM_AOBS information table, and information of the number (HDVMGM_GUST_Ns) of HDVMGM graphics unit streams, which are stored in the content type 1 disc (or these areas are used as reserved areas).

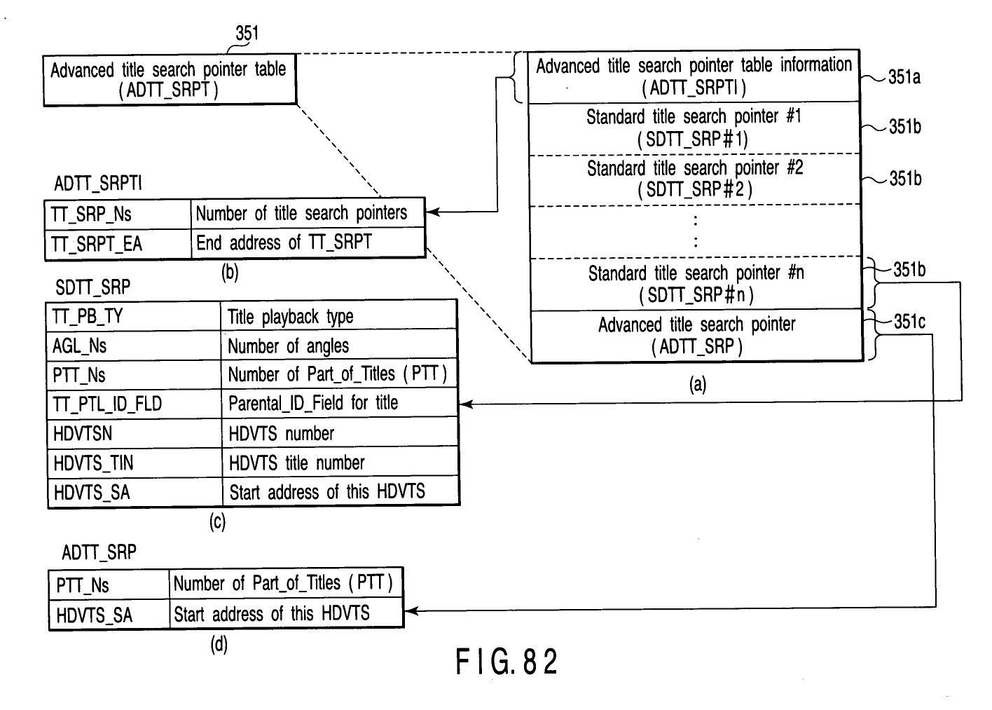

FIG. 82 shows an example of the internal structure of advanced title search pointer table (ADTT_SRPT) 351 shown in FIG. 80. Advanced title search pointer table (ADTT_SRPT) 351 includes advanced title search pointer table information (ADTT_SRPTI) 351a, standard title search pointer (SDTT_SRP) 351b, and advanced title search pointer table (ADTT_SRP) information 351c. Only one piece of advanced title search pointer table (ADTT_SRP) information 351c in advanced title search pointer table (ADTT_SRPT) 351 is present in an information storage medium including an advanced VTS but it does not exist in other information storage media. Also, standard title search pointer (SDTT_SRP) 315b is present only when an information storage medium records standard VTS data.

Advanced title search pointer table information (ADTT_SRPTI) 351a records, as common management information of advanced title search pointer table (ADTT_SRPT) 351, information of the number (ADTT_SRP_Ns) of title search pointers included in advanced title search pointer table (ADTT_SRPT) 351, and the end address (ADTT_SRPT_EA) information of this advanced title search pointer table (ADTT_SRPT) 351 in a file of the advanced HD video manager information (AHDVMGI) area.

Only one advanced title search pointer (ADTT_SRP) information 351c records various kinds of information including the number (PTT_Ns) of Part_of_Titles (PTT), the start address (HDVTS_SA) of the HDVTS of interest, and the like, in association with a title indicated by this search pointer

The information storage medium (content type 2 disc) with the structure shown in FIGS. 79 to 82 does not include a title playback type (TT_PB_TY), the number (AGL_Ns) of angles, title Parental_ID_Field (TT_PTL_ID_FLD) information, an HDVTS number (HDVTSN), and an HDVTS title number (HDVTS_TTN) (or these areas are used as reserved areas).

One standard title search pointer (SDTT_SRP) information 351b records various kinds of information including a title playback type (TT_PB_TY), the number (AGL_Ns) of angles, the number (PTT_Ns) of Part_of_Titles (PTT), title Parental_ID_Field (TT_PTL_ID_FLD) information, an HDVTS number (HDVTSN), an HDVTS title number (HDVTS_TTN), and the start address (HDVTS_SA) of the HDVTS of interest, in association with a title indicated by this search pointer.

FIG. 83 is a view for explaining the relationship between the playback states of an advanced VTS and standard VTS. FIG. 83 shows an example a state machine that indicates transition of a playback control module of the content type 2 disc. In a playback process of the content type 2 disc (of a type including both advanced and standard VTS data), playback starts from an initial state when interactive engine (INT_ENG) 200 interprets startup information (STARTUP.XML) recorded in markup/script language recording area 21A, and the control transits to an advanced VTS playback state.

In the advanced VTS playback state, interactive engine (INT_ENG) 200 generates text information, button images, and the like, which form a menu screen, and issues a video playback start instruction command to DVD-Video playback engine (DVD_ENG) 100. Interactive engine 200 controls AV renderer 203 to mix the output that forms the screen with the video output of DVD-Video playback engine (DVD_ENG) 100, thus implementing playback of the menu screen.

A markup/script language file that describes a menu page to be interpreted in the advanced VTS playback state describes a script which defines the behaviors of event handlers which are associated with events such as button clicking and the like by the user. For example, an event handler associated with a button image that indicates playback of a movie video title itself describes a command required to shift the control to a standard VTS playback state. When the user selects and executes the title playback button by a remote controller operation or the like, interactive engine (INT_ENG) 200 executes the command required to shift the control to the standard VTS playback state, and the state machine makes the video playback control transit to the standard VTS playback state executed by DVD-Video playback engine (DVD_ENG) 100.

In the standard VTS playback state, DVD-Video playback engine (DVD_ENG) 100 interprets a cell playback information table (C_PBIT), program chain command table (PGC_CMDT), and the like in a program chain (PGC) stored in a PGC and the like in the standard VTS, and executes playback control of the standard VTS in accordance with their description content. In the standard VTS playback state, interactive engine (INT_ENG) 200 halts, and never instructs DVD-Video playback engine (DVD_ENG) 100 to execute playback control.

The program chain command table (PGC_CMDT) and the like of the standard VTS can describe a shift command (“CallINTENG” or the like in FIG. 43(d)) to the advanced VTS playback state. With such command, DVD-Video playback engine (DVD_ENG) 100 can execute the shift command to the advanced VTS playback state when it executes a command interpretation process upon completion of a series of video playback processes, or DVD-Video playback engine (DVD_ENG) 100 can shift the video playback control to the advanced VTS playback state executed by interactive engine (INT_ENG) 200 upon reception of an event of a user command such as menu call or the like.

Upon shifting from the standard VTS playback state to the advanced VTS playback state, DVD-Video playback engine 100 may temporarily store information such as the video playback position of the standard VTS or the like immediately before the playback control transits to prepare for a resume playback process from interactive engine (INT_ENG) 200, so as to implement a temporary call process of a menu screen or the like.

Table A below shows a practical example of commands used to shift from the advanced VTS playback state to the standard VTS playback state in the markup/script language file to be interpreted by interactive engine (INT_ENG) 200 (commands other than those in this example may be adopted as needed).

TABLE A

| (Command Name) | (Argument) |
|---|---|
| CallDVDENG_TT | title number |
| CallDDVENG_PTT | title number, chapter number |
| CallDVDENG_TM | title number, playback start time position |
| CallDVDENG_RSM | no argument |

In table A, CallDVDENG_TT is a command that designates the title number of a standard VTS upon shifting from the advanced VTS playback state to the standard VTS playback state. DVD-Video playback engine (DVD_ENG) 100 loads a standard VTS including the designated title, and starts playback from the head of the title.

CallDDVENG_PTT is a command that designates the title number and chapter number (PTT number) of a standard VTS upon shifting from the advanced VTS playback state to the standard VTS playback state. DVD-Video playback engine (DVD_ENG) 100 loads a standard VTS including the designated title, and starts playback from the head of the designated chapter number (PTT number).

CallDVDENG_TM is a command that designates the title number and an offset of the playback start time from the head of the title video of a standard VTS upon shifting from the advanced VTS playback state to the standard VTS playback state. DVD-Video playback engine (DVD_ENG) 100 loads a standard VTS including the designated title, and starts playback from the designated playback time position.

CallDVDENG_RSM is a command that designates execution of a resume process upon shifting from the advanced VTS playback state to the standard VTS playback state. Upon reception of this command, DVD-Video playback engine (DVD_ENG) 100 resumes playback in accordance with the temporarily stored playback position information when the control transits from the immediately preceding standard VTS playback state to the advanced VTS playback state.

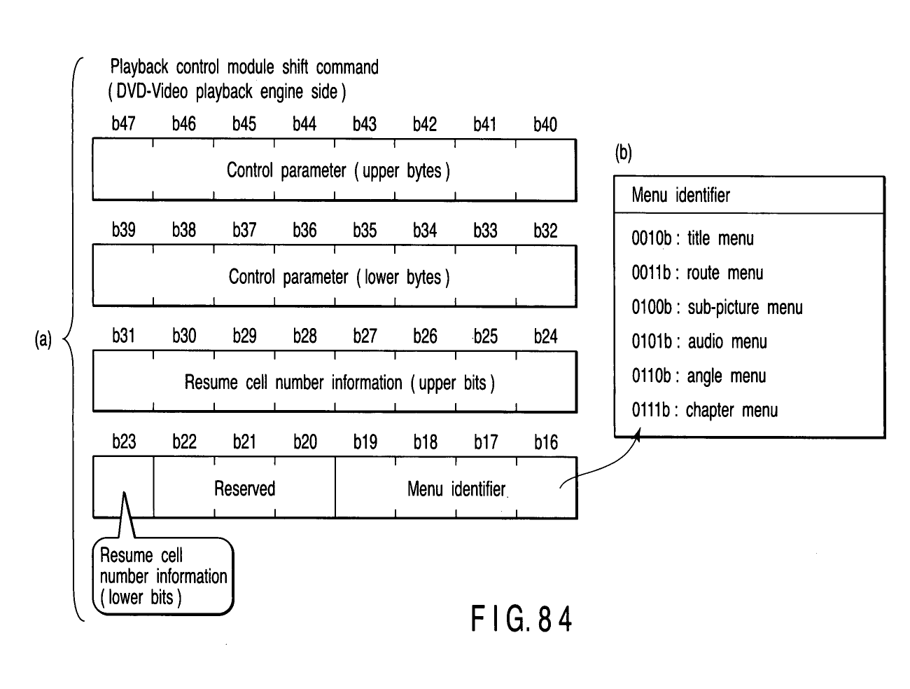

FIG. 84 shows an example of argument definition of a command (CallINTENG command) required to shift from the standard VTS playback state to the advanced VTS playback state of navigation commands to be interpreted by the DVD-Video playback engine (DVD_ENG). In the entire command bit sequence, a command code is stored in bits b63 to b48, and b15 to b0 are assigned to a reserved area for future expansion.

A 16-bit control parameter storage area is assigned to b47 to b32. At a specific playback position or in an event of a standard VTS to be interpreted by DVD-Video playback engine (DVD_ENG) 100, this area can store an arbitrary value which is used to select an arbitrary process in the description of the markup/script language file to be interpreted by interactive engine (INT_ENG) 200 after the control transits to the advanced VTS playback state. That is, this data area can be used for an arbitrary purpose upon producing video content. An area for storing the playback start cell number in the resume process is assigned to b31 to b23.

An area for storing a menu identifier is assigned to b19 to b16, and is used to designate the type of menu to be called upon calling a menu especially when the control transits from the standard VTS playback state to the advanced VTS playback state. The type of menu identifier that can be called includes:
0010b→title menu
0011b→root menu
0100b→sub-picture menu
0101b→audio menu
0110b=angle menu
0111b→chapter menu, etc.
   Also, more detailed behavior differences may be expressed based on the aforementioned control parameter or by combining the control parameter and menu identifier.

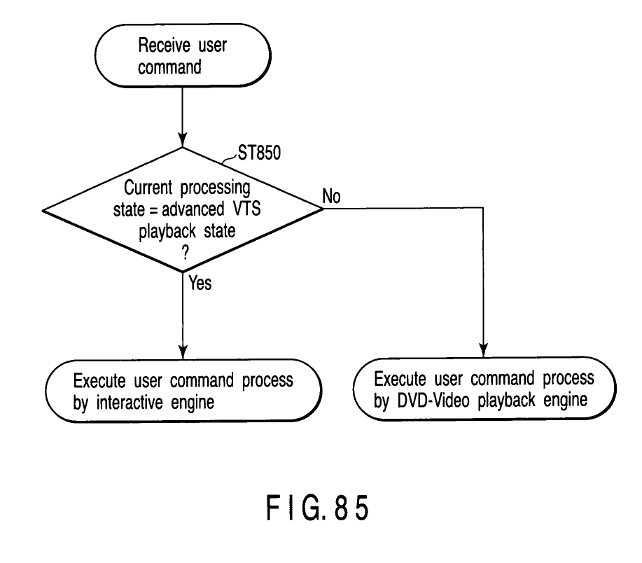

FIG. 85 is a flowchart for explaining the switching algorithm of a user command process. This flowchart exemplifies a process for switching a module that handles a process when a user command is generated. Upon playing back the content type 2 disc (of a type including both advanced and standard VTS data), when an event of a user command associated with button depression on a remote controller or front panel (not shown) is generated, a user operation module confirms the current playback state (step ST850), and switches a module which is to be notified of the user event. If the current state is the advanced VTS playback state (YES in step ST850), the user operation module notifies interactive engine (INT_ENG) 200 of the user event; if the current state is the standard VTS playback state (NO in step ST850), the user operation module notifies DVD-Video playback engine (DVD_ENG) 100 of the user event, thus executing the process of the user command.

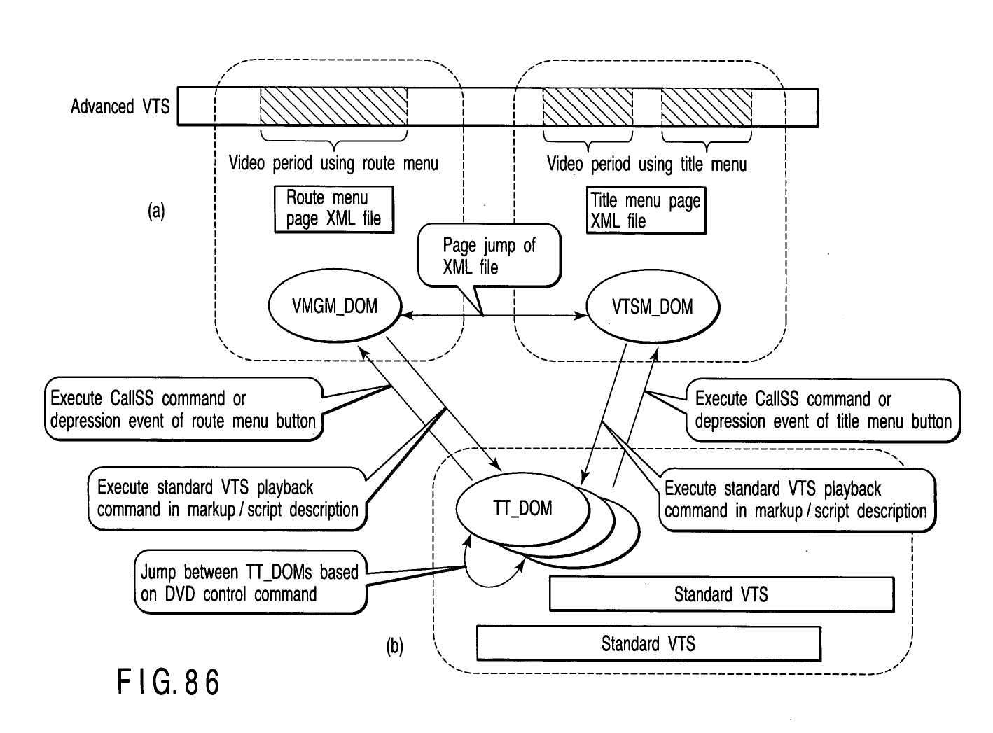

FIG. 86 shows an example of domain transition of the content type 2 disc. In a typical content type 2 disc (of a type including both advanced and standard VTS data), a VMG menu domain (VMGM_DOM) and VTS menu domain (VTSM_DOM) are formed of an advanced VTS and an XML file described in the markup/script language, and a title domain (TT_DOM) such as a video title itself is formed of a standard VTS.

Menu video picture data in the VMG menu domain and VTS menu domain is realized by playing back video picture data stored in the advanced VTS in accordance with the description of the “XML file” in addition to text information and button images rendered in accordance with the description of the “menu XML file” described in the markup/script language.

Transition between the VMG menu domain and VTS menu domain is implemented by executing a hyperlink process between menu XML files described in these menu XML files. At this time, playback of the advanced VTS may stop in correspondence with a change in page, and playback may start from a new position or may be continued from the previous position.

Transition from the VMG menu domain (VMGM_DOM), VTS menu domain (VTS_DOM), or the like to the title domain (TT_DOM) is implemented by executing a playback start command of a standard VTS (e.g., a CallDVDENG_xxx command listed in table A above) described in an XML file, and transferring the DVD playback control to DVD-Video playback engine 100.

On the other hand, transition from the title domain (TT_DOM) to the VMG menu domain (VMGM_DOM) may be implemented by defining a new command such as the aforementioned CallINTENG command and storing this new command in the program chain command table (PGC_CMDT) in the standard VTS. Alternatively, transition from the title domain (TT_DOM) to the VMG menu domain (VMGM_DOM) may take place when an argument of a CallSS command indicates VMGM_DOM. Also, an event generated upon depression of a root menu button arranged on a remote controller or the like (not shown) may be acquired, and transition from the title domain (TT_DOM) to the VMG menu domain (VMGM_DOM) may take place upon acquisition of this event.

Likewise, transition from the title domain (TT_DOM) to the VTS menu domain (VTSM_DOM) may be implemented by defining a new command such as the aforementioned CallINTENG command or the like, and storing this new command in the program chain command table (PGC_CMDT) in the standard VTS, or this domain transition may take place when an argument of a CallSS command indicates VTSM_DOM. Also, an event generated upon depression of a title menu button arranged on a remote controller or the like (not shown) may be acquired, and transition from the title domain (TT_DOM) to the VTS menu domain (VTSM_DOM) may take place upon acquisition of this event.

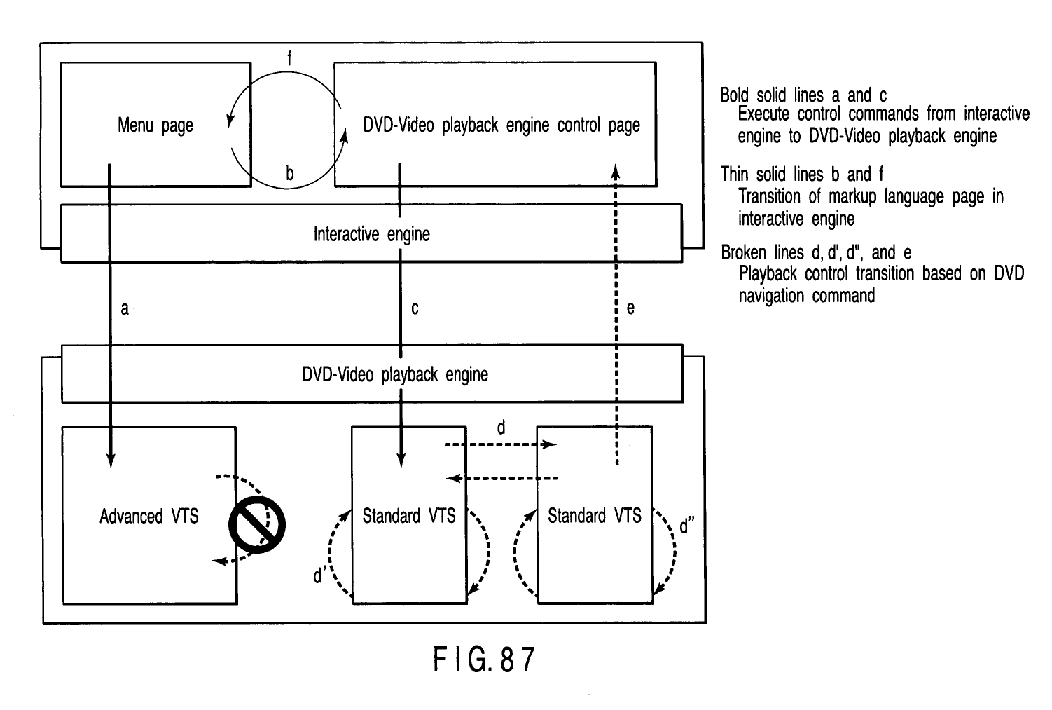

FIG. 87 is a view for explaining a playback model (example 2) of a disc that records both an advanced VTS (AHDVTS) and standard VTS (HDVTS). A playback example of a typical content type 2 disc (of a type including both advanced and standard VTS data) will be explained using FIG. 87.

When playback of the content type 2 disc (including both advanced and standard VTS data) starts, interactive engine (INT_ENG) 200 parses a menu page XML file which is stored in the advanced content recording area and is required to play back a menu screen described in the markup/script language.

For example, when a menu screen which prompts the user to execute a button selection process while repetitively playing back an impressive scene in movie video picture data is to be formed, the menu page XML file describes a control process for controlling DVD-Video playback engine (DVD_ENG) 100 to repetitively play back video data of the advanced VTS using the markup/script language. Interactive engine (INT_ENG) 200 issues a playback command (arrow a) to DVD-Video playback engine (DVD_ENG) 100 in accordance with the description.

At the same time, the menu page XML file stores a description for forming a menu screen using button images stored in the animation/still picture recording area and font data stored in the font recording area in advanced content recording area 21. Interactive engine (INT_ENG) 200 controls AV renderer 203 to mix the output that forms the screen according to these descriptions, and the video output of the advanced VTS by aforementioned DVD-Video playback engine (DVD_ENG) 100, thus implementing playback of the menu screen.

Next, the user selects a button used to execute playback of a video title itself of menu select buttons laid out on the screen using a remote controller or the like. The menu page XML file describes a script process associated with the selected button, and a jump event to a DVD playback engine control page is generated (arrow b).

The DVD playback engine control page describes a CallDVDENG_TT command which has the title number indicating the head of a video title itself as an argument. When interactive engine (INT_ENG) 200 executes this command, transition from the advanced VTS playback state to the standard VTS playback state takes place (arrow c).

After transition to the standard VTS playback state, DVD-Video playback engine (DVD_ENG) 100 executes playback of the standard VTS that stores the video title itself. Depending on video content, a playback position jump process to a playback position of another VTS may be taken place in accordance with the description of a playback control command stored in the VTS (arrow d). Note that a broken arrow marked with a circle with an oblique line in FIG. 87 indicates that a jump event based on a navigation command in the advanced VTS is inhibited. On the other hand, a jump event based on a navigation command is allowed in the standard VTS (arrow d′, d″, or the like).

Upon completion of playback of the video title itself, a “CallINTENG command” described in the program chain command table in the program chain (PGC) is executed, thus causing transition from the standard VTS playback state to the advanced VTS playback state (arrow e).

Interactive engine (INT_ENG) 200 controls the XML file to be processed to jump to the menu page XML file so as to play back the menu screen again in accordance with a script description described in a handler of a CallINTENG command generating event in the DVD-Video playback engine control page XML file (arrow f).

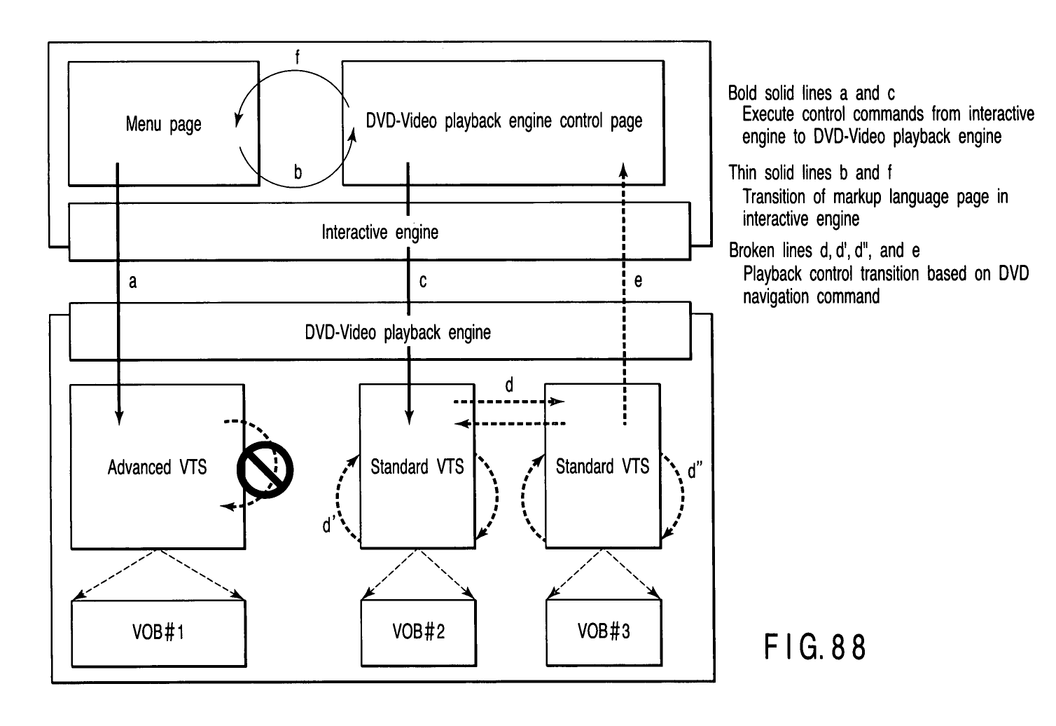

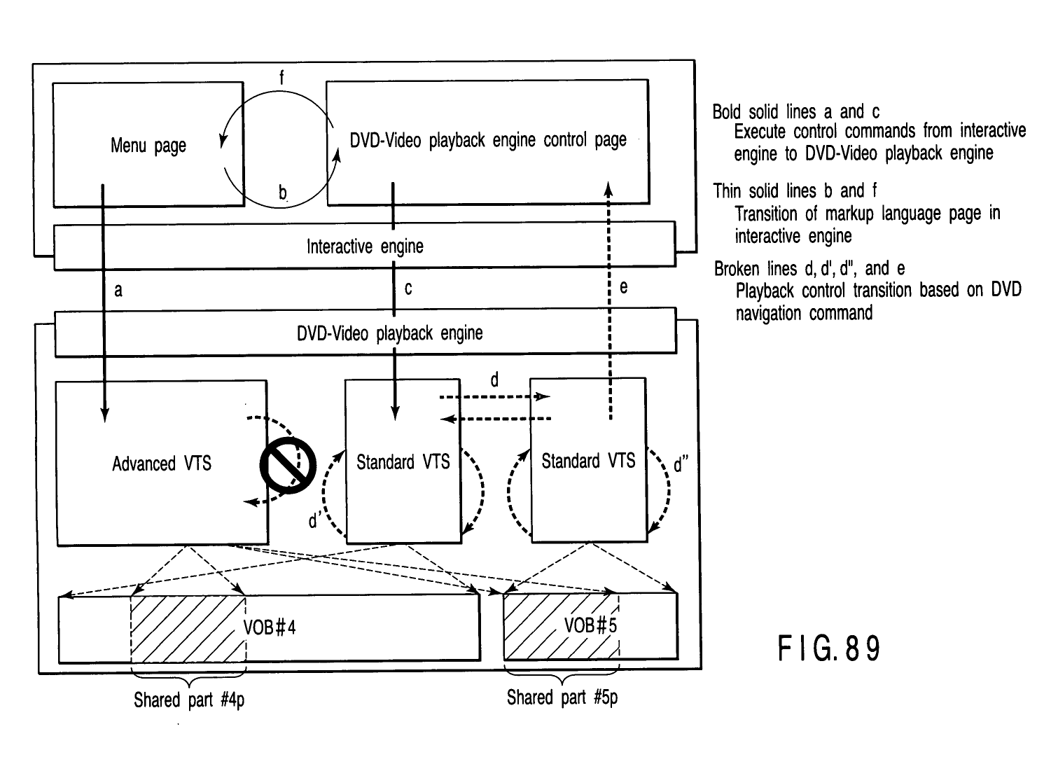

FIG. 88 shows the relationship among an advanced VTS, standard VTS, and video objects (called EVOB or VOB data) in the content type 2 disc including both advanced and standard VTS data. In FIG. 88, an advanced VTS that forms a menu and two standard VTSs which form a title (video title) are present. Respective VTSs refer to independent video objects. In this example, video picture data required to form a menu is quite different from that which forms a title. With the configuration shown in FIG. 88, when a “menu screen which prompts the user to execute a button selection process while repetitively playing back an impressive scene in movie video picture data is to be formed”, two video objects must be prepared although the video title and menu video picture data are the same. In order to avoid such duplicate preparation of “two video objects”, a “shared reference model of objects” shown in FIG. 89 can be referred to.

FIG. 89 is a view for explaining a shared reference model of objects in a disc that records an advanced VTS (AHDVTS) and standard VTS (HDVTS) together. Since each of the advanced VTS side and standard VTS side stores a time map, the advanced VTS and standard VTS can refer to the same video objects, and an arbitrary period of a given scene in the video title can be extracted and used as a background picture of a menu screen. In this way, the content producer can reduce the number of processes for producing two video objects to one (in association with a shared object to be referred to). Also, since the two objects are reduced to one, the required capacity of the information storage medium can be reduced, and improvement of the image quality of the video title itself, addition of a new bonus picture, and the like can be realized accordingly.

When a video object (VOB) to be shared by the advanced VTS and standard VTS is played back as the advanced VTS, PCI/DSI often includes information which is not required as the standard VTS, as shown in FIGS. 64 and 65. When such video object is played back as the standard VTS, playback is made using such information. However, when the video object is played back as the advanced VTS, playback is made while skipping such information, i.e., ignoring it.

FIG. 90 is a view for explaining a practical example of loading information included in advanced content. The loading information includes a file name & location field, file size field, content type field, reference start time field, reference end time field, and the like. The file name & location field describes the URL address and file name of a file when that file is present on the server unit 500, or describes the directory on a disc and file name of a file when that file is present on the disc. The file size field describes the file size of a file (unit: bytes). The content type field describes the type of content using MIME types. The reference start time field describes a reference start time of a file from the markup language or the like, and the reference end time field describes a reference end time of that file from the markup language or the like (that is, when this time has elapsed, the file loaded on the buffer may be immediately erased).

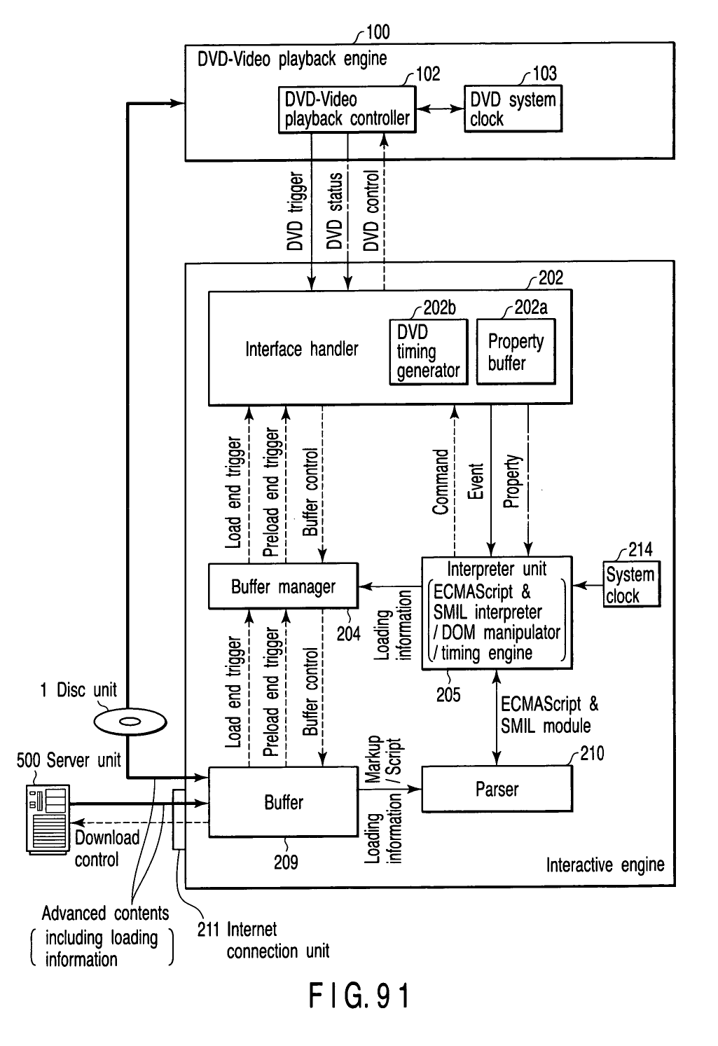

Basically, a file with the reference start time “0” must be loaded onto the buffer (209 in FIGS. 72 and 91 or the like) before playback starts (i.e., before the beginning of execution of the markup language) (“preload”). For other data, the playback apparatus determines the loading start times of all files using the reference start times, reference end times, and file sizes which are described in the loading information, and information associated with a communication rate acquired by the playback apparatus. In this way, the user wait time until the beginning of display of the advanced content/the beginning of playback of the DVD-Video content can be minimized.

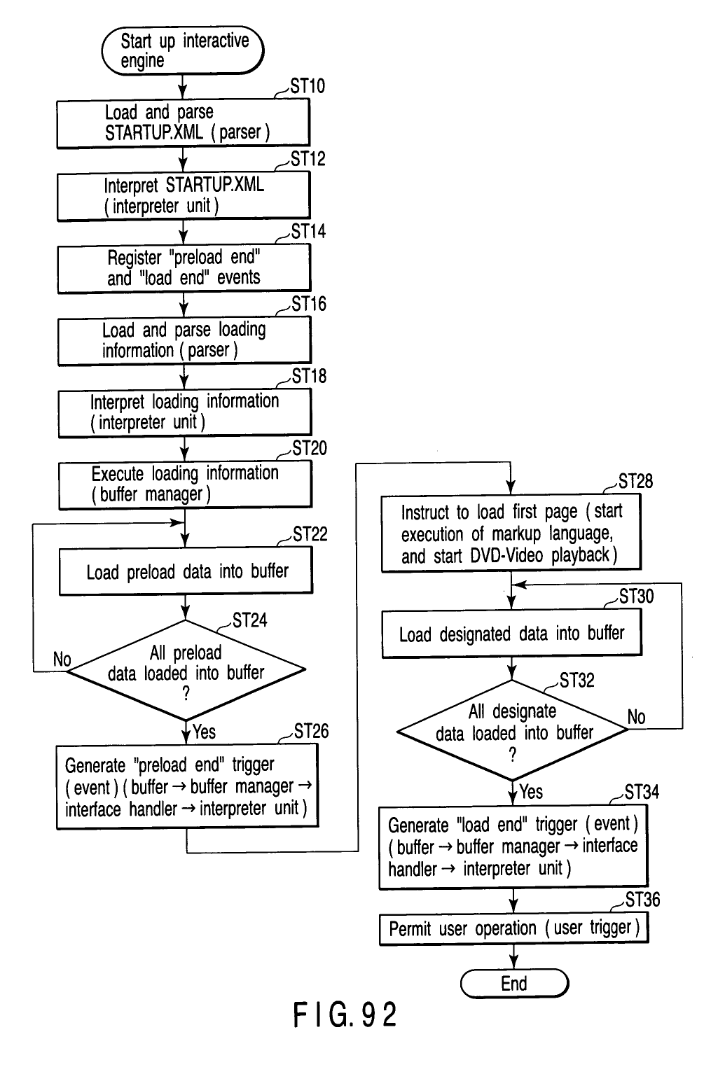

FIG. 91 shows the arrangement of buffer manager 204 and its peripheral units, and FIG. 92 shows the flow upon loading data onto V buffer 209. When interactive engine 200 is started up, a startup information file (STARTUP.XML) as one of advanced content recorded on information storage medium 1 in the disc unit is loaded (step ST10). Parser 210 parses this startup information (step ST12). Interpreter unit 205 interprets the parsed startup information. Interpreter unit 205 registers an operation upon generation of a “preload end” event (trigger) (for example, loading/execution of markup language file INDEX.XML indicating the default screen configuration starts), and an operation upon generation of a “load end” event (trigger) (for example, execution of a user operation which is inhibited so far is permitted) (step ST14).

Note that the control of “user operation” can be made by PGC user operation control (PGC_UOP_CTL) in the standard VTS, and can be made by the markup language in the advanced VTS.

Furthermore, loading information (see FIG. 90) is loaded (step ST16). This loading information may be described in the aforementioned startup file, may be recorded as one file on disc 1, or may be recorded as one file on server 500. When the loading information is recorded on disc 1 or server 500, the recording location and file name are described in the startup file. The loading information is loaded by interactive engine (INT_ENG) 200 in accordance with this description, and is parsed by parser 210 (step ST18). Interpreter unit 205 interprets the parsed loading information, and buffer manager 204 loads the advanced content onto buffer 209 (step ST20).

The loading information describes the file name and location (a place where a file exists), file size, content type or MIME type (the type of data), reference start and end times (data reference duration), and the like of each file to be downloaded.

Buffer manager 204 loads advanced content with the reference start time=“0” (i.e., files that must be stored in the buffer before the beginning of display of the advanced content/the beginning of playback of the DVD-Video content) in accordance with this description (step ST22). At this time, files to be loaded are loaded from disc 1 or server unit 500 in accordance with the description order of the loading information. In this case, for example, the loading information designates advanced content (INDEX.XML file and its related files) that form the first page as those to be “preloaded”.

After all advanced content to be “preloaded” are loaded onto buffer 209 (YES in step ST24), buffer 209 sends a “preload end trigger” signal to buffer manager 204 (step ST26). Upon reception of the “preload end trigger” signal from buffer 209, buffer manager 204 sends a “preload end trigger” signal to interface handler 202. Upon reception of the “preload end trigger” signal from buffer manager 204, interface handler 202 sends a “preload end event” signal as an event to interpreter unit 205.

Interpreter unit 205 has registered the operation upon generation of the “preload end event”, as described above, and executes the registered operation (step ST28). For example, as the operation, execution of loading of INDEX.XML which has been loaded onto buffer 209 and forms the first page is registered. Also, INDEX.XML designates start of playback of DVD-Video content. In this manner, upon completion of preloading of the advanced content (upon generation of the “preload end event”), display of the advanced content/playback of the DVD-Video content starts.

In order to quicken this playback start time, only advanced content which form the first page may be designated as those to be “preloaded”. However, since advanced content other than the first page are not stored in buffer 209 at the beginning of playback, user operations such as fastforwarding, skip, time search, and the like must be inhibited.

While display of the advanced content/playback of the DVD-Video content is performed, buffer manager 204 loads remaining advanced content (files to be stored in the buffer after the beginning of display of the advanced content/the beginning of playback of the DVD-Video content) in accordance with the description of the loading information (step ST30). At this time, the playback apparatus determines the loading start times and order of all advanced content using the reference start times, reference end times, and file sizes which are described in the loading information, and information associated with a communication rate acquired by the playback apparatus (e.g., using a value given by priority=reference start time−file size/communication rate).

For example, the loading information describes that a “preload end trigger” is generated upon completion of loading of advanced content that form the first page, and a “load end trigger” is generated upon completion of loading of advanced content which form the second page.

If advanced content which form the second page are loaded onto buffer 209 (YES in step ST32), buffer 209 sends a “load end trigger” signal to buffer manager 204. Upon reception of the “load end trigger” signal from buffer 209, buffer manager 204 sends a “load end trigger” signal to interface handler 202. Upon reception of the “load end trigger” signal from buffer manager 204 (step ST34), interface handler 202 sends a “load end event” signal as an event to interpreter unit 205.

Interpreter unit 205 has registered the operation upon generation of the “load end event”, as described above, and executes the registered operation (step ST36). For example, when user operations such as fastforwarding, skip, time search, and the like are inhibited, the operation for permitting the inhibited user operations is registered. That is, since all advanced content are stored in buffer 209, the user operations need not be inhibited.

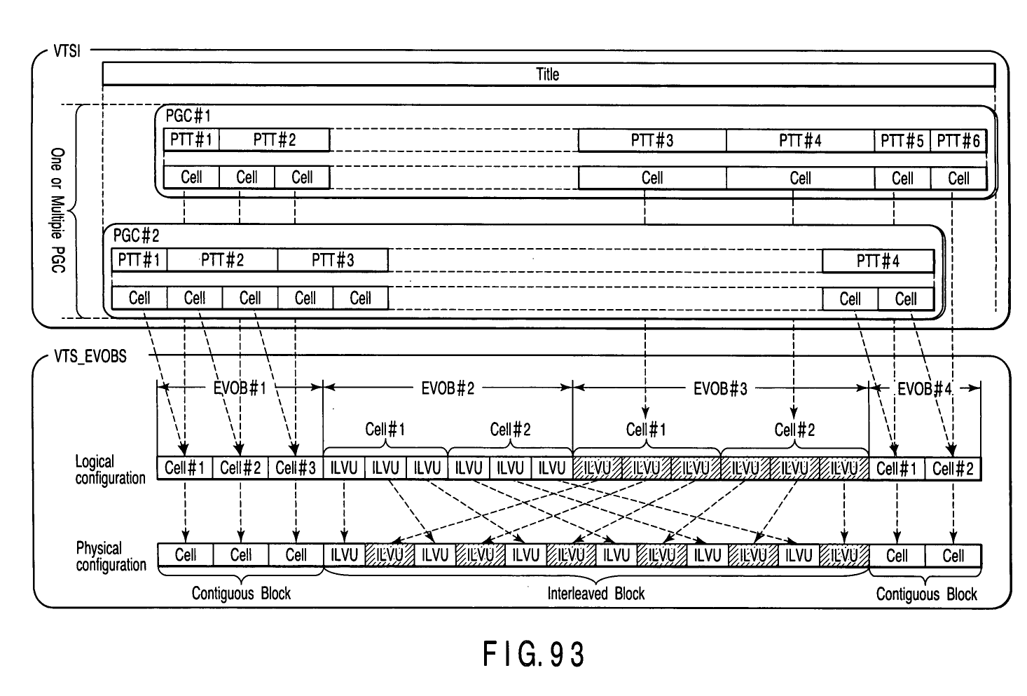

FIG. 93 is a view for explaining the configuration of an advanced VTS (AHDVTS) which exceptionally has multiple PGCs. A VTS_EVOBS of the advanced VTS in FIG. 93 includes one interleaved block. This interleaved block is used to implement playback of the director's cut version and theatrical release version, as shown in, e.g., FIG. 69. In many cases, EVOBs in the interleaved block of such VTS_EVOBS have different playback time durations. In case of such advanced VTS, VTSI may manage information associated with video playback in a plurality of PGCs.

A playback sequence is defined by the cell playback information table (C_PBIT; 53 in FIG. 56) stored in a PGC. The cell position information table (C_POSIT; 54 in FIG. 56) associates cells used in playback and actual cells using EVOB numbers (EVOB#1, etc.) and cell numbers (Cell#1 to Cell#3, etc.) in the VTS_EVOBS. Furthermore, of the cells in the VTS_EVOBS, cells that form the interleaved block are segmented for respective interleaved units (ILVUs), and are allocated at separate positions in the interleaved block on the HD_DVD disc.

In the example of FIG. 93, the cell playback information table is configured as follows. That is, for example, PGC#1 as the director's cut version plays back a contiguous block formed by EVOB#1, then plays back EVOB#3 formed by an interleaved block, and finally plays back a contiguous block formed by EVOB#4 all in the VTS_EVOBS. For example, PGC#2 as the theatrical release version plays back a contiguous block formed by EVOB#1, then plays back EVOB#2 formed by an interleaved block, and finally plays back a contiguous block formed by EVOB#4 all in the VTS_EVOBS.

In this manner, upon describing the playback sequences of the director's cut version and theatrical release version, respective cells (EVOBs) in the interleaved block period have different playback time durations. In such case, the playback sequences are defined by dividing PGCs, as in the example of FIG. 93. In this way, accesses to playback positions in time units can be easily managed.

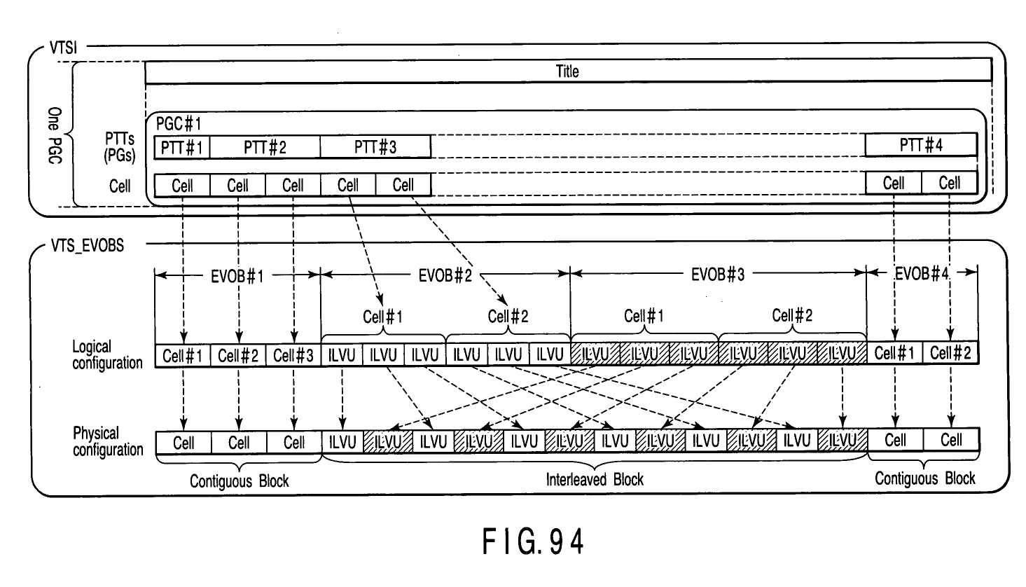

FIG. 94 is a view for explaining the configuration of an advanced VTS (AHDVTS) which includes an interleaved block but has one PGC. This example is convenient, e.g., when the interleaved block forms an angle block.

In the example of FIG. 94, the cell playback information table is configured as follows. That is, a playback sequence defined by PGC#1 plays back a contiguous block formed by EVOB#1, then plays back EVOB#2 formed by an interleaved block, and finally plays back a contiguous block formed by EVOB#4 all in the VTS_EVOBS.

In this case, it appears that no sequence for playing back EVOB#3 that forms another angle is defined. However, in practice, in the angle block, EVOBs which form respective angles, and their cells and ILVU boundaries have equal playback times, and the same multiplexed audio data is used. Hence, angles are configured to be seamlessly switched in ILVU boundary units. Therefore, a parameter that indicates the current playback angle is defined, and the angle can be switched based on the value of this parameter.

To summarize the above description, when the playback sequence of the interleaved block that forms the angle block is to be defined, the playback time is uniquely defined by the cell playback information table given by one PGC, and cells to be actually played back of a VTS_EVOBS can be specified in combination with the aforementioned parameter indicating the playback angle.

In the embodiment of the present invention, using playback control information which is stored in the ADV_OBJ in FIG. 2 and is described using the markup/script language, playback of identical DVD content can be flexibly configured. That is, using the description of the aforementioned playback sequence information file (PBSEQ001.XML in FIG. 2, etc.), a function of freely configuring the playback order of a DVD video picture stored in a VTS_EVOBS in predetermined units (independently of PGC information and navigation information in navigation packs which are originally recorded on disc 1) can be implemented.

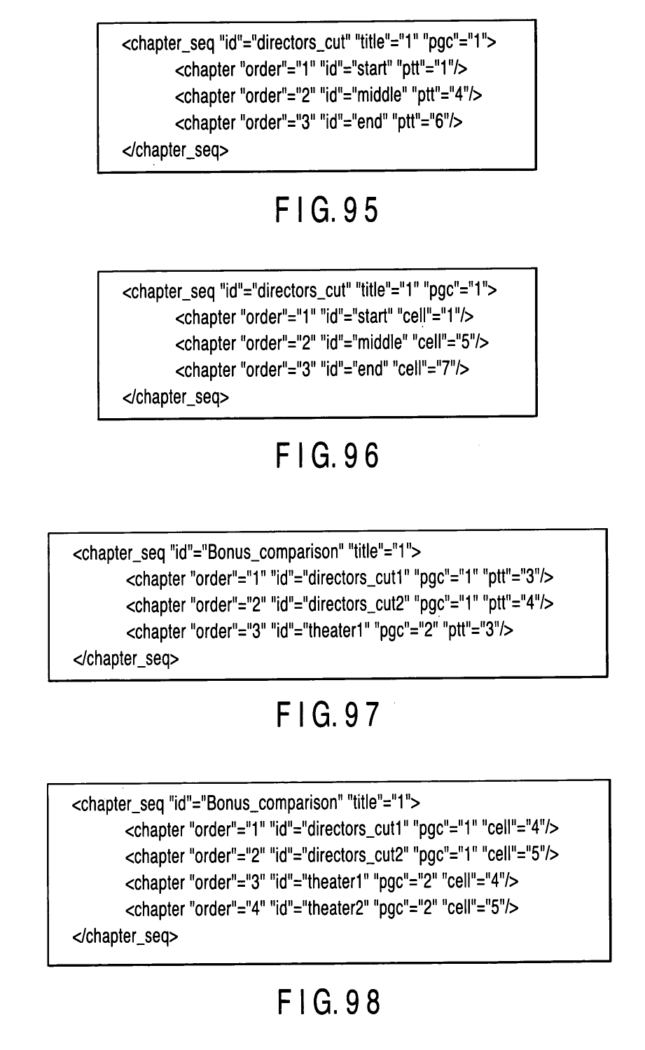

FIG. 95 shows a description example of a playback sequence in the playback sequence information file. Assume that the configuration in FIG. 93 is newly defined using the description of the above playback sequence information file (PBSEQ001.XML in FIG. 2, etc.). In the first line of the description in FIG. 95, “directors_cut” is defined as a name for uniquely defining the playback sequence, and it is defined that this playback sequence is described based on PGC information of PGC#1 and title#1.

In the second to fourth lines of the description in FIG. 95, three chapters (PTT numbers) that form the playback sequence of “directors_cut” are defined, and names that uniquely define these chapters are defined using an attribute “id”. The playback order of the chapters (PTT numbers) is defined using attribute information “order”, and associations between these chapters and those in PGC#1 in FIG. 93 are defined using an attribute “pgc” (in this example, the playback order is described in three entries, e.g., chapter “order” “1”, “2”, and “3”).

The definition of the playback sequence using the markup language description in the aforementioned playback sequence information file is convenient for a case wherein “an advanced VTS is defined as DVD video picture materials divided into respective chapters (PTTs), which are re-defined in correspondence with use purposes like a playback sequence used in a menu screen, that used in title playback, and that used in bonus content”. Since this playback sequence is defined using the markup language, it can be easily edited later. For example, such playback sequence can be advantageously applied to, e.g., a case wherein a different sequence is to be defined later using movie content (divided into a plurality of chapters) already printed on a DVD-Video disc as a material (reordering of the playback order of a plurality of chapters including repetitive playback of a specific chapter and/or playback skip of a specific chapter).

FIG. 96 shows an example in which the same playback sequence as that in FIG. 95 is described using cell units with respect to the advanced VTS shown in FIG. 71. When each of the chapters (PTT numbers) shown in FIG. 95 corresponds to one cell, the playback sequence is configured by three entries (chapter “order”=“1”, “2”, and “3”) as in FIG. 95.

FIG. 97 shows an example of the playback sequence upon expressing a playback sequence across a plurality of PGCs. For example, the playback sequence in FIG. 97 is configured to continuously play back different video parts of the director's cut version and theatrical release version, which are formed by the interleaved block. Such configuration is effective to create content that give an explanation about the difference between the director's cut version and theatrical release version in DVD bonus content or the like.

As the differences of the markup language used to describe the playback sequences, in the examples shown in FIGS. 95 and 96, the first line describes the PGC number that uniquely designates the chapters (PTT numbers) or cell numbers, while in the example of FIG. 97, the markup description that designates the chapter number includes the PGC number. With such description, one playback sequence can be configured across a plurality of PGCs (across PGC#1 and PGC#2 in this example).

FIG. 98 shows an example in which the same playback sequence as that in FIG. 97 is described using cell units with respect to the advanced VTS shown in FIG. 93. Since PTT=3 (PTT#3) of PGC number=2 (PGC#2) are configured by two cells (corresponding to cell#1 and cell#2 of EVOB#2 in the example of FIG. 93), the number of cell entries required to express the same playback sequence is increased to two (“cell”=“4” of chapter “order”=“3” and “cell”=“5” of chapter “order”=“4” in the example of FIG. 98).

Since the description method in the aforementioned playback sequence information file (PBSEQ001.XML in FIG. 2, etc.) allows flexible definitions, a more complicated, detailed playback sequence can be described using a definition different from the above example. By defining the playback sequences as exemplified above, the flow of playback of the advanced VTS stored in a DVD disc can be flexibly changed (after distribution of the disc). For example, after a given DVD disc was released, a movie company contrives a new method of enjoying the DVD video picture, and delivers a new playback sequence via the Internet. Then, users enjoy playback of the DVD video picture using the new playback sequence.

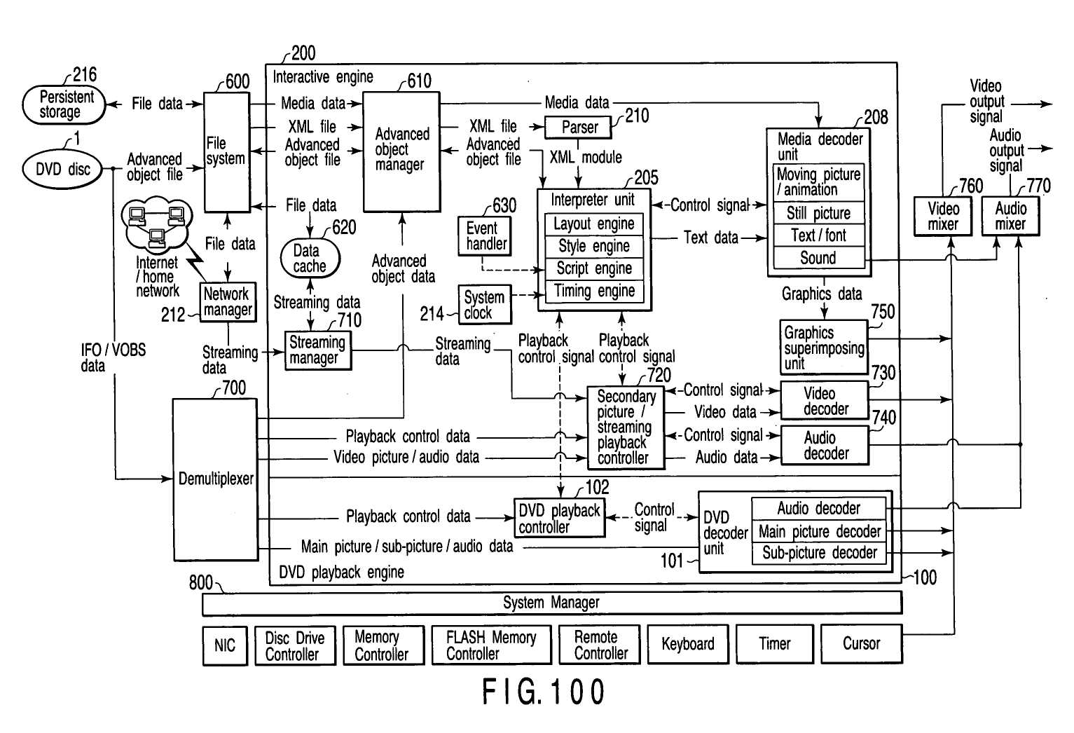

Likewise, the use method that allows the user to edit an arbitrary playback sequence by himself or herself and to enjoy video picture playback by joining his or her favorite scenes can be provided (in this case, information obtained by editing the playback sequence by the user himself or herself can be saved in, e.g., persistent storage 216 in FIG. 72 or 100).

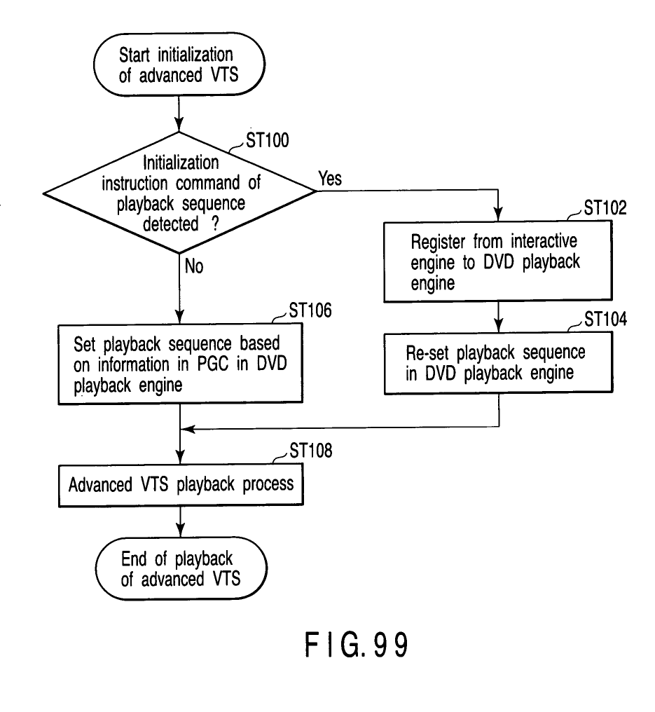

FIG. 99 is a flowchart showing an example of the processing for initializing the playback sequence of the advanced VTS (e.g., for re-setting the settings based on the default playback sequence to those of another playback sequence described in the playback sequence information file) in DVD playback engine 100 in, e.g., FIG. 72 or 100 using the playback sequence information file (PBSEQ001.XML in FIG. 2, etc.) prior to playback of the advanced VTS.

Upon starting playback of the advanced VTS, interactive engine 200 begins to initialize the DVD-Video player (definition of a playback sequence of objects to be played back) in accordance with a predetermined procedure described in, e.g., startup information recording area 210A in FIG. 50.

If it is determined in a condition determination part in step ST100 that the described initialization procedure describes a playback sequence setting command of the advanced VTS based on playback sequence information (YES in step ST100), interactive engine 200 registers playback sequence information (e.g., the description of PBSEQ001.XML in FIG. 2) in DVD playback engine 100 (step ST102). DVD playback engine 100 re-sets the playback sequence of the advanced VTS in accordance with the playback sequence information registered by interactive engine 200 in step ST102 (step ST104).

If it is determined in a condition determination part in step ST100 that no playback sequence setting command of the advanced VTS based on playback sequence information is described (NO in step ST100), DVD playback engine 100 determines a playback sequence in accordance with cell playback information (C_PBIT) in program chain information (PGCI) recorded in the advanced VTS (step ST106).

DVD playback engine 100 controls playback of the advanced VTS in accordance with the playback sequence set based on the cell playback information (C_PBIT) in step ST106, or controls playback of the advanced VTS in accordance with a playback command from interactive engine 200 on the basis of the playback sequence set based on the description of the playback sequence information file or the like in step ST104 (step ST108). After execution of playback using all advanced VTSs, the playback process ends.

In other words, FIG. 99 executes the following processing. That is, it is checked if a playback sequence definition based on playback sequence information (playback sequence information acquired from, e.g., the Internet if it is not stored in the playback sequence information recording area) is available (ST100). If no playback sequence definition based on playback sequence information is available (NO in step ST100), expanded video objects (EVOBs) are played back (ST108) on the basis of management information (PGCI) in the management area (ST106); if the playback sequence definition based on playback sequence information is available (YES in step ST100; initialize the playback sequence), expanded video objects are played back (ST108) on the basis of the playback sequence information (ST102 to ST104).

Alternatively, the processing in FIG. 99 is executed as follows. It is checked if a playback sequence definition based on playback sequence information is available (ST100). If the playback sequence definition based on playback sequence information is available (YES in step ST100; initialize the playback sequence), expanded video objects are played back (ST108) on the basis of at least one of a sequence of the program chain numbers, a sequence of the cell numbers, and a sequence of the chapter numbers, which are defined by the playback sequence information (ST102 to ST104).

FIG. 100 is a system block diagram for explaining an example of the internal structure of a playback apparatus (advanced VTS compatible DVD-Video player: another example of the apparatus shown in FIG. 72) according to another embodiment of the present invention. This DVD-Video player plays back and processes the recording content (DVD-Video content and/or advanced content) from information storage medium 1 (which records the VTSI and VTS_EVOBS shown in, e.g., FIGS. 93, 94, and the like) shown in FIGS. 1, 50, 73, 74, 79, and the like, and downloads and processes advanced content from a communication line (e.g., the Internet/home network or the like).

In the system arrangement of the embodiment shown in FIG. 100, interactive engine 200 comprises parser 210, advanced object manager 610, data cache 620, streaming manger 710, event handler 630, system clock 214, interpreter unit 205 including a layout engine, style engine, script engine, and timing engine, media decoder unit 208 including moving picture/animation, still picture, text/font, and sound decoders, graphics superposing unit 750, secondary picture/streaming playback controller 720, video decoder 730, audio decoder 740, and the like.

On the other hand, DVD playback engine 100 comprises DVD playback controller 102, DVD decoder unit 101 including an audio decoder, main picture decoder, sub-picture decoder, and the like, and so forth.

The DVD-Video player comprises, as functional modules to be provided to interactive engine 200 and DVD playback engine 100, persistent storage 216, DVD disc 1, file system 600, network manager 212, demultiplexer 700, video mixer 760, audio mixer 770, and the like. Also, as modules which are the functions of the DVD-Video player and are mainly used by interactive engine 200 to perform information acquisition and operation control via system manager 800, the player comprises an NIC, disc drive controller, memory controller, FLASH memory controller, remote controller, keyboard, timer, cursor, and the like.

The recording locations and formats of advanced content other than DVD-Video data to be handled by interactive engine 200 are as follows (note that a disc described as a DVD disc includes not only a normal DVD-Video disc but also a next-generation HD_DVD disc).

1. file format data on the DVD disc

2. multiplexed divided data in an EVOB on the DVD disc

3. file format data in the persistent storage of the DVD-Video player 4. file format data or streaming data on a network server on the Internet/home network

“File format data on the DVD disc” of “1.” is stored in advanced content recording area 21 in FIG. 79. Interactive engine 200 loads an advanced content file on the DVD disc via the file system.

“Multiplexed divided data in an EVOB on the DVD disc” of “2.” has a data format which is multiplexed and recorded in a VTS_EVOBS recorded in advanced HD video title set recording area (AHDVTS) 50 in FIG. 79. As the multiplexed data, data redundant to “file format data on the DVD disc” of “1.” are recorded. Such data is loaded to demultiplexer 700 in correspondence with loading of the VTS_EVOBS, and if the demultiplexed data are divided data of advanced content, they are sent to advanced object manager 610.

Advanced object manager 610 temporarily stores the divided data of the advanced content received from demultiplexer 700, and stores them as file format data of the advanced content in data cache 620 at the reception timing of data that can form one file.

As multiplexed advanced content data in an EVOB on the DVD disc, file data obtained by compressing one or a plurality of advanced content files in accordance with a predetermined method may be divisionally stored, so as to improve the efficiency of data upon multiplexing. In this case, advanced object manager 610 temporarily stores divided data until the compressed data can be decompressed, and stores decompressed advanced content data in data cache 620 at a timing at which the advanced content data can be handled as a file format.

“File format data in persistent storage 216 of the DVD-Video player” of “3.” corresponds to, e.g., introduction movie data of a new film or the like which is downloaded from the Internet and is stored at a predetermined position on persistent storage 216 while interactive engine 200 is playing back a DVD title including advanced content created by a given movie company.

For example, when a DVD title including other advanced content created by that movie company is played back, the following use method may be adopted. That is, “interactive engine 200 searches the predetermined position on persistent storage 216 in accordance with the description of the markup/script language of advanced content. If interactive engine 200 finds the saved introduction movie data of the new film there, it jumps to an XML page required to refer to/play back that data. If the playback process is selected by a user operation, interactive engine 200 plays back the introduction movie data of the new film stored in persistent storage 216”.

An example of file format data of “file format data or streaming data on a network server on the Internet/home network” of “4.” corresponds to the aforementioned introduction movie data of the new film or the like. As an example of streaming data, the following use method may be adopted. That is, “when DVD-Video data of a movie on a DVD disc includes only Japanese and English audio data, a movie company creates Chinese audio data, and a DVD-Video player connected to the Internet plays back the Chinese audio data in synchronism with video picture data on the DVD disc while sequentially downloading it”.

In the system block diagram of FIG. 100, file system 600, parser 210, interpreter unit 205, media decoder unit 208, data cache 620, network manager 212, streaming manager 710, graphics superposing unit 750, secondary picture/streaming playback controller 720, video decoder 730, audio decoder 740, demultiplexer 700, DVD playback controller 102, DVD decoder unit 101, and the like can be implemented by a microcomputer and/or hardware logic which implement/implements respective module functions by parsing built-in programs (firmware; not shown). A work area (including a temporary buffer used in a decoding process) used upon executing this firmware can be assured using a semiconductor memory (not shown) (and a hard disc device as needed) of each module. Furthermore, the system includes communication means for control signals (not shown) between respective modules so as to attain data supply and a synchronization process, and operation control between required modules can be managed. The communication means include signal lines of the hardware logic, event/data notification processes between software programs, and the like.

The behaviors for respective functions of the DVD-Video player will be described below using the system block diagram of FIG. 100. The DVD-Video player that plays back advanced content implements richly expressive menus and more interactive playback control, which are difficult to attain in the conventional DVD, using an XML file and style sheet described using the markup/script language or the like. An example in which a menu page including a button selection that outputs an animation effect or effect sound upon selection of the user is to be configured will be examined.

The configuration and functions of the menu page are defined by a menu XML page described using the markup/script language. The menu XML page is stored in a DVD disc, and interpreter unit 205 passes the content of the menu XML page parsed by parser 210 to the layout engine, style engine, script engine, timing engine, and the like in accordance with their description content.

The timing engine receives time events from system clock 214 at predetermined intervals, and instructs processing instructions to the layout engine, style engine, and script engine on the basis of the description of the menu XML page arranged in the timing engine. These engines refer to configuration information of the menu XML page managed by them, and issue decode process instructions to media decoder unit 208 as needed.

Media decoder unit 208 loads media data from the advanced object save area such as data cache 620 or the like as needed in accordance with instructions from interpreter unit 205, and executes decode processes.

Of data decoded by media decoder unit 208, moving picture/animation, still picture, and text/font output results associated with graphics display are sent to graphics superposing unit 750, which generates frame data of a graphics plane to be output in accordance with the descriptions of the layout and style sheet of interpreter unit 205, and outputs it to video mixer 760.

Video mixer 760 mixes the output frame of graphics superposing unit 750, an output frame of the video decoder which is output in accordance with an instruction from secondary picture/streaming playback controller 720, output frames of the main picture decoder and sub-picture decoders in DVD decoder unit 101 which are output in accordance with an instruction from DVD playback controller 102, an output frame of the cursor function of the DVD-Video player, and the like in accordance with a predetermined superposing rule while synchronizing these output frames. Video mixer 760 converts the mixed output frame data into a television output signal, and outputs it onto a video output signal line.

The behavior of the secondary picture/streaming playback controller 720 which is output in synchronism with the output frame of the graphics frame will be described below. As a main storage destination of secondary picture data, a DVD disc and streaming server on the Internet or home network are assumed.

Upon playback of secondary picture data stored on the DVD disc, IFO/VOBS (including an EVOBS) data is loaded from the DVD disc to demultiplexer 700. Demultiplexer 700 identifies various types of multiplexed data, and demultiplexes and sends data associated with main picture playback control to DVD playback controller 102, data associated with main picture, sub-picture, and audio of the DVD-Video to DVD decoder unit 101, and data associated with secondary picture playback control to secondary picture/streaming playback controller 720. If advanced object data are multiplexed and stored in this data, these data are sent to advanced object manager 610.

Secondary picture/streaming playback controller 720 executes playback control of secondary picture data on the DVD disc on the basis of a playback control signal from interpreter unit 205. For example, when interpreter unit 205 instructs not to execute playback of stored secondary picture data, all data are discarded here. When a playback instruction is issued, secondary picture/streaming playback controller 720 outputs data shaped to a format and data size suited to decode processes to video decoder 730 and audio decoder 740. Video decoder 730 and audio decoder 740 execute decode processes while synchronizing their output timings with the output from DVD decoder unit 101, in accordance with an instruction from secondary picture/streaming playback controller 720.

Control signals instructed by secondary picture/streaming playback controller 720 include instructions of the video position, the degree of scaling, that of a transparency process, a chroma color process, and the like to video decoder 730, and a volume control instruction, channel mixing instruction, and the like to audio decoder 740.

When the user designates fastforwarding, jump, or the like via a remote controller or the like, event handler 630 acquires an event from the remote controller, and notifies the script engine of interpreter unit 205 of that event. The script engine runs in accordance with the markup/script description of an XML file used to execute playback control, and confirms the presence/absence of an event handler of the remote controller process. If the XML file used to execute the playback control defines an explicit behavior, the script engine executes a process according to the description; if nothing is defined, it executes a predetermined process.

When fastforwarding is to be executed as a result of the user's remote controller process, interpreter unit 205 instructs DVD playback controller 102 and secondary picture/streaming playback controller 720 to execute fastforwarding. DVD playback controller 102 re-configures a read schedule of VOBS data to change a data read process from the DVD disc in accordance with the fastforwarding instruction from interpreter unit 205. In this way, control is made to supply required data to fastforwarding playback of DVD playback controller 102 and DVD decoder unit 101 without causing any underflow. Since data to be supplied to secondary picture/streaming playback controller 720 are stored in correspondence with the main picture data allocation, secondary picture data suited to fastforwarding playback are supplied from demultiplexer 700 in synchronism with the data read process required for fastforwarding executed by DVD playback controller 102.

Upon playing back stream data based on the secondary picture/streaming playback control, secondary picture/streaming playback controller 720 instructs streaming manager 710 to read streaming data on a predetermined network server and to supply the read data to itself on the basis of a playback control signal from interpreter unit 205.

Streaming manager 710 requests network manager 212 to execute a protocol control process of actual streaming data reception, and acquires data from the network server. At this time, for example, when the bit rate of the streaming data is high, look-ahead cashing of streaming data is made using a streaming buffer area on data cache 620 which is set in advance based on startup information, thus making control for broadening, e.g., an allowance of reception bit rate variations of streaming data.

In this case, streaming manager 710 temporarily stores streaming data from the network server in the streaming buffer on data cache 620, and supplies data stored in the streaming buffer on data cache 620 in response to a streaming data read request from secondary picture/streaming playback controller 720. When no streaming buffer is assured on data cache 620, streaming manager 710 sequentially outputs streaming data acquired from the network server to secondary picture/streaming playback controller 720.

When secondary picture/streaming playback controller 720 performs playback control of streaming data on the network, it need not always perform playback in synchronism with video picture playback of DVD playback engine 100. For this reason, secondary picture/streaming playback controller 720 need not play back any streaming data even when DVD playback engine 100 does not perform any video picture playback, or it need not synchronize the playback state of streaming data with that (e.g., a special playback state such as a fastforwarding state or pause state) of DVD playback engine 100.

Upon executing the playback process of streaming data read from a streaming server on the network, data supply underflow is likely to occur. In this case, a priority process can be designated in the description of the markup/script language of advanced content to flexibly define behaviors as follows. For example, the playback process of DVD playback engine 100 is preferentially executed, and DVD-Video playback is continued even when streaming data is interrupted. Alternatively, playback of streaming data is preferentially executed, and DVD-Video playback is interrupted when streaming data is interrupted. Data to be played back by secondary picture/streaming playback controller 720 may be video data alone or audio data alone.

An example of the functions of respective modules which form the system block diagram of FIG. 100 will be explained below.

Persistent storage 216: It stores generated file data, file data downloaded from the Internet/home network, and the like in accordance with an instruction from interpreter unit 205. Data stored in persistent storage 216 are held even when the ON/OFF event of the power switch of the DVD-Video player occurs. Interpreter unit 205 can erase data in persistent storage 216.

DVD disc 1: It stores advanced content and DVD-Video data. Sector data on the DVD disc are read in accordance with read requests from the file system and demultiplexer.

File system 600: It manages the file system for respective recording modules/devices, and provides a file access function to file data read/write requests from the advanced object manager and the like. As an example of the file system for respective recording modules/devices, when persistent storage 216 comprises a FLASH memory, a file system for the FLASH memory is used to control to average memory rewrite accesses. DVD disc 1 is accessed using a UDF or ISO9660 file system. As for files on the network, network manager 212 executes actual protocol control such as HTTP, TCP/IP, and the like, and the file system itself relays the file access function to network manager 212. The file system manages data cache 620 as, e.g., a RAM disc.

Network manager 212: It provides a read (write as needed) function of file data provided on an HTTP server on the network to the file system. It also executes actual protocol control in accordance with a sequential read request of stream data from streaming manager 710, acquires the requested data from the streaming server on the network, and passes the acquired data to streaming manager 710.

Demultiplexer 700: It reads data on the DVD disc in accordance with a read instruction of sector data that store IFO/VOBS data from DVD playback controller 102 (and the secondary picture/streaming playback controller when secondary picture data alone is played back). As for multiplexed data of the read data, demultiplexer 700 supplies demultiplexed data to appropriate processing units. Demultiplexer 700 supplies IFO data to the DVD playback controller and secondary picture/streaming playback controller 720. Demultiplexer 700 outputs main picture/sub-picture/audio data associated with DVD-Video stored in a VOBS to DVD decoder unit 101, and control information (NV_PCK) to DVD playback controller 102. Demultiplexer 700 outputs control information and picture/audio data associated with secondary picture data to secondary picture/streaming playback controller 720. When advanced objects are multiplexed in a VOBS, these data are output to advanced object manager 610.

Parser 210: It parses the markup language described in an XML file and outputs the parsed result to interpreter unit 205.

Advanced object manager 610: It manages an advanced object file to be handled by interactive engine 200. Upon reception of an access request to an advanced object file from parser 210, interpreter unit 205, media decoder unit 208, and the like, advanced object manager 610 confirms the storage state of file data on data cache 620 managed by manager 610. If the requested file data is stored in data cache 620, advanced object manager 610 reads data from data cache 620, and outputs the file data to a module that issued the read request. If the requested data is not stored in data cache 620, advanced object manager 610 reads file data from the DVD disc, a network server on the Internet/home network, or the like, which stores corresponding data, onto data cache 620, and simultaneously outputs the file data to a module that issued the read request. As for data stored in persistent storage 216, advanced object manager 610 does not normally execute any cache process to data cache 620.

As another principal function of advanced object manager 610, when multiplexed advanced object data is stored in VOBS data loaded by demultiplexer 700, advanced object manager 610 temporarily stores these data output from demultiplexer 700, and stores them in data cache 620 at a timing at which they can be stored as file data. When an advanced object file is stored in VOBS data in a format that compresses one or a plurality of files together, advanced object manager 610 temporarily stores divided data to a size that allows decompression, and then decompresses and stores data in data cache 620 as file data.

Advanced object manager 610 stores advanced object data in data cache 620, and timely deletes a file, which becomes unnecessary in playback of the advanced content of interactive engine 200, from data cache 620, in accordance with an instruction from interpreter unit 205 or a predetermined rule. With this delete process, the data cache area having a limited size can be effectively used in accordance with the progress of playback of the advanced content.

Interpreter unit 205: This is a module for controlling the behavior of entire interactive engine 200. It initializes data cache 620 and DVD playback controller 102 in accordance with startup information, loading information, or playback sequence information parsed by parser 210. In the playback process of the advanced content, interpreter unit 205 passes layout information, style information, script information, and timing information parsed by parser 210 to respective processing modules, sends control signals to media decoder unit 208, secondary picture/streaming playback controller 720, DVD playback controller 102, and the like in accordance with their descriptions, and executes playback control among modules.

Layout engine: The layout engine (one of internal components of interpreter unit 205) handles information associated with objects used in graphics output of the advanced content. It manages definitions, attribute information, and layout information on the screen of moving picture/animation, still picture, text/font, sound objects, and the like, and also manages association information with style information about modifications upon rendering.

Style engine: The style engine (one of internal components of interpreter unit 205) manages information associated with detailed modifications upon rendering of rendering objects managed by the layout engine script engine: The script engine (one of internal components of interpreter unit 205) manages descriptions associated with handler processes that pertain to button depression events from a user interface device (U/I device) such as a remote controller or the like and event messages from the system manager. Event handler 630 defines processing content upon occurrence of a corresponding event, and the script engine changes parameters of graphics rendering objects, and control of DVD playback controller 102, secondary picture/streaming playback controller 720, and the like in accordance with its description.

Timing engine: The timing engine (one of internal components of interpreter unit 205) controls scheduled processes associated with the behavior of graphics rendering objects and playback of secondary picture/streaming data. The timing engine refers to system clock 214, and when system clock 214 matches the timing of the scheduled control process, the timing engine controls respective modules to execute the playback process of the advanced content.

Media decoder unit 208: It executes the decode process of advanced objects in accordance with a control signal from interpreter unit 205. Media to be handled by media decoder unit 208 include cell animation that successively plays back still images of PNG/JPEG or the like as moving picture data, vector animation that successively renders vector graphics, and the like. Media decoder unit 208 can handle JPEG, PNG, GIF, and the like as still picture data. Upon rendering text data, media decoder unit 208 mainly refers to font data such as vector font (open font) and the like and executes rendering of text data designated by interpreter unit 205. As sound data, those which have relatively short playback times such as PCM, MP3, and the like are assumed. Such sound data is mainly used a sound effect involved in an event such as button clicking or the like. Of the decode results of media decoder unit 208, the outputs associated with graphics are output to graphics superposing unit 750. Also, sound outputs are output to audio mixer 770.

Graphics superposing unit 750: It superposes the outputs of graphics rendering objects output from media decoder unit 208 in accordance with the descriptions of the layout engine and style engine, and generates output image frame data. Most of rendering objects have transparency process information, and graphics superposing unit 750 also executes a transparency calculation process of these objects. The generated output image frame data is output to video mixer 760.

Data cache 620: It is mainly used in two use applications. In one use application, data cache 620 is used as a file cache of an advanced object file, and temporarily stores an advanced object file on the DVD disc or network. In the other use application, data cache 620 is used as a buffer of streaming data, and is managed by streaming manager 710. The allocations and sizes of the data cache used as the file cache and streaming buffer may be described in startup information or the like and may be managed for respective advanced content, or the data cache may be used to have predetermined allocations.

Streaming manager 710: It manages supply of streaming data between secondary picture/streaming playback controller 720 and network manager 212. When the bit rate of streaming data is relatively small and the streaming buffer need not be used, streaming manager 710 controls network manager 212 to sequentially supply streaming data acquired from a streaming server to secondary picture/streaming playback controller 720.

When the bit rate of streaming data is relatively large, streaming manager 710 can control supply of streaming data using the streaming buffer which is explicitly assured by the producer of advanced content. Streaming manager 710 stores data to be supplied to secondary picture/streaming playback controller 720 in the streaming buffer assured on data cache 620 in accordance with instructions of the streaming buffer size and read-ahead size interpreted by interpreter unit 205. When the data of the instructed read-ahead size is stored in the stream buffer, streaming manager 710 begins to supply streaming data to secondary picture/streaming playback controller 720. At the same time, as soon as a free space of a given size is assured on the streaming buffer, streaming manager 710 issues a data acquisition request to the streaming server, thus efficiently managing the streaming buffer.

Secondary picture/streaming playback controller 720: It executes playback control of streaming data supplied from streaming manager 710 and secondary picture data supplied from demultiplexer 700 in accordance with a playback control signal from interpreter unit 205.

Video decoder 730: It plays back video picture data supplied from secondary picture/streaming playback controller 720 in accordance with a control signal from secondary picture/streaming playback controller 720. When video picture data is secondary picture data supplied from demultiplexer 700 or when it is instructed to synchronize streaming data with DVD video picture playback, video decoder 730 decodes data to synchronize the output timing of DVD decoder unit 101 with its output timing, and outputs decoded data to video mixer 760.

Video decoder 730 has a chroma color process function for video picture data as its characteristic function. It manages a chroma color area designated by a specific one color or a plurality of colors as a transparent area to form output frame data of video mixer 760.

Audio decoder 740: It plays back audio data supplied from secondary picture/streaming playback controller 720 in accordance with a control signal from secondary picture/streaming playback controller 720. When audio data is that of secondary picture data supplied from demultiplexer 700 or when it is instructed to synchronize streaming data with DVD video picture playback, audio decoder 740 decodes data to synchronize the output timing of DVD decoder unit 101 with its output timing, and outputs decoded data to audio mixer 770.

DVD playback controller 102: It acquires playback control data of DVD-Video from demultiplexer 700 on the basis of a playback control signal from interpreter unit 205, and executes playback control of main picture/sub-picture/audio data of DVD decoder unit 101.

DVD decoder unit 101: It comprises an audio decoder, main picture decoder, sub-picture decoder, and the like, and manages decode processes and output processes while synchronizing respective decoder outputs in accordance with a control signal from DVD playback controller 102.

Audio decoder: The audio decoder in DVD decoder unit 101 decodes audio data supplied from demultiplexer 700 and outputs the decoded data to audio mixer 770 in accordance with a control signal from DVD playback controller 102.

Main picture decoder: The main picture decoder in DVD decoder unit 101 decodes main picture data supplied from demultiplexer 700 and outputs the decoded data to video mixer 760 in accordance with a control signal from DVD playback controller 102.

Sub-picture decoder: The sub-picture decoder in DVD decoder unit 101 decodes sub-picture data supplied from demultiplexer 700 and outputs the decoded data to video mixer 760 in accordance with a control signal from DVD playback controller 102.

Video mixer 760: It receives output frames from graphics superposing unit 750, video decoder 730, the main picture decoder and sub-picture decoder in DVD decoder unit 101, and the cursor module, generates an output frame in accordance with a predetermined superposing rule, and outputs a video output signal. In general, each frame data has transparency information as the whole frame data or at an object or pixel level, and video mixer 760 superposes output frames from respective modules using such transparency information.

Audio mixer 770: It receives audio data from media decoder unit 208, audio decoder 740, and the audio decoder in DVD decoder unit 101, and generates and outputs an output audio signal in accordance with a predetermined mixing rule.

System manager 800: It can provide an interface for status and control of respective modules in the DVD-Video player. Interpreter unit 205 acquires the status of DVD-Video player or can change the behavior via an application interface (API) or the like provided by the system manager.

Network connection controller (NIC): This is a module that implements a network connection function, and corresponds to an Ethernet controller (Ethernet is the registered trade name) or the like. The NIC provides information such as connection status of a network cable and the like via the system manager.

Disc drive controller: It corresponds to a reading device of a DVD disc, and provides status information such as the presence/absence of a DVD disc on a disc tray, disc type, and the like.

Memory controller: It manages the system memory: it provides an area to be used as data cache 620, and executes access management of a work memory used by respective software (firmware) modules.

FLASH memory controller: It provides an area used as persistent storage 216, and executes access management to the FLASH memory that stores execution codes and the like of respective software (firmware) modules.

Remote controller: It executes remote control of the DVD-Video player, and generates a button depression event of the user to event handler 630.

Keyboard: It executes keyboard control of the DVD-Video player, and generates a keyboard depression event of the user to event handler 630.

Timer: It supplies system clocks, and provides a timer function used by the DVD playback tine.

Cursor: It generates a pointer image of the remote controller or the like, and changes the position of the pointer image upon depression of direction keys and the like.

Interpreter unit 205 in FIG. 100 outputs a playback control signal to DVD playback controller 102. In this playback control signal, a new command is added to the conventional DVD playback control command, thus allowing more flexible playback control. That is, in order to define playback sequence information of an advanced VTS using the aforementioned playback sequence information (which corresponds to the PBSEQ001.XML file in FIG. 2, and is information stored in playback sequence information recording area 215A in FIG. 50, playback sequence information externally fetched via the Internet or the like, or playback sequence information which is generated by the system firmware when the user freely re-arranges chapter icons and is stored in persistent storage 216), a command for initializing using the playback sequence information must be issued from interactive engine 200 to DVD playback engine 100.

An “InitPBSEQ( ) command” is a command which is newly defined for the aforementioned purpose, and allows interpreter unit 205 to notify DVD playback controller 102 of the playback sequence information of an advanced VTS to be played back and to initialize it. As an argument of the “InitPBSEQ command”, sequence information of the PGC number, PTT numbers, and the like as a basis of the playback sequence is given (see FIGS. 95 to 98). If the advanced VTS includes a plurality of PGCs, the PGC number specifies a PGC to be selected. The PTT numbers can define the order of chapters to be played back with reference to the PGC_PGMAP number in the PGC designated by the PGC number. Since only one advanced VTS is stored on the DVD disc, and includes only one title, they need not be designated.

Note that the playback order can be described using cell units, as described above. In this case, the argument of the “InitPBSEQ command” is sequence information of the PGC number and cell numbers. The cell numbers can define the order of cells to be played back with reference to the C_PBIT number in the PGC designated by the PGC number. If the advanced VTS includes only one PGC, the argument of the PGC number in an “InitPBSEQ function” need not be used.

To summarize, the apparatus in FIG. 100 is configured to include the following elements. That is, the apparatus is configured to comprise a video playback engine (100) which plays back expanded video objects (EVOBs) from an information storage medium (disc 1); and an interactive engine (200) which acquires advanced content as information (e.g., 21A to 21E in FIG. 50) different from the recording content of a video data recording area from the information storage medium or an external server, and outputs an AV output corresponding to at least one of the playback output of the video playback engine and the content of the advanced content in accordance with the description of a markup language. The processing that “outputs an AV output corresponding to at least one of the playback output of the video playback engine and the content of the advanced content in accordance with the description of a markup language” can correspond to ST102 to ST104+ST108 or ST106+ST108 in FIG. 99.

FIG. 101 shows an example of the data structure of an advanced HD video title set program chain information table (AHDVTS_PGCIT) recorded in advanced HD video title set information (AHDVTSI). As shown in FIG. 101, advanced HD video title set program chain information table (AHDVTS_PGCIT) 512 records information of advanced HD video title set PGCI information table (AHDVTS_PGCITI) 512a including information of the number (AHDVTS_PGCI_SRP_Ns) of AHDVTS_PGCI_SRP data and the end address (AHDVTS_PGCIT_EA) of the AHDVTS_PGCIT. In addition, the advanced HD video title set information (AHDVTSI) includes AHDVTS_PGCI search pointers (AHDVTS_PGCI_SRP) 512b and PGC information (AHDVTS_PGCI) 512c as program chain information in correspondence with the number indicated by AHDVTS_PGCI_SRP_Ns. Each AHDVTS_PGCI search pointer (AHDVTS_PGCI_SRP) 512b includes information of an AHDVTS_PGC category (AHDVTS_PGC_CAT) indicating the type of AHDVTS_PGC, and the start address (AHDVTS_PGCI_SA) of AHDVTS_PGCI. Note that the AHDVTS_PGC category can have the same content as in FIG. 24.

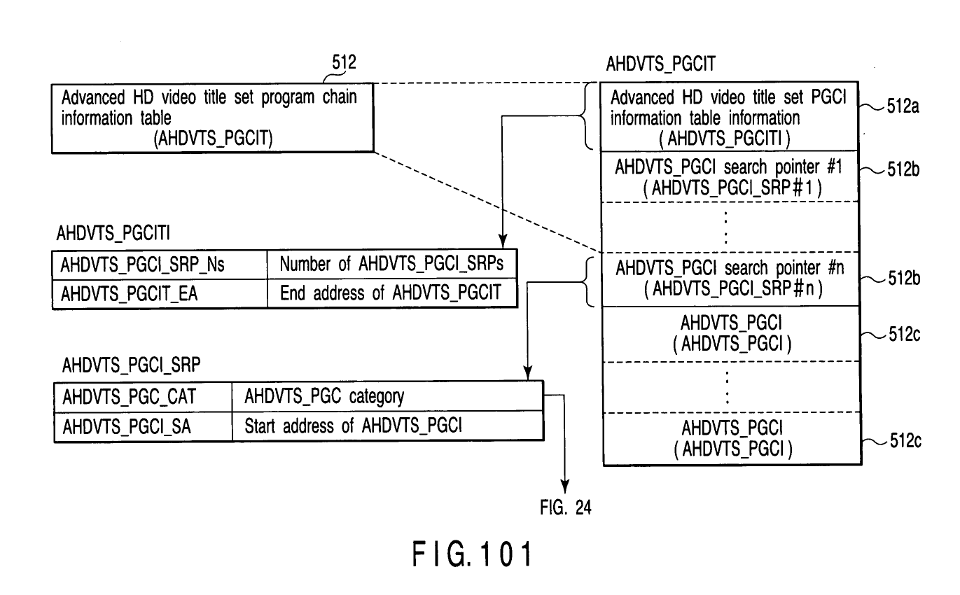

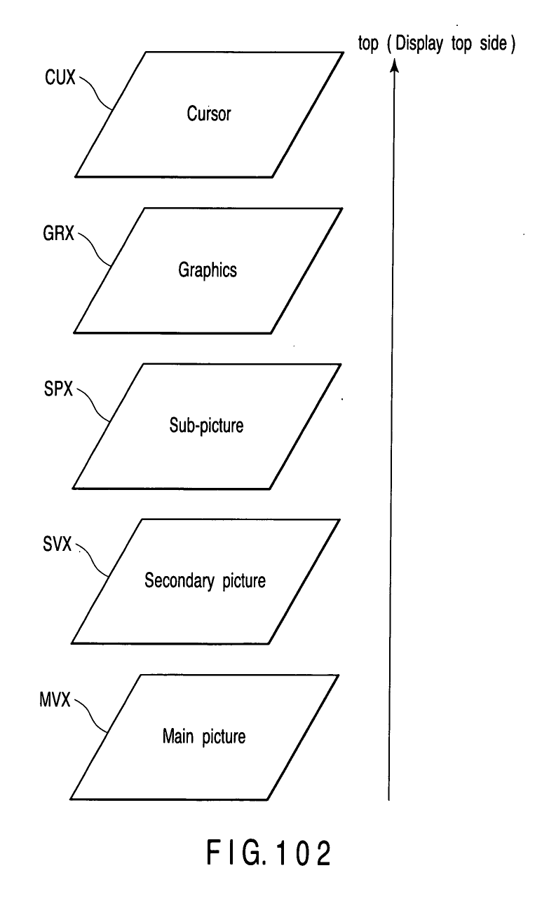

FIG. 102 shows an example of the plane configuration upon superposing the output frames of respective modules in video mixer 760 in FIG. 100. In this example, main picture plane MVX output from the main picture decode in DVD decoder unit 101 is arranged at the lowermost position of the superposed planes. Main picture plane MVX normally does not have transparency information.

Secondary picture plane SVX is arranged on main picture plane MVX. The output of this secondary picture plane SVX includes video picture data of streaming data (in this embodiment, video picture decoding processes of secondary picture and streaming data are exclusive, and these data are never decoded at the same time). Secondary picture plane SVX can have a transparency value of the entire plane as the superposing process with main picture data, and a chroma color process can be applied to a non-transparent pixel region.

This chroma color process may be executed by video decoder 730, and may be implemented in a format including transparency information as output data of video decoder 730. In this case, the transparency information of, e.g., a chroma color region is 0% (full transparency), and the remaining region has a transparency value applied to secondary picture data. The chroma color process may be executed by video mixer 760. In this case, for example, output data from video decoder 730 includes image frame data including a chroma color and chroma color information, and transparency value information for the secondary picture plane. Video mixer 760 applies a transparency process to a region designated by the chroma color to be fully transparent and the remaining region to have an input transparency value on the basis of the input image frame data.

Sub-picture plane SPX arranged on secondary picture plane SVX is the output from the sub-picture decoder in DVD decoder unit 101. On sub-picture plane SPX, a transparency value can be applied to sub-picture rendering objects (text and highlight information).

Graphics plane GRX arranged on sub-picture plane SPX is the output frame of the graphics superposing unit, and a transparency value is applied to this plane at a pixel level. A transparency value of the entire object is generally designated for an advanced object using the markup language. When a rendering object itself can describe a transparency value at a pixel level like PNG data, a transparency value obtained by multiplying that for each pixel of the object itself and that for the entire object becomes the transparency value of the object image at the pixel level. Graphics superposing unit 750 executes superposing and transparency processes of a plurality of rendering objects, and outputs the final color values and transparency values of graphics plane GRX as output data to video mixer 760.

Cursor plane CUX arranged on graphics plane GRX is a plane of a pointer image of the remote controller, mouse, or the like, and is arranged at the uppermost position of all the image planes. In general, cursor plane CUX uses a transparency value for the entire pointer image.

Video mixer 760 executes the superposing process of the output image frames of respective modules in accordance with superposing models defined as described above. Note that the above definition is an example of the superposing rule in video mixer 760, and a different superposing order of planes may be used or another transparency value process may be applied.

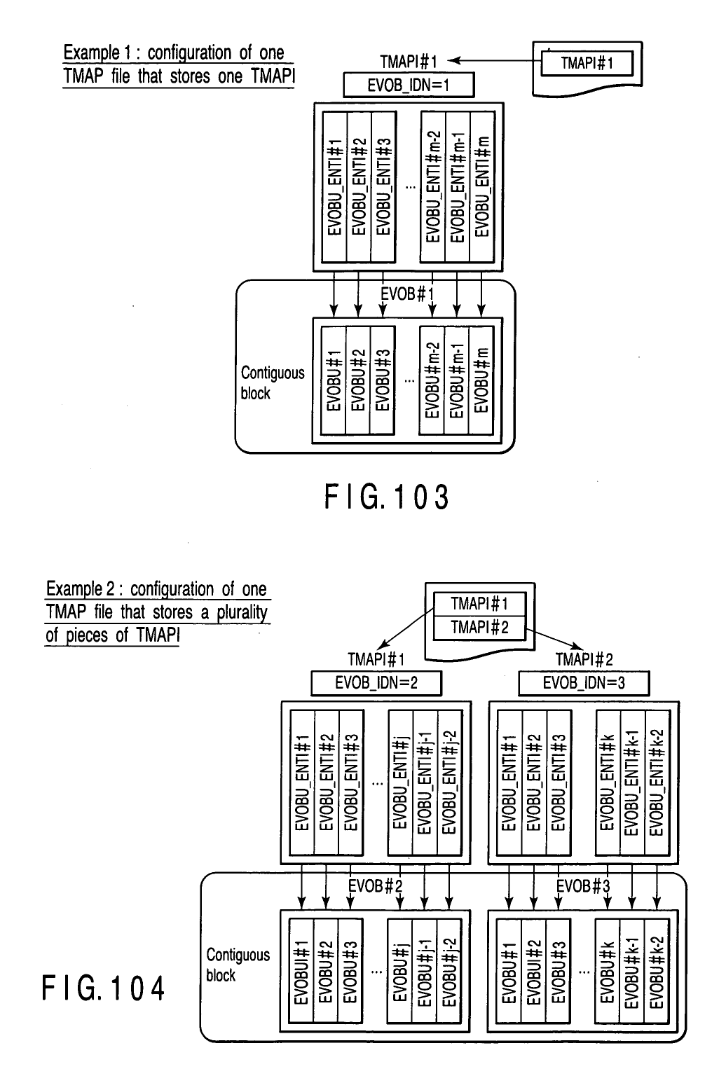

Another embodiment (an example without entry time entry) of time map information (TMAPI) shown in FIGS. 58 to 61 will be described below with reference to FIGS. 103 to 107. FIGS. 103 and 104 show an example of the time map configuration for EVOBs allocated in a contiguous block. FIG. 103 shows example 1 in which one TMAPI is stored in one TMAP file, and FIG. 104 shows example 2 in which one or more pieces of TMAPI are stored in one TMAP file. As shown in FIGS. 103 and 104, one EVOB corresponds to one TMAPI, and a structure that allows time to each EVOB→address conversion using each TMAPI stored in a file is adopted. Each TMAPI includes one or more pieces of EVOBU entry information, and EVOBUs in each EVOB can be accessed using this information.

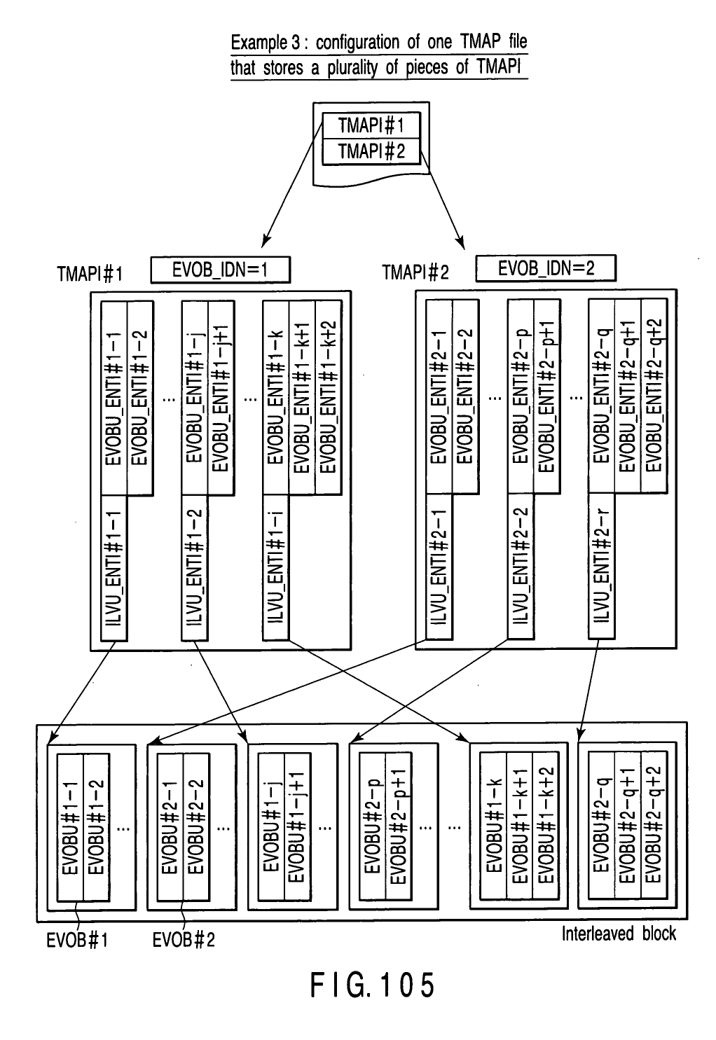

FIG. 105 shows an example of the time map configuration for EVOBs which are allocated in an interleaved block and form angles, so as to allow the user to attain seamless angle switching. As shown in FIG. 105, an EVOB for one angle corresponds to one TMAPI, and a structure that allows time to each EVOB o address conversion using each TMAPI stored in the file is adopted as in the EVOB time map allocated in the contiguous block. Each TMAPI includes one or more pieces of EVOBU entry information and one or more pieces of ILVU entry information, and the head of each ILVU in each EVOB and each EVOBU in that ILVU, which are allocated in the interleaved block, can be accessed.

Since each EVOB allocated in the interleaved block is stored in one file, all pieces of time map information required to play back that angle period can be acquired, and required files need not be searched for each time, thus improving the processing efficiency.

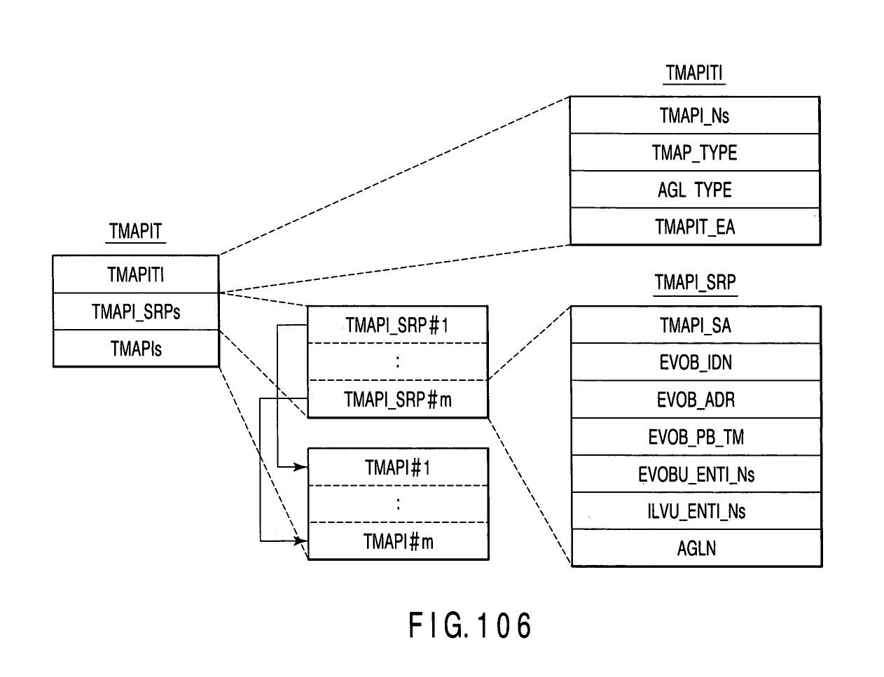

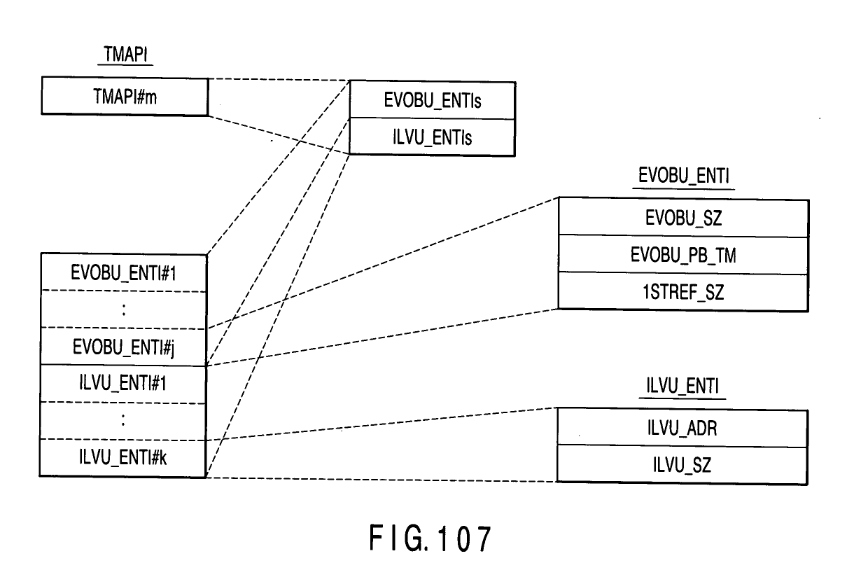

FIGS. 106 and 107 show an example of the data structure of a time map including no time entry. As shown in FIG. 106, a time map information (TMAPI) table includes TMAP information table information (TMAPITI) indicating the configuration of TMAPI stored in a file, a TMAP information search pointer group (TMAPI_SRPs) that gives a search pointer to each stored TMAPI, and a TMAP information group (TMAPIs) that stores EVOBU entry information of each TMAPI.

Time map information table information TMAPITI includes information (TMAPI_Ns) indicating the number of pieces of TMAPI stored in a TMAP file, block type information (TMAP_TYPE) indicating whether the block type of an EVOB stored in the TMAP file is a contiguous block (=0) or interleaved block (=1), angle type information (AGL_TYPE) indicating whether the angle type of an EVOB stored in the TMAP file is no angle (=0), non-seamless angle (=1), or seamless angle (=2), and information (TMAPIT_EA) indicating the end address of the table.

Each time map information search pointer TMAPI_SRP includes information (TMAPI_SA) indicating the start address of target TMAPI, information (EVOB_IDN) indicating the identification number of an EVOB designated by the target TMAPI, information (EVOB_ADR) indicating the start address of the EVOB designated by the target TMAPI, information (EVOB_PB_TM) indicating the playback time of the EVOB designated by the target TMAPI using, e.g., the number of fields, information (EVOBU_ENTI_Ns) indicating the number of pieces of EVOBU entry information stored in the target TMAPI, information (ILVU_ENTI_Ns: if no interleaved block is formed, ILVU_ENTI_Ns=0) indicating the number of pieces of ILVU entry information stored in the target TMAPI, and information (AGLN: if no angle block is formed, AGLN=0) indicating the angle number of the EVOB of the target TMAPI.

As shown in FIG. 107, each time map information TMAPI includes an EVOBU_ENTI group and ILVU_ENTI group. The EVOBU_ENTI group includes one or more pieces of EVOBU entry information (EVOBU_ENTI). Each EVOBU_ENTI includes a size (EVOBU_SZ) of each EVOBU stored in an EVOB, which is indicated by, e.g., the number of packs, a playback time (ESOBU_PB_TM) indicated by, e.g., the number of fields, and a size (1STREF_SZ) of first reference picture data, which is indicated by, e.g., the number of packs).

The ILVU_ENTI group includes one or more ILVU entry information (ILVU_ENTI). Each ILVU_ENTI includes the start address (ILVU_ADR) of each ILVU stored in an EVOB, and a size (ILVU_SZ) of each ILVU, which is indicated by, e.g., the number of EVOBUs.

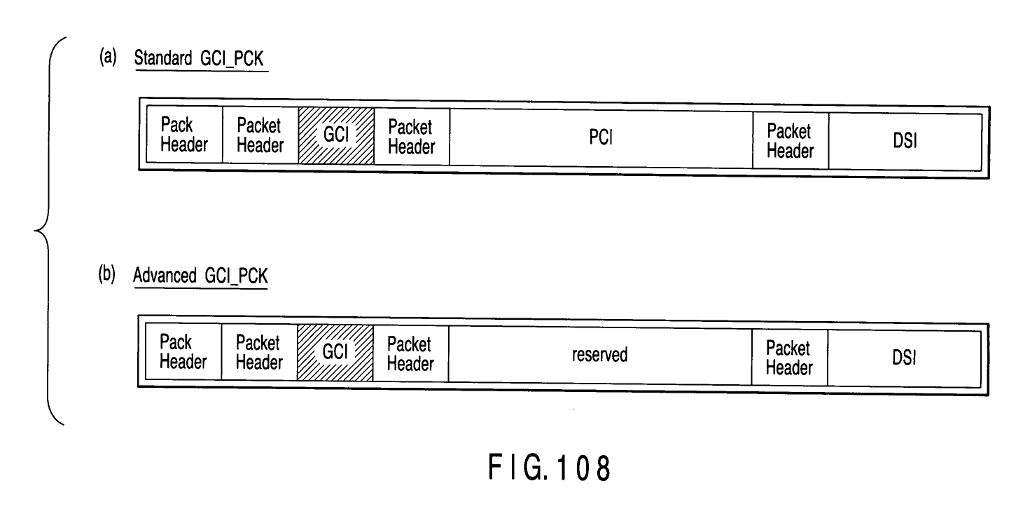

FIG. 108 shows an example of the structure which is different from that of a navigation pack (NV_PCK) shown in FIG. 63. As in NV_PCK, a general control information pack (GCI_PCK) allocated at the head of an EVOBU uses standard GCI_PCK shown in FIG. 108(a) in an EVOB in a standard VTS. This pack includes general control information (GCI) stored in a general control information packet (GCI_PKT), presentation control information (PCI) stored in a presentation control packet (PCI_PKT), and data search information (DSI) stored in a data search information packet (DSI_PKT).

Also, in an EVOB in an advanced VTS, an advanced GCI_PCK shown in FIG. 108(b) is used. This pack includes general control information (GCI) stored in a general control information packet (GCI_PKT) and data search information (DSI) stored in a data search information packet (DSI_PKT).

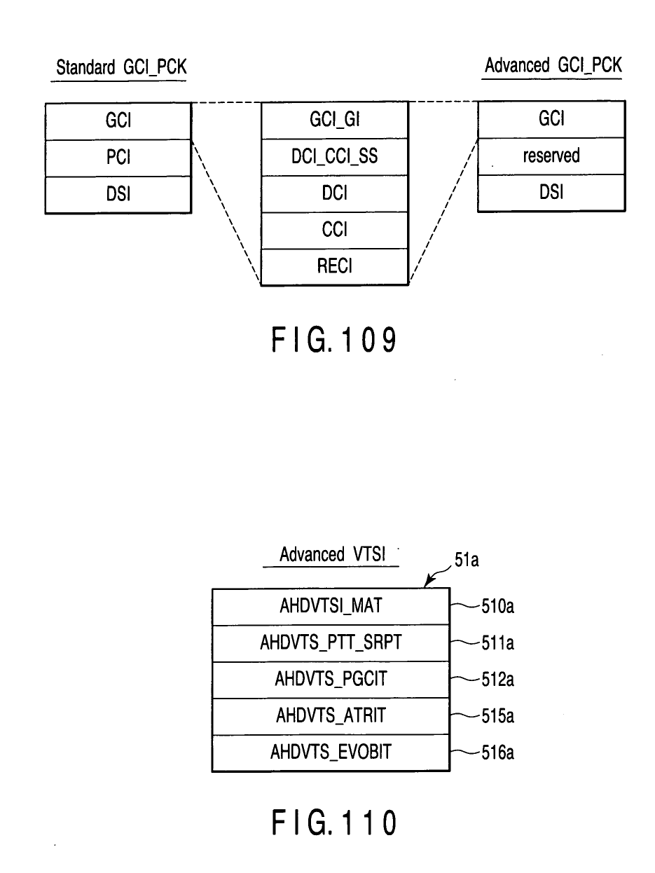

FIG. 109 shows information stored in the general control information (GCI). The general control information includes information (GCI_GI) associated with the entire EVOBU and pack in which that information is stored, information (DCI_CCI_SS) indicating the states of copy control information and display control information in the EVOBU and pack, display control information (DCI) indicating the aspect ratio and the like, copy control information (CCI) such as CGMS information, analog copy control information, and the like, recording information (RECI) that gives copyright information such as ISRC data or the like, and so forth.

FIG. 110 shows another embodiment of the data structure of advanced VTS 151a. As shown in FIG. 110, advanced HD video title set information (AHDVTSI) area 51 shown in FIG. 51(e) is divided into areas (management information groups) including advanced HD video title set information management table (AHDVTSI_MAT) 510a including no attribute information of video data, audio data, and the like, advanced HD video title set search pointer table (AHDVTS_PTT_SRPT) 511a used to search for the head of a part of title (PTT) corresponding to a chapter part of a title, advanced HD video title set program chain information table (AHDVTS_PGCIT) 512a that gives the playback sequence of a title, advanced HD video title set attribute information table (AHDVTS_ATRIT) 515a that gives attribute information of each EVOB, and advanced HD video title set expanded video object set information table (AHDVTS_EVOBIT) 516a that gives information of each EVOB.

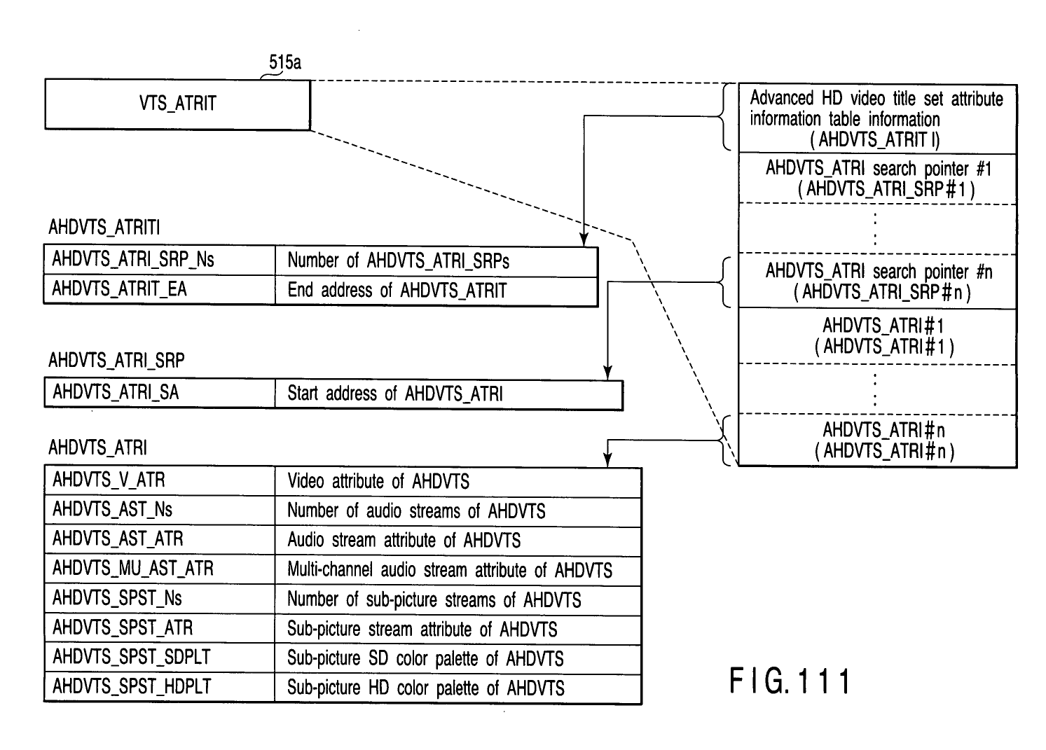

FIG. 111 shows an example of the data structure which shows the content of the advanced HD video title set attribute information table (AHDVTS_ATRIT). As shown in FIG. 111, AHDVTS_ATRIT 515a includes advanced HD video title set attribute information table information (AHDVTS_ATRITI), one or more advanced HD video title set attribute information search pointers (AHDVTS_ATRI_SRP), and one or more pieces of advanced HD video title set attribute information (AHDVTS_ATRI).

The advanced HD video title set attribute information table information (AHDVTS_ATRITI) has (AHDVTS_ATRI_SRP_Ns) indicating the number of pieces of attribute information stored in the table (the number of AHDVTS_ATRI_SRPs), and (AHDVTS_ATRIT_EA) indicating the end address of the table. The advanced HD video title set attribute information search pointer (AHDVTS_ATRI_SRP) has (AHDVTS_ATRI_SA) indicating the start address of each attribute information. The advanced HD video title set attribute information (AHDVTS_ATRI) indicates attribute information for a corresponding EVOB.

More specifically, the AHDVTS_ATRT has information (AHDVTS_V_ATR) indicating video attribute information such as MPEG-2, MPEG-4 AVC (H.264), SMPTE VC-1, and the like stored in an EVOB, information (AHDVTS_AST_Ns) indicating the number of audio streams, audio stream attribute information (AHDVTS_AST_ATR) such as DD+, DTS++, MLP, LPCM, and the like (all of DD for Dolby Digital, DTS for Digital Theater System, and MLP for Meridian Lossless Packing are the registered trade names) stored in an EVOB, multi-channel audio stream attribute information (AHDVTS_MU_AST_ATR), information (AHDVTS_SPST_Ns) indicating the number of sub-picture streams, sub-picture stream attribute information (AHDVTS_SPST_ATR) indicating the SD size (2 bits/pixel), HD size (2 bits/pixel), SD/HD size (8 bits/pixel), or the like stored in an EVOB, information (AHDVTS_SPST_SDPLT) indicating a color palette for sub-picture SD, information (AHDVTS_SPST_HDPLT) indicating a color palette for sub-picture HD, and the like.

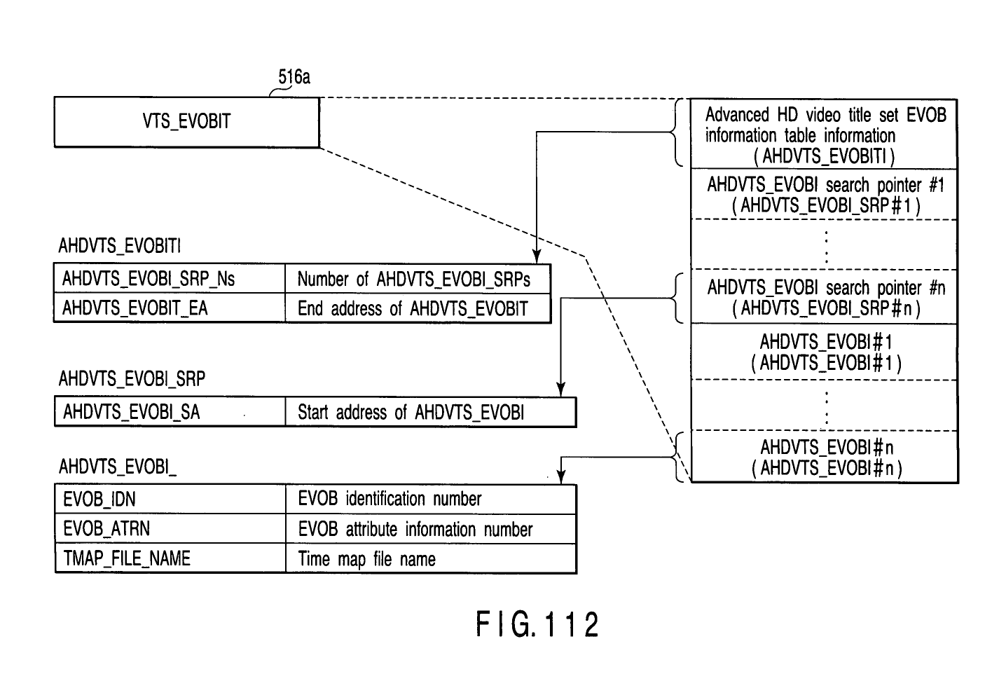

FIG. 112 shows an example of the data structure that shows the content of the advanced HD video title set EVOB information table (AHDVTS_EVOBIT). As shown in FIG. 112, AHDVTS_EVOBIT 516a includes advanced HD video title set EVOB information table information (AHDVTS_EVOBITI), one or more advanced HD video title set EVOB information search pointers (AHDVTS_EVOBI_SRP), and one ore more pieces of advanced HD video title set EVOB information (AHDVTS_EVOBI).

The advanced HD video title set EVOB information table information (AHDVTS_EVOBITI) has information (AHDVTS_EVOBI_SRP_Ns) indicating the number of pieces of EVOB information stored in the table (the number of AHDVTS_EVOBI_SRPs) and information (AHDVTS_EVOBIT_EA) indicating the end address of the table. Note that the advanced HD video title set EVOB information search pointer (AHDVTS_EVOBI_SRP) has information (AHDVTS_EVOBI_SA) indicating the start address of each EVOBI. The advanced HD video title set EVOB information (AHDVTS_EVOBI) has information (EVOB_IDN) of an EVOB identification number used to identify each EVOB, information (EVOB_ATRN) of an EVOB attribute information number indicating an attribute corresponding to each EVOB, information (TMAP_FILE_NAME) indicating the time map file name that stores time map information used to access each EVOB, and the like. Note that the number described in EVOB_ATRN is the number indicated by the advanced HD video title set attribute information search pointer (AHDVTS_ATRI_SRP#) of the advanced HD video title set attribute information table (AHDVTS_ATRIT).

### SUMMARY

An information storage medium (high-definition video disc or the like) according to the embodiment of the present invention has a data area (12) that stores a video data recording area (20) including a management area (30) that records management information and an object area (40, 50) that records objects to be managed by this management information, and an advanced content recording area (21) including information (21A to 21E) different from the recording content (30 to 50) of this video recording area (20), and a file information area (11) storing file information corresponding to the recording content of this data area (12). In this information storage medium, the object area (40, 50) is configured to store expanded video objects (objects in an HDVTS and abbreviated as an EVOBS or VOBS as needed) which undergo playback management using a logical unit called a program chain, and advanced objects (objects in an AHDVTS) recorded independently of the expanded video objects. The advanced objects are configured to store playback control information and the like, which give playback sequence information (playback control information implemented by a markup language and the like, as exemplified in FIGS. 95 to 98) that describes the playback order of expanded video objects, and the playback conditions (playback timings, picture output positions, display sizes, etc.) of other advanced objects.

The playback conditions (or playback control information, playback sequence information, etc.) can be described by a provider of the content recorded on the information storage medium using a predetermined language (markup language or the like). By supplying the markup language that gives the playback conditions to a player via a network (Internet or the like), management information which is recorded on the information storage medium and is uniquely determined so far can be updated.

Furthermore, for example, the playback control information that controls playback of video objects is distributed via the Internet or the like after the disc is produced, or the aforementioned playback control information is added to a video disc which is produced once, thus producing a new disc without re-producing the disc. More specifically, video objects, which cannot be played back upon delivery of a DVD-Video disc, are allowed to be played back using playback control information distributed via the Internet under specific conditions, or problems can be corrected by controlling parts that include errors upon delivery of a DVD-Video disc.

Put differently, the embodiment of the present invention provides a scheme that allows the user to freely change and enjoy the playback sequence of advanced objects and/or expanded video objects using playback control information implemented by the markup language at the time of production or after sales of an information storage medium (ROM-based disc).

In each of the aforementioned embodiments described above with reference to the accompanying drawings, information elements (e.g., 310 to 318 in the example of FIG. 3) are arranged in the illustrated order. This arrangement corresponds to the order indicating which information element is to be loaded first by the player upon playback of disc 1.

The present invention is not limited to the aforementioned specific embodiments, but can be embodied by variously modifying constituent elements without departing from the scope of the invention when it is practiced. For example, the present invention can be applied not only to DVD-ROM Video that has currently spread worldwide but also to recordable/reproducible DVD-VR (video recorder) whose demand is increasing in recent years. Furthermore, the present invention can be applied to a reproduction system or a recording/reproduction system of next-generation HD_DVD which will be spread in the near future.

Furthermore, various inventions can be formed by appropriately combining a plurality of required constituent elements disclosed in the respective embodiments. For example, some required constituent elements may be omitted from all required constituent elements disclosed in the respective embodiments. Furthermore, required constituent elements across different embodiments may be appropriately combined.

What is claimed is:

1. An information storage medium comprising
a data area configured to contain a video data recording area which includes a management area for recording management information and an object area for recording objects to be managed by the management information, and an advanced content recording area which includes information different from recording content of the video data recording area, and
a file information area configured to store file information corresponding to recording content of the data area, wherein
the video data recording area is configured to store an expanded video object which undergoes playback management using a logical unit called a program chain and corresponds to a predetermined video picture, and
the advanced content recording area is configured to have a playback sequence information recording area which can store playback sequence information that defines a playback sequence upon playing back the video picture of the expanded video object using a markup language that describes a text attribute in accordance with predetermined commands.

2. The medium of claim 1, wherein the predetermined video picture can be divided into a plurality of chapters and can be managed by the logical unit of said program chain including a basic playback unit called cell, and
wherein a playback sequence upon playing back the video picture of the expanded video objects can be defined, using the playback sequence information, by at least one of
a sequence of number information of the program chain,
a sequence of number information of the cell, and
a sequence of number information of the chapter.

3. A playback method of playing back an information storage medium comprising a data area configured to contain a video data recording area which includes a management area for recording management information and an object area for recording objects to be managed by the management information, and an advanced content recording area which includes information different from recording content of the video data recording area, and a file information area configured to store file information corresponding to recording content of the data area, wherein the video data recording area is configured to store an expanded video object which undergoes playback management using a logical unit called a program chain and corresponds to a predetermined video picture, and the advanced content recording area is configured to have a playback sequence information recording area which can store playback sequence information that defines a playback sequence upon playing back the video picture of the expanded video object using a markup language that describes a text attribute in accordance with predetermined commands, said playback method comprising:
checking whether a definition of a playback sequence based on the playback sequence information is present;
playing back, when no definition of a playback sequence based on the playback sequence information is present, the expanded video object based on the management information in the management area; and
playing back, when the definition of the playback sequence based on the playback sequence information is present, the expanded video object based on the playback sequence information.

4. A playback method of playing back an information storage medium as defined by claim 2, comprising:
checking whether a definition of a playback sequence based on the playback sequence information is present; and
playing back, when the definition of the playback sequence based on the playback sequence information is present, the expanded video object based on at least one of
the sequence of number information of the program chain,
the sequence of number information of the cell, and
the sequence of number information of the chapter.

5. A playback apparatus using an information storage medium comprising a data area configured to contain a video data recording area which includes a management area for recording management information and an object area for recording objects to be managed by the management information, and an advanced content recording area which includes information different from recording content of the video data recording area, and a file information area configured to store file information corresponding to recording content of the data area, wherein the video data recording area is configured to store an expanded video object which undergoes playback management using a logical unit called a program chain and corresponds to a predetermined video picture, and the advanced content recording area is configured to have a playback sequence information recording area which can store playback sequence information that defines a playback sequence upon playing back the video picture of the expanded video object using a markup language that describes a text attribute in accordance with predetermined commands, said playback apparatus comprising:
a video playback engine configured to play back the expanded video object from the information storage medium; and
an interactive engine configured to acquire advanced content as the information different from the recording content of the video data recording area from the information storage medium or an external server, and to output an AV output corresponding to at least one of a playback output of the video playback engine and the advanced content in accordance with a description of the markup language.

6. A playback apparatus using an information storage medium as defined by claim 2, comprising:
a video playback engine configured to play back the expanded video object from the information storage medium; and
an interactive engine configured to acquire advanced content as the information different from the recording content of the video data recording area from the information storage medium or an external server, and to output an AV output corresponding to at least one of a playback output of the video playback engine and the advanced content in accordance with a description of the markup language.
